(19) United States
(12) Patent Application Publication
(10) Pub. No.: US 2023/0242745 A1
(43) Pub. Date: Aug. 3, 2023

(54) Process for Production of Thermoplastic Vulcanizates using Supported Catalyst Systems and Compositions Made Therefrom

(71) Applicant: ExxonMobil Chemical Patents Inc, Baytown, TX (US)

(72) Inventors: Lubin Luo, Houston, TX (US); Sudhin Datta, Houston, TX (US); Andy H. Tsou, Houston, TX (US); Jo Ann M. Canich, Houston, TX (US); Yen-Hao Lin, Houston, TX (US); Anupriya Jain, Pearland, TX (US); Jacqueline A. Lovell, Crosby, TX (US)

(21) Appl. No.: 17/999,287

(22) PCT Filed: May 20, 2021
(86) PCT No.: PCT/US2021/033294

§ 371 Date: Nov. 18, 2022

Related U.S. Application Data
(60) Provisional application No. 63/034,309, filed on Jun. 3, 2020.

(51) Int. Cl. C08L 23/12; C08F 4/659

(52) U.S. Cl. CPC C08L 23/12; C08F 4/65916; C08F 4/65912; C08L 2205/03; C08L 2205/025; C08L 2207/14; C08L 2207/02; C08L 2308/00; C08L 2314/06; C08F 2420/07; C08F 2420/02

(57) ABSTRACT

The present disclosure provides a catalyst system comprising the product of a catalyst compound capable of making crystalline material (such as isotactic PP) and a second catalyst compound capable of making non-diene-containing-amorphous material and diene-containing-elastomeric material. The catalyst system of the present disclosure may further comprise a support material (or product thereof) having one or more of: a surface area of from 400 m²/g to 800 m²/g; an average pore diameter of 90 Angstroms or greater; an average particle size of 60 μm or greater; 40% or greater of the incremental pore volume comprising pores having a pore diameter larger than 100 Angstroms or greater; and sub-particles having an average particle size in the range of 0.01 μm to 5 μm. In another embodiment, a propylene polymer composition includes: isotactic polypropylene; 5 wt % or greater of atactic polypropylene, based on the weight of the composition; and an ethylene-propylene-diene terpolymer. The present disclosure further provides methods for forming propylene polymer compositions.

### CROSS REFERENCE TO RELATED APPLICATIONS

This application claims the benefit of and priority to U.S. Provisional Application No. 63/034,309 filed Jun. 3, 2020, the disclosure of which is incorporated herein by reference.

This invention relates to U.S. Ser. No. 16/460,260, filed Jul. 2, 2019, which claims the benefit of and priority to U.S. Ser. No. 62/701,898, filed Jul. 23, 2018.

This invention also relates to U.S. Ser. No. 15/570,814, filed Oct. 31, 2017 which claims priority to and the benefit of U.S. Ser. No. 62/205,977, filed Aug. 17, 2015, U.S. Ser. No. 62/206,004, filed Aug. 17, 2015, and U.S. Ser. No. 62/171,590, filed Jun. 5, 2015.

This application also relates to U.S. Ser. No. 15/570,822, filed Oct. 31, 2017, which claims priority to and the benefit of U.S. Ser. No. 62/205,977, filed Aug. 17, 2015, U.S. Ser. No. 62/206,004, filed Aug. 17, 2015, U.S. Ser. No. 62/171,616, filed Jun. 5, 2015, and U.S. Ser. No. 62/171,590, filed Jun. 5, 2015.

This invention also relates to U.S. Ser. No. 16/379,372, filed Apr. 9, 2019 which claims priority to U.S. Ser. No. 62/656,792, filed Apr. 12, 2018.

This invention also relates to concurrently filed U.S. Ser. No. 63/034,303, filed Jun. 3, 2020 entitled “Thermoplastic Vulcanizates, Methods of Making, and Articles Made Therefrom”.

### FIELD

The present disclosure provides processes for production of thermoplastic vulcanizates using supported dual catalyst systems and the thermoplastic vulcanizates of propylene polymers and ethylene-propylene-diene polymer(s) made therefrom.

### BACKGROUND

Recently, efforts have been made to prepare heterophasic copolymers, such as an impact copolymer (ICP), using metallocene (MCN) catalysis technology to capitalize on the benefits such catalysts provide. However, conventional MCN catalysts, immobilized on a conventional support coated with an activator such as methylalumoxane (MAO), have difficulty providing copolymer components with sufficiently high rubber loadings under commercially relevant process conditions. Compared to their Ziegler-Natta (ZN) system catalyzed counterparts, an isotactic polypropylene (iPP) matrix of the ICP prepared using MCN often has a low porosity, and has difficulty holding a sufficiently high rubber content within an iPP matrix which would otherwise provide toughness and impact resistance. In addition, the formation of rubber in a separate phase outside the matrix can promote reactor fouling.

Pore structures in conventional iPP reactor granules, whether from ZN or MCN supported catalyst systems, are thought to be generated from the fast crystallization of low molecular weight portions of the polymer that causes volumetric shrinkage by crystallization right after slurry or gas-phase polymerization (where the polymerization temperature is below the melting temperature of the polymer thus formed). Nello Pasquini (Ed.), 2005, Polypropylene Handbook, 2nd Edition, Hanser Publishers, Munich, pp. 78-89, reports volumetric shrinkage processes lead to low porosities for limited rubber loadings in subsequent serial reactor rubber polymerization, e.g., 7% porosity from a conventional ZN catalyst system, and 16% more is obtained through the treatment of the MgCl₂-supported ZN system via controlled dealcoholation, allowing the iPP matrix to be filled with rubber approaching 25 wt %. Cecchin, G. et al. (2001) “On the Mechanism of Polypropene Growth over MgCl₂/TiCl₄ Catalyst Systems,” Macromol. Chem. Phys., vol. 202(10), p. 1987-1994, report that the micromorphologies of supported catalyst systems based on magnesium chloride-supported titanium tetrachloride (MgCl₂/TiCl₄) contribute to the polymer granule morphology. However, the rubber content of such an ICP obtained from one-catalyst serial reactor system (first reactor(s) for iPP and second reactor(s) for EP) is still significantly below than the 40 wt % rubber content that can be achieved in a post-reactor blending of EP with iPP (e.g., formed by melt blending). For a 160 mm extruder, which is one of the largest available, one can only obtain roughly 20,000 tons per year production. In order to provide rubber feed flowability to prevent feed throat bridging or jamming, granulated rubbers are dusted with talc, calcium stearate, polyethylene powders, or other anti-agglomeration particles. All of these particles will stay in the final blends leading to undesirable blend stiffening and weakening (lowering the toughness). Furthermore, the post reactor blendings cannot deliver the exceptional fine rubber dispersion morphology that can be found in these in-reactor synthesized blends. The synthesis of rubber occurs inside the plastic reactor granule, actually inside the micro-grains of a reactor granule, to produce intimately blended rubber and plastic in-situ. Hence, it could be advantageous to prepare sequential polymerized ICP with high rubber content in-situ.

The first commercial thermoplastic vulcanizate, or TPV, was Santoprene™ rubber and was introduced in the early 1980s. Thermoplastic vulcanizates are thermoplastic elastomers and can be processed or re-processed as thermoplastics but with vulcanized rubber dispersions. Vulcanization, or crosslinking, of rubbers in TPVs is used to keep the rubber, which is typically the majority blend component, as the dispersed phase, instead of the continuous phase. Following the Pual-Barrow continuity criterion (Paul, D. R. et al. (2007) “Polymer Blends,” J. Maromol. Sci., Rev. Macromol. Chem., v. 18(1), pp. 109-168), where phi 1/phi 2=eta 1/eta 2, the phase with high viscosity, such as crosslinked rubbers, would stay dispersed. This allows the packing of a near maximum amount of rubber dispersions in a plastic matrix without rubber phase inversion. The maximum packing volume percent is limited by packing physics and is typically less than 70 vol %. By squeezing in greater than 60 vol % of crosslinked rubber dispersions inside a plastic matrix, the plastic matrix becomes inter-connecting plastic ligaments sandwiched in between crosslinked rubber dispersions. The elasticity of a TPV is actually derived from these thin plastic ligaments sandwiched in between rubber dispersions. Based on experimental findings and theoretical modeling (Boyce, M. C. et al. (2001) “Micromechanisms of Deformation and Recovery in Thermoplastic Vulcanizates,” J. Mech. Phys. Solids, v. 49(6), pp. 1323-1342, and Boyce, M. C. et al. (2001) “Micromechanics of Cyclic Softening in Thermoplastic Vulcanizates,” J. Mech. Phys. Solids, v. 49(6), 1343-1360), these thin plastic ligaments kink or plastic flow during TPV deformation by the incompressible deformation of sandwiching crosslinked rubber dispersions. Subsequently, these plastic ligament kinks act as spatial registrations to allow elastic recovery and to deliver elasticity. Thinner plastic ligaments would be easily deformed and yielded, for plastic flow/kink formation, relative to thick plastic ligaments. If the plastic matrix has plastic patches that are relatively large in between rubber dispersions, these plastic flows and kink developments would not have been possible and could lead to poorer elastic properties. Thus, rubber dispersion size and uniformity are critical to create a uniform plastic ligament network without which the elastic properties of a TPV would decrease.

The rubber dispersion size and uniformity properties in a TPV thus constrain the selection of plastic and rubber components for the preparation of a TPV. For a Santoprene which is a TPV based on isotactic polypropylene plastic matrix, iPP, and crosslinked ethylene-propylene-diene terpolymer rubber dispersions, EPDM, it is critical to used fractional MFR iPP to blend with EPDM in an extruder before the introduction of curatives. Since EPDM typically has much higher molecular weight than that of an iPP, low MFR and high MW iPP is necessary to provide viscosity matching during the initial blending inside an extruder. Viscosity matching is used to allow stress transfer across blend interfaces for finer dispersions (L. A. Utracki, “Polymer Alloys and Blends-Thermodynamics and Rheology”, Hanser Publishers, New York, (1990)), in this case, it is to provide fine iPP dispersions inside the EPDM matrix. Once the curatives are introduced, phase inversion occurs and crosslinked EPDM becomes the dispersed phase.

A typical TPV production line involves the granulation of rubber bales for producing rubber crumbs that can be gravimetrically fed to an extruder. To provide free flowing rubber crumbs, talc or clays or other anti-agglomeration solid particles are dusted onto rubber crumbs and all end up in the TPV, thus, inadvertently stiffening the TPV which is not desirable.

It can be advantageous to prepare serial-reactor synthesized in-reactor blends of iPP with greater than 40 wt % EPDM using supported catalysts with exceptional reactor-blended dispersion morphology which could be subsequently vulcanized at finishing for TPV pellets with super fine vulcanized rubber dispersions and excellent properties without talc or other anti-agglomeration particles. Additionally, using a serial reactor to produce TPV components to be vulcanized in a finishing extruder can increase the production capacity of a large TPV extruder by 10 to 30 times. The conventional ZN catalyst system for ICP based on supported catalyst systems of magnesium chloride-supported titanium tetrachloride (MgCl₂/TiCl₄) cannot synthesize EPDM. Conventional ZN EPDMs are made with unsupported vanadium chloride which has very low activity. It is believed that titanium chloride catalyst does not produce EPDM because titanium chloride on magnesium chloride does not allow the insertion of dienes for insertion polymerization. Hence, the conventional supported ZN catalyst system is not just unable to deliver high rubber content, but it cannot synthesize EPDM in a second reactor.

References of interest include: U.S. Pat. No. 9,809,664, and Makio, H. et al. (2011) “FI Catalysts for Olefin Polymerization—A Comprehensive Treatment,” Chem. Rev., v. 111(3), pp. 2363-2449.

There is a need for new processes for producing vulcanizable polypropylene materials that can be heterophasic with a high fill loading of a second polymer component in a first polymer component, that can be formed without post-reactor blending, that are flowable (e.g., do not foul a reactor or an extruder), and/or that have a low additive content.

### SUMMARY

The present invention relates to processes for production of thermoplastic vulcanizates using supported dual catalyst systems, and the multi-phasic thermoplastic vulcanizates comprising: 1) ethylene and/or propylene polymer(s), and 2) terpolymer(s) of: a) ethylene and/or propylene, b) C₂-C₂₀ alpha olefins different from monomer a), and c) diene polymer(s), made using the using supported dual catalyst systems.

This invention also relates to a catalyst system comprising support having a surface area of 400 m²/g or more, a first catalyst compound capable of producing olefin polymer having a Tm of 100° C. or more in a first polymerization reaction and a second catalyst compound capable of producing an elastomer (preferably a vulcanizable elastomer) in a second polymerization reaction and optionally an amorphous polymer in the first polymerization reaction, provided that the first and second catalyst compounds may be the same catalyst compound when the catalyst compound is capable of producing olefin polymer having a Tm of 100° C. or more in the first polymerization reaction and is capable of producing a vulcanizable elastomer in the second polymerization reaction.

The present invention further relates to processes for production of thermoplastic vulcanizates using supported dual catalyst systems, and the multi-phasic thermoplastic vulcanizates of propylene polymer(s) and ethylene-propylene-diene polymer(s) made therefrom.

This invention relates to processes for production of multi-phasic thermoplastic vulcanizates using supported dual catalyst systems comprising a support having a high surface area, Catalyst I capable of producing: 1) a polyolefin (such as a propylene based polymer or copolymer or an ethylene based polymer or copolymer) with a melting point of at least 100° C.; and Catalyst II capable of copolymerizing multiple comonomers including at least one diene comonomer to form a polyolefin copolymer showing either semi-crystallinity (plastomer) or low- or no-crystallinity (elastomer) with vinyl units on the individual chains (typically end vinyl units) available for vulcanization. Supported Catalysts I and II are used in a sequential polymerization process, where Catalyst I generates at least 50 wt % (such as at least 80 wt %) of the matrix phase in the first polymerization phase and Catalyst II generates at least one vinyl containing plastomer and/or an elastomer fill phase in the second polymerization phase.

This invention further relates to processes for production of multi-phasic thermoplastic vulcanizates using supported dual catalyst systems comprising a support having a high surface area, Catalyst I capable of producing: 1) either a propylene based polymer or copolymer or an ethylene based polymer or copolymer with a melting point at least 100° C.; and Catalyst II capable of copolymerizing multiple comonomers including at least one diene comonomer to form a polyolefin copolymer showing either semi-crystallinity (plastomer) or low- or no-crystallinity (elastomer) with end vinyl units on the individual chains available for vulcanization. Supported Catalysts I and II are used in a sequential polymerization process, where Catalyst I generates at least 80 wt % of the matrix phase in the first phase and Catalyst II generates at least one plastomer in the first phase and a vinyl containing elastomer fill phase in the second phase.

Processes for the dual catalyst system catalyzed sequential polymerization to produce thermoplastic vulcanizates comprise at least two steps that first form a matrix phase in at least one slurry- or gas-phase polymerization reactor, following by forming at least one vulcanizable fill phase in at least one gas-phase reactor, which is the same as or different from the matrix phase formation reactor. The processes can be batch, continuing, or the two combined.

Catalyst I and Catalyst II used in the sequential polymerization processes are preferably co-supported on at least one support material in such a way that the majority of the support particles comprises both Catalyst I and Catalyst II. Catalyst structure requirements for propylene based and ethylene based matrix phase are typically different but are often the same for the fill phase and are discussed below.

For propylene based compositions, catalysts suitable to serve as Catalyst I are preferably bridging C₂, bridging C₁ (both typically isotacticity specific) and/or bridging Cₛ (typically syndiotaticity specific) metallocenes and post-metallocenes, while catalysts suitable to serve as Catalysts II are preferably constrained geometry catalysts (CGC), bridging C₁, and bridging Cₛ metallocenes and post metallocenes.

For ethylene based compositions, catalysts suitable to serve as Catalyst I typically have low or no stereo control restriction and can be any metallocenes and post metallocenes, while catalysts suitable to serve as Catalysts II are typically CGC, bridging C₁, and bridging Cₛ metallocenes and post metallocenes.

This invention also relates to a process to make thermoplastic vulcanizate (TPV) comprising:

A) contacting propylene and/or ethylene and optional comonomer with a supported catalyst comprising: 1) support having a surface area of 400 m²/g or more (such as 400 m²/g to 800 m²/g), 2) a first catalyst compound capable of producing polymer having a melting point of 100° C. or more (such as isotactic polypropylene), said compound typically having a bridging C₁, bridging C₂, or bridging Cₛ symmetry ligand framework for propylene based matrix phase or having no ligand symmetry restriction for ethylene based matrix phase, and 3) a second catalyst compound capable of diene copolymerization, said compound typically being a CGC catalyst or having a bridging C₁ or bridging Cₛ symmetry ligand framework,
B) obtaining polymerizate containing active catalyst, a polymer having a melting point of 100° C. or more, such as isotactic polypropylene or high density polyethylene, and optionally another polymer with a different melting point or an amorphous polymer for propylene based polymer as the matrix phase; or optionally with a polymer with a different molecular weight or a different polymer density for ethylene based polymer;
C) contacting the polymerizate with at least two different C₂ to C₂₀ alpha-olefin monomers and at least one diene monomer;
D) obtaining a heterophasic copolymer product, having a continuous phase of polymer having a Tm of 100° C. or more (such as isotactic propylene polymer) and at least 18 wt % (typically at least 30 wt %) of an alpha-olefin diene monomer (such as ethylene-propylene-diene monomer) discontinuous phase.

This invention also relates to a process to make thermoplastic vulcanizate (TPV) comprising:

A) contacting propylene and optional comonomer with a supported catalyst comprising: 1) support having a surface area of 400 m²/g or more (such as 400 m²/g to 800 m²/g), 2) a first catalyst compound capable of producing polymer having a melting point of 100° C. or more (such as isotactic polypropylene), said compound typically having C₁ or C₂ symmetry, and 3) a second catalyst compound capable of producing an amorphous polymer, said compound typically having Cₛ symmetry,
B) obtaining polymerizate containing active catalyst, amorphous polymer (such as amorphous propylene polymer), and polymer having a melting point of 100° C. or more (such as isotactic polypropylene) isotactic propylene polymer;
C) contacting the polymerizate with alpha-olefin (such as ethylene and/or a C₄ to C₂₀ alpha-olefin) and diene monomer;
D) obtaining a heterophasic copolymer product, having a continuous phase of polymer having a Tm of 100° C. or more (such as isotactic propylene polymer) and at least 30 wt % of an alpha-olefin diene monomer (such as ethylene-propylene-diene monomer) discontinuous phase.

This invention also relates to a supported catalyst comprising: 1) support having a surface area of 400 m²/g or more (such as 400 m²/g to 800 m²/g), 2) a first catalyst compound having C₁ or C₂ symmetry, and 3) a second catalyst compound having C_{S} symmetry.

This invention also relates to a supported catalyst comprising 1) a first catalyst compound having C₁ or C₂ symmetry, 2) a second catalyst compound having C_{S} symmetry, and 3) support material (or product thereof) having (as determined by BET nitrogen adsorption) one or more of:

a surface area of from 400 m²/g to 800 m²/g;

an average pore diameter of 90 Angstroms or greater;

an average particle size of 60 μm or greater;

40% or greater of the incremental pore volume comprising pores having a pore diameter of 100 Angstroms or greater; and

sub-particles having an average particle size in the range of 0.01 μm to 5 μm.

In yet another embodiment, embodiments of the present disclosure provide a process for polymerization of olefin monomers comprising contacting one or more monomers with a catalyst system of the present disclosure; and obtaining a propylene polymer composition. Contacting can include contacting propylene monomer under polymerization conditions with a catalyst system of the present disclosure to form a propylene polymer comprising at least 40 mol % propylene; and contacting an alpha olefin monomer selected from ethylene, C₃ to C₂₀ alpha olefins, and a diene with the catalyst system under polymerization conditions to form an ethylene-C₃ to C₂₀ alpha olefin-diene terpolymer (such as ethylene-propylene-diene terpolymer) and a composition comprising the propylene polymer and the terpolymer.

In another aspect, embodiments of the present disclosure provide a propylene polymer composition that includes: isotactic polypropylene; 5 wt % or greater of atactic polypropylene, based on the weight of the composition; and an ethylene-propylene-diene terpolymer. The propylene polymer compositions comprise a matrix phase comprising the isotactic polypropylene and the atactic polypropylene; and a fill phase comprising the ethylene-propylene-diene terpolymer.

### BRIEF DESCRIPTION OF THE FIGURES

FIG. 1 is a scheme illustrating a general reaction pathway suitable for preparing catalysts of the present disclosure.

FIG. 2 is a high-performance liquid chromatography projection illustrating a polymer composition obtained from a single catalyst system in a 2-stage polymerization, according to an embodiment of the present disclosure.

FIG. 3 is a high-performance liquid chromatography projection illustrating a polymer composition obtained from a dual catalyst system in a stage 1 propylene polymerization, according to an embodiment of the present disclosure.

FIG. 4 is a high-performance liquid chromatography projection illustrating a polymer composition: iPP-EPDM heterophasic copolymer, according to an embodiment of the present disclosure.

FIG. 5 is a high-performance liquid chromatography projection illustrating a polymer composition: iPP-EPDM heterophasic copolymer, according to an embodiment of the present disclosure.

FIG. 6 is a high-performance liquid chromatography projection illustrating the polymer composition: iPP-EPDM heterophasic copolymer, according to an embodiment of the present disclosure.

FIG. 7 is a high-performance liquid chromatography projection illustrating the polymer composition: iPP-EPDM heterophasic copolymer, according to an embodiment of the present disclosure.

FIG. 8 is a graph illustrating particle size distribution of a polymer sample, according to an embodiment of the present disclosure.

FIG. 9a is an image of a polymer sample, according to an embodiment of the present disclosure.

FIG. 9b is an image of a polymer sample, according to an embodiment of the present disclosure.

FIG. 10a is an atomic force microscope image of a polymer sample before curing of the sample, according to an embodiment of the present disclosure.

FIG. 10b is an atomic force microscope image of a polymer sample after curing of the sample, according to an embodiment of the present disclosure.

FIG. 11 is a graph (of force versus displacement) illustrating tensile elongation of a TPV after curing of the sample, according to an embodiment of the present disclosure.

FIG. 12 is a graph (of force versus displacement) illustrating hysteresis of a TPV after curing of the sample, according to an embodiment of the present disclosure.

### DEFINITIONS

For the purposes of this invention and the claims thereto, the new numbering scheme for the Periodic Table Groups is used as described in Chemical and Engineering News, v. 63(5), pg. 27 (1985). Therefore, a “group 4 metal” is an element from group 4 of the Periodic Table, e.g. Hf, Ti, or Zr.

For purposes herein “mean” refers to the statistical mean or average, i.e., the sum of a series of observations or statistical data divided by the number of observations in the series, and the terms mean and average are used interchangeably; “median” refers to the middle value in a series of observed values or statistical data arranged in increasing or decreasing order, i.e., if the number of observations is odd, the middle value, or if the number of observations is even, the arithmetic mean of the two middle values.

For purposes herein, the mode, also called peak value or maxima, refers to the value or item occurring most frequently in a series of observations or statistical data, i.e., the inflection point. An inflection point is that point where the second derivative of the curve changes in sign. For purposes herein, a multimodal distribution is one having two or more peaks, i.e., a distribution having a plurality of local maxima; a bimodal distribution has two inflection points; and a unimodal distribution has one peak or inflection point.

The term “complex” is used to describe molecules in which an ancillary ligand is coordinated to a central transition metal atom. The ligand is bulky and stably bonded to the transition metal so as to maintain its influence during use of the catalyst, such as polymerization. The ligand may be coordinated to the transition metal by covalent bond and/or electron donation coordination or intermediate bonds. The transition metal complexes are generally subjected to activation to perform their polymerization function using an activator which is believed to create a cation as a result of the removal of an anionic group, often referred to as a leaving group, from the transition metal. “Complex,” as used herein, is also often referred to as “catalyst precursor,” “pre-catalyst,” “catalyst,” “catalyst compound,” “metal compound,” “metal catalyst compound”, “transition metal compound,” or “transition metal complex.” These words are used interchangeably.

The term “pyridyldiamido complex” or “pyridyldiamide complex” or “pyridyldiamido catalyst” or “pyridyldiamide catalyst” refers to a class of coordination complexes described in U.S. Pat. No. 7,973,116B2, US 2012/0071616A1, US 2011/0224391A1, US 2011/0301310A1, US 2015/0141601A1, U.S. Pat. Nos. 6,900,321 and 8,592,615 that feature a dianionic tridentate ligand that is coordinated to a metal center through one neutral Lewis basic donor atom (e.g., a pyridine group) and a pair of anionic amido or phosphido (i.e., deprotonated amine or phosphine) donors. In these complexes the pyridyldiamido ligand is coordinated to the metal with the formation of one five membered chelate ring and one seven membered chelate ring. It is possible for additional atoms of the pyridyldiamido ligand to be coordinated to the metal without affecting the catalyst function upon activation; an example of this could be a cyclometalated substituted aryl group that forms an additional bond to the metal center.

The term “quinolinyldiamido complex” or “quinolinyldiamido catalyst” or “quinolinyldiamide complex” or “quinolinyldiamide catalyst” refers to a related class of pyridyldiamido complex/catalyst described in US 2018/0002352 where a quinolinyl moiety is present instead of a pyridyl moiety.

The term “phenoxyimine complex” or “phenoxyimine catalyst” refers to a class of coordination complexes described in EP 0874005 that feature a monoanionic bidentate ligand that is coordinated to a metal center through one neutral Lewis basic donor atom (e.g., an imine moiety) and an anionic aryloxy (i.e., deprotonated phenoxy) donor. Typically two of these bidentate phenoxyimine ligands are coordinated to a group 4 metal to form a complex that is useful as a catalyst component.

The term “bisphenolate complex” or “bisphenolate catalyst” refers to a class of coordination complexes described in U.S. Pat. No. 6,841,502, WO 2017/004462, and WO 2006/020624 that feature a dianionic tetradentate ligand that is coordinated to a metal center through two neutral Lewis basic donor atoms (e.g., oxygen bridge moieties) and two anionic aryloxy (i.e., deprotonated phenoxy) donors.

The term “cyclopentadienyl-amidinate complex” or “cyclopentadienyl-amidinate catalyst” refers to a class of coordination complexes described in U.S. Pat. No. 8,188,200 that typically feature a group 4 metal bound to a cyclopentadienyl anion, a bidentate amidinate anion, and a couple of other anionic groups.

The term “iron pyridyl bis(imine) complex” refers to a class of iron coordination complexes described in U.S. Pat. No. 7,087,686 that typically feature an iron metal center coordinated to a neutral, tridentate pyridyl bis(imine) ligand and two other anionic ligands.

For purposes herein, silica catalyst support particle size (PS) or particle diameter, and distributions thereof, are determined by laser diffraction using a LS 13 320 particle size analyzer equipped with a micro liquid module (range 0.017-2000 μm for purposes herein, silica catalyst support particle size (PS) or particle diameter. Average PS refers to the distribution of particle volume with respect to particle size.

For purposes herein, the surface area (SA, also called the specific surface area or BET surface area), pore volume (PV), and mean or average pore diameter (PD) of catalyst support materials are determined by the Brunauer-Emmett-Teller (BET) method using adsorption-desorption of nitrogen (temperature of liquid nitrogen: 77 K) with a MICROMERITICS ASAP 2420 instrument after degassing of the powders for 4 hours at 350° C. for raw or calcined silica or 60° C. for the silica supported activator (e.g., methylaluminoxane or MAO) or the derived finished catalysts. More information regarding the method can be found, for example, in “Characterization of Porous Solids and Powders: Surface Area, Pore Size and Density”, S. Lowell et al., Springer, 2004. PV refers to the total PV, including both internal and external PV. Mean PD refers to the distribution of total PV with respect to PD.

Unless otherwise indicated expressly or by context, “main particle” or “aggregate” refers to the overall particle body or assemblies that are not connected to another main particle through chemical bonding or physical binding. The terms “main particle” and “aggregate” can be used interchangeably. The average main particle size (simplified as average particle size or particle size) can be measured with a particle size analyzer, e.g., as mentioned above, rather than subunits or parts of the body such as the “primary particles” or the “sub-particles” inside the overall particle body or assembly; “primary particle” refers to the smallest particle unit in the main particle that does not fragment to keep the particle integrity during the main particle fragmentation process caused by the polymer growing expansion in the pores of a main particle (see polymerization expansion fragmentation definition below) due to the non-porous or very small pore structure of a primary particle where typically no active catalyst species can form inside the primary particle; and “sub-particle” refers to another type of subunit in a main particle, where the subunit is made of primary particles, i.e., in a main particle, the main particle size >sub-particle size >primary particle size. For purposes herein, “regular main particle” refers a main particle consisting of only primary particle subunits and “sub-particle containing main particle” refers to a main particle consisting of both sub-particles and primary particle. Therefore, since sub-particles contain primary particles, if a main particle contains sub-particles, it means that the main particle also contains primary particles. In other words, both regular main particles and sub-particle containing main particles all contain the same basic unit, the primary particles. To help to understand the main particle, sub-particle, and primary particle concepts, please refer to Scheme 1 below, which shows a simplified process to construct a sub-particle containing main particle through breaking a regular main particle:

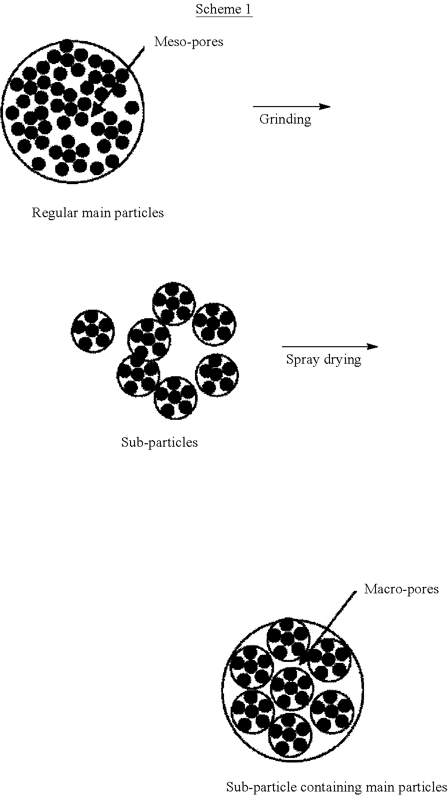

### Regular Main Particles Sub-Particles Sub-Particle Containing Main Particles

Note the “Regular main particles” are made of primary particles (as solid dots), which are non-fragmentable during polymerization and the gaps between primary particles are meso-pores. The “Sub-particle containing main particles” are made of sub-particles (fragmentable during polymerization), which contain primary particles and gaps between sub-particles are macro-pores.

For purpose herein, three types of pore sizes are used to define the pore structures in these porous particles: 1) “micro-pore” or “micropore” refers to pores with pore diameters <2 nm; 2) “meso-pore” or “mesopore” refers to pores with pore diameters 2 nm-50 nm; and 3) “macro-pore” or “macropore” refers to pores with pore diameters >50 nm, per IUPAC definition (Rouqurol, J. et al, (1994), “Recommendations for the characterization of porous solids (Technical Report)” Pure and Applied Chemistry, 66 (8)).

For purpose herein, “regular silica” refers to the silica having two layers of particle structures: a main particle formed by the agglomeration of primary particles. Many types of amorphous silica (or silica gel) consist of nano-scale non-porous fumed silica as the primary particles. However, nano-scale size micropore containing silica can also be used as primary particles to construct the main particles, e.g., 10-100 nm size silica with dominant micropores, where the majority of catalyst or cocatalyst molecules are too large to enter into the micropores, i.e., the majority of active catalytic species are attached on the outside surface of the primary particle instead of being in the micropores and therefore no polymer expansion fragmentation can occur and such particles become non-fragmentable during the polymerization reaction.

For purpose herein, “sub-particle containing silica” refers to the silica having three layers of particle structures: a main particle contains sub-particles and a sub-particle contains primary particles. For example, the silica with sub-particles can form through the re-aggregation process, e.g., through a spray drying process, to assembly the fragmented regular silica main particles obtained by applying certain physical force, e.g., grinding, as indicated in Scheme 1. Therefore, “sub-particle containing silica” and “spray dried silica” will be used interchangeably.

In the case of the spray drying process as the re-aggregation method, “spray dried” or “spray drying” refers to metal oxide main particles such as silica main particles obtained by expanding a sol in such a manner as to evaporate the liquid from the sol, e.g., by passing the silica sol through a jet or nozzle with a hot gas.

In the case of a re-aggregation process to form the sub-particle containing amorphous, hydrated-surface main particles, e.g., amorphous silica, the main particles may typically have an overall size range of 30 μm-300 μm (e.g., 50 μm-100 μm, or 70 μm-90 μm), the sub-particles have a size range of 0.01 μm-50 μm (e.g., 50 μm-400 nm or 1 μm-50 μm, such as from 0.01 μm to 5 μm), and the primary particles have a size range of 10 nm-400 nm (e.g., 20 nm-40 nm). In these size ranges, mesopores can form as the main pore structure in a sub-particle and macropores can form as the main pore structures outside sub-particles in a main particle.

For purpose herein, hetero-phasic copolymer refers to products containing at least one non-crystalline and/or lower crystalline fill phase and one stiff matrix, wherein the stiff matrix is 30 to 92 wt % (such as 60 to 92 wt %, such as 40 wt %-70 wt %) based on the total hetero-phasic copolymer. Because such materials contain diene derived vinyl end groups in polymer chains readily for vulcanization to crosslink polymer chains to a form dismobilized low crystallinity phase, the compositions are also called TPV(s), i.e., thermoplastic vulcanizate(s), to differentiate from TPO (thermoplastic polyolefinelastomer), e.g., impact copolymer or ICP. Stiff matrix refers to a highly crystalline polyolefin material with a melting point equal or higher than 100° C., significantly higher than the typical industry preferred slurry or gas phase polymerization temperature, e.g., in the range of 60° C.-90° C. “Plastomer fill phase” refers to a semi-crystalline polyolefin material having a melting point lower than 100° C. and/or having a heat of fusion of 85 j/g or less and/or having crystallinity of 20% or less but not the amorphous rubber or elastomer which has essentially very low or no crystallinity. “Rubber fill phase” or “elastomer fill phase” refers to low or no crystalline compositions, characterized as having essentially no detectable melting point. Rubber and elastomer can be used interchangeably to refer to low or no crystallinity materials. It should be understood that both elastomer and plastomer fill phases contain vinyl units derived from a diene comonomer on the polymer backbones with an amount enough to undergo vulcanization to demobilize the rubber phase. Therefore, “EPDM” is also used to describe both the plastomer and elastomer phases containing vinyl units derived from the diene monomor, with an emphasis on diene unit containing. Although EPD in EPDM usually means ethylene, propylene and diene monomer, it should be understood that EBD (ethyelen, butene, diene), EHD (ethylene, hexene, diene), etc. are also included. In some cases, rubber is used to represent either plastomer or elastomer or both. For purpose herein, stiff phase or stiff matrix is used interchangeably and both refer to a phase/matrix having polymers having a melting point of at least 100° C. For purpose herein, in some cases, rubber refers to the plastomer fill phase or elastomer fill phase.

The plastomer or elastomer fill capability of a stiff phase is related to the porosity of the stiff phase, e.g., the porosity of the stiff polymer particles. For purposes herein, porosity of the polymer particles refers to the volume fraction or percentage of PV within a particle or body comprising a skeleton or matrix of the stiff polymer (e.g., having a Tm of 100° C. or more), on the basis of the overall volume of the particle or body with respect to total volume. The porosity and median PD of polymer particles are determined using mercury intrusion porosimetry. Mercury intrusion porosimetry involves placing the sample in a penetrometer and surrounding the sample with mercury. Mercury is a non-wetting liquid to most materials and resists entering voids, doing so only when pressure is applied. The pressure at which mercury enters a pore is inversely proportional to the size of the opening to the void. As mercury is forced to enter pores within the sample material, it is depleted from a capillary stem reservoir connected to the sample cup. The incremental volume depleted after each pressure change is determined by measuring the change in capacity of the stem. This intrusion volume is recorded with the corresponding pressure. Unless otherwise specified, all porosimetry data are obtained using MICROMERITICS ANALYTICAL SERVICES and/or the AUTOPORE IV 9500 mercury porosimeter.

For purposes herein, “as determined by mercury intrusion porosimetry” shall also include and encompass “as if determined by mercury intrusion porosimetry,” such as, for example, where the mercury porosimetry technique cannot be used, e.g., in the case where the pores are filled with a non-gaseous material such as a fill phase. In such a case, mercury porosimetry may be employed on a sample of the material obtained prior to filling the pores with the material or just prior to another processing step that prevents mercury porosimetry from being employed, or on a sample of the material prepared at the same conditions used in the process to prepare the material up to a point in time just prior to filling the pores or just prior to another processing step that prevents mercury porosimetry from being employed.

The matrix phase may be further characterized by a porosity, as determined by mercury intrusion porosimetry, of at least 20%, 30% or 40% or more. It may also be further characterized by a random statistical distribution of monomer units, meaning that the probability of finding a given type of monomer residue at a particular point in the polymer chain is about equal to the mole fraction of that monomer residue in the chain. It may have a composition distribution breadth index of 50% or more, 60% or more, or 70% or more. The matrix phase may also have a multimodal (such as bimodal) molecular weight distribution.

Understanding the particle fragmentation behavior of a silica particle during the transportation/storage handling, during the catalyst preparation, and in the polymerization process can help for the catalyst support structure design to improve the catalyst performance including the operability in a reactor, the polymerization activity, the resulting polymer morphology, and the rubber fill capability, etc.

Fragmentation of a particle can occur by the external application of many kinds of physical forces. For example, mechanical force from crushing under such as high heat such as during calcination of support particles, and/or the presence of mechanical forces from crushing under compression or from the impact of moving particles into contact with other particles and/or onto fixed surfaces, sometimes referred to as “agitation fragmentation.” Fragmentation can also result in at least one embodiment herein from the insertion, expansion and/or other interaction of materials in connection with pores of the particles, such as, for example, when MAO is inserted or polymer is formed in the pores, and subunits of the support particle are broken off or the support particle otherwise expands to force subunits of the particle away from other subunits, e.g., causing a capsule to break open, forcing primary particles away from each other and/or fracturing primary particles, such as may occur during polymerization or during a heat treatment for catalyst preparation or activation. This latter type of fragmentation is referred to herein as “expansion fragmentation” and/or “expansion disagglomeration” in the case of disagglomerating particles from an agglomerate, including microencapsulated agglomerates. Some types of fragmentation above, e.g., the “agitation fragmentation” and catalyst preparation related chemical expansion such as “MAO expansion fragmentation” are undesired and should be limited or eliminated because they can cause poor morphology of the resulting granules and even a reactor fouling, such as the fines related fouling. However, the expansion fragmentation of the main particles of a catalyst support during the polymerization can be advantageous because such a fragmentation can help the catalyst debris to distribute on the growing polymer granules for better catalytic polymerization activity, better morphology, and better removal of heat generated by the polymerization reaction, and so on. Non-fragmentable main particles, such as the highly crystalline zeolites, are typically not suitable to be used as the polyolefin catalyst supports because if the particles are non-fragmentable, the active catalyst in the particle will be wrapped inside the granule due to the growing polymer and can quickly lose the activity since monomers are becoming more and more difficult to reach the catalyst species in the pores. Furthermore, more evenly distributed catalyst debris over the growing polymer granules can be advantageous because the large hollow spots in a granule can be limited to obtain better granule morphology, e.g., better bulk density and flowability, i.e., most of the granules having similar flowing behaviors in a gas phase reactor to ensure smooth polymerization control. Sub-particle containing silica can therefore be more advantageous for such purposes since their fragmentation results in more evenly distributed catalyst debris.

For purposes herein, “vulcanization” or “cure” refers to a chemical process to cause a rubber fill phase to undergo a cross-linking reaction between vinyl groups (typically end groups) on the individual rubber polymer chains through a chemical and/or a physical treatment, e.g., by contacting the rubber fill phase with a curative agent and/or heating. “Vulcanizable” means the polymer (typically an elastomer, such as EPDM) contains vinyl groups (typically diene derived vinyl end groups) in polymer chains that can be subjected to vulcanization (such as chemical or thermal vulcanization) to crosslink polymer chains, typically to form a dismobilized low crystallinity phase.

As used herein, when referring to polymerizing in the presence of at least X mmol hydrogen or other chain transfer or termination agent (“CTA”) per mole of propylene, the ratio is determined based upon the amounts of hydrogen or other chain transfer agent and propylene fed into the reactor. A “chain transfer agent” is hydrogen or an agent capable of hydrocarbyl and/or polymeryl group exchange between a coordinative polymerization catalyst and a metal center of the CTA during polymerization.

Unless otherwise indicated, “catalyst productivity” is a measure of how many grams of polymer (Pol or P) are produced using a polymerization catalyst comprising W g of catalyst (cat), over a period of time of T hours; and may be expressed by the following formula: P/(T×W) and expressed in units of grams polymer divided by the product of grams catalyst and time in hours (gPol gcat⁻¹hr.⁻¹).

Unless otherwise indicated, “conversion” is the amount of monomer that is converted to polymer product, and is reported as mol % and is calculated based on the polymer yield and the amount of monomer fed into the reactor.

Unless otherwise indicated, “catalyst activity” is a measure of how active the catalyst is and is reported as the mass of product polymer (P) produced per mole of catalyst (cat) transition metal used (kg P/mol cat).

An “olefin”, alternatively referred to as “alkene”, is a linear, branched, or cyclic compound of carbon and hydrogen having at least one double bond. For the purposes of the present disclosure, ethylene shall be considered an α-olefin. An “alkene” group is a linear, branched, or cyclic radical of carbon and hydrogen having at least one double bond.

For purposes of this specification and the claims appended thereto, when a polymer or copolymer is referred to as comprising an olefin, the olefin present in such polymer or copolymer is the polymerized form of the olefin. For example, when a copolymer is said to have an “ethylene” content of 35 wt % to 55 wt %, it is understood that the “mer” unit in the copolymer is derived from ethylene in the polymerization reaction and said derived units are present at 35 wt % to 55 wt %, based upon the weight of the copolymer. A “polymer” has two or more of the same or different mer units. A “homopolymer” is a polymer having mer units that are the same. A “copolymer” is a polymer having two or more mer units that are different from each other. A “terpolymer” is a polymer having three mer units that are different from each other. “Different” as used to refer to mer units indicates that the mer units differ from each other by at least one atom or are different isomerically. Accordingly, the definition of copolymer, as used herein, includes terpolymers and the like.

An “ethylene polymer” or “polyethylene” or “ethylene copolymer” is a polymer or copolymer comprising at least 50 mol % ethylene derived units; a “propylene polymer” or “polypropylene” or “propylene copolymer” is a polymer or copolymer comprising at least 50 mol % propylene derived units; and so on. The term “polypropylene” is meant to encompass isotactic polypropylene (iPP), defined as having at least 10% or more isotactic pentads, highly isotactic polypropylene, defined as having 50% or more isotactic pentads, syndiotactic polypropylene (sPP), defined as having at 10% or more syndiotactic pentads, homopolymer polypropylene (hPP, also called propylene homopolymer or homopolypropylene), and so-called random copolymer polypropylene (RCP, also called propylene random copolymer). Herein, an RCP is specifically defined to be a copolymer of propylene and 1 to 10 wt % of an olefin chosen from ethylene and C₄ to C₈ 1-olefins. Isotactic polymers (such as iPP) have at least 20% (such as at least 30%, such as at least 40%) isotactic pentads, as determined by ¹³C NMR. A polyolefin is “atactic”, also referred to as “amorphous” if it has less than 10% isotactic pentads and syndiotactic pentads, as determined by ¹³C NMR.

For purposes of this invention and the claims thereto, an ethylene polymer having a density of 0.86 g/cm³ or less is referred to as an ethylene elastomer or elastomer; an ethylene polymer having a density of more than 0.86 to less than 0.910 g/cm³ is referred to as an ethylene plastomer or plastomer; an ethylene polymer having a density of 0.910 to 0.940 g/cm³ is referred to as a low density polyethylene (LDPE); and an ethylene polymer having a density of more than 0.940 g/cm³ is referred to as a high density polyethylene (HDPE). Density is determined according to ASTM D 1505 using a density-gradient column on a compression-molded specimen that has been slowly cooled to room temperature (i.e., over a period of 10 minutes or more) and allowed to age for a sufficient time that the density is constant within +/−0.001 g/cm³).

Polyethylene in an overlapping density range, i.e., 0.890 to 0.930 g/cm³, typically from 0.915 to 0.930 g/cm³, which is linear and does not contain long chain branching (such as branching typically found in HDPE) is referred to as “linear low density polyethylene” (LLDPE) and can be produced with conventional Ziegler-Natta catalysts, vanadium catalysts, or with metallocene catalysts in gas phase reactors and/or in slurry reactors and/or in solution reactors. Polyethylene in an overlapping density range, i.e., 0.92 to 0.940 g/cm³, typically from 0.926 to 0.940 g/cm³, may also be referred to as “medium density polyethylene” (MDPE).

The terms “ethylene-propylene rubber” or “EP rubber” (EPR) mean a copolymer of ethylene and propylene, where the ethylene content is from 30 to 80 mol %, and the propylene content is 20 to 70 mol %.

The terms “ethylene-propylene-diene terpolymer rubber” or “EPDM rubber” (EPDM) mean a terpolymer of ethylene, propylene, and one or more diene monomers, where the ethylene content is from 30 to 80 wt %, the diene content is from 0.1 to 10 wt % (such as 2 to 10 wt %), and the balance is propylene with a minimum propylene content of 20 wt %, typically from 20 to 69.9 wt %. EPDM may have a Tg of −30° C. or less and/or a Mooney viscosity, ML(1+4) @ 125° (measured according to ASTM D1646) of 15 to 100. Similarly, the terms EBDM, EHDM, and EODM refer to ethylene-butylene-diene, ethylene-hexene-diene, and ethylene-octene-diene terpolymer rubbers, respectively while PBDM, PHDM, and PODM refer to propylene-butylene-diene, propylene-hexene-diene, propylene-octene-diene terpolymer rubber, respectively; and either their ethylene or propylene content is from 30 to 80 wt %, the diene content is from 0.1 to 10 wt % (such as 2 to 10 wt %), and the balance is butene, hexene, or octene with a minimum monomer content of 20 wt %, typically from 20 to 69.9 wt %. EXDM or PXDM (X═B, H, or O) may have a Tg of −30° C. or less and/or a Mooney viscosity, ML(1+4) @ 125° C. (measured according to ASTM D1646) of 15 to 100.

An “elastomer” is an ethylene copolymer having a density of less than 0.85 g/cm³ (ASTM D 1505) or a propylene copolymer having from 40 to 60 mol % propylene.

A “plastomer” is an olefin copolymer having a density of from 0.85 to 0.915 g/cm³ ASTM D 1505.

The elastomers produced in the second stage herein differ from the amorphous material produced in the first stage in that they have different mer units and the amorphous material is not vulcanizable, for example the amorphous material lacks a diene.

The term “hetero-phase” or “heterophasic” refers to the presence of two or more morphological phases in a composition comprising two or more polymers, where each phase comprises a different polymer or a different ratio of the polymers as a result of partial or complete immiscibility (i.e., thermodynamic incompatibility). A common example is a morphology consisting of a continuous matrix phase and at least one dispersed or discontinuous phase. The dispersed phase takes the form of discrete domains (particles) distributed within the matrix (or within other phase domains, if there are more than two phases). Another example is a co-continuous morphology, where two phases are observed but it is unclear which one is the continuous phase, and which is the discontinuous phase, e.g., where a matrix phase has generally continuous internal pores and a fill phase is deposited within the pores, or where the fill phase expands within the pores of an initially globular matrix phase to expand the porous matrix globules, corresponding to the polymer initially formed on or in the support agglomerates, into subglobules which may be partially or wholly separated and/or co-continuous or dispersed within the fill phase, corresponding to the polymer formed on or in the primary particles of the support. For example, a polymer globule may initially have a matrix phase with a porosity corresponding to the support agglomerates, but a higher fill phase due to expansion of the fill phase in interstices between subglobules of the matrix phase.

The presence of multiple phases is determined using microscopy techniques, e.g., optical microscopy, scanning electron microscopy (SEM), or atomic force microscopy (AFM); or by the presence of two glass transition (Tg) peaks in a dynamic mechanical analysis (DMA) experiment; or by a physical method such as solvent extraction, e.g., xylene extraction at an elevated temperature to preferential separate one polymer phase; in the event of disagreement among these methods, DMA performed according to the procedure set out in US 2008/0045638 at page 36, including any references cited therein, shall be used.

The term “sequential polymerization” refers to a polymerization process wherein different polymers are produced at different periods of time in the same or different reactors, e.g., to produce a multimodal and/or heterophasic polymer. The terms “gas phase polymerization,” “slurry phase polymerization,” “homogeneous polymerization process,” and “bulk polymerization process” are defined below.

The term “solvent free” in polymerization process description refers to no inert solvent in use, such as no propane, butane, pentane, or hexane in use. A monomer serving as a liquid to form a slurry with a supported catalyst or the resulting polymer resins is not defined as a solvent, such as the liquidized propylene for slurry polymerization.

The term “continuous” means a system that operates without interruption or cessation. For example, a continuous process to produce a polymer would be one where the reactants are continually introduced into one or more reactors and polymer product is continually withdrawn.

As used herein, Mn is number average molecular weight, Mw is weight average molecular weight, Mz is z average molecular weight, wt % is weight percent, and mol % is mole percent. Molecular weight distribution (MWD), also referred to as polydispersity index (PDI), is defined to be Mw divided by Mn. Unless otherwise noted, all molecular weights (e.g., Mw, Mn, and Mz) are reported in g/mol and are determined by GPC as described below.

The following abbreviations may be used herein: Me is methyl, Et is ethyl, Pr is propyl, cPr is cyclopropyl, nPr is n-propyl, iPr is isopropyl, Bu is butyl, nBu is normal butyl, iBu is isobutyl, sBu is sec-butyl, tBu is tert-butyl, Oct is octyl, Ph is phenyl, Bn is benzyl, THF or thf is tetrahydrofuran, MAO is methylalumoxane, OTf is trifluoromethanesulfonate, Cy is cyclohexyl, Cp is cyclopentadienyl, Cp* is pentamethyl cyclopentadienyl, Ind is indenyl, Flu is fluorenyl, and MAO is methylalumoxane.

Ambient temperature, also referred to herein as room temperature (RT), is 23° C.±3° C. unless otherwise indicated.

A “catalyst system” is a combination of at least two catalyst precursor compounds, an optional activator, an optional co-activator, and a support material. A polymerization catalyst system is a catalyst system that can polymerize monomers to polymer. For the purposes of the present disclosure and the claims thereto, when catalyst systems are described as comprising neutral stable forms of the components, it is well understood by one of ordinary skill in the art that the ionic form of the component is the form that reacts with the monomers to produce polymers. Catalyst systems of the present disclosure are intended to embrace neutral and ionic forms of the catalyst system components, such as the catalyst compounds of Formula (I) and Formula (II) and an optional activator.

In the description herein, the single site catalyst precursor compound may be described as a catalyst precursor, a catalyst precursor compound, a pre-catalyst compound, or a transition metal compound, or similar variation, and these terms are used interchangeably. A catalyst precursor compound is a neutral compound without polymerization activity, e.g., Cp₂ZrCl₂, which when contacted with an activator, e.g., MAO, can form an active catalyst species, e.g., [Cp₂ZrMe]⁺, or a resting active catalyst species, e.g., [Cp₂Zr(p-Me)₂AlMe₂]⁺ to become capable of polymerizing olefin monomers. A metallocene catalyst compound (also referred to as metallocene, MCN, metallocene compound, metallocene catalyst, metallocene catalyst compound, metallocene catalyst precursor compound) is a transition metal catalyst compound having one, two or three, typically one or two, substituted or unsubstituted cyclopentadienyl ligands bound to the transition metal, typically a metallocene catalyst is an organometallic compound containing at least one π-bound cyclopentadienyl moiety (or substituted cyclopentadienyl moiety). Substituted or unsubstituted cyclopentadienyl ligands include substituted or unsubstituted indenyl, fluorenyl, tetrahydro-s-indacenyl, tetrahydro-as-indacenyl, benz[f]indenyl, benz[e]indenyl, tetrahydrocyclopenta[b]naphthalene, tetrahydrocyclopenta[a]naphthalene, and the like.

The term “post-metallocene” also referred to as “post-metallocene catalyst” or “post-metallocene compound” describes transition metal complexes that contain a transition metal, at least one anionic donor ligand, and at least one leaving group with a non-carbon atom directly linking to the metal (such as halogen leaving group(s)), but do not contain any π-coordinated cyclopentadienyl anion donors (e.g., π-bound cyclopentadienyl moiety or substituted cyclopentadienyl moiety), where the complexes are useful for the polymerization of olefins, typically when combined with activator(s). Post-metallocene catalysts include those first disclosed after 1980, typically after 1990.

A C₁, C₂, or Cₛ catalyst means the catalyst metal center with the ligand framework forms a C₁, C₂, or Cₛ symmetry for the neutral (non-activated) catalyst molecule. Symmetry of metallocene compounds is described in Chemical Applications of Group Theory (2nd Edition) by F. Albert Cotton, Wiley-Interscience, 1971. A constrained geometry catalyst (CGC) features a pi-bonded moiety (e.g. substituted or unsubstituted cyclopentadienyl) linked (or called bridged) to one of the other ligands on the same metal center in such a way that the angle at this metal between the centroid of the pi-system and the additional ligand is smaller than in the comparable unlinked (or called unbridged) complexes (Holger Braunschweig and Frank-M. Breitling (2006). “Constrained geometry complexes—Synthesis and applications”. Coordination Chemistry Reviews. 250 (21-22): 2691-2720). A bridging C₁, C₂, or Cₛ catalyst is a catalyst where the catalyst metal center with the ligand framework forms a C₁, C₂, or Cₛ symmetry for the neutral (non-activated) catalyst molecule, where the ligand framework is bridged or multidentate (which is referred to herein as containing a bridge), for example (rac-dimethylsilandiyl(4-(3′,5′-di-tert-butyl-4′-methoxy-phenyl)-2-methylindenyl)(4-o-biphenyl-2-hexyl-indenyl)zirconium dichloride) is a bridging C₁ catalyst).

The phrase “compositionally different” means the compositions in question differ by at least one atom. For example, cyclopentadiene differs from methyl cyclopentadiene in the presence of the methyl group. For example, “bisindenyl zirconium dichloride” is different from “(indenyl)(2-methylindenyl) zirconium dichloride” which is different from “(indenyl)(2-methylindenyl) hafnium dichloride.” A catalyst compound is considered different from another if they differ by at least one atom. For example, “bisindenyl zirconium dichloride” is different from “(indenyl)(2-methylindenyl) zirconium dichloride” which is different from “(indenyl)(2-methylindenyl) hafnium dichloride.” Catalyst compounds that differ only by isomer are considered the same for purposes if this invention, e.g., rac-dimethylsilylbis(2-methyl 4-phenylindenyl)hafnium dimethyl is considered to be the same as meso-dimethylsilylbis(2-methyl 4-phenylindenyl)hafnium dimethyl.

An organometallic compound is defined as a compound containing at least one bond between a carbon atom of an organic compound and a metal, and is typically, although not always, capable of deprotonating hydroxyl groups, e.g., from a support material. A deprotonating agent is defined as a compound or system capable of deprotonating hydroxyl groups from the support, and may be an organometallic or another compound such as a metal amide, e.g., aluminum amide or lithium amide.

An “anionic ligand” is a negatively charged ligand, which donates one or more pairs of electrons to a metal ion. A “neutral donor ligand” is a neutrally charged ligand, which donates one or more pairs of electrons to a metal ion.

The terms “cocatalyst” and “activator” are used herein interchangeably and are defined to be any compound which can activate the catalyst precursor compound by converting a neutral catalyst precursor compound to a catalytically active catalyst compound cation. The terms, “non-coordinating anion” (NCA), “compatible” NCA, “bulky activator,” “molecular volume,” “less bulky,” “more bulky,” are defined below.

In embodiments, the heterophasic propylene polymer composition produced herein, e.g., comprising fill rubber, or produced with phased hydrogen supply, and/or produced after the matrix phase when specified, may be referred to herein as an impact copolymer, or a propylene impact copolymer, or an in-reactor propylene impact copolymer, or an in-reactor propylene impact copolymer composition, and such terms are used interchangeably herein.

A substituted hydrocarbyl radical is a hydrocarbyl radical where at least one hydrogen has been replaced by a heteroatom or heteroatom containing group.

Halocarbyl radicals are radicals in which one or more hydrocarbyl hydrogen atoms have been substituted with at least one halogen (e.g., F, Cl, Br, I) or halogen-containing group (e.g., CF₃).

Silylcarbyl radicals (also called silylcarbyls) are groups in which the silyl functionality is bonded directly to the indicated atom or atoms. Examples include SiH₃, SiH₂R*, SiHR*₂, SiR*₃, SiH₂(OR*), SiH(OR*)₂, Si(OR*)₃, SiH₂(NR*₂), SiH(NR*₂)₂, Si(NR*₂)₃, and the like, where R* is independently a hydrocarbyl or halocarbyl radical and two or more R* may join together to form a substituted or unsubstituted saturated, partially unsaturated or aromatic cyclic or polycyclic ring structure.

Germylcarbyl radicals (also called germylcarbyls) are groups in which the germyl functionality is bonded directly to the indicated atom or atoms. Examples include GeH₃, GeH₂R*, GeHR*₂, GeR*₃, GeH₂(OR*), GeH(OR*)₂, Ge(OR*)₃, GeH₂(NR*₂), GeH(NR*₂)₂, Ge(NR*₂)₃, and the like, where R* is independently a hydrocarbyl or halocarbyl radical and two or more R* may join together to form a substituted or unsubstituted saturated, partially unsaturated or aromatic cyclic or polycyclic ring structure.

As used herein, the term “metallocene compound” includes compounds having two or three Cp ligands (cyclopentadienyl and ligands isolobal to cyclopentadienyl, such as indenyl or hydrogenated indenyl) bound to at least one Zr or Hf metal atom, and one or more leaving group(s) bound to the at least one metal atom.

For purposes of the present disclosure in relation to all catalyst compounds, the term “substituted” means that a hydrogen group has been replaced with a hydrocarbyl group, a heteroatom, or a heteroatom containing group. For example, methyl cyclopentadiene (Cp) is a Cp group substituted with a methyl group.

For purposes of the present disclosure, “alkoxides” or “alkoxy” include those where the alkyl group is a C₁ to C₁₀ hydrocarbyl. The alkyl group may be straight chain, branched, or cyclic. The alkyl group may be saturated or unsaturated. In at least one embodiment, the alkyl group may comprise at least one aromatic group.

The terms “hydrocarbyl radical,” “hydrocarbyl”, “alkyl”, and “hydrocarbyl group” are used interchangeably throughout this document. Likewise the terms “group,” “radical,” and “substituent” are also used interchangeably in this document. For purposes of the present disclosure, “hydrocarbyl radical” is defined to be C₁-C₁₀₀ radicals, that may be linear, branched, or cyclic, and when cyclic, aromatic or non-aromatic.

For purposes of the present disclosure, unless otherwise indicated, the term “substituted” means that a hydrogen group has been replaced with a heteroatom, or a heteroatom containing group. For example, substituted hydrocarbyl radicals are radicals in which at least one hydrogen atom of the hydrocarbyl radical has been substituted with at least one functional group such as Cl, Br, F, I, NR*₂, OR*, SeR*, TeR*, PR*₂, AsR*₂, SbR*₂, SR*, BR*₂, SiR*₃, GeR*₃, SnR*₃, PbR*₃ and the like (where R* is H or a C₁ to C₂₀ hydrocarbyl group), or where at least one heteroatom has been inserted within a hydrocarbyl ring.

The term “ring atom” means an atom that is part of a cyclic ring structure. By this definition, a benzyl group has six ring atoms and tetrahydrofuran has 5 ring atoms.

A “ring carbon atom” is a carbon atom that is part of a cyclic ring structure. By this definition, a benzyl group has six ring carbon atoms and para-methylstyrene also has six ring carbon atoms.

Reference to an alkyl, alkenyl, alkoxide, or aryl group without specifying a particular isomer (e.g., butyl) expressly discloses all isomers (e.g., n-butyl, iso-butyl, sec-butyl, and tert-butyl), unless otherwise indicated.

The term “aryl” or “aryl group” means a six carbon aromatic ring and the substituted variants thereof, including but not limited to, phenyl, 2-methyl-phenyl, xylyl, 4-bromo-xylyl. Likewise, heteroaryl means an aryl group where a ring carbon atom (or two or three ring carbon atoms) has been replaced with a heteroatom, such as N, O, or S.

The term “arylalkyl” or “aralkyl” means an aryl group where a hydrogen has been replaced with an alkyl or substituted alkyl group. For example, 3,5′-di-tert-butyl-phenyl indenyl is an indene substituted with an arylalkyl group. Additional examples of arylalkyl groups include benzyl, diphenylmethyl, triphenylmethyl, phenylethyl and diphenylethyl.

The term “alkylaryl” means an alkyl group where a hydrogen has been replaced with an aryl or substituted arylgroup. For example, ethylbenzyl indenyl is an indene substituted with an ethyl group bound to a benzyl group.

The term “alkenyl” means a straight-chain, branched-chain, or cyclic hydrocarbon radical having one or more carbon-carbon double bonds. These alkenyl radicals may be substituted. Examples of suitable alkenyl radicals can include ethenyl, propenyl, allyl, 1,4-butadienyl cyclopropenyl, cyclobutenyl, cyclopentenyl, cyclohexenyl, cycloctenyl and the like including their substituted analogues.

The term “arylalkenyl” means an aryl group where a hydrogen has been replaced with an alkenyl or substituted alkenyl group. For example, styryl indenyl is an indene substituted with an arylalkenyl group (a styrene group).

A “heterocyclic ring” is a ring having a heteroatom in the ring structure as opposed to a heteroatom substituted ring where a hydrogen on a ring atom is replaced with a heteroatom. For example, tetrahydrofuran is a heterocyclic ring and 4-N,N-dimethylamino-phenyl is a heteroatom substituted ring.

As used herein the term “aromatic” also refers to pseudoaromatic heterocycles which are heterocyclic substituents that have similar properties and structures (nearly planar) to aromatic heterocyclic ligands, but are not by definition aromatic; likewise, the term aromatic also refers to substituted aromatics.

A “solution polymerization” means a polymerization process in which the polymerization is conducted in a liquid polymerization medium, such as an inert solvent or monomer(s) or their blends. A solution polymerization is typically homogeneous. A homogeneous polymerization is one where the polymer product is dissolved in the polymerization medium. Such systems are preferably not turbid as described in J. Vladimir Oliveira, C. Dariva and J. C. Pinto, Ind. Eng. Chem. Res., 2000, 29, 4627.

A bulk polymerization means a polymerization process in which the monomers and/or comonomers being polymerized are used as a solvent or diluent using little or no inert solvent or diluent. A small fraction of inert solvent might be used as a carrier for catalyst and scavenger. A bulk polymerization system contains less than about 25 wt % of inert solvent or diluent, such as less than about 10 wt %, such as less than about 1 wt %, such as 0 wt %.

As used herein, “and/or” means either or both (or any or all) of the terms or expressions referred to, and “and or” means the earlier one(s) of the terms or expressions referred to or both (all) of the terms or expressions referred to, i.e., the later term or expression is optional.

### DETAILED DESCRIPTION

The present disclosure provides dual catalyst systems, propylene polymer compositions, and polymerization methods. In at least one embodiment, the catalyst system comprises the product of a catalyst capable of producing a matrix phase with melting point at least 100° C. and a second catalyst capable of producing amorphous polymer and an ethylene-alpha-olefin diene terpolymer. In at least one embodiment, the catalyst system comprises the product of catalyst compound capable of making isotactic polypropylene and a mono-Cp catalyst precursor compound. In at least one embodiment, the catalyst system comprises the product of a bis-cyclopentadienyl (bis-Cp) catalyst precursor compound and a mono-cyclopentadienyl (mono-Cp) catalyst precursor compound. In embodiments, the catalyst system comprises the product of a catalyst capable of producing a matrix phase with melting point at least 100° C. (see, Nello Pasquini (Ed.), Polypropylene Handbook, 2^{nd} Edition, Hanser Publisher, Munich (2005), p 75-89 and references cited therein) and a second catalyst capabile of producing amorphous polymer and an ethylene-alpha-olefin diene terpolymer.

In another embodiment, a catalyst system of the present disclosure further comprises a support material (or product thereof) having one or more of: a surface area of from 400 m²/g to 800 m²/g; an average pore diameter of 90 Angstroms or greater; an average particle size of 60 μm or greater; 40% or greater of the incremental pore volume comprising pores having a pore diameter larger than 100 Angstroms or greater; and sub-particles having an average particle size in the range of 0.01 μm to 5 μm. In yet another embodiment, embodiments of the present disclosure provide a process for polymerization of olefin monomers comprising contacting one or more monomers with a catalyst system of the present disclosure; and obtaining a propylene polymer composition. In another aspect, embodiments of the present disclosure provide a propylene polymer composition that includes: isotactic polypropylene; 5 wt % or greater of atactic polypropylene, based on the weight of the composition; and an ethylene-propylene-diene terpolymer.

Catalyst systems and processes of the present disclosure can provide polypropylene materials that can be heterophasic with a high fill loading of a second polymer component in a first polymer component, polypropylene materials that can be formed without post-reactor blending, polypropylene materials that are flowable (e.g., do not foul a reactor), and polypropylene materials having a low additive content. Processes of the present disclosure can be solventless, can use diene(s) in a second stage polymerization, and do not require post-reactor physical blending or additives for suitable processability of propylene polymer compositions.

A catalyst system useful herein is a mixed metallocene catalyst system comprising two or more different metallocene catalyst compounds, at least one activator, and at least one support. Alternately, the catalyst system useful herein is a mixed metallocene catalyst system comprising one, two or more different metallocene catalyst compounds, Catalyst I described below and, one, two or more different metallocene catalyst compounds, Catalyst II described below, at least one activator, and at least one support.

Alternately, the catalyst system useful herein is a mixed metallocene catalyst system comprising a metallocene catalyst compound, Catalyst I described below and a different metallocene catalyst compound, Catalyst II described below, at least one activator, and at least one support.

The invention also relates to processes for the production of multiphasic thermoplastic vulcanizates using C₂-C₂₀ alpha olefins and non-conjugated dienes using the catalysts and processes described herein. (The multiphasic TPV compositions include at least one matrix phase and at least one fill phase. The matrix phase in a polymer resin is required to remain stiff under the polymerization conditions to protect the fill phase (which has a tendency to agglomerate) to avoid reactor fouling due to resin particle agglomeration. Therefore, there is a requirement for the matrix phase to have a melting temperature (Tm) higher than the polymerization reaction temperature, which is typically in the range of 60-85° C. for commercial production reactors. The matrix phase Tm is preferably 100° C. or more, as the Tm of a polymer is the peak temperature of a wide range of Tm's (hence avoiding lower range material melting during polymerization). A Tm at least 15° C. higher than the polymerization temperature is usually enough to minimize a significant amount of polymer with Tms on the low side of the peak Tm and lower than the polymerization temperature). Monomers suitable for forming the matrix phase are either propylene or ethylene, with or without the presence of a low concentration comonomer that form a polymer or a copolymer having a Tm 100° C. or more. Propylene based matrix comprises isotactic polypropylene (iPP), syndiotactic polypropylene (sPP), and/or their low comonomer incorporated copolymers, such as random copoymer polypropylene (RCP). Ethylene based matrix typically comprises HDPE, MDPE, and/or LDPE having a Tm 100° C. or more. Monomers suitable for forming the fill phase include at least two of the C₂ to C₂₀ alphaolefin monomers and at least one non-conjugated diene.

For propylene based compositions, catalysts suitable to serve as Catalyst I are bridging C₂, bridging C₁ (both isotacticity specific) and bridging Cₛ (syndiotaticity specific) metallocenes and post-metallocenes, while catalysts suitable to serve as Catalysts II are constrained geometry catalysts (CGC), bridging C₁, and bridging Cₛ metallocenes and post metallocenes.

For propylene based compositions, the matrix phase require an isotactic or syndiotactic specified compound to obtain isotactic PP (iPP) or syndiotactic PP (sPP) or their low monomer incorporated copolymer with Tm 100° C. or more. Typical catalysts suitable as Catalyst I for propylene based compositions are therefore those metallocenes or post-metallocenes with a C₂ or C₁ symmetry ligand framework for isotacticity and Cₛ symmetry ligand framework for syndiotacticity. To obtain a more preferred higher Tm of the matrix phase, multiple ligands directly bonded to a catalyst metal center are designed to link to each other to form one ligand framework to enhance the ligand rigidness for better propylene stereo insertion regulation, e.g., bridging C₂ and C₁ metallocenes are usually better iPP catalysts and bridging Cₛ metallocenes are better sPP catalysts. Typical catalysts suitable to serve as Catalyst II for propylene based compositions are CGC, bridging C₁ and Cₛ catalysts, all feathering bridging a smaller ligand with a larger ligand to open up space for large diene molecule incorporation.

For ethylene based compositions, catalysts suitable to serve as Catalyst I have no stereo control restriction and can be any metallocenes and post metallocenes, while catalysts suitable to serve as Catalysts II are CGC, bridging C₁, and bridging Cₛ metallocenes and post metallocenes.

For ethylene based composition, theoretically any metallocenes or post-metallocenes can serve as Catalyst I if the resulting Tm is 100° C. or more, e.g., HDPE (Tm >130° C.), MDPE (Tm >120° C.), and LDPE (Tm >105° C.). Typical catalysts suitable for ethylene polymerization can serve as Catalyst for ethylene based compositions, such as bridging and non-bridging metallocenes or post-metallocenes with any symmetrical ligand frameworks, including those designed for C₂, C₁ iPP catalysts and Cₛ sPP catalysts. Typical catalysts suitable to serve as Catalyst II for ethylene based compositions are CGC, bridging C₁ and Cₛ catalysts, feathering one side less congested and bridging ligand framework to open up space for large diene molecule coordination, the same requirements for propylene based compositions.

This invention also relates to a process to make thermoplastic vulcanizate (TPV) comprising:

A) contacting propylene or ethylene and optional comonomer with a supported catalyst comprising: 1) support having a surface area of 400 m²/g or more (such as 400 m²/g to 800 m²/g), 2) a first catalyst compound capable of producing polymer having a melting point of 100° C. or more (such as isotactic polypropylene), said compound typically having a bridging C₁, bridging C₂, or bridging Cₛ symmetry ligand framework for propylene based matrix phase or having no ligand symmetry restriction for ethylene based matrix phase, and 3) a second catalyst compound capable of diene copolymerization, said compound typically being a CGC catalyst or having a bridging C₁ or bridging Cₛ symmetry ligand framework,
B) obtaining polymerizate containing active catalyst, a polymer having a melting point of 100° C. or more, such as isotactic polypropylene or high density polyethylene, and optionally another polymer with a different melting point or an amorphous polymer for propylene based polymer as the matrix phase; or optionally with a polymer with a different molecular weight or a different polymer density for ethylene based polymer;
C) contacting the polymerizate with at least two different C₂ to C₂₀ alpha-olefin monomers and at least one diene monomer;
D) obtaining a heterophasic copolymer product, having a continuous phase of polymer having a Tm of 100° C. or more (such as isotactic propylene polymer) and at least 18 wt % (such as 30 wt %) of an alpha-olefin diene monomer (such as ethylene-propylene-diene monomer) discontinuous phase.

This invention also relates to a supported catalyst comprising: 1) support having a surface area of 400 m²/g or more (such as 400 m²/g to 800 m²/g), 2) a first catalyst compound having C₁ or C₂ symmetry, and 3) a second catalyst compound having Cₛ symmetry.

This invention also relates to a supported catalyst comprising:

A. For TPV compositions with a propylene based matrix phase: 1) support having a surface area of 400 m²/g or more (such as 400 m²/g to 800 m²/g), 2) a first catalyst compound having bridging C₁, bridging C₂, or bridging Cₛ symmetry ligand framework, and 3) a second catalyst compound being a CGC catalyst or having C₁ or Cₛ symmetry. When C₁ or Cₛ catalysts are used as both the first and the second catalysts, they can be different or the same.

B. For TPV compositions with an ethylene based matrix phase: 1) support having a surface area of 400 m²/g or more (such as 400 m²/g to 800 m²/g), 2) a first catalyst compound, either a metallocene or a post-metallocene bearing either a non-bridging or bridging, symmetrical or asymmetrical ligand framework, and 3) a second catalyst compound being CGC catalyst or having a bridging C₁ or bridging Cₛ symmetry ligand framework. When CGC, C₁, or Cₛ catalysts are used as both the first catalyst and the second catalysts, they can be different or the same.

This invention also relates to a supported catalyst comprising 1) a first catalyst compound having C₁ or C₂ symmetry, 2) a second catalyst compound having Cₛ symmetry, and 3) support material (or product thereof) having (as determined by BET nitrogen adsorption) one or more of:

a surface area of from 400 m²/g to 800 m²/g;

an average pore diameter of 90 Angstroms or greater;

an average particle size of 60 μm or greater;

40% or greater of the incremental pore volume comprising pores having a pore diameter of 100 Angstroms or greater; and

sub-particles having an average particle size in the range of 0.01 μm to 5 μm.

This invention also relates to a supported catalyst system described in A or B above comprising 1) a first catalyst compound having C₁ or C₂ symmetry, 2) a second catalyst compound having Cₛ or C₁ symmetry, and 3) support material (or product thereof) having (as determined by BET nitrogen adsorption) one or more of:

a surface area of from 400 m²/g to 800 m²/g;

an average pore diameter of 90 Angstroms or greater;

an average particle size of 60 μm or greater;

40% or greater of the incremental pore volume comprising pores having a pore diameter of 100 Angstroms or greater; and

sub-particles having an average particle size in the range of 0.01 μm to 5 μm.

In yet another embodiment, embodiments of the present disclosure provide a process for polymerization of olefin monomers comprising contacting one or more monomers with a catalyst system of the present disclosure; and obtaining either a propylene based polymer composition or an ethylene based polymer composition. Contacting can include contacting: 1) propylene monomer under polymerization conditions with a catalyst system of the present disclosure to form a propylene based polymer comprising at least 40 mol % propylene to form a matrix phase; and following contacting at least two alpha olefin monomers selected from C₂ to C₂₀ alpha olefins, and at least one diene with the catalyst system under polymerization conditions to at least form an C₂ to C₂₀ alpha olefin-diene terpolymer (such as ethylene-propylene-diene terpolymer) to form a fill phase and thus obtaining a composition comprising the propylene based polymer and the terpolymer; or 2) ethylene monomer under polymerization conditions with a catalyst system of the present disclosure to form an ethylene based polymer comprising at least 40 mol % ethylene to form a matrix phase; and following contacting at least two alpha olefin monomer selected from C₂ to C₂₀ alpha olefins and at least one diene with the catalyst system under polymerization conditions to form a C₂ to C₂₀ alpha olefin-diene terpolymer (such as ethylene-hexene-diene terpolymer) to form a fill phase and thus obtaining a composition comprising the ethylene based polymer and the terpolymer.

In another aspect, embodiments of the present disclosure provide a propylene based polymer composition from the catalyst system comprising a catalyst with a C₂, C₁, or Cₛ symmetry as Catalyst I and a CGC catalyst as Catalyst II that includes: isotactic or syndiotatic polypropylene; 10 wt % or less of atactic polypropylene, based on the weight of the composition; and an ethylene-propylene-diene terpolymer. The propylene polymer compositions comprise a matrix phase comprising the isotactic polypropylene and the atactic polypropylene; and a fill phase comprising the ethylene-propylene-diene terpolymer.

In another aspect, embodiments of the present disclosure provide a propylene polymer composition that includes: isotactic polypropylene; 5 wt % or more of atactic polypropylene, based on the weight of the composition; and an ethylene-propylene-diene terpolymer. The propylene polymer compositions comprise a matrix phase comprising the isotactic polypropylene and the atactic polypropylene; and a fill phase comprising the ethylene-propylene-diene terpolymer.

In another aspect, embodiments of the present disclosure provide a propylene based polymer composition from the catalyst system comprising a catalyst with C₂, C₁, or Cₛ symmetry as Catalyst I and a different catalyst with C₁ or Cₛ symmetry as Catalyst II that produces either iPP or sPP with 5 wt % or greater of another iPP or sPP with a different crystallinity, based on the weight of the total composition, as the matrix phase and an ethylene-propylene-diene terpolymer as the fill phase. Different crystallinity means the % crystallinities as determined by DSC (see procedure below) differ by at least 5%, alternately by at least 10%, alternately by at least 20%. Polymers with different crystallinities will also have different melting points (Tm). Preferably the Tm's differ by at least 30° C., alternately by at least 40° C., alternately by at least 60° C., alternately by at least 80° C. If one of the polymers has no measureable Tm, then the other polymer will preferably have a Tm of at least 40° C., alternately at least 60° C., alternately at least 80° C., alternately at least 90° C., alternately at least 100° C.

In another aspect, embodiments of the present disclosure provide a propylene based polymer composition from a catalyst system comprising a catalyst with either a C₁ or a Cₛ symmetry to serve as both Catalyst I and Catalyst II to produce either an iPP or a sPP as the matrix phase and an ethylene-propylene-diene terpolymer as the fill phase.

In another aspect, embodiments of the present disclosure provide an ethylene based polymer composition from the catalyst system comprising a bridging C₁, bridging C₂, bridging Cₛ, CGC, or a non-bridging metallocene or post-metallocene as Catalyst I and a CGC, a bridging C, or a bridging C₁ catalyst as Catalyst II to produce a PB polymer with a polymer density 0.918 or more as the matrix phase and an ethylene-C₃ to C₂₀ alpha olefin-diene terpolymer with a polymer density 0.910 or less as the fill phase. When a C₁, Cₛ, or CGC catalyst is used as Catalyst I, the C₁, Cₛ, or CGC catalyst used as Catalyst II can be different or the same.

Catalyst systems suitable for the current application are shown in the Table below:

Catalyst Table

| | Ethylene | | | | Propylene | | |
|---|---|---|---|---|---|---|---|
| | Based Composition | | | | Based Composition | | |
| Matrix | HDPE, MDPE, or LDPE w/ | | | | iPP, sPP, or RCP | | |
| Phase | Tm 100° C. or more | | | | w/Tm 100° C. or more | | |
| Catalyst I | C2, | Cs | CGC | C1 | C2 | C1 | Cs |
| for Matrix | Non- | | | | | | |
| Phase | Bridging | | | | | | |
| Fill Phase | EPDM, EBDM, | | | | EPDM, PBDM, | | |
| | EHDM, EODM, etc. | | | | PHDM, PODM, etc. | | |
| Catalyst II | CGC, Cs, or C1 | | | | CGC, Cs, or C1 | | |
| for Fill | | | | | | | |
| Phase | | | | | | | |
| Possible | C2- | CS- | CGC- | C1- | C2- | C1-CGC, | Cs- |
| Catalyst | CGC, | CGC, | CGC | CGC, | CGC, | C1-Cs, | CGC, |
| Pairing | C2-Cs, | Cs-Cs | (can be | C1-Cs, | C2-Cs, | C1-C1 | Cs-Cs |
| | C2-C1, | (can be | different or | C1-C1 | C2-C1 | (can be | (can be |
| | NB- | different | the same), | (can be | | different or | different |
| | CGC, | of the | CGC-Cs, | different | | the same) | or the |
| | NB-Cs, | same), | CGC-CI | or the | | | same), |
| | NB-Cl | Cs-Cl | | same) | | | Cs-C1 |

| | | |
|---|---|---|
| Unlimited | C2⁼ homo-polymer (HDPE): | C3⁼ homo-polymer: |
| Examples | HDPE w/ PDI <3 (Mw from Cat I & | iPP-aPP, sPP-aPP, iPP1-iPP2, |
| of Matrix | II similar or same); | iPP-sPP, sPP1-sPP2, iPP, sPP, |
| Phase | HDPE w/ PDI >3 (Mw from | required a component with |
| Com- | Cat I & II different); | Tm <100° C. (e.g., aPP) |
| positions | (e.g., HDPE w/ density 0.93-0.97) | to be 10 wt % or less |
| | C2⁼/C6⁼ copolymer: | C3⁼/C2⁼ copolymer: |
| | MDPE or LDPE, | RCP, required a possible 2^{nd} |
| | required any component | component with Tm <100° C. |
| | with Tm <100° C. (e.g., | from Cat II (e.g., |
| | LDPE w/density >0.915) | aPP dominant RCP) to |
| | to be 10 wt % or less | be 10 wt % or less |
| Unlimited | C2⁼/C6⁼/2-Me-1,4- | C3⁼/C2⁼/2-Me-1,4-pentadiene |
| Examples of | pentadiene terpolymer: | terpolymer: |
| Fill Phase | Plastomers: density = 0.850-0.915 | Plastomer: C2⁼ mol % >5 but |
| Compositions | Elastomers: density < 0.850 | <40 and >60 and <95; |
| | | Elastomer: C2⁼ mol % = |
| | | 40-60 |

### Catalyst I, the First Catalyst Compound.

Catalyst systems of the present disclosure include a catalyst capable of polymerizing either propylene or ethylene with or without one or more comonomers to form a polymer or copolymer having a melting point of at least 100° C. that is preferably stiff enough to serve as a matrix phase in a hetero-phasic copolymer. In at least one embodiment, Catalyst I contributes at least 80% of the matrix phase, the matrix phase having a melting point at least 100° C. in the dual catalyst system where Catalyst I to Catalyst II ratio is in any suitable range (e.g., in the range of 1:20 mol:mol to 20:1 mol:mol).

In embodiments of the invention, the first catalyst compound is any catalyst compound capable of making tactic polymer (isotactic and or syndiotactic) having a melting point of 100° C. or more (such as 120° C. or more, such as 140° C. or more, such as 155° C. or more). In embodiments of the invention the first catalyst compound, Catalsyt I, is any metallocene catalyst compound capable of making tactic polymer, such as isotactic polypropylene or syndiotactic polypropylene, preferably having a melting point of 100° C. or more.

Preferably, Catalyst I produces crystalline polymer (e.g. having a Tm of 100° C. or more), such as tactic polypropylene, such as isotactic polypropylene and is represented by the formula (A):

Cp^{A}T_{y}Cp^{B}M′X′ₙ (A)

wherein,

Cp^{A} is a cyclopentadienyl group which may be substituted or unsubstituted, provided that Cp^{A} is substituted with at least one R** group, where R** is a group containing at least three carbon or silicon atoms, preferably R** is a C₃ to C₁₂ alky group, preferably R** is a linear C₃ to C₁₂ alkyl group (such as n-propyl, n-butyl, n-pentyl, n-hexyl, n-heptyl, n-octyl, n-nonyl, n-decyl, n-undecyl or n-dodecyl), and Cp^{A} IS optionally also independently substituted by one, two, three, or four R″ groups;

Cp^{B} is a cyclopentadienyl group which may be substituted or unsubstituted, substituted by one, two, three, four, or five R″ groups or R** groups;

T is a bridging group, and y is 0 or 1;

M′ is selected from the group consisting of Groups 3 through 12 atoms and lanthanide Group atoms, preferably M is a group 4 metal, such as Hf, Zr, or Ti, preferably Hf;

each X′ is, independently, a univalent anionic ligand, or two X′ are joined and bound to the metal atom to form a metallocycle ring, or two X′ are joined to form a chelating ligand, a diene ligand, or an alkylidene ligand (preferably each X′ is independently, halogen or C₁ to C₁₂ alkyl or Cₛ to C₁₂ aryl, such as Br, Cl, I, Me, Et, Pr, Bu, Ph);

n is 0, 1, 2, 3, or 4, preferably n is 2; and

each R″ is independently selected from the group consisting of hydrocarbyl, substituted hydrocarbyl, heteroatom, or heteroatom containing group.

In a preferred embodiment of the invention in formula (A), M is Hf.

In a preferred embodiment of the invention in formula (A), Cp^{A} and Cp^{B} are each substituted with at least one R** group, preferably n-propyl or n-butyl.

In a preferred embodiment of the invention in formula (A), each R″ is independently selected from the group consisting of alkyl, substituted alkyl, heteroalkyl, alkenyl, substituted alkenyl, heteroalkenyl, alkynyl, substituted alkynyl, heteroalkynyl, alkoxy, aryloxy, alkylthio, arylthio, aryl, substituted aryl, heteroaryl, aralkyl, aralkylene, alkaryl, alkarylene, haloalkyl, haloalkenyl, haloalkynyl, heteroalkyl, heterocycle, heteroaryl, a heteroatom-containing group, hydrocarbyl, substituted hydrocarbyl, heterohydrocarbyl, silyl, boryl, phosphino, phosphine, amino, amine, ether, and thioether.

In a preferred embodiment of the invention in formula (A), each R″ is independently hydrogen, or a substituted C₁ to C₁₂ hydrocarbyl group or an unsubstituted C₁ to C₁₂ hydrocarbyl group, preferably R″ is a C₁ to C₂₀ substituted or unsubstituted hydrocarbyl, preferably a substituted C₁ to C₁₂ hydrocarbyl group or an unsubstituted C₁ to C₁₂ hydrocarbyl group, preferably methyl, ethyl, propyl, butyl, pentyl, hexyl, or an isomer thereof. More particular, non-limiting examples of R″ include methyl, ethyl, propyl, butyl, pentyl, hexyl, cyclopentyl, cyclohexyl, benzyl, phenyl, methylphenyl, and tert-butylphenyl groups and the like, including all their isomers, for example, tertiary-butyl, isopropyl, and the like.

In a preferred embodiment of the invention in formula (A), R** is a C₃ to C₄ hydrocarbyl (preferably n-propyl or n-butyl).

In a preferred embodiment of the invention in formula (A), each X′ is, independently, selected from the group consisting of hydrocarbyl radicals having from 1 to 20 carbon atoms, aryls, hydrides, amides, alkoxides, sulfides, phosphides, halides, dienes, amines, phosphines, ethers, and a combination thereof (two X′ 's may form a part of a fused ring or a ring system), preferably each X′ is independently selected from halides, aryls and C₁ to C₅ alkyl groups, preferably each X′ is a phenyl, methyl, ethyl, propyl, butyl, pentyl, bromo, or chloro group. Preferably, each X′ is, independently, a halide, a hydride, an alkyl group, an alkenyl group or an arylalkyl group. Alternately each X′ is Br, Cl, I, F, methyl, ethyl, propyl, butyl, pentyl, hexyl, cyclopentyl, cyclohexyl, benzyl, phenyl, methylphenyl, or tert-butylphenyl.

Compounds useful as Catalyst I are disclosed in U.S. Pat. No. 6,242,545, which is incorporated by reference herein.

Preferably compounds useful as Catalyst I are selected from the group consisting of:
bis(n-propylcyclopentadienyl)hafnium dichloride,
bis(n-propylcyclopentadienyl)hafnium dimethyl,
bis(n-propylcyclopentadienyl)zirconium dichloride,
bis(n-propylcyclopentadienyl)zirconium dimethyl,
bis(n-propylcyclopentadienyl)titanium dichloride,
bis(n-propylcyclopentadienyl)titanium dimethyl,
(n-propylcyclopentadienyl) (pentamethylcyclopentadienyl)zirconium dichloride,
(n-propylcyclopentadienyl) (pentamethylcyclopentadienyl)zirconium dimethyl,
(n-propylcyclopentadienyl) (pentamethylcyclopentadienyl)hafnium dichloride,
(n-propylcyclopentadienyl) (pentamethylcyclopentadienyl)hafnium dimethyl,
(n-propylcyclopentadienyl) (pentamethylcyclopentadienyl)titanium dichloride,
(n-propylcyclopentadienyl) (pentamethylcyclopentadienyl)titanium dimethyl,
(n-propylcyclopentadienyl) (tetramethylcyclopentadienyl)zirconium dichloride,
(n-propylcyclopentadienyl) (tetramethylcyclopentadienyl)zirconium dimethyl,
(n-propylcyclopentadienyl) (tetramethylcyclopentadienyl)hafnium dichloride,
(n-propylcyclopentadienyl) (tetramethylcyclopentadienyl)hafnium dimethyl,
(n-propylcyclopentadienyl) (tetramethylcyclopentadienyl)titanium dichloride,
(n-propylcyclopentadienyl) (tetramethylcyclopentadienyl)titanium dimethyl,
bis(cyclopentadienyl)hafnium dimethyl,
bis(n-butylcyclopentadienyl)hafnium dichloride,
bis(n-butylcyclopentadienyl)hafnium dimethyl,
bis(n-butylcyclopentadienyl)zirconium dichloride,
bis(n-butylcyclopentadienyl)zirconium dimethyl,
bis(n-butylcyclopentadienyl)titanium dichloride,
bis(n-butylcyclopentadienyl)titanium dimethyl,
bis(1-methyl-3-n-butylcyclopentadienyl)hafnium dichloride,
bis(1-methyl-3-n-butylcyclopentadienyl)hafnium dimethyl,
bis(1-methyl-3-n-butylcyclopentadienyl)zirconium dichloride,
bis(1-methyl-3-n-butylcyclopentadienyl)zirconium dimethyl,
bis(1-methyl-3-n-butylcyclopentadienyl)titanium dichloride, and
bis(1-methyl-3-n-butylcyclopentadienyl)titanium dimethyl.

Two or more of the metallocene catalysts as described herein (preferably at least one Catalyst I compound represented by formula (A) and at least one Catalyst II compound represented by formula (B) below) may be used in a mixed catalyst system also known as a dual catalyst system comprising, for example, two or three metallocene catalysts or any of the catalysts described herein or known in the art to be useful for olefin polymerization.

In a preferred embodiment of the invention Catalyst I may be a bridged bis-cyclopentadienyl catalyst precursor compounds, where the compounds have at least one indenyl ligand substituted at the 2-position with a linear alkyl group and at least one indenyl ligand substituted at the 4-position with a phenyl group, the phenyl group being substituted at the 3′, 4′, and 5′ positions with particular combinations of substituents. In at least one embodiment, the 3′ and 5′ positions of the phenyl ring are selected to be sterically hindering (e.g., branched hydrocarbyl groups) and the 4′-substituent is selected from —(XR′ₙ), wherein X is a Group 14, 15, 16 or 17 heteroatom having an atomic weight of 13 to 79 (such as N, O, S, P, or Si) and R′ is one of a hydrogen atom, halogen atom, a C₁-C₁₀ alkyl group (such as methyl, ethyl, propyl, butyl, pentyl, hexyl, octyl, nonyl, decyl or an isomer thereof), or a C₆-C₁₀ aryl group and n is 0, 1, 2, or 3; such as —(XR′ₙ) is —NR′₂, —SR′, —OR′, —OSiR′₃, —SiR′₃, or —PR′₂, such as —(XR′ₙ) is —NR′₂, —SR′, —OR′, —OSiR′₃, or —PR′₂, such as (XR′ₙ)⁻ is —SR′, —OR′, or —OSiR′₃, such as (XR′ₙ)⁻ is —NR′₂ or —PR′₂, such as (XR′ₙ)⁻ is —OR′.

In at least one embodiment, the bis-Cp catalyst precursor compound useful as Catalyst (I) is represented by the Formula (I):

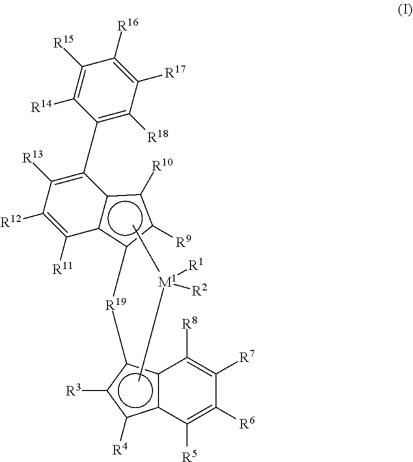

wherein M¹ is selected from the group consisting of titanium, zirconium, hafnium, vanadium, niobium, tantalum, chromium, molybdenum and tungsten;

R¹ and R² are independently hydrogen, halogen, hydroxyl, hydrocarbyl, or substituted hydrocarbyl (such as C₁-C₁₀ alkyl, C₁-C₁₀ alkoxy, C₆-C₂₀ aryl, C₆-C₁₀ aryloxy, C₂-C₁₀ alkenyl, C₂-C₄₀ alkenyl, C₇-C₄₀ arylalkyl, C₇-C₄₀ alkylaryl, C₈-C₄₀ arylalkenyl, or conjugated diene which is optionally substituted with one or more hydrocarbyl, tri(hydrocarbyl) silyl or tri(hydrocarbyl) silylhydrocarbyl, said diene having up to 30 atoms other than hydrogen);

R³ and R⁹ are independently linear alkyl (such as methyl, ethyl, propyl, butyl, pentyl, hexyl, heptyl, octyl, nonyl, or decyl);

each of R⁴, R⁶, R⁷, R⁸, R¹⁰, R¹¹, R¹², and R¹³ is independently hydrogen, halogen, C₁-C₄₀ hydrocarbyl or C₁-C₄₀ substituted hydrocarbyl (such as C₁-C₁₀ alkyl which may be substituted, C₆-C₄₀ aryl which may be substituted, C₂-C₁₀ alkenyl, C₇-C₄₀ arylalkyl, C₇-C₄₀ alkylaryl, C₈-C₄₀ arylalkenyl), —NR′₂, —SR′, —OR, —OSiR′₃, —PR′₂, where each R′ is hydrogen, halogen, C₁-C₁₀ alkyl, or C₆-C₁₀ aryl;

R⁵ is hydrogen, halogen, C₁-C₄₀ hydrocarbyl or C₁-C₄₀ substituted hydrocarbyl (such as C₁-C₁₀ alkyl which may be substituted, C₆-C₄₀ aryl which may be substituted, C₂-C₁₀ alkenyl, C₇-C₄₀ arylalkyl, C₇-C₄₀ alkylaryl, C₈-C₄₀ arylalkenyl), —NR′₂, —SR′, —OR, —OSiR′₃, —PR′₂, where each R′ is hydrogen, halogen, C₁-C₁₀ alkyl, or C₆-C₁₀ aryl, or two or more adjacent radicals R⁵ to R⁸ together form one or more saturated or unsaturated rings;

R¹⁹ is —B(R²⁰)—, —Al(R²⁰)—, —O—, —S—, —SO—, —SO₂—, —N(R²⁰)—, —CO—, —P(R²⁰)—, or —P(O)(R²⁰)—, an amidoborane radical or one of the following:

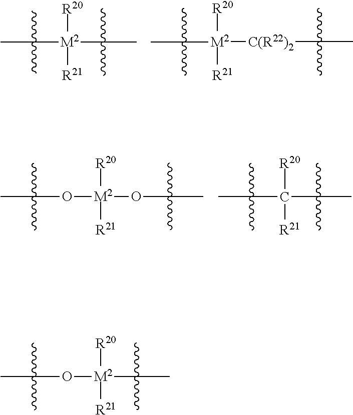

wherein each of R²⁰, R²¹, R²² is independently hydrogen, halogen, C₁-C₂₀ alkyl, C₁-C₂₀ fluoroalkyl or silaalkyl, C₆-C₃₀ aryl, C₆-C₃₀ fluoroaryl, C₁-C₂₀ alkoxy, C₂-C₂₀ alkenyl, C₇-C₄₀ arylalkyl, C₈-C₄₀ arylalkenyl, C₇-C₄₀ alkylaryl, or one R²⁰ and one R²¹, together with the atoms in R¹⁹ connecting them, form one or more rings; M² is one or more carbon, silicon, germanium or tin;

R¹⁴ is substituted or unsubstituted C₆-C₁₀ aryl (such as phenyl or substituted phenyl). In at least one embodiment, R¹⁴ is substituted with one or more of C₁-C₁₀ alkyl which may be substituted (such as halogenated), C₆-C₂₀ aryl which may be substituted (such as halogenated aryl, C₇-C₄₀ arylalkyl, C₇-C₄₀ alkylaryl, C₈-C₄₀ arylalkenyl), C₂-C₁₀ alkenyl which may be substituted, a hydrocarbyl group, a heteroatom, or a heteroatom containing group, such as halogen (such as Br, C₁, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, and the like, where each R* is independently a hydrocarbyl or halocarbyl radical, and two or more R* may join together to form a substituted or unsubstituted saturated, partially unsaturated or aromatic cyclic or polycyclic ring structure, or where at least one heteroatom has been inserted within a hydrocarbyl ring;

R¹⁸ is hydrogen, halogen, substituted or unsubstituted C₃-C₂₀ alkyl, substituted or unsubstituted C₆-C₄₀ aryl (such as C₇-C₄₀ arylalkyl, C₇-C₄₀ alkylaryl, C₈-C₄₀ arylalkenyl, biphenyl), C₂-C₁₀ alkenyl, —NR′₂, —SR′, —OR, —OSiR′₃ or —PR′₂, wherein each R′ is hydrogen, halogen, C₁-C₁₀ alkyl, or C₆-C₁₀ aryl;

R¹⁵ and R¹⁷ are independently hydrogen, C₂-C₂₀ alkyl which may be substituted (such as halogenated), C₆-C₄₀ aryl which may be substituted (such as halogenated aryl, C₇-C₂₀ arylalkyl, C₇-C₂₀ alkylaryl, C₈-C₂₀ arylalkenyl), or C₂-C₁₀ alkenyl; and

R¹⁶ is selected from hydrogen, halogen, C₁-C₁₀ alkyl which may be substituted (such as halogenated), C₆-C₂₀ aryl which may be substituted (such as halogenated aryl, C₇-C₄₀ arylalkyl, C₇-C₄₀ alkylaryl, C₈-C₄₀ arylalkenyl), C₂-C₁₀ alkenyl which may be substituted, or two or more adjacent radicals R¹⁵ to R¹⁸ together form one or more rings, and —XR′ₙ, wherein X is a group 14-17 heteroatom having an atomic weight of 13 to 79 and R′ is one of hydrogen, halogen, C₁-C₁₀ alkyl, or C₆-C₁₀ aryl and n is 0, 1, 2, or 3.

In at least one embodiment, a bis-Cp catalyst precursor compound useful as Catalyst (I) is represented by Formula (Ia):

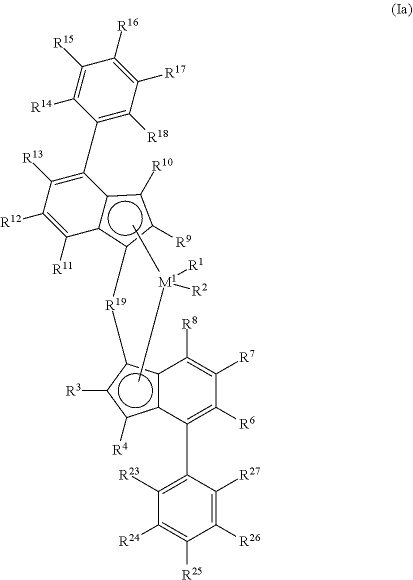

wherein

M¹, R¹, R², R³, R⁴, R⁶, R⁷, R⁸, R⁹, R¹⁰, R¹¹, R¹², R¹³, R¹⁴, R¹⁵, R¹⁷, and R¹⁹ are as defined for Formula (I) above;

each of R¹⁸, R²³, and R²⁷ is independently hydrogen, halogen, substituted or unsubstituted C₃-C₂₀ alkyl, substituted or unsubstituted C₆-C₄₀ aryl (such as C₇-C₄₀ arylalkyl, C₇-C₄₀ alkylaryl, C₈-C₄₀ arylalkenyl, biphenyl), C₂-C₁₀ alkenyl, —NR′₂, —SR′, —OR, —OSiR′₃ or —PR′₂, wherein each R′ is hydrogen, halogen, C₁-C₁₀ alkyl, or C₆-C₁₀ aryl;

R²⁴ and R²⁶ are independently substituted or unsubstituted C₂-C₂₀ alkyl, substituted or unsubstituted C₆-C₄₀ aryl (such as C₇-C₂₀ arylalkyl, C₇-C₂₀ alkylaryl, or C₈-C₂₀ arylalkenyl), C₂-C₁₀ alkenyl; and wherein R¹⁶ and R²⁵ are independently —(XR′ₙ), wherein X is a group 14-17 heteroatom having an atomic weight of 13 to 79 and R′ is one of hydrogen, halogen, C₁-C₁₀ alkyl, or C₆-C₁₀ aryl and n is 0, 1, 2, or 3.

In at least one embodiment, R¹⁴ is phenyl. In at least one embodiment, R⁵ is

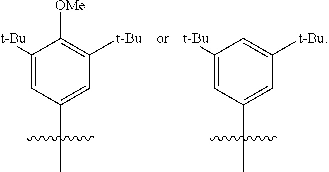 [SMILES: *c1cc(C(C)(C)C)c(OC)c(C(C)(C)C)c1 ; *c1cc(C(C)(C)C)cc(C(C)(C)C)c1]

In at least one embodiment, R⁶ and R⁷ or R⁷ and R⁸ can combine to form a cyclobutyl ring, a cyclopentyl ring or cyclohexyl ring.

In at least one embodiment, M¹ is Hf, Zr or Ti, such as Hf or Zr, such as Zr.

In at least one embodiment, M² is Si, C or Ge, such as C or Si, such as Si.

R¹⁵, R¹⁶, and R¹⁷ can be hydrogen, methyl, ethyl, propyl, butyl, pentyl, hexyl, heptyl, octyl, nonyl, decyl, undecyl, or dodecyl.

In at least one embodiment, R¹⁹ is represented by the formula R^{a}₂J, where J is C, Si, or Ge, and each R^{a} is, independently, hydrogen, halogen, C₁ to C₂₀ hydrocarbyl (such as methyl, ethyl, propyl, butyl, pentyl, hexyl, heptyl, octyl, nonyl, decyl, undecyl, or dodecyl) or a C₁ to C₂₀ substituted hydrocarbyl, and two R^{a} can form a cyclic structure including aromatic, partially saturated, or saturated cyclic or fused ring system. R¹⁹ can be a bridging group comprising carbon or silica, such as dialkylsilyl, such as R¹⁹ is selected from CH₂, CH₂CH₂, C(CH₃)₂, SiMe₂, SiPh₂, SiMePh, silylcyclobutyl (Si(CH₂)₃), (Ph)₂C, (p-(Et)₃SiPh)₂C, and cyclopentasilylene (Si(CH₂)₄).

In at least one embodiment, each R¹ and R² is independently hydrocarbyl having from 1 to 20 carbon atoms, hydride, amide, alkoxide, sulfide, phosphide, halide, dienyl, amine, phosphine, ether, or a combination thereof. R¹ and R² may form a part of a fused ring or a ring system. In at least one embodiment, each R¹ and R² is independently halide or C₁ to C₅ alkyl (such as methyl). R¹ and R² can be independently chloro, bromo, methyl, ethyl, propyl, butyl, pentyl, hexyl, heptyl, octyl, nonyl, decyl, undecyl, and dodecyl.

Alternatively, R¹ and R² may also be joined together to form an alkanediyl group or a conjugated C₄-C₄₀ diene ligand which is coordinated to M¹ in a metallocyclopentene fashion. R¹ and R² may also be identical or different conjugated dienes, optionally substituted with one or more hydrocarbyl, tri(hydrocarbyl) silyl or tri(hydrocarbyl) silylhydrocarbyl, said dienes having up to 30 atoms not counting hydrogen and/or forming a r-complex with M¹.

Exemplary groups suitable for R¹ and or R² include 1,4-diphenyl, 1,3-butadiene, 1,3-pentadiene, 2-methyl 1,3-pentadiene, 2,4-hexadiene, 1-phenyl, 1,3-pentadiene, 1,4-dibenzyl, 1,3-butadiene, 1,4-ditolyl-1,3-butadiene, 1,4-bis (trimethylsilyl)-1,3-butadiene, and 1,4-dinaphthyl-1,3-butadiene. R¹ and R² can be identical and are C₁-C₃ alkyl or alkoxy, C₆-C₁₀ aryl or aryloxy, C₂-C₄ alkenyl, C₇-C₁₀ arylalkyl, C₇-C₁₂ alkylaryl, or halogen, such as chlorine.

In at least one embodiment, R³ may be selected from substituted or unsubstituted methyl, ethyl, n-propyl, n-butyl, pentyl, hexyl, heptyl, or octyl. In at least one embodiment, R³ in Formula (I) or (Ia) is a hydrocarbyl radical having from 1 to 20 carbon atoms that is not substituted with a heteroatom.

In at least one embodiment, each of R⁴, R⁶, R⁷, R⁸, R¹⁰, R¹¹, R¹², and R¹³ is independently hydrogen, halogen, C₁-C₁₀ alkyl which may be halogenated (such as C₂ to C₁₀, such as C₃ to C₁₀, such as methyl, ethyl, propyl, butyl, pentyl, hexyl, heptyl, octyl, nonyl, decyl, undecyl, dodecyl or an isomer thereof), C₆-C₁₀ aryl which may be halogenated, C₂-C₁₀ alkenyl, C₇-C₄₀ arylalkyl, C₇-C₄₀ alkylaryl, C₈-C₄₀ arylalkenyl, —NR′₂, —SR′, —OR, —OSiR′₃, —PR′₂, wherein R′ is one of hydrogen, halogen, C₁-C₁₀ alkyl, or C₆-C₁₀ aryl.

In at least one embodiment, each of R⁴, R⁶, R⁷, R⁸, R¹⁰, R¹¹, R¹², and R¹³ is independently hydrogen, halogen, C₁-C₄₀ hydrocarbyl or C₁-C₄₀ substituted hydrocarbyl (such as C₁-C₁₀ alkyl which may be substituted, C₆-C₄₀ aryl which may be substituted, C₂-C₁₀ alkenyl, C₇-C₄₀ arylalkyl, C₇-C₄₀ alkylaryl, C₈-C₄₀ arylalkenyl).

In at least one embodiment, R⁵ is hydrogen, halogen, C₁-C₄₀ hydrocarbyl or C₁-C₄₀ substituted hydrocarbyl (such as C₁-C₁₀ alkyl which may be substituted, C₆-C₄₀ aryl which may be substituted, C₂-C₁₀ alkenyl, C₇-C₄₀ arylalkyl, C₇-C₄₀ alkylaryl, C₈-C₄₀ arylalkenyl), —NR′₂, —SR′, —OR, —OSiR′₃, —PR′₂, where each R′ is hydrogen, halogen, C₁-C₁₀ alkyl, or C₆-C₁₀ aryl, or two or more adjacent radicals R⁵ to R⁸ together form one or more saturated or unsaturated rings.

In at least one embodiment, R¹⁸ is hydrogen, halogen, C₁-C₁₀ alkyl (such as C₂ to C₁₀, such as C₃ to C₁₀, such as methyl, ethyl, propyl, butyl, pentyl, hexyl, heptyl, octyl, nonyl, decyl, undecyl, dodecyl or an isomer thereof) which may be halogenated, C₆-C₁₀ aryl (such as phenyl), which may be halogenated. In at least one embodiment, R¹⁸ is hydrogen, methyl, ethyl, propyl, butyl, pentyl, hexyl, phenyl, octyl, nonyl, decyl, undecyl, dodecyl, such as methyl, ethyl, or phenyl.

In at least one embodiment, R¹⁵ and R¹⁷ are independently hydrogen, C₂-C₂₀ alkyl (such as C₃ to C₁₆, such as C₄ to C₁₂, such as butyl, pentyl, hexyl, heptyl, octyl, nonyl, decyl, undecyl, dodecyl and isomers thereof) which may be halogenated, C₆-C₁₀ aryl which may be halogenated. R¹⁵ and R¹⁷ may be independently hydrogen, butyl, aryl, isopropyl, fluoroalkyl, n-propyl, n-butyl, iso-butyl, or tert-butyl. In at least one embodiment, R¹⁵ and R¹⁷ are independently hydrogen, C₄ to C₂₀, such as C₄ to C₁₂ alkyl, and R³ is a hydrocarbyl radical having from 1 to 20 carbon atoms that is not substituted with a heteroatom.

In at least one embodiment, R¹⁶ is selected from —NR′₂, —SR′, —OR′, —OSiR′₃ and PR′₂ radical, wherein R′ is one of a hydrogen atom, halogen atom, a C₁-C₁₀ alkyl group, or a C₆-C₁₀ aryl group, such as wherein R¹⁶ is —OR′ wherein R′ is a C₁-C₁₀ alkyl group, such as a methoxy, ethoxy, n-propoxy, isopropoxy, n-butoxy, iso-butoxy, sec-butoxy, or t-butoxy group, such as methoxy.

In at least one embodiment, R⁵ is a substituted or unsubstituted C₆-C₁₀ aryl group (such as phenyl, naphthyl, indenyl, such as phenyl) which may be substituted (such as halogenated), e.g., a substituted or unsubstituted phenyl, napthyl, or indenyl. R⁵ can be phenyl, such as 3′- and/or 5′-substituted phenyl, such as wherein the 3′ and or 5′ substituents are selected from C₂-C₂₀ alkyl group which may be halogenated, a C₆-C₁₀ aryl group which may be halogenated, a C₂-C₁₀ alkenyl group, a C₇-C₂₀ arylalkyl group, a C₇-C₂₀ alkylaryl group, a C₈-C₂₀ arylalkenyl group. In at least one embodiment, where R⁵ is phenyl, the 3′ and 5′ (i.e., R²⁴ and R²⁶) positions are independently butyl, aryl, isopropyl, or fluoroalkyl, such as wherein each is independently n-butyl, iso-butyl, or tert-butyl, such as wherein each is tert-butyl. In at least one embodiment, where R⁵ is phenyl, the 3′ and 5′ positions are independently butyl, aryl, isopropyl, or fluoroalkyl (such as wherein each is selected from n-butyl-, iso-butyl-, and tert-butyl, such as wherein each is tert-butyl), and the phenyl is also substituted at the 4′ position (i.e., R²⁵) with a —NR′₂, —SR′, —OR′, —OSiR′₃ or —PR′₂ radical, wherein R′ is one of hydrogen, halogen, C₁-C₁₀ alkyl, or C₆-C₁₀ aryl, such as alkyloxy, such as methoxy, ethoxy, n-propoxy, isopropoxy, n-butoxy, iso-butoxy, sec-butoxy, or t-butoxy.

In at least one embodiment, R³ is methyl, each of R¹⁵ and R¹⁷ is independently hydrogen, n-butyl, iso-butyl, or tert-butyl groups, and R¹⁶ is hydrogen, methoxy, ethoxy, n-propoxy, isopropoxy, n-butoxy, iso-butoxy, sec-butoxy, or t-butoxy group, such as a methoxy group.

In at least one embodiment, R³ is methyl, each of R¹⁵, R¹⁷, R²⁴ and R²⁶ is independently hydrogen, n-butyl-, iso-butyl-, or tert-butyl. R¹⁶ and R²⁵ may be independently methoxy, ethoxy, n-propoxy, isopropoxy, n-butoxy, iso-butoxy, sec-butoxy, or t-butoxy group, such as a methoxy group.

In at least one embodiment, R⁶ and R⁷ form a saturated or unsaturated, single or multi-ring structure, such as R⁶ and R⁷ form a saturated ring having 5 or 6 ring atoms, such as R⁶ and R⁷ form a saturated ring having 5 ring atoms, such that the indenyl fragment is a substituted tetrahydroindacenyl group.

Some catalysts useful herein may be described as bridged bis(4-phenyl-indenyl) transition metal complexes wherein: at least one of the phenyl rings is substituted at the 3′ and 5′ positions (i.e., R¹⁵, R¹⁷, R²⁴ and R²⁶) by radicals which may be independently C₂-C₂₀ alkyl which may be halogenated, C₆-C₁₀ aryl which may be halogenated, C₂-C₁₀ alkenyl, C₇-C₂₀ arylalkyl, C₇-C₂₀ alkylaryl, C₈-C₂₀ arylalkenyl, wherein at least one of the phenyl rings substituted at the 3′ and 5′ positions is also substituted at the 4′ position with —NR′₂, —SR′, —OR′, —OSiR′₃ or —PR′₂, wherein R′ is one of hydrogen, halogen, C₁-C₁₀ alkyl, or C₆-C₁₀ aryl, and one or more of the remaining positions on the phenyl and/or indenyl ring(s) of the transition metal complex may be substituted. In at least one embodiment, each of the phenyl rings is substituted at the 3′ and 5′ positions by C₂-C₂₀ alkyl which may be halogenated, C₆-C₁₀ aryl which may be halogenated, C₂-C₁₀ alkenyl, C₇-C₂₀ arylalkyl, C₇-C₂₀ alkylaryl, C₈-C₂₀ arylalkenyl. R³ may be linear C₁-C₁₀ alkyl which may be halogenated. In at least one embodiment, when either R³ is methyl or ethyl, then one or both phenyl rings are substituted at the 3′ and 5′ positions by n-butyl, sec-butyl, or t-butyl. In at least one aspect, at least one 4-phenyl group is substituted at the 3′ and 5′ position with a tert-butyl group and at the 4′ position with —OR′, wherein R′ is hydrogen, halogen, C₁-C₁₀ alkyl, such as methyl, or a C₆-C₁₀ aryl group.

In at least one embodiment, a bis-Cp Catalyst I compound of the present disclosure is a Zr- or Hf-based complex. Additionally, some such catalysts are bridged by a dialkylsiladiyl group or a diisopropylamidoborane group.

In at least one embodiment, Catalyst I of the present disclosure is represented by Formula (Ia) above where: M¹ is selected from titanium, zirconium, and hafnium, such as zirconium or hafnium, such as zirconium; R¹ and R² are independently hydrogen, C₁-C₁₀ alkyl (such as methyl, ethyl, butyl, pentyl, hexyl, heptyl, octyl, nonyl, decyl, undecyl, dodecyl and isomers thereof), or halogen (such as Cl, Br, F, or I).

In at least one embodiment, for catalysts represented by Formula (Ia), R³ is linear C₁-C₁₀ alkyl (such as C₂ to C₁₀, such as C₃ to C₈, such as methyl, ethyl, butyl, pentyl, hexyl, heptyl, octyl, nonyl, decyl, undecyl, or dodecyl) which may be halogenated.

In at least one embodiment, for catalysts represented by Formula (Ia), R⁴, R⁶, R⁷, R⁸, R¹⁰, R¹¹, R¹² and R¹³ are independently hydrogen, halogen, C₁-C₁₀ alkyl (such as methyl, ethyl, butyl, pentyl, hexyl, heptyl, octyl, nonyl, decyl, undecyl, dodecyl or an isomer thereof) which may be halogenated, or C₆-C₁₀ aryl which may be halogenated. Two or more of R⁴, R⁶, R⁷, R⁸, R¹⁰, R¹¹, R¹² and R¹³ adjacent to each other together form one or more rings, such as 4-8 membered ring, such as a five membered ring, such as R⁶ and R⁷ form a saturated ring having 5 ring carbon atoms.

In at least one embodiment, for catalysts represented by Formula (Ta), R¹⁹ is —SiR″₂— wherein each R″ is independently hydrogen or C₁-C₁₀ alkyl, such as C₁-C₂ alkyl (e.g., methyl or ethyl) or R¹⁹ is a C₁-C₁₀ dialkylamidoborane.

In at least one embodiment, for catalysts represented by Formula (Ta), R¹⁸ is independently hydrogen, halogen, C₃-C₁₀ alkyl which may be halogenated, C₆-C₁₀ aryl which may be halogenated.

In at least one embodiment, for catalysts represented by Formula (Ia), each R¹⁵ and R¹⁷ is independently hydrogen, C₁-C₂₀ alkyl which may be halogenated, C₆-C₁₀ aryl group which may be halogenated, C₂-C₁₀ alkenyl, C₇-C₂₀ arylalkyl, C₇-C₂₀ alkylaryl, or C₈-C₂₀ arylalkenyl. In at least one embodiment, R¹⁵ and R¹⁷ are independently hydrogen, n-butyl, sec-butyl, or tertiary butyl, aryl, isopropyl, fluoroalkyl, trialkyl silyl, or other groups of similar size, such as butyl, such as n-butyl-, iso-butyl-, and tert-butyl.

In at least one embodiment, for catalysts represented by Formula (I) or (Ia), R¹⁶ and/or R²⁵ is selected from —(XR′ₙ), wherein X is a Group 14-17 heteroatom having an atomic weight of 13 to 79 and each R′ is independently one of a hydrogen atom, halogen atom, a C₁-C₁₀ alkyl group, or a C₆-C₁₀ aryl group and n is 0, 1, 2, or 3. R¹⁶ and or R²⁵ may be —NR′₂, —SR′, —OR′, —OSiR′₃, —SiR′₃, or —PR′₂, such as R¹⁶ and or R²⁵ is —NR′₂, —SR′, —OR′, —OSiR′₃, or —PR′₂, wherein R′ is one of hydrogen, halogen, C₁-C₁₀ alkyl or C₆-C₁₀ aryl. R¹⁶ and or R²⁵ can be —NR′₂ or —PR′₂, or R¹⁶ and or R²⁵ is —OR′. In at least one embodiment, R¹⁶ and or R²⁵ is independently —NH₂, —NH(methyl), —NH(ethyl), —NH(n-propyl), —NH(iso-propyl), —NH(phenyl), —N(methyl)₂, —N(methyl)(ethyl), —N(n-propyl)(phenyl), —N(iso-propyl)(phenyl), —N(methyl)(phenyl), N(ethyl)(ethyl), —N(ethyl)(n-propyl), —N(ethyl)(iso-propyl), —N(n-propyl)(phenyl), —N(phenyl)(phenyl), —SH, —S(methyl), —S(ethyl), —S(n-propyl), —S(iso-propyl), —S(n-butyl), —S(iso-butyl), —S(sec-butyl), —S(tert-butyl), —S(phenyl), —OH, —O(methyl), —O(ethyl), —O(n-propyl), —O(iso-propyl), —O(n-butyl), —O(iso-butyl), —O(sec-butyl), —O(tert-butyl), —O(phenyl), —OSiH₃, —OSiH₂(methyl), —OSiH(methyl)₂, —OSi(methyl)₃, —OSiH₂(ethyl), —OSiH(ethyl)₂, —OSi(ethyl)₃, —OSiH₂(propyl), —OSiH(propyl)₂, —OSi(propyl)₃, —OSiH₂(butyl), —OSiH(butyl)₂, —OSi(butyl)₃, —OSiH(methyl)(ethyl), —OSi(methyl)(ethyl)₂, —OSiH(methyl)(propyl), —OSi(methyl)(propyl)₂, —OSiH(methyl)(butyl), —OSi(methyl)(butyl)₂, —OSiH(ethyl)(propyl), —OSi(ethyl)(propyl)₂, —OSiH(ethyl)(butyl), —OSi(ethyl)(butyl)₂, —PH₂, —PH(methyl), —PH(ethyl), —PH(n-propyl), —PH(iso-propyl), —PH(phenyl), —P(methyl)₂, —P(methyl)(ethyl), —P(n-propyl)(phenyl), —P(iso-propyl)(phenyl), —P(methyl)(phenyl), —P(ethyl)(ethyl), —P(ethyl)(n-propyl), —P(ethyl)(iso-propyl), —P(n-propyl)(phenyl), —P(phenyl)(phenyl), —SiH₃, —SiH₂(methyl), —SiH(methyl)₂, —Si(methyl)₃, —SiH₂(ethyl), —SiH(ethyl)₂, —OSi(ethyl)₃, —SiH₂(propyl), —SiH(propyl)₂, —Si(propyl)₃, —SiH₂(butyl), —SiH(butyl)₂, —Si(butyl)₃, —SiH(methyl)(ethyl), —Si(methyl)(ethyl)₂, —SiH(methyl)(propyl), —Si(methyl)(propyl)₂, —SiH(methyl)(butyl), —Si(methyl)(butyl)₂, —OSiH(ethyl)(propyl), —OSi(ethyl)(propyl)₂, —OSiH(ethyl)(butyl), or —OSi(ethyl)(butyl)₂.

In at least one embodiment, for catalysts represented by Formula (I) or (Ia), R¹⁵, R¹⁷, R²⁴, and R²⁶ are independently hydrogen, n-butyl, sec-butyl, tertiary butyl, aryl, isopropyl, such as tert-butyl; and at least one of R¹⁶ and R²⁵ is —OH, —O(methyl), —O(ethyl), —O(n-propyl), —O(iso-propyl), —O(n-butyl), —O(iso-butyl), —O(sec-butyl), —O(tert-butyl), —O(phenyl), such as —O(methyl). In at least one embodiment, R¹⁶ and R²⁵ may be hydrogen, —OH, —O(methyl), —O(ethyl), —O(n-propyl), —O(iso-propyl), —O(n-butyl), —O(iso-butyl), —O(sec-butyl), —O(tert-butyl), —O(phenyl), such as R²⁵ is —O(methyl).

In at least one embodiment, each R¹ and R² is independently halogen, such as C₁; R³ is a C₁-C₁₀ alkyl group, such as methyl; each of R⁴, R⁶, R⁷, R⁸, R¹⁰, R¹¹, R¹², and R¹³ is independently hydrogen or C₁-C₁₀ alkyl, such as each is hydrogen; each of R²⁴ and R²⁶ is a C₁-C₁₀ alkyl group, such as n-butyl, iso-butyl, and tert-butyl, such as tert-butyl; and wherein each R²⁵ is —OH, —O(methyl), —O(ethyl), —O(n-propyl), —O(iso-propyl), —O(n-butyl), —O(iso-butyl), —O(sec-butyl), —O(tert-butyl), —O(phenyl), such as —O(methyl).

In at least one embodiment, catalysts represented by Formula (Ia) include those wherein each R¹ and R² are chlorine; R³ is methyl; each R⁴, R⁶, R⁷, R⁸, R¹⁰, R¹¹ and R¹² are hydrogen; R¹⁹ is —Si(CH₃)₂—; R⁹ is n-hexyl; R¹⁵, R¹⁶, R¹⁷ are hydrogen, and R²⁴ and R²⁶ are both a tert-butyl group.

In at least one embodiment, catalysts represented by Formula (Ia) include those wherein each R¹ and R² are chlorine or methyl; R³ is methyl; each R⁴, R⁶, R⁷, R⁸, R¹⁰, R¹¹ and R¹² are hydrogen; R¹⁹ is —Si(CH₃)₂—; R⁹ is n-hexyl; R¹⁵, R¹⁶, and R¹⁷ are hydrogen, and R²⁴ and R²⁶ are both a tert-butyl group; R²⁵ is methoxy and R⁶ and R⁷ are hydrogen.

In at least one embodiment, catalysts represented by Formula (I) or Formula (Ia) include: dimethylsilandiyl(2-methyl-(4-(3′,5′-di-tert-butyl-4′-methoxy-phenyl)indenyl)(2-hexyl-4-(o-biphenyl)indenyl)ZrCl₂;
dimethylsilandiyl(2-ethyl-4-(3′,5′-di-tert-butyl-4′-methoxyphenyl)indenyl)(2-n-hexyl-4-(o-biphenyl)indenyl)ZrCl₂;
dimethylsilandiyl(2-propyl-4-(3′,5′-di-tert-butyl-4′-methoxyphenyl)indenyl)(2-n-hexyl-4-(o-biphenyl)indenyl)ZrCl₂;
dimethylsilandiyl(2-butyl-4-(3′,5′-di-tert-butyl-4′-methoxyphenyl)indenyl)(2-n-hexyl-4-(o-biphenyl)indenyl)ZrCl₂;
dimethylsilandiyl(2-methyl-4-(3′,5′-bistrifluoromethyl-4′-methoxyphenyl)indenyl)(2-n-hexyl-4-(o-biphenyl)indenyl)ZrCl₂;
dimethylsilandiyl(2-methyl-4-(3′,5′-bistrifluoromethyl-4′-methoxyphenyl)indenyl)(2-n-hexyl-4-(o-biphenyl)indenyl)Zr(CH₃)₂;
dimethylsilandiyl(2-ethyl-4-(3′,5′-bistrifluoromethyl-4′-methoxyphenyl)indenyl)(2-n-hexyl-4-(o-biphenyl)indenyl)ZrCl₂;
dimethylsilandiyl(2-propyl-4-(3′,5′-bistrifluoromethyl-4′-methoxyphenyl)indenyl)(2-n-hexyl-4-(o-biphenyl)indenyl)ZrCl₂;
dimethylsilandiyl(2-butyl-4-(3′,5′-bistrifluoromethyl-4′-methoxyphenyl)indenyl)(2-n-hexyl-4-(o-biphenyl)indenyl)ZrCl₂;
dimethylsilandiyl(2-methyl-4-(3′,5′-di-iso-propyl-4′-methoxyphenyl)indenyl)(2-n-hexyl-4-(o-biphenyl)indenyl)ZrCl₂;
dimethylsilandiyl(2-ethyl-4-(3′,5′-di-iso-propyl-4′-methoxyphenyl)indenyl)(2-n-hexyl-4-(o-biphenyl)indenyl)ZrCl₂;
dimethylsilandiyl(2-propyl-4-(3′,5′-di-iso-propyl-4′-methoxyphenyl)indenyl)(2-n-hexyl-4-(o-biphenyl)indenyl)ZrCl₂;
dimethylsilandiyl(2-butyl-4-(3′,5′-di-iso-propyl-4′-methoxyphenyl)indenyl)(2-n-hexyl-4-(o-biphenyl)indenyl)ZrCl₂; dimethylsilandiyl(2-methyl-4-(3′,5′-di-phenyl-4′-methoxyphenyl)indenyl)(2-n-hexyl-4-(o-biphenyl)indenyl)ZrCl₂;
dimethylsilandiyl(2-ethyl-4-(3′,5′-di-phenyl-4′-methoxyphenyl)indenyl)(2-n-hexyl-4-(o-biphenyl)indenyl)ZrCl₂; dimethylsilandiyl(2-propyl-4-(3′,5′-di-phenyl-4′-methoxyphenyl)indenyl)(2-n-hexyl-4-(o-biphenyl)indenyl)ZrCl₂; and
dimethylsilandiyl(2-butyl-4-(3′,5′-di-phenyl-4′-methoxyphenyl)indenyl)(2-n-hexyl-4-(o-biphenyl)indenyl)ZrCl₂.
In at least one embodiment, catalysts represented by Formula (I) or Formula (Ia) include: dimethylsilandiyl(2-methyl-4-(3′,5′-di-tert-butyl-4′-methoxyphenyl)indenyl)(2-n-hexyl-4-(o-biphenyl)indenyl)Zr(CH₃)₂;
dimethylsilandiyl(2-methyl-4-(3′,5′-di-tert-butyl-4′-methoxyphenyl), 1,5,6,7-tetrahydro-s-indacenyl)(2-n-hexyl-4-(o-biphenyl)indenyl)Zr(CH₃)₂;
dimethylsilandiyl(2-ethyl-4-(3′,5′-di-tert-butyl-4′-methoxyphenyl) indenyl)(2-n-hexyl-4-(o-biphenyl) indenyl)Zr(CH₃)₂;
dimethylsilandiyl(2-propyl-4-(3′,5′-di-tert-butyl-4′-methoxyphenyl)indenyl)(2-n-hexyl-4-(o-biphenyl)indenyl)Zr(CH₃)₂;
dimethylsilandiyl(2-butyl-4-(3′,5′-di-tert-butyl-4′-methoxyphenyl)indenyl)(2-n-hexyl-4-(o-biphenyl)indenyl)Zr(CH₃)₂;
dimethylsilandiyl(2-methyl-4-(3′,5′-bistrifluoromethyl-4′-methoxyphenyl)indenyl)(2-n-hexyl-4-(o-biphenyl)indenyl)Zr(CH₃)₂;
dimethylsilandiyl(2-ethyl-4-(3′,5′-bistrifluoromethyl-4′-methoxyphenyl)indenyl)(2-n-hexyl-4-(o-biphenyl)indenyl)Zr(CH₃)₂;
dimethylsilandiyl(2-propyl-4-(3′,5′-bistrifluoromethyl-4′-methoxyphenyl)indenyl)(2-n-hexyl-4-(o-biphenyl)indenyl)Zr(CH₃)₂;
dimethylsilandiyl(2-butyl-4-(3′,5′-bistrifluoromethyl-4′-methoxyphenyl)indenyl)(2-n-hexyl-4-(o-biphenyl)indenyl)Zr(CH₃)₂;
dimethylsilandiyl(2-methyl-4-(3′,5′-di-iso-propyl-4′-methoxyphenyl)indenyl)(2-n-hexyl-4-(o-biphenyl)indenyl)Zr(CH₃)₂;
dimethylsilandiyl(2-ethyl-4-(3′,5′-di-iso-propyl-4′-methoxyphenyl)indenyl)(2-n-hexyl-4-(o-biphenyl)indenyl)Zr(CH₃)₂;
dimethylsilandiyl(2-propyl-4-(3′,5′-di-iso-propyl-4′-methoxyphenyl)indenyl)(2-n-hexyl-4-(o-biphenyl)indenyl)Zr(CH₃)₂;
dimethylsilandiyl(2-butyl-4-(3′,5′-di-iso-propyl-4′-methoxyphenyl)indenyl)(2-n-hexyl-4-(o-biphenyl)indenyl)Zr(CH₃)₂;
dimethylsilandiyl(2-methyl-4-(3′,5′-di-phenyl-4′-methoxyphenyl)indenyl)(2-n-hexyl-4-(o-biphenyl)indenyl)Zr(CH₃)₂;
dimethylsilandiyl(2-ethyl-4-(3′,5′-di-phenyl-4′-methoxyphenyl)indenyl)(2-n-hexyl-4-(o-biphenyl)indenyl)Zr(CH₃)₂;
dimethylsilandiyl(2-propyl-4-(3′,5′-di-phenyl-4′-methoxyphenyl)indenyl)(2-n-hexyl-4-(o-biphenyl)indenyl)Zr(CH₃)₂;
dimethylsilandiyl(2-butyl-4-(3′,5′-di-phenyl-4′-methoxyphenyl)indenyl)(2-n-hexyl-4-(o-biphenyl)indenyl)Zr(CH₃)₂;
dimethylamidoborane(2-methyl-4-(3′,5′-di-tert-butyl-4′-methoxyphenyl)indenyl)(2-n-hexyl-4-(o-biphenyl)indenyl)Zr(CH₃)₂;
dimethylamidoborane(2-ethyl-4-(3′,5′-di-tert-butyl-4′-methoxyphenyl)indenyl)(2-n-hexyl-4-(o-biphenyl)indenyl)Zr(CH₃)₂;
dimethylamidoborane(2-propyl-4-(3′,5′-di-tert-butyl-4′-methoxyphenyl)indenyl)(2-n-hexyl-4-(o-biphenyl)indenyl)Zr(CH₃)₂;
dimethylamidoborane(2-butyl-4-(3′,5′-di-tert-butyl-4′-methoxyphenyl)indenyl)(2-n-hexyl-4-(o-biphenyl)indenyl)Zr(CH₃)₂;
dimethylamidoborane(2-methyl-4-(3′,5′-bistrifluoromethyl-4′-methoxyphenyl)indenyl)(2-n-hexyl-4-(o-biphenyl)indenyl)Zr(CH₃)₂;
dimethylamidoborane(2-ethyl-4-(3′,5′-bistrifluoromethyl-4′-methoxyphenyl)indenyl)(2-n-hexyl-4-(o-biphenyl)indenyl)Zr(CH₃)₂;
dimethylamidoborane(2-propyl-4-(3′,5′-bistrifluoromethyl-4′-methoxyphenyl)indenyl)(2-n-hexyl-4-(o-biphenyl)indenyl)Zr(CH₃)₂;
dimethylamidoborane(2-butyl-4-(3′,5′-bistrifluoromethyl-4′-methoxyphenyl)indenyl)(2-n-hexyl-4-(o-biphenyl)indenyl)Zr(CH₃)₂;
dimethylamidoborane(2-methyl-4-(3′,5′-di-iso-propyl-4′-methoxyphenyl)indenyl)(2-n-hexyl-4-(o-biphenyl)indenyl)Zr(CH₃)₂;
dimethylamidoborane(2-ethyl-4-(3′,5′-di-iso-propyl-4′-methoxyphenyl)indenyl)(2-n-hexyl-4-(o-biphenyl)indenyl)Zr(CH₃)₂;
dimethylamidoborane(2-propyl-4-(3′,5′-di-iso-propyl-4′-methoxyphenyl)indenyl)(2-n-hexyl-4-(o-biphenyl)indenyl)Zr(CH₃)₂;
dimethylamidoborane(2-tert-butyl-4-(3′,5′-di-iso-propyl-4′-methoxyphenyl)indenyl)(2-n-hexyl-4-(o-biphenyl)indenyl)Zr(CH₃)₂;
dimethylamidoborane(2-methyl-4-(3′,5′-di-phenyl-4′-methoxyphenyl)indenyl)(2-n-hexyl-4-(o-biphenyl)indenyl)Zr(CH₃)₂;
dimethylamidoborane(2-ethyl-4-(3′,5′-di-phenyl-4′-methoxyphenyl)indenyl)(2-n-hexyl-4-(o-biphenyl)indenyl)Zr(CH₃)₂;
dimethylamidoborane(2-propyl-4-(3′,5′-diphenyl-4′-methoxyphenyl)indenyl)(2-n-hexyl-4-(o-biphenyl)indenyl)Zr(CH₃)₂;
dimethylamidoborane(2-butyl-4-(3′,5′-diphenyl-4′-methoxyphenyl)indenyl)(2-n-hexyl-4-(o-biphenyl)indenyl)Zr(CH₃)₂;
di-iso-propylamidoborane(2-methyl-4-(3′,5′-di-tert-butyl-4′-methoxyphenyl)indenyl)(2-n-hexyl-4-(o-biphenyl)indenyl)Zr(CH₃)₂;
di-iso-propylamidoborane(2-ethyl-4-(3′,5′-di-tert-butyl-4′-methoxyphenyl)indenyl)(2-n-hexyl-4-(o-biphenyl)indenyl)Zr(CH₃)₂;
di-iso-propylamidoborane(2-propyl-4-(3′,5′-di-tert-butyl-4′-methoxyphenyl)indenyl)(2-n-hexyl-4-(o-biphenyl)indenyl)Zr(CH₃)₂;
di-iso-propylamidoborane(2-butyl-4-(3′,5′-di-tert-butyl-4′-methoxyphenyl)indenyl)(2-n-hexyl-4-(o-biphenyl)indenyl)Zr(CH₃)₂;
di-iso-propylamidoborane(2-methyl-4-(3′,5′-bistrifluoromethyl-4′-methoxyphenyl)indenyl)(2-n-hexyl-4-(o-biphenyl)indenyl)Zr(CH₃)₂;
di-iso-propylamidoborane(2-ethyl-4-(3′,5′-bistrifluoromethyl-4′-methoxyphenyl)indenyl)(2-n-hexyl-4-(o-biphenyl)indenyl)Zr(CH₃)₂;
di-iso-propylamidoborane(2-propyl-4-(3′,5′-bistrifluoromethyl-4′-methoxyphenyl)indenyl)(2-n-hexyl-4-(o-biphenyl)indenyl)Zr(CH₃)₂;
di-iso-propylamidoborane(2-butyl-4-(3′,5′-bistrifluoromethyl-4′-methoxyphenyl)indenyl)(2-n-hexyl-4-(o-biphenyl)indenyl)Zr(CH₃)₂;
di-iso-propylamidoborane(2-methyl-4-(3′,5′-di-iso-propyl-4′-methoxyphenyl)indenyl)(2-n-hexyl-4-(o-biphenyl) indenyl)Zr(CH₃)₂;
di-iso-propylamidoborane(2-ethyl-4-(3′,5′-di-iso-propyl-4′-methoxyphenyl)indenyl)(2-n-hexyl-4-(o-biphenyl) indenyl)Zr(CH₃)₂;
di-iso-propylamidoborane(2-propyl-4-(3′,5′-di-iso-propyl-4′-methoxyphenyl)indenyl)(2-n-hexyl-4-(o-biphenyl)indenyl)Zr(CH₃)₂;
di-iso-propylamidoborane(2-tert-butyl-4-(3′,5′-di-iso-propyl-4′-methoxyphenyl)indenyl)(2-n-hexyl-4-(o-biphenyl)indenyl)Zr(CH₃)₂;
di-iso-propylamidoborane(2-methyl-4-(3′,5′-diphenyl-4′-methoxyphenyl)indenyl)(2-n-hexyl-4-(o-biphenyl)indenyl)Zr(CH₃)₂;
di-iso-propylamidoborane(2-ethyl-4-(3′,5′-di-phenyl-4′-methoxyphenyl)indenyl)(2-n-hexyl-4-(o-biphenyl)indenyl)Zr(CH₃)₂;
di-iso-propylamidoborane(2-propyl-4-(3′,5′-diphenyl-4′-methoxyphenyl)indenyl)(2-n-hexyl-4-(o-biphenyl)indenyl)Zr(CH₃)₂;
di-iso-propylamidoborane(2-butyl-4-(3′,5′-diphenyl-4′-methoxyphenyl)indenyl)(2-n-hexyl-4-(o-biphenyl)indenyl)Zr(CH₃)₂;
bis(trimethylsilyl)amidoborane(2-methyl-4-(3′,5′-di-tert-butyl-4′-methoxyphenyl)indenyl)(2-n-hexyl-4-(o-biphenyl)indenyl)Zr(CH₃)₂;
bis(trimethylsilyl)amidoborane(2-ethyl-4-(3′,5′-di-tert-butyl-4′-methoxyphenyl)indenyl)(2-n-hexyl-4-(o-biphenyl)indenyl)Zr(CH₃)₂;
bis(trimethylsilyl)amidoborane(2-propyl-4-(3′,5′-di-t-butyl-4′-methoxyphenyl)indenyl)(2-n-hexyl-4-(o-biphenyl)indenyl)Zr(CH₃)₂;
bis(trimethylsilyl)amidoborane(2-butyl-4-(3′,5′-di-tert-butyl-4′-methoxyphenyl)indenyl)(2-n-hexane,4-(o-biphenyl)indenyl)Zr(CH₃)₂;
bis(trimethylsilyl)amidoborane(2-methyl-4-(3′,5′-bis-trifluoromethyl-4′-methoxyphenyl)indenyl)(2-n-hexane,4-(o-biphenyl)indenyl)Zr(CH₃)₂;
bis(trimethylsilyl)amidoborane(2-ethyl-4-(3′,5′-bis-trifluoromethyl-4′-methoxyphenyl)indenyl)(2-n-hexane,4-(o-biphenyl)indenyl)Zr(CH₃)₂;
bis(trimethylsilyl)amidoborane(2-propyl-4-(3′,5′-bis trifluoromethyl-4′-methoxyphenyl)indenyl)(2-n-hexane,4-(o-biphenyl)indenyl)Zr(CH₃)₂;
bis(trimethylsilyl)amidoborane(2-butyl-4-(3′,5′-bis-trifluorometllyl-4′-methoxyphenyl)indenyl)(2-n-hexane,4-(o-biphenyl)indenyl)Zr(CH₃)₂;
bis(trimethylsilyl)amidoborane(2-methyl-4-(3′,5′-di-iso-propyl-4′-methoxyphenyl)indenyl)(2-n-hexane,4-(o-biphenyl)indenyl)Zr(CH₃)₂;
bis(trimethylsilyl)amidoborane(2-ethyl-4-(3′,5′-di-iso-propyl-4′-methoxyphenyl)indenyl)(2-n-hexane,4-(o-biphenyl)indenyl)Zr(CH₃)₂;
bis(trimethylsilyl)amidoborane(2-propyl-4-(3′,5′-di-iso-propyl-4′-methoxyphenyl)indenyl)(2-n-hexane,4-(o-biphenyl)indenyl)Zr(CH₃)₂;
bis(trimethylsilyl)amidoborane(2-butyl-4-(3′,5′-di-iso-propyl-4′-methoxyphenyl)indenyl)(2-n-hexane,4-(o-biphenyl)indenyl)Zr(CH₃)₂;
bis(trimethylsilyl)amidoborane(2-methyl-4-(3′,5′-diphenyl-4′-methoxyphenyl)indenyl)(2-n-hexane,4-(o-biphenyl)indenyl)Zr(CH₃)₂;
bis(trimethylsilyl)amidoborane(2-ethyl-4-(3′,5′-diphenyl-4′-methoxyphenyl)indenyl)(2-n-hexane,4-(o-biphenyl)indenyl)Zr(CH₃)₂;
bis(trimethylsilyl)amidoborane(2-propyl-4-(3′,5′-diphenyl-4′-methoxyphenyl)indenyl)(2-n-hexane,4-(o-biphenyl)indenyl)Zr(CH₃)₂; and
bis(trimethylsilyl)amidoborane(2-butyl-4-(3′,5′-diphenyl-4′-methoxyphenyl)indenyl)(2-n-hexane,4-(o-biphenyl)indenyl)Zr(CH₃)₂.

While 4′-methoxy (i.e, O(methyl)) analogs are enumerated above, —O(ethyl), —O(n-propyl), —O(iso-propyl), —O(n-butyl), —O(iso-butyl), —O(sec-butyl), —O(tert-butyl), —O(phenyl), etc.; —OSiH₃, —OSiH₂(methyl), —OSiH(methyl)₂, —OSi(methyl)₃, —OSiH₂(ethyl), —OSiH(ethyl)₂, —OSi(ethyl)₃, —OSiH₂(propyl), —OSiH(propyl)₂, —OSi(propyl)₃, —OSiH₂(butyl), —OSiH(butyl)₂, —OSi(butyl)₃, —OSiH(methyl)(ethyl), —OSi(methyl)(ethyl)₂, —OSiH(methyl)(propyl), —OSi(methyl)(propyl)₂, —OSiH(methyl)(butyl), —OSi(methyl)(butyl)₂, —OSiH(ethyl)(propyl), —OSi(ethyl)(propyl)₂, —OSiH(ethyl)(butyl), —OSi(ethyl)(butyl)₂ analogs are also expressly disclosed. Likewise, while the Zirconium dichloro-substituted and dimethyl-substituted compounds (—ZrCl₂ and —Zr(CH₃)₂) are enumerated above, the compounds where zirconium is replaced by hafnium (e.g., —Hf(CH₃)₂) and —Hf(C₁)₂) are also expressly disclosed.

As used herein, o-biphenyl is an ortho-biphenyl moiety represented by the structure:

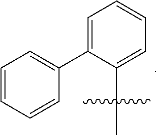 [SMILES: *c1ccccc1-c1ccccc1]

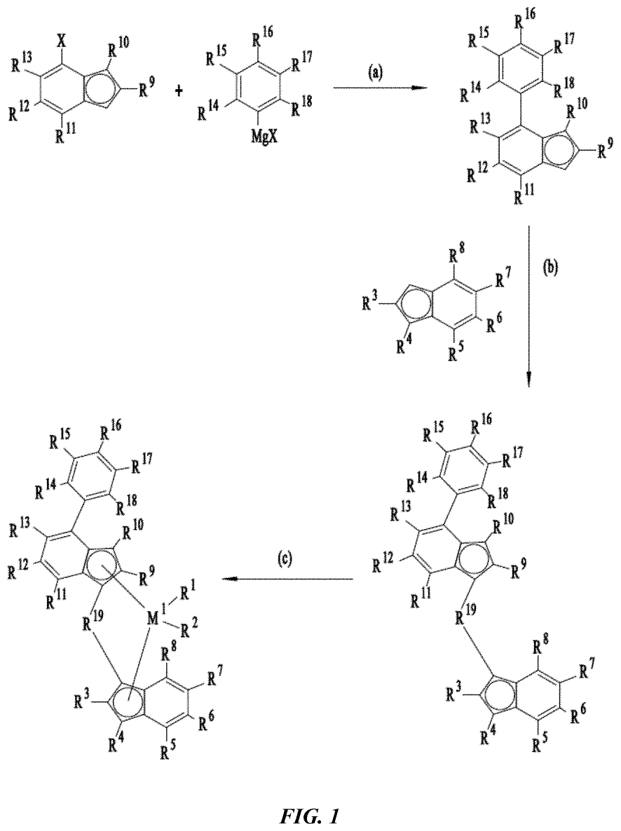

Generally, bis-Cp catalyst compounds of the present disclosure may be synthesized according to the schematic reaction procedure described in FIG. 1 where (i) is a deprotonation via a metal salt of alkyl anion (e.g., n-BuLi) to form an indenide; (ii) is reaction of indenide with an appropriate bridging precursor (e.g., Me₂SiCl₂); (iii) is reaction of the above product with AgOTf; (iv) is reaction of the above triflate compound with another equivalent of indenide; (v) is deprotonation via an alkyl anion (e.g., n-BuLi) to form a dianion; (vi) is reaction of the dianion with a metal halide (e.g., ZrCl₄). The final products are obtained by recrystallization of the crude solids.

### Catalyst II, the Second Catalyst Compound

Catalyst systems of the present disclosure can include a Catalyst II precursor compound capable of producing plastomers (such a semi-crystalline materials, Tm less than 100° C., such as less than 75° C., or greater than 20° C. to 50° C.) and/or elastomers (low crystallinity or amorphous materials, having no detectable Tm (DSC), or Tm less than 20° C.), such as C₂-C₂₀ copolymers such as ethylene-propylene copolymers, ethylene-butene copolymers, ethylene-hexene copolymers, and the like. Metallocene compounds can be used to prepare the plastomers (semi crystalline materials) and/or elastomers (low crystallinity or amorphous materials) described herein. Amorphous materials preferably have an Hf of 10 J/g or less, preferably 5 J/g or less, preferably 0 J/g or less before any vulcanization. Preferred amorphous materials have an Hf of 10 J/g or less, preferably 5 J/g or less, preferably 0 J/g or less, no detectable Tm, and no detectable Tc, as determined by differential scanning calorimetry before any vulcanization.

Catalyst systems of the present disclosure can include a Catalyst II precursor compound capable of producing vulcanizable plastomers (such a semi-crystalline materials, Tm less than 100° C., such as less than 75° C., or greater than 20° C. to 50° C.) and/or elastomers (low crystallinity or amorphous materials, having no detectable Tm (DSC), or Tm less than 20° C.), such as C₂-C₂₀ copolymers such as ethylene-propylene copolymers, ethylene-butene copolymers, ethylene-hexene copolymers, and the like with diene comonomer. Metallocene compounds can be used to prepare the vulcanizable plastomers (semi crystalline materials) and/or elastomers (low crystallinity or amorphous materials) described herein. Amorphous materials preferably have an Hf of 10 J/g or less, preferably 5 J/g or less, preferably 0 J/g or less before vulcanization. Preferred amorphous materials have an Hf of 10 J/g or less, preferably 5 J/g or less, preferably 0 J/g or less, no detectable Tm, and no detectable Tc, as determined by differential scanning calorimetry before vulcanization.

In a preferred embodiment of the invention, Catalsyt II produces a plastomer having a Tm less than 100° C. (such as 0° to 80° C., alternately 20° C. to 70° C.), and Catalsyt I produces a tactic polymer having a Tm of 100° C. or more (such as 120° C. to 168° C., alternately 130° C. to 160° C.) in a first stage and Catalsyt II produces an elastomer (having no detectable melting point) in a second stage.

### I. Catalsyt II: Metallocene Compounds

In useful embodiments of the invention metallocene catalyst compound may be used as the second catalyst to produce the plastomers and/or elastomers described herein.

In useful embodiments of the invention metallocene catalyst compound may be used as the second catalyst to produce the vulcanizable plastomers and/or elastomers described herein.

In useful embodiments of the invention a metallocene catalyst compound capable of diene incorporation may be used as the second catalyst to produce the vulcanizable plastomers and/or elastomers described herein.

Second catalyst compounds (Catalyst II) useful herein are compounds different from compounds used to make the polymer having a melting point over 100° C. (Catalyst I) and are typically compounds represented by the Formula (B):

T_{y}CpₘM⁶GₙX⁵_{q} (B)

wherein,

each Cp is, independently, a cyclopentadienyl group (such as cyclopentadiene, indene or fluorene) which may be substituted or unsubstituted, preferably at least one Cp is an indene or fluorene group;

M⁶ is a Group 4 transition metal, for example, titanium, zirconium, hafnium;

G is a heteroatom group represented by the formula JR*z where J is N, P, O or S, and R* is a C₁ to C₂₀ hydrocarbyl group and z is 1 or 2;

T is a bridging group;

y is 0 or 1;

X⁵ is a leaving group (such as a halide, a hydride, an alkyl group, an alkenyl group or an arylalkyl group);

m is 1 or 2;

n is 0, 1, 2 or 3;

q is 0, 1, 2, or 3; and

the sum of m+n+q is equal to the oxidation state of the transition metal, preferably 4. See, for example, WO 2016/094843.

In a preferred embodiment of the invention in Formula (A) and or (B), each Cp is, independently, an indenyl group which may be substituted or unsubstituted, preferably each Cp is independently substituted with a C₁ to C₄₀ hydrocarbyl group or an unsubstituted C₁ to C₄₀ hydrocarbyl group, preferably Cp is an indenyl group substituted with a C₁ to C₂₀ substituted or unsubstituted hydrocarbyl, preferably a substituted C₁ to C₁₂ hydrocarbyl group or an unsubstituted C₁ to C₁₂ hydrocarbyl group, preferably methyl, ethyl, propyl, butyl, pentyl, hexyl, or an isomer thereof.

In a preferred embodiment of the invention in Formula (A) and or (B), T is present (e.g., y=1) and is a bridging group containing at least one Group 13, 14, 15, or 16 element, in particular boron or a Group 14, 15 or 16 element. Examples of suitable bridging groups include P(═S)R′, P(═Se)R′, P(═O)R′, R′₂C, R′₂Si, R′₂Ge, R′₂CCR′₂, R′₂CCR′₂CR′₂, R′₂CCR′₂CR′₂CR′₂, R′C═CR′, R′C═CR′CR′₂, R′₂CCR′═CR′CR′₂, R′C═CR′CR′═CR′, R′C═CR′CR′₂CR′₂, R′₂CSiR′₂, R′₂SiSiR′₂, R′₂SiOSiR′₂, R′₂CSiR′₂CR′₂, R′₂SiCR′₂SiR′₂, R′C═CR′SiR′₂, R′₂CGeR′₂, R′₂GeGeR′₂, R′₂CGeR′₂CR′₂, R′₂GeCR′₂GeR′₂, R′₂SiGeR′₂, R′C═CR′GeR′₂, R′B, R′₂C—BR′, R′₂C—BR′—CR′₂, R′₂C—O—CR′₂, R′₂CR′₂C—O—CR′₂CR′₂, R′₂C—O—CR′₂CR′₂, R′₂C—O—CR′═CR′, R′₂C—S—CR′₂, R′₂CR′₂C—S—CR′₂CR′₂, R′₂C—S—CR′₂CR′₂, R′₂C—S—CR′═CR′, R′₂C—Se—CR′₂, R′₂CR′₂C—Se—CR′₂CR′₂, R′₂C—Se—CR′₂CR′₂, R′₂C—Se—CR′═CR′, R′₂C—N═CR′, R′₂C—NR′—CR′₂, R′₂C—NR′—CR′₂CR′₂, R′₂C—NR′—CR′═CR′, R′₂CR′₂C—NR′—CR′₂CR′₂, R′₂C—P═CR′, R′₂C—PR′—CR′₂, O, S, Se, Te, NR′, PR′, AsR′, SbR′, O—O, S—S, R′N—NR′, R′P—PR′, O—S, O—NR′, O—PR′, S—NR′, S—PR′, and R′N—PR′ where R′ is hydrogen or a C₁-C₂₀ containing hydrocarbyl, substituted hydrocarbyl, halocarbyl, substituted halocarbyl, silylcarbyl or germylcarbyl substituent and optionally two or more adjacent R′ may join to form a substituted or unsubstituted, saturated, partially unsaturated or aromatic, cyclic or polycyclic substituent. Preferred examples for the bridging group T include CH₂, CH₂CH₂, SiMe₂, SiPh₂, SiMePh, Si(CH₂)₃, Si(CH₂)₄, O, S, NPh, PPh, NMe, PMe, NEt, NPr, NBu, PEt, PPr, Me₂SiOSiMe₂, and PBu.

In a preferred embodiment of the invention in Formula (A) and or (B), T is represented by the formula R^{a}₂J or (R^{a}₂J)₂, where J is C, Si, or Ge, and each R^{a} is, independently, hydrogen, halogen, C₁ to C₂₀ hydrocarbyl (such as methyl, ethyl, propyl, butyl, pentyl, hexyl, heptyl, octyl, nonyl, decyl, undecyl, or dodecyl) or a C₁ to C₂₀ substituted hydrocarbyl, and two R^{a} can form a cyclic structure including aromatic, partially saturated, or saturated cyclic or fused ring system. In a preferred embodiment of the invention in Formula (A) and or (B), T is a bridging group comprising carbon or silica, such as dialkylsilyl, preferably T is selected from CH₂, CH₂CH₂, C(CH₃)₂, SiMe₂, SiPh₂, SiMePh, silylcyclobutyl (Si(CH₂)₃), (Ph)₂C, (p-(Et)₃SiPh)₂C, Me₂SiOSiMe₂, and cyclopentasilylene (Si(CH₂)₄).

In a preferred embodiment of the invention, M⁶ is Zr.

In a preferred embodiment of the invention, G is an alkyl amido group, preferably t-butyl amido or do-decyl amido.

In a preferred embodiment of the invention, each X⁵ is, independently, selected from the group consisting of hydrocarbyl radicals having from 1 to 20 carbon atoms, aryls, hydrides, amides, alkoxides, sulfides, phosphides, halides, dienes, amines, phosphines, ethers, and a combination thereof (two X⁵'s may form a part of a fused ring or a ring system), preferably each X⁵ is independently selected from halides, aryls and C₁ to C₅ alkyl groups, preferably each X⁵ is a phenyl, methyl, ethyl, propyl, butyl, pentyl, bromo, or chloro group. Preferably, each X⁵ is, independently, a halide, a hydride, an alkyl group, an alkenyl group or an arylalkyl group.

In an embodiment, each Cp is independently an indene, which may be substituted or unsubstituted, each M⁶ is zirconium, and each X⁵ is, independently, a halide, a hydride, an alkyl group, an alkenyl group or an arylalkyl group. In any of the embodiments described herein, y may be 1, m may be one, n may be 1, J may be N, and R* may be methyl, ethyl, propyl, butyl, pentyl, hexyl, heptyl, octyl, nonyl, cyclooctyl, cyclododecyl, decyl, undecyl, dodecyl, adamantyl or an isomer thereof.

In yet another embodiment, Catalyst II may comprise one or more of bis(tetrahydroindenyl)Hf Me₂; (dimethylsilyl)₂O bis(indenyl)ZrCl₂; dimethylsilylbis(tetrahydroindenyl)ZrCl₂; dimethylsilyl-(3-phenyl-indenyl)(tetramethylcyclopentadienyl)ZrCl₂; tetramethyldisilylene bis(4-(3,5-di-tert-butylphenyl)-indenyl)ZrCl₂; bis(indenyl)zirconium dichloride; bis(indenyl)zirconium dimethyl; bis(tetrahydro-1-indenyl)zirconium dichloride; bis(tetrahydro-1-indenyl)zirconium dimethyl; dimethylsilylbis(tetrahydroindenyl)zirconium dichloride; dimethylsilylbis(tetrahydroindenyl)zirconium dimethyl; dimethylsilylbis(indenyl)zirconium dichloride; or dimethylsilyl(bisindenyl)zirconium dimethyl.

In another class of embodiments, the second catalyst (Catalyst II) may comprise bis(indenyl)zirconium dichloride, bis(indenyl)zirconium dimethyl, bis(tetrahydro-1-indenyl)zirconium dichloride, bis(tetrahydro-1-indenyl)zirconium dimethyl, rac/meso-bis(1-ethylindenyl)zirconium dichloride, rac/meso-bis(1-ethylindenyl)zirconium dimethyl, rac/meso-bis(1-methylindenyl)zirconium dichloride, rac/meso-bis(1-methylindenyl)zirconium dimethyl, rac/meso-bis(1-propylindenyl)zirconium dichloride, rac/meso-bis(1-propylindenyl)zirconium dimethyl, rac/meso-bis(1-butylindenyl)zirconium dichloride, rac/meso-bis(1-butylindenyl)zirconium dimethyl, meso-bis(lethylindenyl) zirconium dichloride, meso-bis(1-ethylindenyl) zirconium dimethyl, (1-methylindenyl)(pentamethyl cyclopentadienyl) zirconium dichloride, (1-methylindenyl)(pentamethyl cyclopentadienyl) zirconium dimethyl, or combinations thereof.

In yet another class of embodiments, the second catalyst (Catalyst II) may comprise rac/meso-bis(1-ethylindenyl)zirconium dichloride, rac/meso-bis(1-ethylindenyl)zirconium dimethyl, rac/meso-bis(1-methylindenyl)zirconium dichloride, rac/meso-bis(1-methylindenyl)zirconium dimethyl, rac/meso-bis(1-propylindenyl)zirconium dichloride, rac/meso-bis(1-propylindenyl)zirconium dimethyl, rac/meso-bis(1-butylindenyl)zirconium dichloride, rac/meso-bis(1-butylindenyl)zirconium dimethyl, meso-bis(1-ethylindenyl) zirconium dichloride, meso-bis(lethylindenyl) zirconium dimethyl, (1-methylindenyl)(pentamethyl cyclopentadienyl) zirconium dichloride, (1-methylindenyl)(pentamethyl cyclopentadienyl) zirconium dimethyl, or combinations thereof.

In embodiments of the invention the metallocene Catalyst II compound can be: a IA) Mono-Cp Catalyst II Compound, a IB) bis-Cp Catalyst II Compound, or combinations thereof.

### Catalyst I—A) Mono-Cp Compounds:

Mono-Cp catalyst precursor compounds (also referred to as constrained geometry catalyst compounds, CGC) useful in the present disclosure have one cyclopentadienyl (Cp) ligand (which includes ligands that are isolobal to cyclopentadienyl). Mono-Cp catalyst precursor compounds of the present disclosure can provide aPP in a stage 1 polymerization (with optional Catalyst I producing crystalline polymer (such as iPP) in stage I as well) and an “ethylene-propylene-diene terpolymer” (EPDM) is a stage 2 polymerization.

In at least one embodiment, the mono-Cp Catalyst II compound of the present disclosure is represented by Formula (II):

T_{y}CpₘMGₙX_{q} (II)

where Cp is independently a substituted or unsubstituted cyclopentadienyl ligand or substituted or unsubstituted ligand isolobal to cyclopentadienyl such as indenyl, fluorenyl, tetrahydro-s-indacenyl and tetrahydro-as-indecenyl. M is a group 4 transition metal, such as Hf, Ti, or Zr. G is a heteroatom group represented by the formula JR*z where J is N, P, O or S, and R* is a linear, branched, or cyclic C₁-C₂₀ hydrocarbyl. z is 1 or 2. T is a bridging group. y is 0 or 1. X is a leaving group. m=1, n=1, 2 or 3, q=0, 1, 2 or 3, and the sum of m+n+q is equal to the oxidation state of the transition metal, such as 2, 3 or 4, such as 4.

In at least one embodiment, J is N, and R* is methyl, ethyl, propyl, butyl, pentyl, hexyl, heptyl, octyl, nonyl, cyclooctyl, cyclododecyl, decyl, undecyl, dodecyl, adamantyl or an isomer thereof. Exemplary JR*z groups include t-butyl amido and cyclododecylamido.

Examples of the bridging group T include CH₂, CH₂CH₂, SiMe₂, SiPh₂, SiMePh, Si(CH₂)₃, Si(CH₂)₄, O, S, NPh, PPh, NMe, PMe, NEt, NPr, NBu, PEt, PPr, Me₂SiOSiMe₂, and PBu. In at least one embodiment, T is represented by the formula ERd₂ or (ERd₂)₂, where E is C, Si, or Ge, and each R^{d} is, independently, hydrogen, halogen, C₁ to C₂₀ hydrocarbyl (such as methyl, ethyl, propyl, butyl, pentyl, hexyl, heptyl, octyl, nonyl, decyl, undecyl, or dodecyl) or a C₁ to C₂₀ substituted hydrocarbyl, or two R^{d} can form a cyclic structure including aromatic, partially saturated, or saturated cyclic or fused ring system.

Each X is independently selected from the group consisting of hydrocarbyl radicals having from 1 to 20 carbon atoms, aryls, hydrides, amides, alkoxides, sulfides, phosphides, halides, dienes, amines, phosphines, ethers, and a combination thereof, (two Xs may form a part of a fused ring or a ring system), such as each X is independently selected from halides, aryls and C₁ to C₅ alkyl groups, such as each X is a phenyl, methyl, ethyl, propyl, butyl, pentyl, or chloro group. Alternately each X is Br, Cl, I, F, methyl, ethyl, propyl, butyl, pentyl, hexyl, cyclopentyl, cyclohexyl, benzyl, phenyl, methylphenyl, or tert-butylphenyl.

In at least one embodiment, the mono-Cp catalyst precursor compound of Formula (II) is selected from:
dimethylsilandiyl (2,3,4,5-tetramethylcyclopentadienyl)(cyclododecylamido)M(R)₂;
dimethylsilandiyl (2,3,4,5-tetramethylcyclopentadienyl)(cycloundecylamido)M(R)₂;
dimethylsilandiyl (2,3,4,5-tetramethylcyclopentadienyl)(cyclodecylamido)M(R)₂;
dimethylsilandiyl (2,3,4,5-tetramethylcyclopentadienyl)(t-butylamido)M(R)₂;

where M is selected from Ti, Zr, and Hf; and each R is selected from halogen or C₁ to C₅ alkyl (such as chloro, bromo, methyl, ethyl, propyl, butyl, pentyl or isomers thereof). In at least one embodiment, M is Ti and each R is methyl.

Mono-Cp catalyst precursor compounds of the present disclosure may be synthesized as described in U.S. Pat. Nos. 5,621,126 and 5,547,675 which are incorporated herein by reference.

Catalyst II compounds capable of making the propylene-α-olefin polymers can also include metallocene compounds (pre-catalysts) having the structure represented by formula (2) preferably having Cₛ or pseudo-Cₛ symmetry:

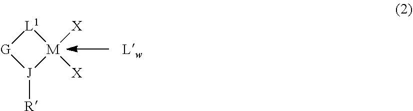

wherein:

M is zirconium;

L¹ is a unsubstituted fluorenyl, heterocyclopentapentalenyl, or heterofluorenyl, or a substituted fluorenyl, heterocyclopentapentalenyl, or heterofluorenyl ligand with one or more symmetric or pseudo symmetric substituents, each substituent group being, independently, a radical group which is a hydrocarbyl, substituted hydrocarbyl, halocarbyl, substituted halocarbyl, silylcarbyl or germylcarbyl, and optionally two or more adjacent substituents may join to form a substituted or unsubstituted, saturated, partially unsaturated or aromatic, cyclic or polycyclic substituent;

G is a bridging group (and may be as defined for bridging group T above, such as for T in Formula (B));

J is a heteroatom from group 15, such as N or P, such as N;

R′ is a radical group which is a hydrocarbyl, substituted hydrocarbyl, halocarbyl, or substituted halocarbyl;

L′ is a neutral Lewis base and w represents the number of L′ bonded to M where w is 0, 1, or 2, and optionally any L′ and any X may be bonded to one another;

X are independently, hydride radicals, hydrocarbyl radicals, substituted hydrocarbyl radicals, halocarbyl radicals, substituted halocarbyl radicals, silylcarbyl radicals, substituted silylcarbyl radicals, germylcarbyl radicals, or substituted germylcarbyl radicals; or both X are joined and bound to the metal atom to form a metallacycle ring containing from about 3 to about 20 carbon atoms; or both together can be an olefin, diolefin or aryne ligand; both X may, independently, be a halogen, alkoxide, aryloxide, amide, phosphide or other univalent anionic ligand or both X can also be joined to form a anionic chelating ligand.

In Formula (2), L¹ is fluorenyl or substituted fluorenyl, such as fluorenyl, 2,7-dimethylfluorenyl, 2,7-diethylfluorenyl, 2,7-dipropylfluorenyl, 2,7-dibutylfluorenyl, 2,7-diphenylfluorenyl, 2,7-dichlorofluorenyl, 2,7-dibromofluorenyl, 3,6-dimethylfluorenyl, 3,6-diethylfluorenyl, 3,6-dipropylfluorenyl, 3,6-dibutylfluorenyl, 3,6-diphenylfluorenyl, 3,6-dichlorofluorenyl, 3,6-dibromofluorenyl or 1,1,4,4,7,7,10,10-octamethyl-octahydrodibenzofluorenyl, such as fluorenyl, 2,7-dimethylfluorenyl, 2,7-diethylfluorenyl, 2,7-dipropylfluorenyl, 2,7-dibutylfluorenyl, 3,6-dimethylfluorenyl, 3,6-diethylfluorenyl, 3,6-dipropylfluorenyl, 3,6-dibutylfluorenyl, or 1,1,4,4,7,7,10,10-octamethyl-octahydrodibenzofluorenyl, such as 2,7-di-tert-butylfluorenyl, 3,6-di-tert-butylfluorenyl, 1,1,4,4,7,7,10,10-octamethyl-octahydrodibenzofluorenyl, or fluorenyl. G is methylene, dimethylmethylene, diphenylmethylene, dimethylsilylene, methylphenylsilylene, diphenylsilylene, di(4-triethylsilylphenyl)silylene, ethylene, such as diphenylmethylene, diphenylsilylene, methylphenylsilylene, and dimethylsilylene; such as dimethylsilylene. Suitable J can be nitrogen. R′ is hydrocarbyl or halocarbyl, such as C₃-C₂₀ hydrocarbyl, such as all isomers (including cyclics and polycyclics) of propyl, butyl, pentyl, hexyl, heptyl, octyl, nonyl, decyl, undecyl, dodecyl, benzyl, phenyl and substituted phenyl, such as tert-butyl, neopentyl, benzyl, phenyl, diisopropylphenyl, adamantyl, norbornyl, cyclohexyl, cyclooctyl, cyclodecyl, and cyclododecyl, such as tert-butyl, adamant-1-yl, norborn-2-yl, cyclohexyl, cyclooctyl, and cyclododecyl. X is hydrocarbyl or halo, such as methyl, benzyl, floro or chloro, such as methyl or chloro; w is zero (L′ being absent); M is zirconium.

Unlimited examples of Mono-Cp catalyst compounds capable of diene incorporation to serve as Catalyst II include:

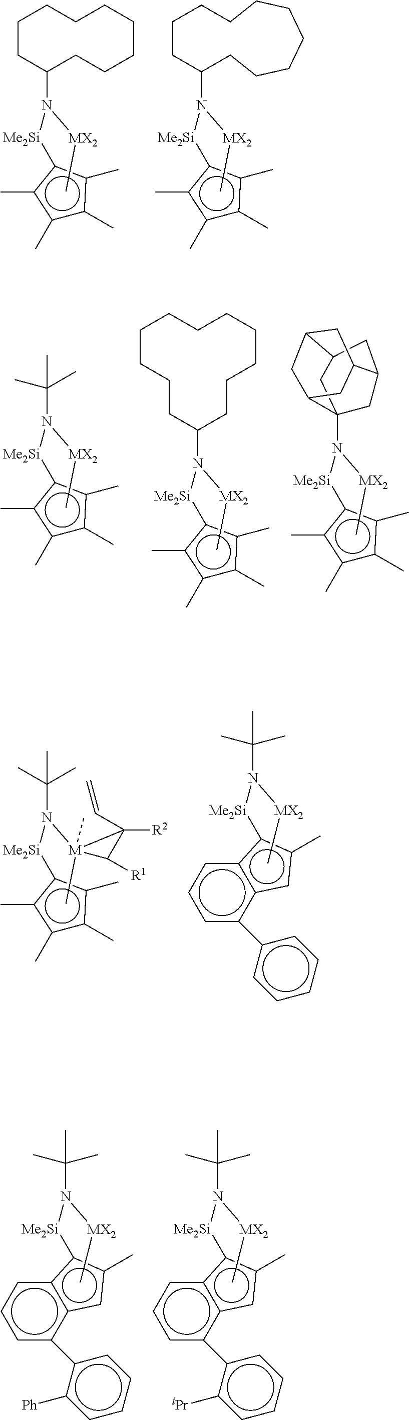

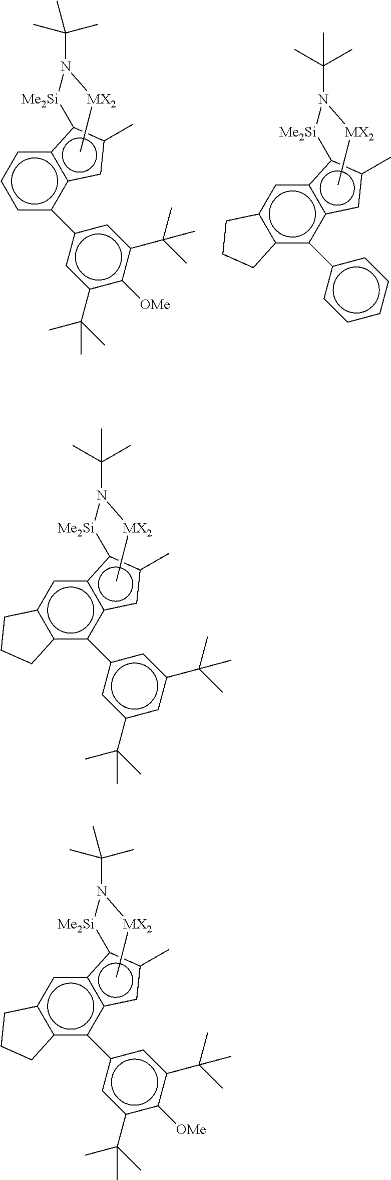

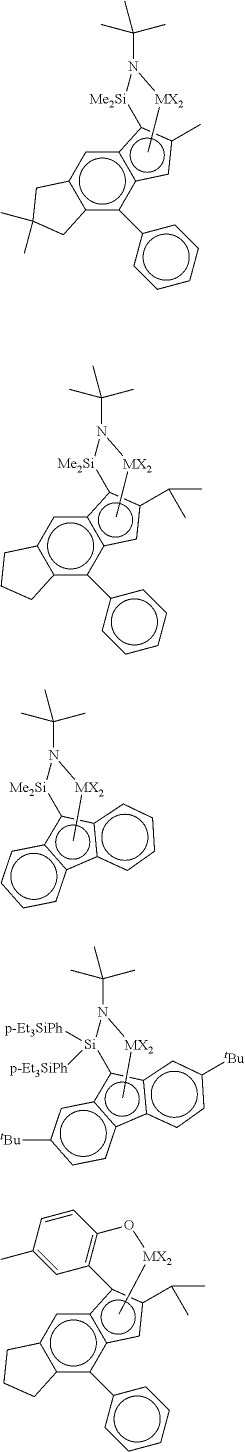

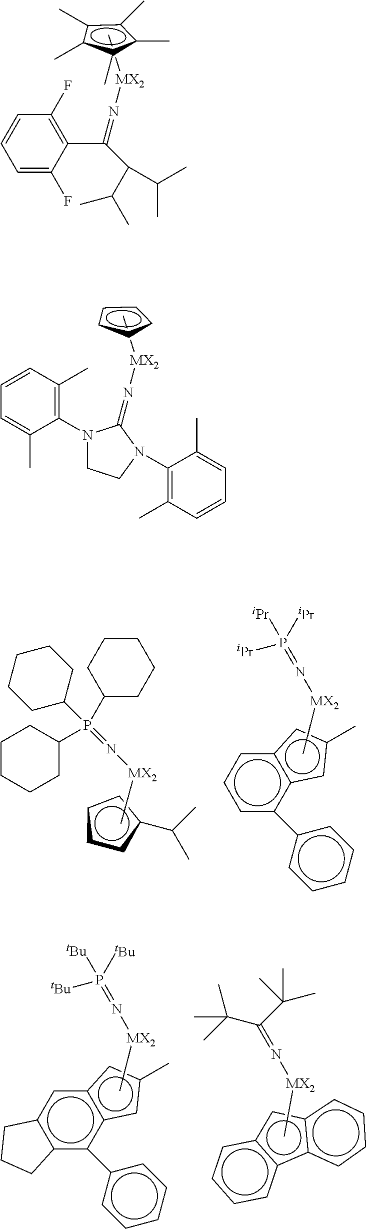

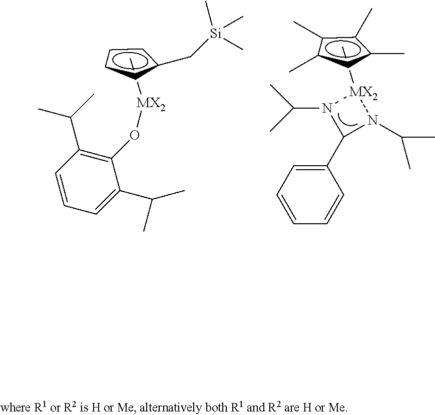

where M is Ti, Hf or Zr, preferably Ti, and each X is independently halogen or C₁ to C₂₀ hydrocarbyl (alternately each X is, independently, is Br, Cl, I, F, methyl, ethyl, propyl, butyl, pentyl, hexyl, cyclopentyl, cyclohexyl, benzyl, phenyl, methylphenyl, or tert-butylphenyl).

### Catalys II-B) Bis-Cp Compounds:

Catalyst II-B)-1, BIS CP Catalyst II Compounds with Cs or Pseudo-Cs Symmetry

Bis-Cp Catalyst II compounds having Cₛ symmetry are also useful to make plastomers and elastomers herein. Symmetry of metallocene compounds is described in Chemical Applications of Group Theory (2nd Edition) by F. Albert Cotton, Wiley-Interscience, 1971. Compounds with Cₛ symmetry possess a mirror plane and are useful herein. For example, the structure below has a Cₛ symmetric plane that bisects the zirconium center, the carbon bridge and the cyclopentadienyl and fluorenyl ligands. Cp-Flu compounds represented by the Formula (X) below are useful to make the plastomer and elastomer materials for use in this invention.

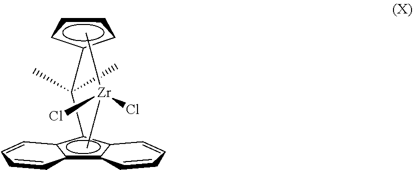

Substituted versions of the Cp-Flu catalyst compounds represented by the Formula (X) that retain the Cₛ symmetry are also useful herein. For example, alkyl groups, such as t-butyl groups, substituted in the 2 and 7 positions of a fluorenyl ligand would be symmetric substituents.

Compounds with pseudo-Cₛ symmetry (where the bridging group, the labile ligands, and distant substituents of similar size on the cyclopentadienyl ligand or fluorenyl ligand are not included in determining the symmetry of the compound) are also useful in making plastomer or elastomer copolymers. Non-limiting examples of pseudo Cₛ symmetric compounds are illustrated below:

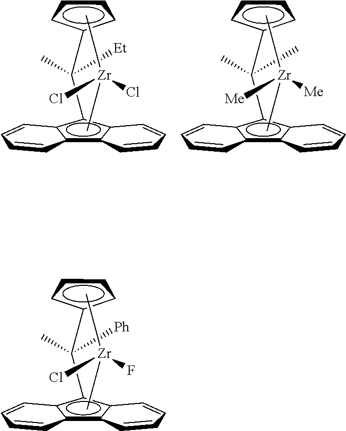

Substituted versions of the three catalyst compounds represented above that retain the pseudo Cₛ symmetry are also useful herein.

Compounds with pseudo-Cₛ symmetry can also have unlike substituents on the non-labile ligands (i.e., cyclopentadienyl or fluorenyl ligands) if the substituents are distant from the active site. Substituents of this type, referred to as pseudo symmetric substituents, are typically adjacent to the bridging group and do not substantially differ in size from one another. Typically the size difference of these substituents is within 2 non-hydrogen atoms of each other. Thus, a cyclopentadienyl substituted at the 2 and the 5 positions with methyl and ethyl, respectively, or a cyclopentadienyl substituted at the 2 position with methyl and not substituted in the 5 position, or a fluorenyl substituted at the 1 and the 8 positions with hexyl and octyl, respectively, would be considered to have pseudo-Cₛ symmetry. Such compounds are useful herein.

In general, those catalysts both capable of producing propylene polymers and capable of reacting with hydrogen to terminate the growing polymer chain, are catalysts that are useful for producing the propylene-α-olefin copolymers (plastomers or elastomers) herein.

Catalysts useful for making the propylene-α-olefin copolymers (plastomers or elastomers) include metallocene compounds (pre-catalysts) having the structure represented by Formula (1), preferably having Cₛ or pseudo-Cₛ symmetry:

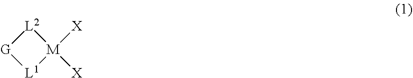

wherein:

M is zirconium;

L¹ is a unsubstituted fluorenyl, heterocyclopentalenyl, or heterofluorenyl, or a substituted fluorenyl, heterocyclopentapentalenyl, or heterofluorenyl ligand with one or more symmetric or pseudo symmetric substituents, each substituent group being, independently, a radical group which is a hydrocarbyl, substituted hydrocarbyl, halocarbyl, substituted halocarbyl, silylcarbyl or germylcarbyl, and optionally two or more adjacent substituents may join to form a substituted or unsubstituted, saturated, partially unsaturated or aromatic, cyclic or polycyclic substituent;

L² is a cyclopentadienyl ring or a substituted cyclopentadienyl ring with one or more symmetric or pseudo symmetric substituents in the 2 and 5 positions of the ring, each substituent group being, independently, a radical group which is a hydrocarbyl, substituted hydrocarbyl, halocarbyl, substituted halocarbyl, silylcarbyl or germylcarbyl;

G is a bridging group (and may be as defined for bridging group T above, such as for T in Formula (B));

X are independently, hydride radicals, hydrocarbyl radicals, substituted hydrocarbyl radicals, halocarbyl radicals, substituted halocarbyl radicals, silylcarbyl radicals, substituted silylcarbyl radicals, germylcarbyl radicals, or substituted germylcarbyl radicals; or both X are joined and bound to the metal atom to form a metallacycle ring containing from about 3 to about 20 carbon atoms; or both together can be an olefin, diolefin or aryne ligand; both X may, independently, be a halogen, alkoxide, aryloxide, amide, phosphide or other univalent anionic ligand or both X can also be joined to form a anionic chelating ligand.

In at least one embodiment of Formula (1), L¹ is fluorenyl or substituted fluorenyl; such as fluorenyl, 2,7-dimethylfluorenyl, 2,7-diethylfluorenyl, 2,7-dipropylfluorenyl, 2,7-dibutylfluorenyl, 2,7-diphenylfluorenyl, 2,7-dichlorofluorenyl, 2,7-dibromofluorenyl, 3,6-dimethylfluorenyl, 3,6-diethylfluorenyl, 3,6-dipropylfluorenyl, 3,6-dibutylfluorenyl, 3,6-diphenylfluorenyl, 3,6-dichlorofluorenyl, 3,6-dibromofluorenyl, 2-7-di-tertbutyl fluorenyl, or 1,1,4,4,7,7,10,10-octamethyl-octahydrodibenzofluorenyl; such as fluorenyl, 2,7-dimethylfluorenyl, 2,7-diethylfluorenyl, 2,7-dipropylfluorenyl, 2,7-dibutylfluorenyl, 3,6-dimethylfluorenyl, 3,6-diethylfluorenyl, 3,6-dipropylfluorenyl, 3,6-dibutylfluorenyl, 2-7-di-tertbutylfluorenyl, or 1,1,4,4,7,7,10,10-octamethyl-octahydrodibenzofluorenyl; such as 2,7-di-tert-butylfluorenyl or fluorenyl; suitable L² can be cyclopentadienyl; suitable G can be methylene, dimethylmethylene, diphenylmethylene, dimethylsilylene, diphenylsilylene, di(4-triethylsilylphenyl)silylene, ethylene, or di(para-triethylsilylphenyl)methylene; such as diphenylmethylene, diphenylsilylene, dimethylsilylene, ethylene, or di(para-triethylsilylphenyl)methylene; such as diphenylmethylene or di(para-triethylsilylphenyl)methylene; suitable X can be hydrocarbyl or halo, such as methyl, benzyl, fluoro or chloro, such as methyl or chloro; M is zirconium.

A subset of the metallocene compounds represented by Formula (1) having Cₛ or pseudo-Cₛ symmetry that may be used herein are represented by Formula (Ia):

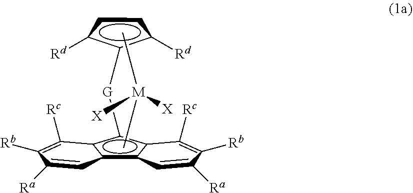

wherein

M is zirconium;

G is a bridging group (and may be as defined for bridging group T above, such as for T in Formula (B));

X are independently, hydride radicals, hydrocarbyl radicals, substituted hydrocarbyl radicals, halocarbyl radicals, substituted halocarbyl radicals, silylcarbyl radicals, substituted silylcarbyl radicals, germylcarbyl radicals, or substituted germylcarbyl radicals; or both X are joined and bound to the metal atom to form a metallacycle ring containing from about 3 to about 20 carbon atoms; or both together can be an olefin, diolefin or aryne ligand; both X may, independently, be a halogen, alkoxide, aryloxide, amide, phosphide or other univalent anionic ligand or both X can also be joined to form a anionic chelating ligand;

each R^{a} and R^{b} are selected from hydrogen, halogen, hydrocarbyl, substituted hydrocarbyl, halocarbyl, substituted halocarbyl, silylcarbyl, germylcarbyl or polar radicals, and optionally two or more adjacent substituents may join to form a substituted or unsubstituted, saturated, partially unsaturated or aromatic, cyclic or polycyclic substituent, preferably each R^{a} is the same and each R^{b} is the same and the compound is Cₛ-symmetric or pseudo Cₛ-symmetric;

each R^{c} is selected from hydrogen or a hydrocarbyl, substituted hydrocarbyl, halocarbyl, substituted halocarbyl, silylcarbyl or germylcarbyl radicals, preferably R^{c} is a symmetric or pseudo symmetric substituent with respect to the other R^{c};

each R^{d} is selected from hydrogen or a hydrocarbyl, substituted hydrocarbyl, halocarbyl, substituted halocarbyl, silylcarbyl or germylcarbyl radicals, preferably R^{d} is a symmetric or pseudo symmetric substituent with respect to the other R^{d}.

In at least one embodiment of Formula (1a), each R^{d}, R^{a} and R^{c} can be hydrogen, and each R^{b} can be a hydrogen, hydrocarbyl, halogen, silylcarbyl, or polar radical; such as hydrogen, methyl, ethyl, propyl, butyl, phenyl, mesityl, fluoro, chloro, bromo, dimethylamido, diethylamido or methoxy; such as hydrogen or butyl; such as hydrogen or tert-butyl; such as hydrogen.

In other embodiments of Formula (1a), each R^{d}, R^{b} and R^{c} can be hydrogen, and each R^{a} can be a hydrogen, hydrocarbyl, halogen, or silylcarbyl; such as hydrogen, methyl, ethyl, propyl, butyl, fluoro, chloro, or bromo; such as hydrogen or butyl; such as hydrogen or tert-butyl; such as hydrogen.

Still, in other embodiments of Formula (1a), each R^{d} and R^{c} can be hydrogen, and each R^{a} and R^{b} are joined together to form a fused partially saturated six-membered carbon ring, each such fused ring can be substituted with four methyl substituents. Such exemplary ligand structure is illustrated in Formula (1b):

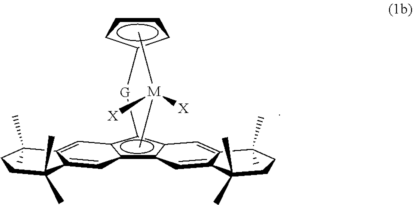

Still in other embodiments of Formula (1a) R^{c} and R^{d} can be hydrogen; each R^{a} and R^{b} are chosen from hydrogen, bromine, chlorine, methyl, ethyl, propyl, butyl or phenyl, such as R^{a} is hydrogen and R^{b} is chosen from hydrogen, methyl, ethyl, propyl, or butyl, or R^{b} is hydrogen and R^{a} is chosen from hydrogen, methyl, ethyl, propyl, or butyl, such as R^{a} is hydrogen and R^{b} is tert-butyl or hydrogen; suitable G is a bridging group and can be methylene, dimethylmethylene, diphenylmethylene, dimethylsilylene, diphenylsilylene, di(4-triethylsilylphenyl)silylene, ethylene, such as diphenylmethylene, diphenylsilylene, and dimethylsilylene; such as diphenylmethylene; suitable X can be hydrocarbyl or halo, such as methyl, benzyl, floro or chloro, such as methyl or chloro; M can be zirconium.

Suitable but non-limiting examples of pre-catalysts represented by Formula (1) include: diphenylmethylene(cyclopentadienyl)(9-fluorenyl)zirconium dichloride, methylene-(cyclopentadienyl)(9-fluorenyl)zirconium dichloride, dimethylmethylene(cyclopentadienyl) (9-fluorenyl)zirconium dichloride, dimethylsilylene(cyclopentadienyl)(9-fluorenyl)zirconium dichloride, diphenylsilylene(cyclopentadienyl)(9-fluorenyl)zirconium dichloride, ethylene-(cyclopentadienyl)(9-fluorenyl)zirconium dichloride, diphenylmethylene(cyclopentadienyl) (9-fluorenyl)zirconium dimethyl, methylene(cyclopentadienyl)(9-fluorenyl)zirconium di-methyl, dimethylmethylene(cyclopentadienyl)(9-fluorenyl)zirconium dimethyl, dimethyl-silylene(cyclopentadienyl)(9-fluorenyl)zirconium dimethyl, diphenylsilylene-(cyclopentadienyl)(9-fluorenyl)zirconium dimethyl, ethylene(cyclopentadienyl)(9-fluorenyl)zirconium dimethyl, and di(para-triethylsilylphenyl)methylene(2,7-di-tert-butyl fluorenyl)(cyclopentadienyl) zirconium dimethyl. Suitable pre-catalysts represented by formula (1) can be diphenylmethylene(cyclopentadienyl)(9-fluorenyl)zirconium dimethyl, diphenyl-methylene(cyclopentadienyl)(9-fluorenyl)zirconium dimethyl, and di(para-triethylsilylphenyl)methylene(2,7-di-tert-butyl fluorenyl)(cyclopentadienyl) zirconium dimethyl.

Catalysts useful for making the propylene-α-olefin copolymers (plastomers or elastomers) can also include metallocene compounds (pre-catalysts) having a structure represented by Formula (3) having Cₛ or pseudo-Cₛ symmetry:

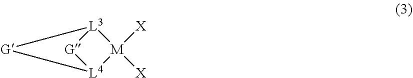

wherein:

M is zirconium;

L³ is a cyclopentadienyl ring optionally substituted in the 4 position of the ring, the substituent group being chosen from a radical group which is a hydrocarbyl, substituted hydrocarbyl, halocarbyl, substituted halocarbyl, silylcarbyl or germylcarbyl;

L⁴ is a substituted cyclopentadienyl ring with symmetric or pseudo symmetric substituents in the 3 and 5 positions of the ring, each substituent group being, independently, a radical group which is a hydrocarbyl, substituted hydrocarbyl, halocarbyl, substituted halocarbyl, silylcarbyl or germylcarbyl;

G′ and G″ are bridging groups (and may be as defined for bridging group T above, such as for T in Formula (B));

X are independently, hydride radicals, hydrocarbyl radicals, substituted hydrocarbyl radicals, halocarbyl radicals, substituted halocarbyl radicals, silylcarbyl radicals, substituted silylcarbyl radicals, germylcarbyl radicals, or substituted germylcarbyl radicals; or both X are joined and bound to the metal atom to form a metallacycle ring containing from about 3 to about 20 carbon atoms; or both together can be an olefin, diolefin or aryne ligand; both X may, independently, be a halogen, alkoxide, aryloxide, amide, phosphide or other univalent anionic ligand or both X can also be joined to form a anionic chelating ligand.

In Formula (3), L³ is cyclopentadienyl, or hydrocarbyl or silylcarbyl substituted cyclopentadienyl with the substitution on the 4-position of the cyclopentadienyl ring, such as cyclopentadienyl, 4-methylcyclopentadienyl, 4-ethylcyclopentadienyl, 4-propylcyclopentadienyl, 4-butylcyclopentadienyl, 4-pentylcyclopentadienyl, 4-hexylcyclopentadienyl, 4-heptylcyclopentadienyl, 3-octylcyclopentadienyl, or 4-trimethylsilylcyclopentadieyl, such as cyclopentadienyl, 4-isopropylcyclopentadienyl, 4-tert-butylcyclopentadienyl, 4-(2,2-dimethylpent-3-yl)cyclopentadienyl, 4-(2,2-dimethylbut-3-yl)cyclopentadienyl or 4-trimethylsilylcyclopentadienyl, such as cyclopentadienyl, 4-isopropylcyclopentadienyl, or 4-trimethylsilylcyclopentadienyl; L⁴ is hydrocarbyl or silylcarbyl substituted cyclopentadienyl with the substitutions on the 3- and 5-positions of the cyclopentadienyl ring, such as 3,5-dimethylcyclopentadienyl, 3,5-diethylcyclopentadienyl, 3,5-dipropylcyclopentadienyl, 3,5-dibutylcyclopentadienyl, 3,5-dipentylcyclopentadienyl, 3,5-dihexylcylopentadienyl, 3,5-dibenzylcyclopentadienyl, or 3,5-bis(trimethylsilyl)cyclopentadieyl, such as 3,5-dimethylcyclopentadienyl, 3,5-diisopropylcyclopentadienyl, 3,5-di-tert-butylcyclopentadienyl, 3,5-dicyclopentylcyclopentadienyl, 3,5-dipent-3-ylcyclopentadienyl, 3,5-dicyclohexylcylopentadienyl, 3,5-dibenzylcyclopentadienyl, or 3,5-bis(trimethylsilyl)cyclopentadienyl, such as 3,5-dimethylcyclopentadienyl, 3,5-diisopropylcyclopentadienyl, 3,5-di-tert-butylcyclopentadienyl, 3,5-dibenzylcyclopentadienyl, or 3,5-bis(trimethylsilyl)cyclopentadieyl; each G′ and G″ are methylene, dimethylmethylene, dimethylsilylene, such as dimethylmethylene, and dimethylsilylene; such as dimethylsilylene; X is hydrocarbyl or halo, such as methyl, benzyl, floro or chloro, such as methyl or chloro; M is zirconium.

A subset of the metallocene compounds (pre-catalysts) represented by Formula (3) that may be used include those having Cₛ or pseudo-Cₛ symmetry are represented by Formula (3a):

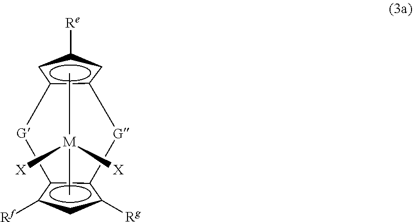

wherein M, G′, G″, and X are defined as in Formula (3);

R^{e} is selected from hydrogen or a hydrocarbyl, substituted hydrocarbyl, halocarbyl, substituted halocarbyl, silylcarbyl or germylcarbyl radicals;

each R^{f} and R^{g} are selected from hydrocarbyl, substituted hydrocarbyl, halocarbyl, substituted halocarbyl, silylcarbyl, or germylcarbyl, with the proviso that each R^{f} and R^{g} are chosen to allow the compound to be Cₛ-symmetric or pseudo Cₛ-symmetric.

In at least one embodiment of Formula (3a), each R^{f} and R^{g} can be hydrocarbyl or silylcarbyl, such as methyl, ethyl, propyl, butyl, pentyl, hexyl, benzyl, or trimethylsilyl, such as methyl, isopropyl, tert-butyl, cyclopentyl, pent-3-yl, cyclohexyl, benzyl, or trimethylsilyl, such as methyl, isopropyl, tert-butyl, benzyl or trimethylsilyl; and suitable R can be hydrogen, hydrocarbyl or silylcarbyl, such as methyl, ethyl, propyl, butyl, pentyl, hexyl, heptyl, octyl, or trimethylsilyl; such as hydrogen, isopropyl, tert-butyl, 2,2-dimethylpent-3-yl, 2,2-dimethylbut-3-yl, or trimethylsilyl, such as hydrogen, isopropyl or trimethylsilyl.

In Formulas 1, 1a, 1b, 2, 3 or 3a, G, G′ and G″ are selected from R*₂C, R*₂Si, R*₂Ge, R*₂CCR*₂, R*C═CR*, R*₂CSiR*₂, R*₂SiSiR*₂, R*B, R*₂C—BR*, R*N, R*P, O, S, and Se, where each R* is independently selected from hydrogen, C₁-C₂₀ containing hydrocarbyl, substituted hydrocarbyl, halocarbyl, substituted halocarbyl, silylcarbyl or germylcarbyl substituent and optionally two or more adjacent R* may join to form a substituted or unsubstituted, saturated, partially unsaturated, cyclic or polycyclic substituent. For example, G, G′ and G″ are selected from R*₂C, R*₂Si, R*₂Ge, R*₂CCR*₂, R*B, R*N, R*P, O, S, and Se, where each R* is as defined above, such as G, G′ and G″ are selected from R*₂C, R*₂Si, and R*₂CCR*₂.

Catalysts capable of making the propylene-α-olefin copolymers described (as Catalyst I or Catalyst II) herein may also include metallocene compounds (pre-catalysts) having a structure represented by Formula (4) having C₂ symmetry.

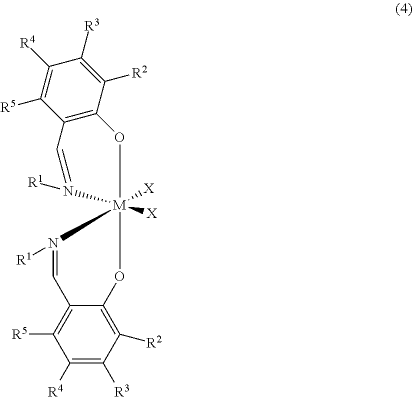

wherein:

M is zirconium or titanium;

O is oxygen;

N is nitrogen;

R¹ is a radical group which is a hydrocarbyl, substituted hydrocarbyl, halocarbyl, substituted halocarbyl, silylcarbyl or germylcarbyl, such as R¹ is halocarbyl;

R² is a radical group which is a hydrocarbyl, substituted hydrocarbyl, halocarbyl, substituted halocarbyl, silylcarbyl or germylcarbyl, such as R² is hydrocarbyl having three or more carbon atoms or silylcarbyl having three or more carbon atoms;

R³, R⁴ and R⁵ are independently hydrogen or a radical group which is a hydrocarbyl, substituted hydrocarbyl, halocarbyl, substituted halocarbyl, silylcarbyl or germylcarbyl, such as R³, R⁴ and R⁵ are hydrogen;

X are independently, hydride radicals, hydrocarbyl radicals, substituted hydrocarbyl radicals, halocarbyl radicals, substituted halocarbyl radicals, silylcarbyl radicals, substituted silylcarbyl radicals, germylcarbyl radicals, or substituted germylcarbyl radicals; or both X are joined and bound to the metal atom to form a metallacycle ring containing from about 3 to about 20 carbon atoms; or both together can be an olefin, diolefin or aryne ligand; both X may, independently, be a halogen, alkoxide, aryloxide, amide, phosphide or other univalent anionic ligand or both X can also be joined to form a anionic chelating ligand.

In at least one embodiment of Formula (4), suitable R¹ can be hydrocarbyl or halocarbyl radicals, such as methyl, ethyl, propyl, butyl, pentyl, hexyl, benzyl, phenyl, methylphenyl, dimethylphenyl, ethylphenyl, diethylphenyl, propylphenyl, dipropylphenyl, perfluorophenyl, trifluorphenyl, difluorophenyl, or fluorophenyl, such as phenyl, 2-methylphenyl, 2,6-dimethylphenyl, 2-isopropylphenyl, perfluorophenyl, 2,4,6-trifluorophenyl, 2,6-difluorophenyl, 3,5-difluorophenyl or 4-fluorophenyl, such as perfluorophenyl; suitable R² can be hydrocarbyl or silylcarbyl radicals, such as C₃-C₁₂ hydrocarbyl or C₃-C₁₂ silylcarbyl, such as propyl, butyl, pentyl, hexyl, heptyl, octyl, cumyl, or trimethylsilyl, such as isopropyl, tert-butyl, cumyl, or trimethylsilyl, such as tert-butyl or trimethylsilyl; suitable R³, R⁴ and R⁵ can be hydrogen or hydrocarbyl radicals, such as hydrogen; suitable X can be hydrocarbyl or halo, such as methyl, benzyl, fluoro or chloro, such as methyl or chloro; M is titanium.

Catalyst II-B)-2, BIS CP Catalyst II Compounds with C1 Symmetry

In at least one embodiment, many C₁ symmetry Bis-Cp metallocene catalysts capable of diene incorporation can be represented by bridging substituted cyclopentadienyl and substituted indenyl catalyst precursor compounds as the Formula (C1a):

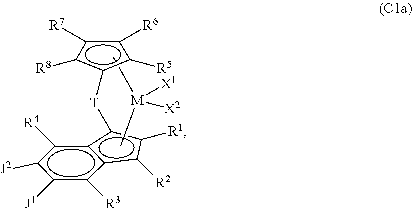

wherein:

M is a transition metal atom;

T is a bridging group;

each of X¹ and X² is a univalent anionic ligand, or X¹ and X² are joined to form a metallocycle ring;

R¹ is hydrogen, a halogen, an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′₂, —SR′, —OR, —SiR′₃, —OSiR′₃, —PR′₂, or —R″—SiR′3, where R″ is C₁-C₁₀ alkyl and each R′ is hydrogen, halogen, C₁-C₁₀ alkyl, or C₆-C₁₀ aryl;

R³ is an unsubstituted C₄-C₆₂ cycloalkyl, a substituted C₄-C₆₂ cycloalkyl, an unsubstituted C₄-C₆₂ aryl, a substituted C₄-C₆₂ aryl, an unsubstituted C₄-C₆₂ heteroaryl, or a substituted C₄-C₆₂ heteroaryl;

each of R² and R⁴ is independently hydrogen, a halogen, an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′₂, —SR′, —OR, —SiR′₃, —OSiR′₃, —PR′₂, or —R″—SiR′₃, wherein R″ is C₁-C₁₀ alkyl and each R′ is hydrogen, halogen, C₁-C₁₀ alkyl, or C₆-C₁₀ aryl;

each of R⁵, R⁶, R⁷, and R⁸ is independently hydrogen, a halogen, an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′₂, —SR′, —OR, —SiR′₃, —OSiR′₃, —PR′₂, or —R″—SiR′₃, wherein R″ is C₁-C₁₀ alkyl and each R′ is hydrogen, halogen, C₁-C₁₀ alkyl, or C₆-C₁₀ aryl, or one or more of R⁵ and R⁶, R⁶ and R⁷, or R⁷ and R⁸ can be joined to form a substituted or unsubstituted C₄-C₆₂ saturated or unsaturated cyclic or polycyclic ring structure, or a combination thereof; and

each of J¹ and J² is joined to form a substituted or unsubstituted C₄-C₆₂ saturated or unsaturated cyclic or polycyclic ring structure, or a combination thereof.

In some embodiments of the present disclosure, M is a transition metal such as a transition metal of Group 3, 4, or 5 of the Periodic Table of Elements, such as a Group 4 metal, for example Zr, Hf, or Ti.

In some embodiments of the present disclosure, each of X¹ and X² is independently an unsubstituted C₁-C₄₀ hydrocarbyl (such as an unsubstituted C₂-C₂₀ hydrocarbyl), a substituted C₁-C₄₀ hydrocarbyl (such as a substituted C₂-C₂₀ hydrocarbyl), an unsubstituted C₄-C₆₂ aryl, a substituted C₄-C₆₂ aryl, an unsubstituted C₄-C₆₂ heteroaryl, a substituted C₄-C₆₂ heteroaryl, hydride, amide, alkoxide, sulfide, phosphide, halide, diene, amine, phosphine, ether, and a combination thereof, for example each of X¹ and X² is independently a halide or a C₁-C₅ alkyl, such as methyl. In some embodiments, each of X¹ and X² is independently chloro, bromo, methyl, ethyl, propyl, butyl, pentyl, hexyl, heptyl, octyl, nonyl, decyl, undecyl, or dodecyl. In some embodiments of the present disclosure, X¹ and X² form a part of a fused ring or a ring system.

In some embodiments, T is represented by the formula, (R*₂G)_{g}, wherein each G is C, Si, or Ge, g is 1 or 2, and each R* is, independently, hydrogen, halogen, an unsubstituted C₁-C₂₀ hydrocarbyl (such as methyl, ethyl, propyl, butyl, pentyl, hexyl, heptyl, octyl, nonyl, decyl, undecyl, or dodecyl), a substituted C₁-C₂₀ hydrocarbyl, or the two or more R* may join to form a substituted or unsubstituted, saturated, partially unsaturated or aromatic, cyclic or polycyclic substituent. In some embodiments of the present disclosure, T is a bridging group and is represented by R′₂C, R′₂Si, R′₂Ge, R′₂CCR′₂, R′₂CCR′₂CR′₂, R′₂CCR′2CR′₂CR′₂, R′C═CR′, R′C═CR′CR′₂, R′2CCR′═CR′CR′2, R′C═CR′CR′═CR′, R′C═CR′CR′2CR′2, R′2CSiR′2, R′2SiSiR′2, R²CSiR′2CR′₂, R′₂SiCR′₂SiR′₂, R′C═CR′SiR′₂, R′₂CGeR′₂, R′₂GeGeR′₂, R′₂CGeR′₂CR′₂, R′₂GeCR′₂GeR′₂, R′₂SiGeR′₂, R′C═CR′GeR′₂, R′B, R′₂C—BR′, R′₂C—BR′—CR′₂, R′₂C—O—CR′₂, R′₂CR′₂C—O—CR′₂CR′₂, R′₂C—O—CR′₂CR′₂, R′₂C—O—CR′═CR′, R′₂C—S—CR′₂, R′₂CR′₂C—S—CR′₂CR′₂, R′₂C—S—CR′₂CR′₂, R′₂C—S—CR′═CR′, R′₂C—Se—CR′₂, R′₂CR′₂C—Se—CR′₂CR′₂, R′₂C—Se—CR₂CR′₂, R′₂C—Se—CR′═CR′, R′₂C—N═CR′, R′₂C—NR′—CR′₂, R′₂C—NR′—CR′₂CR′₂, R′₂C—NR′—CR′═CR′, R′₂CR′₂C—NR′—CR′₂CR′₂, R′₂C—P═CR′, or R′₂C—PR′—CR′₂ where each R′ is independently hydrogen or an unsubstituted C₁-C₂₀ hydrocarbyl (such as methyl, ethyl, propyl, butyl, pentyl, hexyl, heptyl, octyl, nonyl, decyl, undecyl, or dodecyl), a substituted C₁-C₂₀ hydrocarbyl, a C₁-C₂₀ halocarbyl, a C₁-C₂₀ silylcarbyl, or a C₁-C₂₀ germylcarbyl substituent, or two or more adjacent R′ join to form a substituted or unsubstituted, saturated, partially unsaturated or aromatic, cyclic or polycyclic substituent. In some embodiments of the present disclosure, T is a bridging group that includes carbon or silicon, such as dialkylsilyl, for example T is a CH₂, CH₂CH₂, C(CH₃)₂, (Ph)₂C, (p-(Et)₃SiPh)₂C, SiMe₂, SiPh₂, SiMePh, Si(CH₂)₃, Si(CH₂)₄, or Si(CH₂)₄.

In some embodiments, R¹ is hydrogen, a substituted C₁-C₂₀ hydrocarbyl, or an unsubstituted C₁-C₂₀ hydrocarbyl, such as a substituted C₁-C₁₂ hydrocarbyl or an unsubstituted C₁-C₁₂ hydrocarbyl (such as methyl, ethyl, propyl, butyl, pentyl, hexyl, heptyl, octyl, nonyl, decyl, undecyl, or dodecyl), for example hydrogen, a substituted C₁-C₆ hydrocarbyl, or an unsubstituted C₁-C₆ hydrocarbyl.

In some embodiments, each of R² and R⁴ is independently hydrogen, a substituted C₁-C₂₀ hydrocarbyl, or an unsubstituted C₁-C₂₀ hydrocarbyl, such as a substituted C₁-C₁₂ hydrocarbyl or an unsubstituted C₁-C₁₂ hydrocarbyl (such as methyl, ethyl, propyl, butyl, pentyl, hexyl, heptyl, octyl, nonyl, decyl, undecyl, or dodecyl), for example hydrogen, a substituted C₁-C₆ hydrocarbyl, or an unsubstituted C₁-C₆ hydrocarbyl.

In some embodiments, each of R⁵, R⁶, R⁷, and R⁸ is independently hydrogen, a substituted C₁-C₂₀ hydrocarbyl, or an unsubstituted C₁-C₂₀ hydrocarbyl, such as a substituted C₁-C₁₂ hydrocarbyl or an unsubstituted C₁-C₁₂ hydrocarbyl (such as methyl, ethyl, propyl, butyl, pentyl, hexyl, heptyl, octyl, nonyl, decyl, undecyl, or dodecyl), such as a substituted C₁-C₆ hydrocarbyl, or an unsubstituted C₁-C₆ hydrocarbyl (such as methyl, ethyl, propyl, butyl, pentyl, or hexyl), or one or more of R⁵ and R⁶, R⁶ and R⁷, or R⁷ and R⁸ can be joined to form a substituted or unsubstituted C₄-C₂₀ saturated or unsaturated cyclic or polycyclic ring structure, or a combination thereof.

In some embodiments, one or more of R⁵ and R⁶, R⁶ and R⁷, or R⁷ and R⁸ can be joined to form a substituted or unsubstituted C₈-C₈ saturated or unsaturated cyclic or polycyclic ring structure, or a combination thereof.

In some embodiments, R³ is an unsubstituted C₄-C₂₀ cycloalkyl (e.g., cyclohexane, cyclypentane, cycloocatane, adamantane), or a substituted C₄-C₂₀ cycloalkyl.

In some embodiments, R³ is a substituted or unsubstituted phenyl, benzyl, carbazolyl, naphthyl, or fluorenyl.

In some embodiments, R³ is a substituted or unsubstituted aryl group represented by the formula:

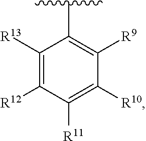

wherein each of R⁹, R¹⁰, R¹¹, R¹², and R¹³ is independently hydrogen, an unsubstituted C₁-C₄₀ hydrocarbyl, a substituted C₁-C₄₀ hydrocarbyl, a heteroatom, a heteroatom-containing group, or two or more of R⁹, R¹⁰, R¹¹, R¹², and R¹³ are joined together to form a C₄-C₆₂ cyclic or polycyclic ring structure, or a combination thereof.

In some embodiments of the present disclosure, each of R⁹, R¹⁰, R¹¹, R¹², and R¹³ is independently hydrogen, a halogen, an unsubstituted C₁-C₄₀ hydrocarbyl, a substituted C₁-C₄₀ hydrocarbyl, an unsubstituted C₄-C₆₂ aryl (such as an unsubstituted C₄-C₂₀ aryl, such as a phenyl), a substituted C₄-C₆₂ aryl (such as a substituted C₄-C₂₀ aryl), an unsubstituted C₄-C₆₂ heteroaryl (such as an unsubstituted C₄-C₂₀ heteroaryl), a substituted C₄-C₆₂ heteroaryl (such as a substituted C₄-C₂₀ heteroaryl), —NR′₂, —SR′, —OR, —SiR′₃, —OSiR′₃, —PR′₂, or —R″—SiR′₃, where R″ is C₁-C₁₀ alkyl and each R′ is hydrogen, halogen, C₁-C₁₀ alkyl, or C₆-C₁₀ aryl. For example, each of R⁹, R¹⁰, R¹¹, R¹², and R¹³ is independently hydrogen, a substituted C₁-C₂₀ hydrocarbyl, or an unsubstituted C₁-C₂₀ hydrocarbyl, such as a substituted C₁-C₁₂ hydrocarbyl or an unsubstituted C₁-C₁₂ hydrocarbyl (such as methyl, ethyl, propyl, butyl, pentyl, hexyl, heptyl, octyl, nonyl, decyl, undecyl, or dodecyl), such as a substituted C₁-C₆ hydrocarbyl, or an unsubstituted C₁-C₆ hydrocarbyl (such as methyl, ethyl, propyl, butyl, pentyl, or hexyl), or two or more of R⁹, R¹⁰, R¹¹, R¹², and R¹³ can be joined to form a substituted or unsubstituted C₄-C₂₀ saturated or unsaturated cyclic or polycyclic ring structure, or a combination thereof.

In some embodiments of the present disclosure, at least one of R⁹, R¹⁰, R¹¹, R¹², and R¹³ is a phenyl.

In some embodiments of the present disclosure, each of J¹ and J² is joined form an unsubstituted C₄-C₂₀ cyclic or polycyclic ring, either of which may be saturated, partially saturated, or unsaturated. In some embodiments each J joins to form a substituted C₄-C₂₀ cyclic or polycyclic ring, either of which may be saturated or unsaturated. Examples include:

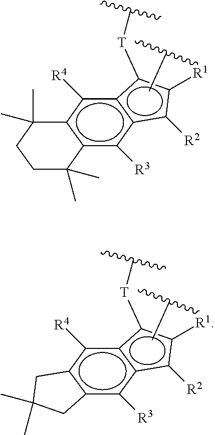

In at least one embodiment, C₁ symmetry bis-Cp metallocene catalysts can also be represented by bridging substituted cyclopentadienyl and substituted indenyl catalyst precursor compounds as the Formula (C1b):

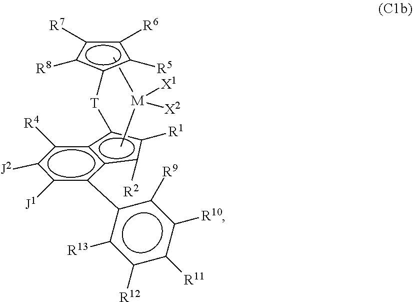

wherein M, T, J¹, J², X¹, X², R¹, R², and R⁴-R¹³ are described above.

In at least one embodiment, C₁ symmetry bis-Cp metallocene catalysts can also be represented by bridging substituted cyclopentadienyl and substituted indenyl catalyst precursor compounds as the Formula (C1c):

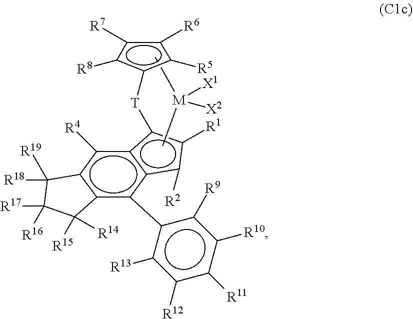

wherein:

each of R¹⁴, R⁵, R¹⁶, R¹⁷, R¹⁸, and R¹⁹ is independently hydrogen, an unsubstituted C₁-C₄₀ hydrocarbyl, a substituted C₁-C₄₀ hydrocarbyl, a heteroatom, a heteroatom-containing group, or two or more of R¹⁴, R⁵, R¹⁶, R¹⁷, R¹⁸, and R¹⁹ are joined together to form a cyclic or polycyclic ring structure, or a combination thereof; and

M, T, X¹, X², R¹, R², and R⁴-R¹³ are described above.

In some embodiments, each of R¹⁴, R¹⁵, R¹⁶, R¹⁷, R¹⁸, and R¹⁹ is independently hydrogen, a halogen, an unsubstituted C₁-C₄₀ hydrocarbyl, a substituted C₁-C₄₀ hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′₂, —SR′, —OR, —SiR′₃, —OSiR′₃, —PR′₂, or —R″—SiR′₃, where R″ is C₁-C₁₀ alkyl and each R′ is hydrogen, halogen, C₁-C₁₀ alkyl, or C₆-C₁₀ aryl. For example, each of R¹⁴, R¹⁵, R¹⁶, R¹⁷, R¹⁸, and R¹⁹ is independently hydrogen, a substituted C₁-C₂₀ hydrocarbyl, or an unsubstituted C₁-C₂₀ hydrocarbyl, such as a substituted C₁-C₁₂ hydrocarbyl or an unsubstituted C₁-C₁₂ hydrocarbyl (such as methyl, ethyl, propyl, butyl, pentyl, hexyl, heptyl, octyl, nonyl, decyl, undecyl, or dodecyl), such as a substituted C₁-C₆ hydrocarbyl, or an unsubstituted C₁-C₆ hydrocarbyl (such as methyl, ethyl, propyl, butyl, pentyl, or hexyl), or two or more of R¹⁴, R¹⁵, R¹⁶, R¹⁷, R¹⁸, and R¹⁹ can be joined to form a substituted or unsubstituted C₄-C₂₀ saturated or unsaturated cyclic or polycyclic ring structure, or a combination thereof.

In at least one embodiment, C₁ symmetry bis-Cp metallocene catalysts that can also be represented by bridging substituted cyclopentadienyl and substituted indenyl catalyst precursor compounds as the Formula (C1d):

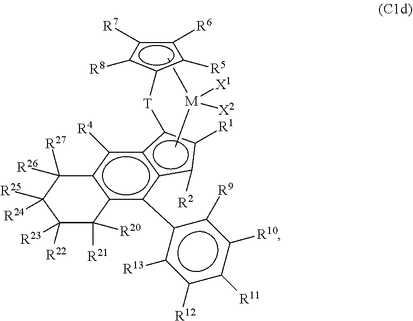

wherein:

each of R²⁰, R², R²², R²³, R²⁴, R²⁵, R²⁶, R²⁷ is independently hydrogen, an unsubstituted C₁-C₄₀ hydrocarbyl, a substituted C₁-C₄₀ hydrocarbyl, a heteroatom, a heteroatom-containing group, or two or more of R²⁰, R²¹, R²², R²³, R²⁴, R²⁵, R²⁶, R²⁷ are joined together to form a cyclic or polycyclic ring structure, or a combination thereof; and

M, T, X¹, X², R¹, R², and R⁴-R¹³ are described above.

In some embodiments, each of R²⁰, R²¹, R²², R²³, R²⁴, R²⁵, R²⁶, R²⁷ is independently hydrogen, a halogen, an unsubstituted C₁-C₄₀ hydrocarbyl, a substituted C₁-C₄₀ hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′₂, —SR′, —OR, —SiR′₃, —OSiR′₃, —PR′₂, or —R″—SiR′₃, where R″ is C₁-C₁₀ alkyl and each R′ is hydrogen, halogen, C₁-C₁₀ alkyl, or C₆-C₁₀ aryl. For example, each of R²⁰, R²¹, R²², R²³, R²⁴, R²⁵, R²⁶, R²⁷ is independently hydrogen, a substituted C₁-C₂₀ hydrocarbyl, or an unsubstituted C₁-C₂₀ hydrocarbyl, such as a substituted C₁-C₁₂ hydrocarbyl or an unsubstituted C₁-C₁₂ hydrocarbyl (such as methyl, ethyl, propyl, butyl, pentyl, hexyl, heptyl, octyl, nonyl, decyl, undecyl, or dodecyl), such as a substituted C₁-C₆ hydrocarbyl, or an unsubstituted C₁-C₆ hydrocarbyl (such as methyl, ethyl, propyl, butyl, pentyl, or hexyl), or two or more R²⁰, R²¹, R²², R²³, R²⁴, R²⁵, R²⁶, R²⁷ can be joined to form a substituted or unsubstituted C₄-C₂₀ saturated or unsaturated cyclic or polycyclic ring structure, or a combination thereof.

It should be understood that since C₁ symmetry metallocenes can produce iPP and alpha-olefin-diene vulcanizable plastomer and elastomer, they can be used as Catalyst I and Catalyst II, which can be different or the same.

Useful examples of bridging C₂ metallocenes (typically as Catalyst for iPP matrix phase) include but are not limited to:
dimethylsilandiyl(2-methyl-(4-(3′,5′-di-tert-butyl-4′-methoxy-phenyl)indenyl)(2-hexyl-4-(o-biphenyl)indenyl)Zr dichloride or dimethyl;
dimethylsilandiyl(2-ethyl-4-(3′,5′-di-tert-butyl-4′-methoxyphenyl)indenyl)(2-n-hexyl-4-(o-biphenyl)indenyl)Zr dichloride or dimethyl;
dimethylsilandiyl(2-propyl-4-(3′,5′-di-tert-butyl-4′-methoxyphenyl)indenyl)(2-n-hexyl-4-(o-biphenyl)indenyl)Zr dichloride or dimethyl;
dimethylsilandiyl(2-butyl-4-(3′,5′-di-tert-butyl-4′-methoxyphenyl)indenyl)(2-n-hexyl-4-(o-biphenyl)indenyl)Zr dichloride or dimethyl;
dimethylsilandiyl(2-methyl-4-(3′,5′-bistrifluoromethyl-4′-methoxyphenyl)indenyl)(2-n-hexyl-4-(o-biphenyl)indenyl)Zr dichloride or dimethyl;
dimethylsilandiyl(2-methyl-4-(3′,5′-bistrifluoromethyl-4′-methoxyphenyl)indenyl)(2-n-hexyl-4-(o-biphenyl)indenyl)Zr(CH₃)₂;
dimethylsilandiyl(2-ethyl-4-(3′,5′-bistrifluoromethyl-4′-methoxyphenyl)indenyl)(2-n-hexyl-4-(o-biphenyl)indenyl)Zr dichloride or dimethyl;
dimethylsilandiyl(2-propyl-4-(3′,5′-bistrifluoromethyl-4′-methoxyphenyl)indenyl)(2-n-hexyl-4-(o-biphenyl)indenyl)Zr dichloride or dimethyl;
dimethylsilandiyl(2-butyl-4-(3′,5′-bistrifluoromethyl-4′-methoxyphenyl)indenyl)(2-n-hexyl-4-(o-biphenyl)indenyl)Zr dichloride or dimethyl;
dimethylsilandiyl(2-methyl-4-(3′,5′-di-iso-propyl-4′-methoxyphenyl)indenyl)(2-n-hexyl-4-(o-biphenyl)indenyl)Zr dichloride or dimethyl;
dimethylsilandiyl(2-ethyl-4-(3′,5′-di-iso-propyl-4′-methoxyphenyl)indenyl)(2-n-hexyl-4-(o-biphenyl)indenyl)Zr dichloride or dimethyl;
dimethylsilandiyl(2-propyl-4-(3′,5′-di-iso-propyl-4′-methoxyphenyl)indenyl)(2-n-hexyl-4-(o-biphenyl)indenyl)Zr dichloride or dimethyl;
dimethylsilandiyl(2-butyl-4-(3′,5′-di-iso-propyl-4′-methoxyphenyl)indenyl)(2-n-hexyl-4-(o-biphenyl)indenyl)Zr dichloride or dimethyl;
dimethylsilandiyl(2-methyl-4-(3′,5′-di-phenyl-4′-methoxyphenyl)indenyl)(2-n-hexyl-4-(o-biphenyl)indenyl)Zr dichloride or dimethyl;
dimethylsilandiyl(2-ethyl-4-(3′,5′-di-phenyl-4′-methoxyphenyl)indenyl)(2-n-hexyl-4-(o-biphenyl)indenyl)Zr dichloride or dimethyl; dimethylsilandiyl(2-propyl-4-(3′,5′-di-phenyl-4′-methoxyphenyl)indenyl)(2-n-hexyl-4-(o-biphenyl)indenyl)Zr dichloride or dimethyl; and
dimethylsilandiyl(2-butyl-4-(3′,5′-di-phenyl-4′-methoxyphenyl)indenyl)(2-n-hexyl-4-(o-biphenyl)indenyl)Zr dichloride or dimethyl.
dimethylsilandiyl(2-methyl-4-(3′,5′-di-tert-butyl-4′-methoxyphenyl)indenyl)(2-n-hexyl-4-(o-biphenyl)indenyl)Zr dichloride or dimethyl;
dimethylsilandiyl(2-methyl-4-(3′,5′-di-tert-butyl-4′-methoxyphenyl)(1,5,6,7-tetrahydro-s-indacenyl))(2-n-hexyl-4-(o-biphenyl)indenyl)Zr dichloride or dimethyl;
dimethylsilandiyl(2-methyl-4-phenyl-(1,5,6,7-tetrahydro-s-indacenyl))(2-isopropyl-4-(4′-t-butylphenyl)indenyl)Zr dichloride or dimethyl;
dimethylsilandiyl(2-methyl-4-(4′-t-butylphenyl)indenyl)(2-isopropyl-4-(4′-t-butylphenyl)indenyl)Zr dichloride or dimethyl;
dimethylsilandiyl(2-ethyl-4-(3′,5′-di-tert-butyl-4′-methoxyphenyl) indenyl)(2-n-hexyl-4-(o-biphenyl) indenyl)Zr dichloride or dimethyl;
dimethylsilandiyl(2-propyl-4-(3′,5′-di-tert-butyl-4′-methoxyphenyl)indenyl)(2-n-hexyl-4-(o-biphenyl)indenyl)Zr dichloride or dimethyl;
dimethylsilandiyl(2-butyl-4-(3′,5′-di-tert-butyl-4′-methoxyphenyl)indenyl)(2-n-hexyl-4-(o-biphenyl)indenyl)Zr dichloride or dimethyl;
dimethylsilandiyl(2-methyl-4-(3′,5′-bistrifluoromethyl-4′-methoxyphenyl)indenyl)(2-n-hexyl-4-(o-biphenyl)indenyl)Zr dichloride or dimethyl;
dimethylsilandiyl(2-ethyl-4-(3′,5′-bistrifluoromethyl-4′-methoxyphenyl)indenyl)(2-n-hexyl-4-(o-biphenyl)indenyl)Zr dichloride or dimethyl;
dimethylsilandiyl(2-propyl-4-(3′,5′-bistrifluoromethyl-4′-methoxyphenyl)indenyl)(2-n-hexyl-4-(o-biphenyl)indenyl)Zr dichloride or dimethyl;
dimethylsilandiyl(2-butyl-4-(3′,5′-bistrifluoromethyl-4′-methoxyphenyl)indenyl)(2-n-hexyl-4-(o-biphenyl)indenyl)Zr dichloride or dimethyl;
dimethylsilandiyl(2-methyl-4-(3′,5′-di-iso-propyl-4′-methoxyphenyl)indenyl)(2-n-hexyl-4-(o-biphenyl)indenyl)Zr dichloride or dimethyl;
dimethylsilandiyl(2-ethyl-4-(3′,5′-di-iso-propyl-4′-methoxyphenyl)indenyl)(2-n-hexyl-4-(o-biphenyl)indenyl)Zr dichloride or dimethyl;
dimethylsilandiyl(2-propyl-4-(3′,5′-di-iso-propyl-4′-methoxyphenyl)indenyl)(2-n-hexyl-4-(o-biphenyl)indenyl)Zr dichloride or dimethyl;
dimethylsilandiyl(2-butyl-4-(3′,5′-di-iso-propyl-4′-methoxyphenyl)indenyl)(2-n-hexyl-4-(o-biphenyl)indenyl)Zr dichloride or dimethyl;
dimethylsilandiyl(2-methyl-4-(3′,5′-di-phenyl-4′-methoxyphenyl)indenyl)(2-n-hexyl-4-(o-biphenyl)indenyl)Zr dichloride or dimethyl;
dimethylsilandiyl(2-ethyl-4-(3′,5′-di-phenyl-4′-methoxyphenyl)indenyl)(2-n-hexyl-4-(o-biphenyl)indenyl)Zr dichloride or dimethyl;
dimethylsilandiyl(2-propyl-4-(3′,5′-di-phenyl-4′-methoxyphenyl)indenyl)(2-n-hexyl-4-(o-biphenyl)indenyl)Zr dichloride or dimethyl;
dimethylsilandiyl(2-butyl-4-(3′,5′-di-phenyl-4′-methoxyphenyl)indenyl)(2-n-hexyl-4-(o-biphenyl)indenyl)Zr dichloride or dimethyl;
dimethylamidoborane(2-methyl-4-(3′,5′-di-tert-butyl-4′-methoxyphenyl)indenyl)(2-n-hexyl-4-(o-biphenyl)indenyl)Zr dichloride or dimethyl;
dimethylamidoborane(2-ethyl-4-(3′,5′-di-tert-butyl-4′-methoxyphenyl)indenyl)(2-n-hexyl-4-(o-biphenyl)indenyl)Zr dichloride or dimethyl;
dimethylamidoborane(2-propyl-4-(3′,5′-di-tert-butyl-4′-methoxyphenyl)indenyl)(2-n-hexyl-4-(o-biphenyl)indenyl)Zr dichloride or dimethyl;
dimethylamidoborane(2-butyl-4-(3′,5′-di-tert-butyl-4′-methoxyphenyl)indenyl)(2-n-hexyl-4-(o-biphenyl)indenyl)Zr dichloride or dimethyl;
dimethylamidoborane(2-methyl-4-(3′,5′-bistrifluoromethyl-4′-methoxyphenyl)indenyl)(2-n-hexyl-4-(o-biphenyl)indenyl)Zr dichloride or dimethyl;
dimethylamidoborane(2-ethyl-4-(3′,5′-bistrifluoromethyl-4′-methoxyphenyl)indenyl)(2-n-hexyl-4-(o-biphenyl)indenyl)Zr dichloride or dimethyl;
dimethylamidoborane(2-propyl-4-(3′,5′-bistrifluoromethyl-4′-methoxyphenyl)indenyl)(2-n-hexyl-4-(o-biphenyl)indenyl)Zr dichloride or dimethyl;
dimethylamidoborane(2-butyl-4-(3′,5′-bistrifluoromethyl-4′-methoxyphenyl)indenyl)(2-n-hexyl-4-(o-biphenyl)indenyl)Zr dichloride or dimethyl;
dimethylamidoborane(2-methyl-4-(3′,5′-di-iso-propyl-4′-methoxyphenyl)indenyl)(2-n-hexyl-4-(o-biphenyl)indenyl)Zr dichloride or dimethyl;
dimethylamidoborane(2-ethyl-4-(3′,5′-di-iso-propyl-4′-methoxyphenyl)indenyl)(2-n-hexyl-4-(o-biphenyl)indenyl)Zr dichloride or dimethyl;
dimethylamidoborane(2-propyl-4-(3′,5′-di-iso-propyl-4′-methoxyphenyl)indenyl)(2-n-hexyl-4-(o-biphenyl)indenyl)Zr dichloride or dimethyl;
dimethylamidoborane(2-tert-butyl-4-(3′,5′-di-iso-propyl-4′-methoxyphenyl)indenyl)(2-n-hexyl-4-(o-biphenyl)indenyl)Zr dichloride or dimethyl;
dimethylamidoborane(2-methyl-4-(3′,5′-di-phenyl-4′-methoxyphenyl)indenyl)(2-n-hexyl-4-(o-biphenyl)indenyl)Zr dichloride or dimethyl;
dimethylamidoborane(2-ethyl-4-(3′,5′-di-phenyl-4′-methoxyphenyl)indenyl)(2-n-hexyl-4-(o-biphenyl)indenyl)Zr dichloride or dimethyl;
dimethylamidoborane(2-propyl-4-(3′,5′-diphenyl-4′-methoxyphenyl)indenyl)(2-n-hexyl-4-(o-biphenyl)indenyl)Zr dichloride or dimethyl;
dimethylamidoborane(2-butyl-4-(3′,5′-diphenyl-4′-methoxyphenyl)indenyl)(2-n-hexyl-4-(o-biphenyl)indenyl)Zr dichloride or dimethyl;
di-iso-propylamidoborane(2-methyl-4-(3′,5′-di-tert-butyl-4′-methoxyphenyl)indenyl)(2-n-hexyl-4-(o-biphenyl)indenyl)Zr dichloride or dimethyl;
di-iso-propylamidoborane(2-ethyl-4-(3′,5′-di-tert-butyl-4′-methoxyphenyl)indenyl)(2-n-hexyl-4-(o-biphenyl)indenyl)Zr dichloride or dimethyl;
di-iso-propylamidoborane(2-propyl-4-(3′,5′-di-tert-butyl-4′-methoxyphenyl)indenyl)(2-n-hexyl-4-(o-biphenyl)indenyl)Zr dichloride or dimethyl;
di-iso-propylamidoborane(2-butyl-4-(3′,5′-di-tert-butyl-4′-methoxyphenyl)indenyl)(2-n-hexyl-4-(o-biphenyl)indenyl)Zr dichloride or dimethyl;
di-iso-propylamidoborane(2-methyl-4-(3′,5′-bistrifluoromethyl-4′-methoxyphenyl)indenyl)(2-n-hexyl-4-(o-biphenyl)indenyl)Zr dichloride or dimethyl;
di-iso-propylamidoborane(2-ethyl-4-(3′,5′-bistrifluoromethyl-4′-methoxyphenyl)indenyl)(2-n-hexyl-4-(o-biphenyl)indenyl)Zr dichloride or dimethyl;
di-iso-propylamidoborane(2-propyl-4-(3′,5′-bistrifluoromethyl-4′-methoxyphenyl)indenyl)(2-n-hexyl-4-(o-biphenyl)indenyl)Zr dichloride or dimethyl;
di-iso-propylamidoborane(2-butyl-4-(3′,5′-bistrifluoromethyl-4′-methoxyphenyl)indenyl)(2-n-hexyl-4-(o-biphenyl)indenyl)Zr dichloride or dimethyl;
di-iso-propylamidoborane(2-methyl-4-(3′,5′-di-iso-propyl-4′-methoxyphenyl)indenyl)(2-n-hexyl-4-(o-biphenyl) indenyl)Zr dichloride or dimethyl;
di-iso-propylamidoborane(2-ethyl-4-(3′,5′-di-iso-propyl-4′-methoxyphenyl)indenyl)(2-n-hexyl-4-(o-biphenyl) indenyl)Zr dichloride or dimethyl;
di-iso-propylamidoborane(2-propyl-4-(3′,5′-di-iso-propyl-4′-methoxyphenyl)indenyl)(2-n-hexyl-4-(o-biphenyl)indenyl)Zr dichloride or dimethyl;
di-iso-propylamidoborane(2-tert-butyl-4-(3′,5′-di-iso-propyl-4′-methoxyphenyl)indenyl)(2-n-hexyl-4-(o-biphenyl)indenyl)Zr dichloride or dimethyl;
di-iso-propylamidoborane(2-methyl-4-(3′,5′-diphenyl-4′-methoxyphenyl)indenyl)(2-n-hexyl-4-(o-biphenyl)indenyl)Zr dichloride or dimethyl;
di-iso-propylamidoborane(2-ethyl-4-(3′,5′-di-phenyl-4′-methoxyphenyl)indenyl)(2-n-hexyl-4-(o-biphenyl)indenyl)Zr dichloride or dimethyl;
di-iso-propylamidoborane(2-propyl-4-(3′,5′-diphenyl-4′-methoxyphenyl)indenyl)(2-n-hexyl-4-(o-biphenyl)indenyl)Zr dichloride or dimethyl;
di-iso-propylamidoborane(2-butyl-4-(3′,5′-diphenyl-4′-methoxyphenyl)indenyl)(2-n-hexyl-4-(o-biphenyl)indenyl)Zr dichloride or dimethyl;
bis(trimethylsilyl)amidoborane(2-methyl-4-(3′,5′-di-tert-butyl-4′-methoxyphenyl)indenyl)(2-n-hexyl-4-(o-biphenyl)indenyl)Zr dichloride or dimethyl;
bis(trimethylsilyl)amidoborane(2-ethyl-4-(3′,5′-di-tert-butyl-4′-methoxyphenyl)indenyl)(2-n-hexyl-4-(o-biphenyl)indenyl)Zr dichloride or dimethyl;
bis(trimethylsilyl)amidoborane(2-propyl-4-(3′,5′-di-t-butyl-4′-methoxyphenyl)indenyl)(2-n-hexyl-4-(o-biphenyl)indenyl)Zr dichloride or dimethyl;
bis(trimethylsilyl)amidoborane(2-butyl-4-(3′,5′-di-tert-butyl-4′-methoxyphenyl)indenyl)(2-n-hexane,4-(o-biphenyl)indenyl)Zr dichloride or dimethyl;
bis(trimethylsilyl)amidoborane(2-methyl-4-(3′,5′-bis-trifluoromethyl-4′-methoxyphenyl)indenyl)(2-n-hexane,4-(o-biphenyl)indenyl)Zr dichloride or dimethyl;
bis(trimethylsilyl)amidoborane(2-ethyl-4-(3′,5′-bis-trifluoromethyl-4′-methoxyphenyl)indenyl)(2-n-hexane,4-(o-biphenyl)indenyl)Zr dichloride or dimethyl;
bis(trimethylsilyl)amidoborane(2-propyl-4-(3′,5′-bis trifluoromethyl-4′-methoxyphenyl)indenyl)(2-n-hexane,4-(o-biphenyl)indenyl)Zr dichloride or dimethyl;
bis(trimethylsilyl)amidoborane(2-butyl-4-(3′,5′-bis-trifluorometllyl-4′-methoxyphenyl)indenyl)(2-n-hexane,4-(o-biphenyl)indenyl)Zr dichloride or dimethyl;
bis(trimethylsilyl)amidoborane(2-methyl-4-(3′,5′-di-iso-propyl-4′-methoxyphenyl)indenyl)(2-n-hexane,4-(o-biphenyl)indenyl)Zr dichloride or dimethyl;
bis(trimethylsilyl)amidoborane(2-ethyl-4-(3′,5′-di-iso-propyl-4′-methoxyphenyl)indenyl)(2-n-hexane,4-(o-biphenyl)indenyl)Zr dichloride or dimethyl;
bis(trimethylsilyl)amidoborane(2-propyl-4-(3′,5′-di-iso-propyl-4′-methoxyphenyl)indenyl)(2-n-hexane,4-(o-biphenyl)indenyl)Zr dichloride or dimethyl;
bis(trimethylsilyl)amidoborane(2-butyl-4-(3′,5′-di-iso-propyl-4′-methoxyphenyl)indenyl)(2-n-hexane,4-(o-biphenyl)indenyl)Zr dichloride or dimethyl;
bis(trimethylsilyl)amidoborane(2-methyl-4-(3′,5′-diphenyl-4′-methoxyphenyl)indenyl)(2-n-hexane,4-(o-biphenyl)indenyl)Zr dichloride or dimethyl;
bis(trimethylsilyl)amidoborane(2-ethyl-4-(3′,5′-diphenyl-4′-methoxyphenyl)indenyl)(2-n-hexane,4-(o-biphenyl)indenyl)Zr dichloride or dimethyl;
bis(trimethylsilyl)amidoborane(2-propyl-4-(3′,5′-diphenyl-4′-methoxyphenyl)indenyl)(2-n-hexane,4-(o-biphenyl)indenyl)Zr dichloride or dimethyl; and
bis(trimethylsilyl)amidoborane(2-butyl-4-(3′,5′-diphenyl-4′-methoxyphenyl)indenyl)(2-n-hexane,4-(o-biphenyl)indenyl)Zr dichloride or dimethyl;
dimethylsilandiyl bis(2-methyl-4-phenyl-indenyl)Zr dichloride or dimethyl;
dimethylsilandiyl bis(2-methyl-4-(3′,5-di-t-butylphenyl)indenyl)Zr dichloride or dimethyl;
dimethylsilandiyl bis(2-methyl-4-(3′,5-di-t-butyl-4-methoxyphenyl)indenyl)Zr dichloride or dimethyl
dimethylsilandiyl bis(2-methyl-4-(4′-t-butylphenyl)indenyl) Zr dichloride or dimethyl;
dimethylsilandiyl bis(2-ethyl-4-phenyl-indenyl)Zr dichloride or dimethyl;
dimethylsilandiyl bis(2-ethyl-4-(3′,5-di-t-butylphenyl)indenyl)Zr dichloride or dimethyl;
dimethylsilandiyl bis(2-ethyl-4-(3′,5-di-t-butyl-4-methoxyphenyl)indenyl)Zr dichloride or dimethyl
dimethylsilandiyl bis(2-ethyl-4-(4′-t-butylphenyl)indenyl) Zr dichloride or dimethyl;
dimethylsilandiyl bis(2-propyl-4-phenylindenyl) Zr dichloride or dimethyl;
dimethylsilandiyl bis(2-propyl-4-(3′,5-di-t-butylphenyl)indenyl)Zr dichloride or dimethyl;
dimethylsilandiyl bis(2-propyl-4-(3′,5-di-t-butyl-4-methoxyphenyl)indenyl)Zr dichloride or dimethyl
dimethylsilandiyl bis(2-propyl-4-(4′-t-butylphenyl)indenyl) Zr dichloride or dimethyl;
dimethylsilandiyl bis(2-isopropyl-4-phenylindenyl) Zr dichloride or dimethyl;
dimethylsilandiyl bis(2-isopropyl-4-(3′,5-di-t-butylphenyl)indenyl)Zr dichloride or dimethyl;
dimethylsilandiyl bis(2-isopropyl-4-(4′-t-butylphenyl)indenyl) Zr dichloride or dimethyl;
dimethylsilandiyl bis(2-cyclopropyl-4-phenylindenyl) Zr dichloride or dimethyl;
dimethylsilandiyl bis(2-cyclopropyl-4-(3′,5-di-t-butylphenyl)indenyl)Zr dichloride or dimethyl;
dimethylsilandiyl bis(2-cyclopropyl-4-(4′-t-butylphenyl)indenyl) Zr dichloride or dimethyl;
dimethylsilandiyl bis(2-butyl-4-phenylindenyl) Zr dichloride or dimethyl;
dimethylsilandiyl bis(2-butyl-4-(3′,5-di-t-butylphenyl)indenyl)Zr dichloride or dimethyl;
dimethylsilandiyl bis(2-butyl-4-(4′-t-butylphenyl)indenyl) Zr dichloride or dimethyl;
dimethylsilandiyl bis(2-methyl-4-(2′-methylphenyl)indenyl)Zr dichloride or dimethyl;
dimethylsilandiyl bis(2-isopropyl-4-(2′-methylphenyl)indenyl)Zr dichloride or dimethyl;
dimethylsilandiyl bis(2-methyl-4-carbozolindenyl)Zr dichloride or dimethyl; and
dimethylsilandiyl bis(2-isopropyl-4-carbozolindenyl)Zr dichloride or dimethyl.

Useful examples of bridging C₁ metallocenes include;

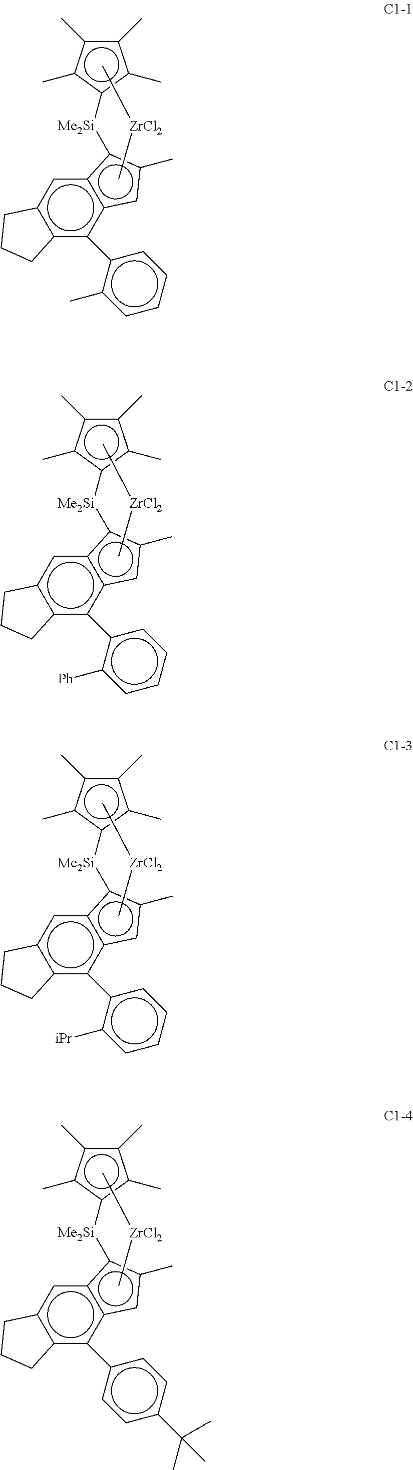

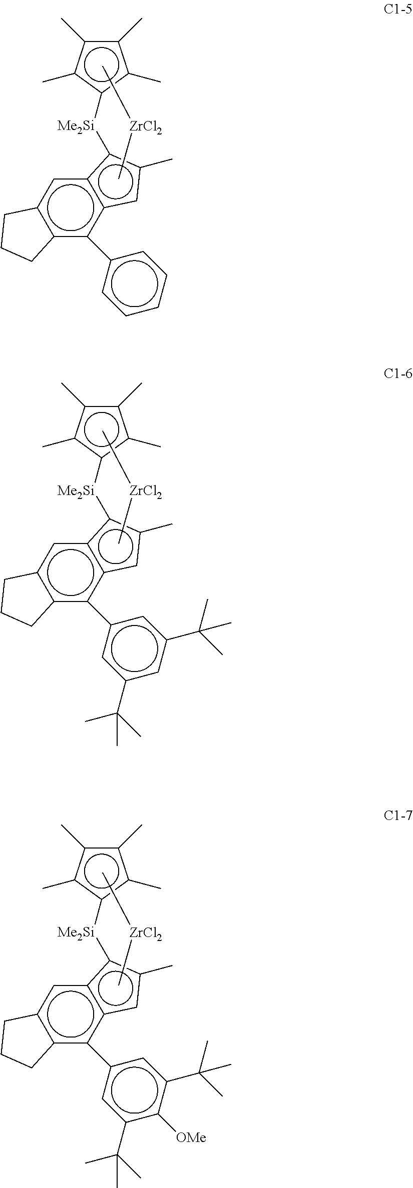

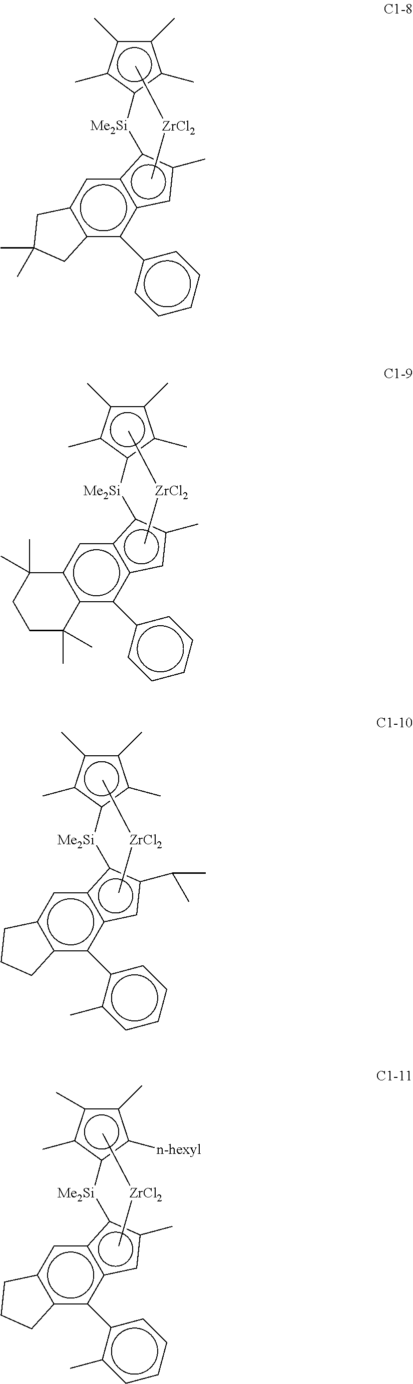

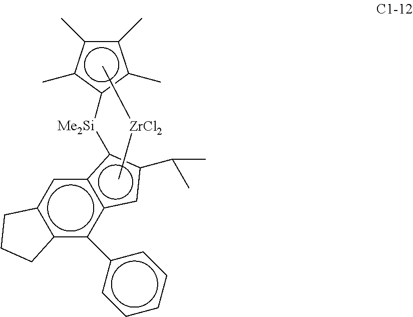

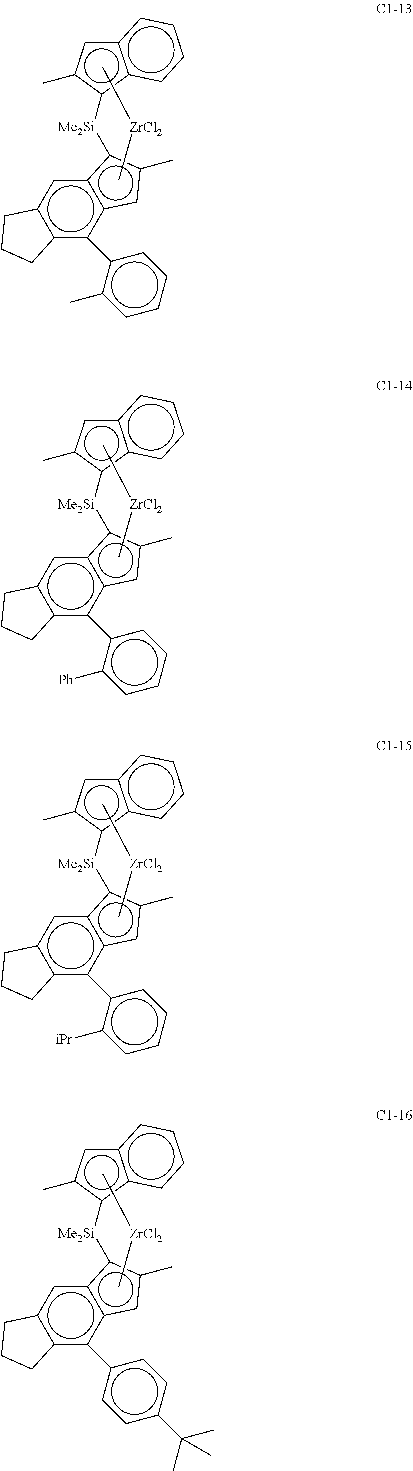

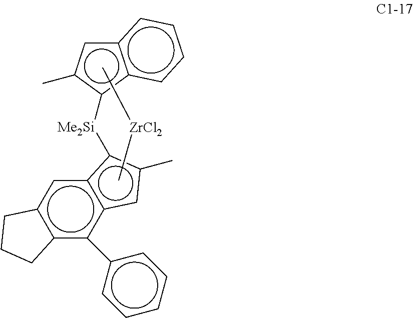

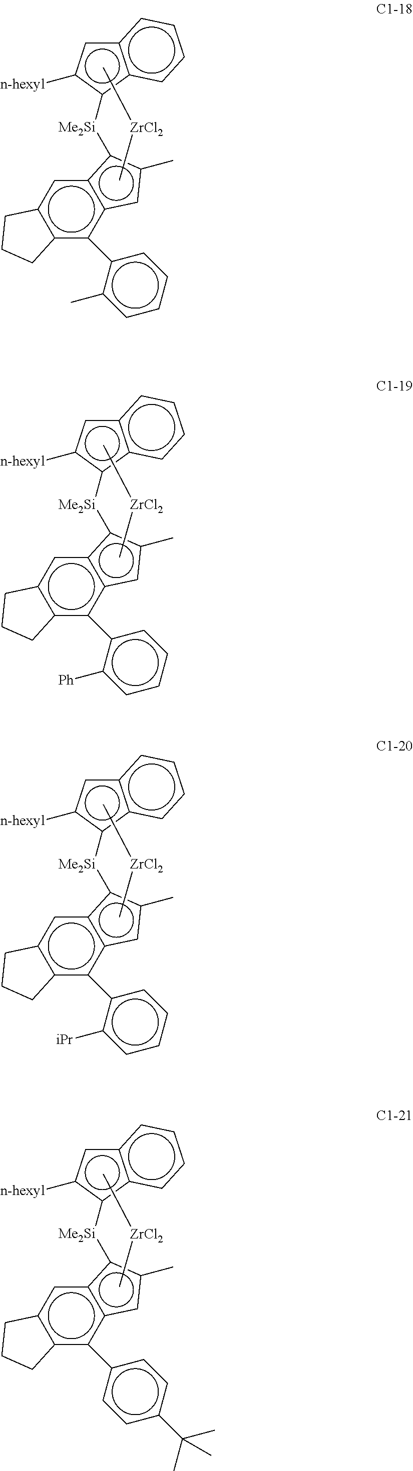

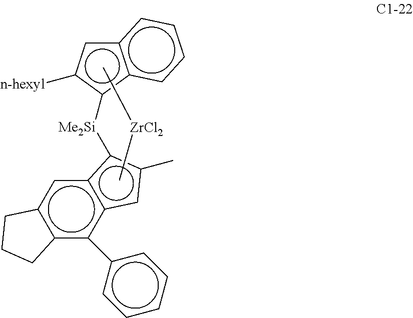

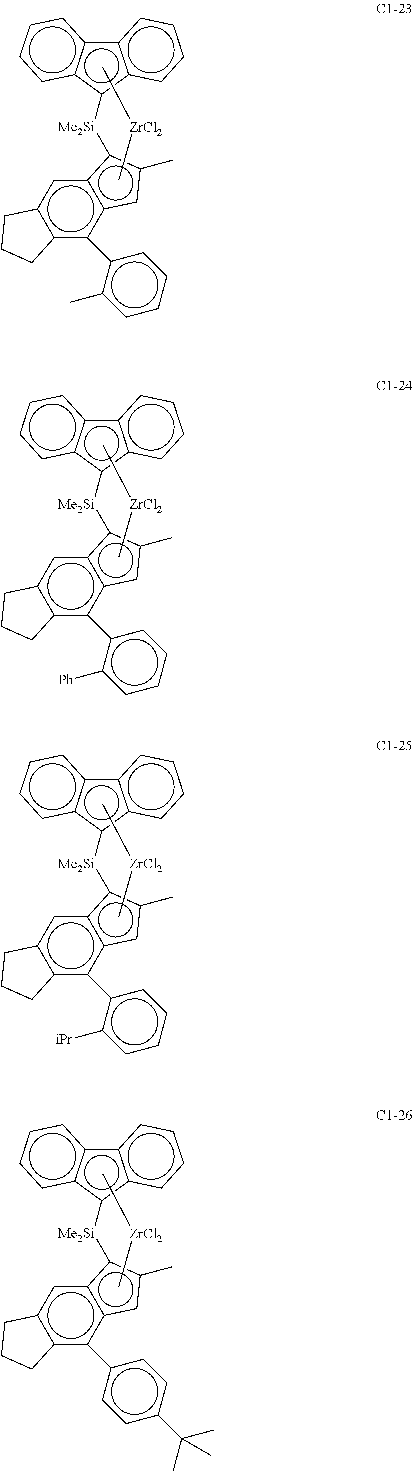

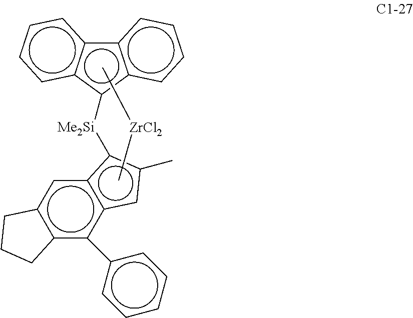

Useful examples of bridging Cₛ metallocenes include:
diphenylmethylene(cyclopentadienyl)(9-fluorenyl)zirconium dichloride,
diphenylmethylene(cyclopentadienyl)(9-fluorenyl)zirconium dimethyl,
methylene-(cyclopentadienyl)(9-fluorenyl)zirconium dichloride,
methylene-(cyclopentadienyl)(9-fluorenyl)zirconium dimethyl,
dimethylmethylene(cyclopentadienyl)(9-fluorenyl)zirconium dichloride,
dimethylmethylene(cyclopentadienyl)(9-fluorenyl)zirconium dimethyl,
dimethylsilylene(cyclopentadienyl)(9-fluorenyl)zirconium dichloride,
dimethylsilylene(cyclopentadienyl)(9-fluorenyl)zirconium dimethyl,
diphenylsilylene(cyclopentadienyl)(9-fluorenyl)zirconium dichloride,
diphenylsilylene(cyclopentadienyl)(9-fluorenyl)zirconium dimethyl,
ethylene-(cyclopentadienyl)(9-fluorenyl)zirconium dichloride,
ethylene-(cyclopentadienyl)(9-fluorenyl)zirconium dimethyl,
di(para-triethylsilylphenyl)methylene(2,7-di-tert-butylfluorenyl)(cyclopentadienyl)zirconium dichloride,
di(para-triethylsilylphenyl)methylene(2,7-di-tert-butylfluorenyl)(cyclopentadienyl)zirconium dimethyl,
diphenylmethylene(cyclopentadienyl)(9-fluorenyl)zirconium dichloride
diphenylmethylene(cyclopentadienyl)(9-fluorenyl)zirconium dimethyl,
methylene(cyclopentadienyl)(9-fluorenyl)zirconium dichloride,
methylene(cyclopentadienyl)(9-fluorenyl)zirconium dimethyl,
dimethylmethylene(cyclopentadienyl)(9-fluorenyl)zirconium dichloride,
dimethylmethylene(cyclopentadienyl)(9-fluorenyl)zirconium dimethyl,
dimethyl-silylene(cyclopentadienyl)(9-fluorenyl)zirconium dichloride,
dimethyl-silylene(cyclopentadienyl)(9-fluorenyl)zirconium dimethyl,
diphenylsilylene-(cyclopentadienyl)(9-fluorenyl)zirconium dichloride,
diphenylsilylene-(cyclopentadienyl)(9-fluorenyl)zirconium dimethyl,
ethylene(cyclopentadienyl)(9-fluorenyl)zirconium dichloride,
ethylene(cyclopentadienyl)(9-fluorenyl)zirconium dimethyl,
di(para-triethylsilylphenyl)methylene(2,7-di-tert-butyl fluorenyl)(cyclopentadienyl) zirconium dichloride,
and di(para-triethylsilylphenyl)methylene(2,7-di-tert-butyl fluorenyl)(cyclopentadienyl) zirconium dimethyl.

Useful examples of post-metallocene as Catalyst I for isotactic polypropolyene based matrix phase formation include:

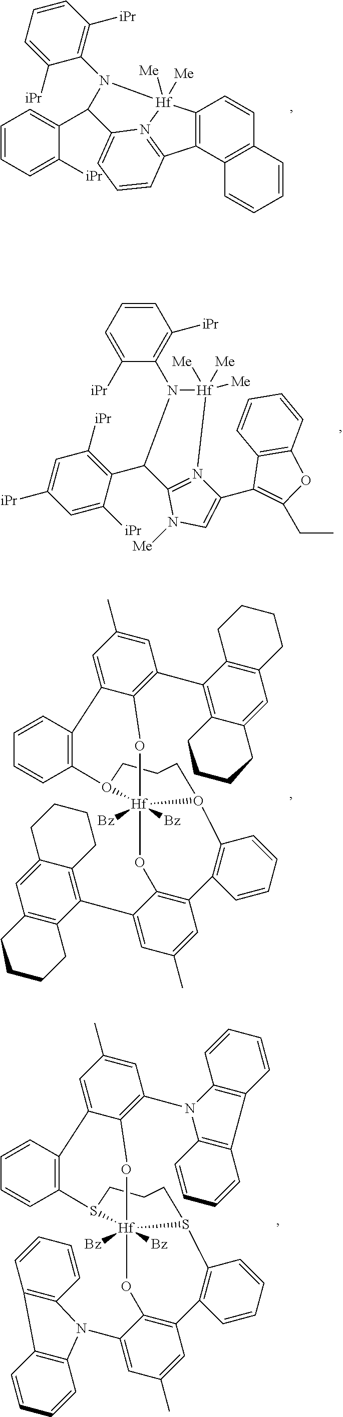

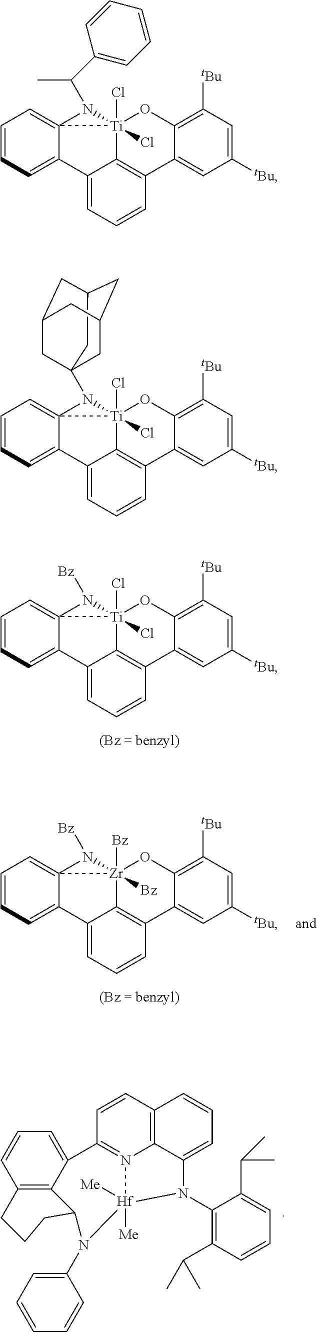

Useful examples of post-metallocene as Catalyst I for syndiotactic polypropolyene based matrix phase formation include

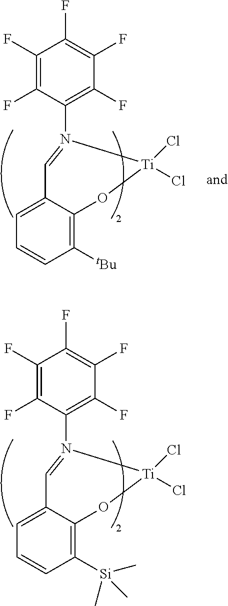

when the activator is an alumoxane, such as MAO (see H. Makio, et al, Chem. Rev., 2011, 111, 2363-2449).

### Catalyst Combinations

Many combinations of catalyst pairs can be used to produce reactor-made vulcanizable hetero-phasic copolymer containing at least one matrix phase with Tm 100° C. or higher and at least one vulcanizable elastomer or plastomer phase.

In at least one embodiment of the invention the catalyst system useful herein comprises the product of a metallocene or post-metallocene capable of producing polyethylene matrix phase with Tm 100° C. or higher as Catalyst I and a mono-Cp catalyst, a Cs bis-Cp catalyst, or a C₁ bis-Cp catalyst capable of producing vulcanizable elastomer or plastomer phase as Catalyst II.

In at least one embodiment of the invention the catalyst system useful herein comprises the product of a C₂, C₁, or Cₛ metallocene or a post-metallocene capable of producing isotactic or syndiotatic polypropylene matrix phase with Tm 100° C. or higher as Catalyst I and a mono-Cp catalyst, a Cₛ bis-Cp catalyst, or a C1 bis-Cp catalyst capable of producing vulcanizable elastomer or plastomer phase as Catalyst II.

In another embodiment of the invention the catalyst system useful herein comprises the product of a group 4 metallocene catalyst represented by Formula (I):

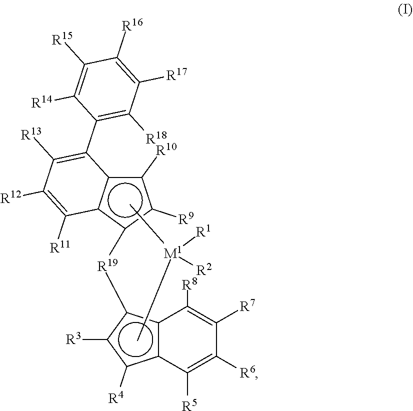

wherein:

M¹ is selected from the group consisting of titanium, zirconium, hafnium, vanadium, niobium, tantalum, chromium, molybdenum and tungsten;

R¹ and R² are independently hydrogen, halogen, hydroxyl, hydrocarbyl, or substituted hydrocarbyl;

each of R³ and R⁹ is independently linear alkyl;

each of R³, R⁴, R⁶, R⁷, R⁸, R¹⁰, R¹¹, R¹², and R¹³ is independently hydrogen, halogen, C₁-C₄₀ hydrocarbyl or C₁-C₄₀ substituted hydrocarbyl, —NR′₂, —SR′, —OR, —OSiR′₃, —PR′₂, wherein each R′ is hydrogen, halogen, C₁-C₁₀ alkyl, or C₆-C₁₀ aryl;

R⁵ is hydrogen, halogen, C₁-C₄₀ hydrocarbyl or C₁-C₄₀ substituted hydrocarbyl, —NR′₂, —R′, —OR, —OSiR′₃, —PR′₂, wherein each R′ is hydrogen, halogen, C₁-C₁₀ alkyl, or C₆-C₁₀ aryl, or two or more adjacent radicals R⁵ to R⁸ together form one or more saturated or unsaturated rings;

R¹⁹ is —B(R²⁰)—, —Al(R²⁰)—, —O—, —S—, —SO—, —SO₂—, —N(R²⁰)—, —CO—, —P(R²⁰)—, or —P(O)(R²⁰)—, —B—NR²⁰₂— radical or one of the following:

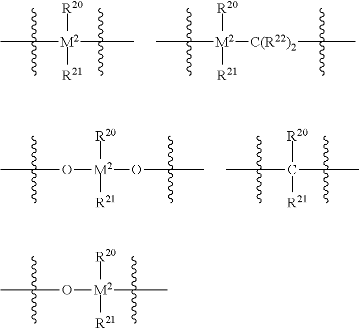

wherein each of R²⁰, R²¹, and R²² is independently hydrogen, halogen, C₁-C₂₀ alkyl, C₁-C₂₀ fluoroalkyl or sila-alkyl, C₆-C₃₀ aryl, C₆-C₃₀ fluoroaryl, C₁-C₂₀ alkoxy, C₂-C₂₀ alkenyl, C₇-C₄₀ arylalkyl, C₈-C₄₀ arylalkenyl, C₇-C₄₀ alkylaryl, or one R²⁰ and one R²¹, together with the atoms in R¹⁹ connecting them, form one or more rings; M² is one or more carbons, silicon, germanium or tin;

R¹⁴ is substituted or unsubstituted C₆-C₁₀ aryl;

R¹⁸ is hydrogen, halogen, substituted or unsubstituted C₃-C₂₀ alkyl, substituted or unsubstituted C₆-C₄₀ aryl, C₂-C₁₀ alkenyl, —NR′₂, —SR′, —OR, —OSiR′₃ or —PR′₂, wherein each R′ is hydrogen, halogen, C₁-C₁₀ alkyl, or C₆-C₁₀ aryl;

R¹⁵ and R¹⁷ are independently hydrogen, C₂-C₂₀ alkyl which may be substituted, C₆-C₄₀ aryl which may be substituted, or C₂-C₁₀ alkenyl; and

R¹⁶ is selected from hydrogen, halogen, C₁-C₁₀ alkyl which may be substituted, C₆-C₂₀ aryl which may be substituted, C₂-C₁₀ alkenyl which may be substituted, or two or more adjacent radicals R¹⁵ to R¹⁸ together form one or more rings, and —XR′ₙ, wherein X is a group 14-17 heteroatom having an atomic weight of 13 to 79 and R′ is one of hydrogen, halogen, C₁-C₁₀ alkyl, or C₆-C₁₀ aryl and n is 0, 1, 2, or 3; and

a group 4 metallocene catalyst represented by Formula (II):

T_{y}CpₘMGₙX_{q} (II)

wherein:

Cp is independently a substituted or unsubstituted cyclopentadienyl ligand or substituted or unsubstituted ligand isolobal to cyclopentadienyl such as indenyl, fluorenyl, tetrahydro-as-indacenyl an tetrahydro-s-indacenyl;

M is a group 4 transition metal;

G is a heteroatom group represented by the formula JR*_{z}, wherein J is N, P, O or S, and R* is a linear, branched, or cyclic C₁-C₂₀ hydrocarbyl, and z is 1 or 2;

T is a bridging group (and may be as defined for bridging group T above, such as for T in Formula (B));

y is 0 or 1;

X is a leaving group;

m=1;

n=1, 2 or 3;

q=0, 1, 2 or 3; and

the sum of m+n+q is equal to the oxidation state of the transition metal.

The molar ratio of a Catalyst I to a Catalyst II can vary depending on the balance of processability versus physical characteristics of the desired polymer. For example, the molar ratio (I):(II) can range from 20:1 to 1:1, such as from 1:1 to 20:1, such as from 1:1 to 1:3, such as from 1:1 to 1:2, for example 1:2, such as for example 10:1 to 1:4.

### Rubber Growth Mechanism in a Stiff Porous Matrix and the Support Materials

The multiple catalyst systems used herein produce heterophasic copolymer compositions having both a matrix phase and a fill phase. The rubber fill capability of the generated matrix (stiff) phase is related to the structure of the support materials. Based on the rubber growing behavior observed through the studies on Ziegler-Natta catalyst systems in impact copolymer application (Nello Pasquini (Ed.), Polypropylene Handbook, 2^{nd} Edition, Hanser Publisher, Munich (2005), p 75-89 and references cited therein), after the formation of the 1^{st} stage polymerization that generates the stiff matrix (such as iPP) as subglobules inside a polymer granule (such as an iPP granule), the 2^{nd} stage EP rubber polymerization generates a rubber phase that coats outside the subglobules.

The experimental observation of rubber growing outside the iPP sub-globules indicate that there should be a thickness threshold of the rubber layer to determine the reactor operable granule stickiness. The reactor operable granule stickiness is also related to the polymerization conditions such as the reaction temperature. For instance, at a higher temperature, the same thickness rubber layer becomes stickier. Therefore, at a higher temperature, the rubber layer thickness threshold should be thinner, i.e., the rubber fill capability is lower. Above the threshold the granules in the reactor may become so sticky that they may agglomerate and cause the reactor fouling. Therefore, it is expected that a sub-particle containing support with a higher sub-particle surface area (i.e., smaller sub-particles) and with larger main particle size (i.e., deeper pores and smaller granule contact area), the rubber layer thickness (i.e., the stickiness threshold) can remain the same but the rubber fill capability can be largely increased.

The surface area of a support should be at least 400 m²/g and the particle size should be at least 50 μm, preferably with desired small and uniform sub-particle sizes to have good rubber fill capability.

However, the support structure of choice should not only consider the rubber fill capability, but also other support structure related properties such as the reactor operability, the catalyst activity, the Mw control, the practical support material production conditions, and the support material handling (mainly the mechanical strength related to the main particle integrity during the catalyst preparation process and the transportation process). For example, the mechanical strength of a porous silica is determined by the “wall thickness” between pores, i.e., the more porous the structure, the weaker the mechanical strength if the pore diameter is remained the same. To maintain the mechanical strength while increasing the surface area, the pore diameter should be reduced. However, there is a limit for the pore diameter reduction. For instance, to allow the oligomeric activator MAO to enter the pores, the pore diameter should be larger than 5 nm (Luo, et al, WO 2016/195876). Pore diameters too close to this value, e.g., 6 nm (such as for Asahi silica D150-60A), MAO solid can be pushed out of the pores to form another solid phase containing only small solid MAO particles, presumably due to the heat expansion. These small, low pore solid MAO particles are poor for hetero-phasic copolymer, e.g., iPP-EPDM construction. Pores should therefore be large enough not only for MAO molecules to enter, but also for catalyst precursor to attach to MAO, and for monomers to move in without mass transfer limit to allow the desired polymerization to occur in the pores. To compromise these factors, the surface area should is typically limited in the range of 400 m²/g-800 m²/g and the pore diameter in the range of 6 nm-20 nm, wherein a higher end surface area in the range matching a lower end pore diameter in the range or a lower end surface in the range matching a higher end pore diameter in the range is more preferred. Using the BET particle porosity method, when the surface area and the pore diameter are determined, the pore volume PV can be calculated, e.g., PD (angstrom, Å)=40,000*PV (mL/g)/SA (m²/g). When the surface area is at the highest end (800 m²/g) it is optimally paired with the lowest end of pore diameter (60A or 6 nm) to maintain a reasonable mechanical strength, the PV is calculated as about 1.2 mL/g; and when the surface area is at the lowest end 400 m²/g, it can allow a higher pore diameter 200A or 20 nm, the PV is about 2 mL/g, to maintain a similar mechanical strength, although the mechanical strength is also determined by other factors, such as the method for the support material construction. It should be understood that through a milder preparation operation, especially in some preparation methods where a mechanical stirrer is not required, e.g., the column chromatography method that allows the silica be packed in a column to absorb MAO activated metallocene from the MAO activated metallocene solution by passing the solution through the silica column, more fragile silica can be used, e.g., silica with a surface area of 800 m²/g can have pore diameter 8 nm or higher. For the particle size consideration, increasing the particle size can decrease the heat removal efficiency in the center of the particles during polymerization. Increasing heat removal difficulty is observed as the polymer granule growing larger and larger. Poor heat removal efficiency can cause the actual polymerization temperature in the particle center significantly higher than the environmental temperature (i.e., the reactor temperature) and melt the granules, which may cause the agglomeration of particles to result in reactor fouling. Significantly higher polymerization temperature may also reduce the polymer molecular weight significantly.

Therefore, in term of main particles in the present disclosure, the useful particle size range is 30 μm-200 μm; such as 50 μm-150 μm, such as 70 μm-100 μm. For a more active finished catalyst system, a lower end in the particle size range is selected.

In term of sub-particles, smaller sub-particles with more uniform size distribution are desired; however, the cost and production operability may limit the size to go very small and the distribution to go very narrow. More practical average sub-particle size range is in the range of 0.01 μm to 50 μm, e.g., 0.1 μm-50 μm. A sieving process may be applied to eliminate fines or large particles or both to obtain a narrower distribution of the sub-particles.

And in terms of primary particles, since the catalyst species cannot enter inside the particle due to the very small pore or non-pore structure but attach to the outside the particle surface, the smaller the primary particle size, the more outside surface area for the catalyst species to attach. There is a compromise of the practical catalyst loading to determine the primary particle size range. The useful primary particle size range is about 1 nm to 100 nm; such as 5 nm-50 nm.

Sub-particles in a main particle can form through a variety of methods; they can form by any processes that are able to agglomerate the primary particles to form relatively small particles (sub-particles) and then further agglomerate to form the larger particles (main particles); or through a disagglomeration process, e.g., grinding, to break regular main particles into smaller particles (sub-particles) and then re-agglomerate, e.g., spray drying, to form the larger sub-particle containing main particles. Particles with dominant micro-pores or without pore, e.g., the fumed silica, can be used as the primary particles to construct main particles or sub-particles through certain agglomeration process; e.g., they can be held together by certain adhesion through either the chemically bonding or the physically binding, i.e., characterized by weak interactions such that the mechanical strength of the main particles can be controlled for the majority or all of the particles to become non-fragmentable when applying only a limited mechanical force, e.g., during a catalyst preparation process or a transportation process, but to become fragmentable in the polymerization process where polymer growing expansion occurs to force the desired fragmentation. Both the meso-pore size and macro-pore size and their distributions are closely related to the catalyst operability in a polymerization reactor, e.g., density and flowability, the polymerization activity, and the rubber fill capability, etc. Pores inside a regular main particle, i.e., the gaps formed among the agglomerated primary particles, are in the mesopore range (2 nm-50 nm) if the primary particles have a size range in about 5 nm-50 nm (e.g., 10 nm-40 nm). Pores inside a sub-particle containing main particle can have two types, one from the gaps formed among the agglomerated primary particles and the other from the gaps formed among the agglomerated sub-particles. If the sub-particle size is in the range of about 0.01 μm-20 μm (e.g., 0.05 μm-0.60 μm or 1 μm-20 μm), the gaps among the agglomerated sub-particles can form pores in the macropore range (>50 nm, IUPAC definition).

Except high surface area (i.e., highly porous) and larger particle size (i.e., deeper pores and smaller rubber contact area) requirements that are related to the rubber fill capability, another important factor is that the active catalyst debris should locate on the pore surface of the porous (sponge like) stiff matrix phase formed in the stiff phase polymerization stage to allow at least the majority of the rubber phase to grow inside the pores. The sub-particles are considered to serve as the template to grow stiff phase subglobules with catalyst debris on the subglobule surface, which is now in the macro-pore (gaps among agglomerated sub-particles) derived pores of the stiff phase that are readily for rubber growth under rubber polymerization conditions, as shown in Scheme 3.

In embodiments according to the present disclosure, the catalyst system may comprise porous solid particles, with structure as described above, as an inert support material to which the catalyst precursor compound and/or activator may be anchored, bound, adsorbed or the like. In at least one embodiment, the support material is an inorganic oxide in a finely divided form. Suitable inorganic oxide materials for use in MCN catalyst systems herein include periodic groups 2, 4, 13, and 14 metal oxides, such as silica, alumina, magnesia, titania, zirconia, and the like, and mixtures thereof. Other suitable support materials, however, can be employed, for example, finely divided functionalized polyolefins, such as finely divided polyethylene or polypropylene. Particularly useful supports include silica, magnesia, titania, zirconia, montmorillonite, phyllosilicate, zeolites, talc, clays, and the like. Also, combinations of these support materials may be used, for example, silica-chromium, silica-alumina, silica-titania, and the like.

In at least one embodiment of the invention, the support material can comprise silica, e.g., amorphous silica, which may include a hydrated surface presenting hydroxyl or other groups which can be deprotonated to form reactive sites to anchor activators and/or catalyst precursors. Other porous support materials may optionally be present with the silica as a co-support, for example, alumina, talc, other inorganic oxides, zeolites, clays, organoclays, or any other organic or inorganic support material and the like, or mixtures thereof.

The support materials of at least one embodiment of the present disclosure, unexpectedly, are generally resistant to agitation fragmentation or expansion fragmentation during calcination temperatures. In at least one embodiment, the support can be calcined essentially free of fragmentation, i.e., the particle size distribution is not changed significantly and/or less than 5 vol % of primary particles (if present) and/or fines is generated, by total volume of the support material.

In at least one embodiment of the present disclosure, the support material is then contacted with the activator (described in more detail below), at least one Catalyst I, at least one Catalyst II, and/or cocatalyst (described in more detail below), and optionally a scavenger or co-activator (described in more detail below).

In at least one embodiment, the support in, and/or used to prepare, the catalyst system, can have the following:

40% or greater of the incremental pore volume comprised of pores having a pore diameter larger than 100 Angstroms or greater (incremental pore volume is determined using a MICROMERITICS ASAP 2420 Surface Area and Porosity Analyzer and plotting pore volume distribution versus pore diameter. For each silica sample, the sum of the incremental pore volumes with pore diameters larger than 100 angstrom are divided by the total pore volumes to obtain the percentage of the incremental pore volume having pore diameters larger than about 100 angstrom);

sub-particles having an average particle size in the range of 0.01 μm to 5 μm;
a) an average main particle size (PS) and/or a PS mode of more than 30 μm, or more than 40 μm, or more than 50 μm, or more than 60 μm, or more than 65 μm, or more than 70 μm, or more than 75 μm, or more than 80 μm, or more than 85 μm, or more than 90 μm, or more than 100 μm, or more than 120 μm; and/or up to 200 μm, or less than 180 μm, or less than 160 μm, or less than 150 μm, or less than 130 μm; e.g., 50-200 μm, or 60-200 μm;
b) a pore volume (PV) from at least 0.5 mL/g; and/or up to 2 mL/g, or less than 1.6 mL/g, or less than 1.5 mL/g, or less than 1.4 mL/g, e.g., 1.3-2 mL/g, or 1.4-1.6 mL/g, or 1.3-1.8 mL/g;
c) a specific surface area (SA) of less than 800 m²/g, or less than 750 m²/g, or less than 700 m²/g, or less than 650 m²/g; and/or more than 400 m²/g, or more than 600 m²/g, or more than 650 m²/g, or more than 700 m²/g; e.g., 400-800 m²/g, or 600-800 m²/g, or 650-800 m²/g, or 700-800 m²/g, or 400-650 m²/g, or 400-800 m²/g;
d) a mean or average pore diameter (PD) greater than 7 nm, or greater than 8 nm; and/or less than 20 nm, or less than 15 nm, or less than 13 nm, or less than 12 nm, or less than 10 nm, or less than 8 nm, or less than 7 nm, or less than 6 nm; e.g., 7-8 nm, or 7-10 nm, or 7-13 nm, or 7-15 nm, or 8-15 nm, or 7-20 nm, or 8-20 nm;
e) main particles composed of a plurality of sub-particles, the sub-particles having an average PS of 10 nm to less than 50 μm, or 1 μm to less than 30 μm;
f) spray dried;
g) silica, e.g., amorphous silica and/or silica having a hydrated surface; and/or
h) any combination or sub combination thereof.

Incremental pore volume, particle size (PS), surface area (SA), pore volume (PV), and pore diameter (PD) characteristics are determined by MICROMERITICS ASAP 2420 Surface Area and Porosity Analyzer.

In at least one embodiment, the support comprises an agglomerate of a plurality of sub-particles e.g., spray dried silica. In embodiments according to the present disclosure, the support materials, in addition to meeting the PS, SA, PV, and PD characteristics, can be made from a process that agglomerates smaller sub-particles, e.g., average PS in the range of 0.01 μm-50 μm, into the larger agglomerates with average PS in the range of 30 μm-200 μm, such as those from a spray drying process. The large particles, i.e., the main particles, may thus comprise medium particles, i.e., the sub-particles; and the medium particles, i.e., the sub-particles, may thus comprise small particles, i.e., the primary particles. Either or both of the agglomerates and/or sub-particles can have high or low sphericity and roundness, e.g., a Wadell sphericity of 0.8 or more, 0.85 or more, 0.9 or more, or 0.95 or more, or less than 0.95, less than 0.90, less than 0.85, or less than 0.8; and a Wadell roundness from 0.1 or less, up to 0.9 or more. While the majority of both main particles and sub-particles can become fragmented during the polymerization process, the primary particles remain non-fragmented during the polymerization process due to their very small pore structure or non-pore structure that excludes the active catalyst to form inside the particles.

The SA, PV, and mean PD, are generally interrelated, in at least one embodiment, in that within certain ranges of these parameters the product of the mean PD and SA may be proportional to the PV. The PV, PD, and SA in at least one embodiment are selected to balance the desired mechanical strength with the desired activator loading, i.e., high SA to accommodate high activator and catalyst loading, yet not too high so as to maintain sufficient strength to avoid fragmentation during calcination or from agitation and handling, while at the same time avoiding excessive strength, which might undesirably inhibit fragmentation during polymerization in at least one embodiment. For example, the support materials in at least one embodiment have PS in the range of 30-200 μm, SA 400-800 m²/g, PV 0.5-2 mL/g, and mean PD 7-20 nm. Silicas which may be suitable according to at least one embodiment are commercially available from PQ Corporation (PD 14024 and PD13054); Asahi Glass Chemical (D 150-60A, D 100-100A, and D70-120A), and the like. This combination of property ranges is in contrast to most other silica supports used for MCN catalysts for iPP. For example, if the SA is too low, the rubber fill limit and the activity may be low; if the PV is too high, the particles may be mechanically fragile; if the PD and/or PV are too small, the result may be low activity, low porosity, low rubber fill, excess surface-deposited rubber, and/or reactor fouling; and if the PS is too large, heat removal is inefficient, monomer mobility into the interior of the polymer particle is limited, monomer concentration is insufficient, chain termination is premature, and/or low molecular weights result.

In at least one embodiment, agglomerates having, within the ranges of SA ≥400 m²/g and mean PD=7 nm-20 nm, either a lower SA, e.g., less than 700 m²/g or less than 650 m²/g, and/or a higher mean PD, e.g., more than 9 nm or more than 10 nm, have higher strength and are more resistant to debris dominated fragmentation during the supportation process, which can thus be carried out at higher temperatures, and higher catalyst loadings can be achieved for higher catalyst activity.

In at least one embodiment, on the other hand, agglomerates with SA greater than 650 m²/g or greater than 700 m²/g, and mean PD less than 8 nm or less than 7 nm, can be prepared with minimal solid MAO exclusion from the pores if MAO is used as the activator, with selected process conditions, such as low supportation reaction temperatures.

The support material can be used wet, i.e., containing adsorbed water, or dry, that is, free of absorbed water. The amount of absorbed water can be determined by standard analytical methods, e.g., LOD (loss of drying) from an instrument such as LECO TGA 701 under conditions such as 300° C. for 3 hours. In at least one embodiment, wet support material (without calcining) can be contacted with the activator or another organometallic compound as otherwise described below, with the addition of additional organometallic or other scavenger compound that can react with or otherwise remove the water, such as a metal alkyl. For example, contacting wet silica with an aluminum alkyl such as AlMe₃, usually diluted in an organic solvent such as toluene, forms in-situ MAO, and if desired additional MAO can be added to control the desired amount of MAO loaded on the support, in a manner otherwise similar as described below for dry silica.

Drying of the support material can be effected according to at least one embodiment by heating or calcining above about 100° C., e.g., from about 100° C. to about 1,000° C., such as at least about 200° C. When the support material is silica, it can be heated to at least 130° C., such as about 130° C. to about 850° C., such as at about 200° C.-600° C.; and for a time of 1 minute to about 100 hours, e.g., from about 12 hours to about 72 hours, or from about 24 hours to about 60 hours. The calcined support material in at least one embodiment comprises at least some groups reactive with an organometallic compound, e.g., reactive hydroxyl (OH) groups to produce the supported catalyst systems.

Supportation: According to at least one embodiment, the support is treated with an organometallic compound to react with deprotonated reactive sites on the support surface. In general the support is treated first with an organometallic activator, such as MAO, and then the supported activator is treated with a Catalyst I and/or Catalyst II, optional metal alkyl co-activator, as in the following discussion for illustrative purposes, although the catalyst(s) and or co-activator(s) can be loaded first, followed by contact with the other catalyst system components, especially where the activator is not an organometallic compound or otherwise reactive with the support surface.

The support material in at least one embodiment, having reactive surface groups, typically hydroxyl groups, e.g., after calcining (or metal alkyl treatment, e.g., in the wet process), is slurried in a non-polar solvent and contacted with the organometallic compound (activator in this example), such as dissolved in the solvent, such as for a period of time in the range of from about 0.5 hours to about 24 hours, from about 2 hours to about 16 hours, or from about 4 hours to about 8 hours. Suitable non-polar solvents are materials in which, other than the support material and its adducts, all of the reactants used herein, i.e., the activator, and the MCN compound, are at least partially soluble and which are liquid at reaction temperatures. Exemplary non-polar solvents are alkanes, such as isopentane, hexane, n-heptane, octane, nonane, and decane, although a variety of other materials including cycloalkanes, such as cyclohexane, aromatics, such as benzene, toluene, and ethylbenzene, may also be employed.

The mixture of the support material and activator (or other organometallic compound) in various embodiments may generally be heated or maintained at a temperature of from about −60° C. up to about 130 or 140° C., such as, for example: about 40° C. or below, about 23° C. or below, about −20° C. or below; from about 10° C. or 20° C. up to about 60° C. or about 40° C.; 23° C. or about 25° C. or above; or from about 40° C., about 60° C., or about 80° C. up to about 100° C., or about 120° C. Where the support may be susceptible to fragmentation during activator/catalyst precursor supportation (e.g., SA ≥650 m²/g, PD≤7 nm), fragmentation can be controlled through the manipulation of reaction conditions to inhibit fragmentation such as at a lower reaction temperature, e.g., −60° C.-40° C., such as −20° C.-30° C., to achieve <10 vol % fragmented particles, such as <5 vol % fragmented particles; or to promote fragmentation such as at a higher reaction temperature, e.g., ≥40° C., such as ≥60° C., to achieve greater than 10 vol % fragmented particles, e.g., 10 vol %-80 vol % fragmented particles, such as 10 vol %-20 vol % fragmented particles, 20 vol %-70 vol % fragmented particles, 70 vol %-90 vol % fragmented particles, >90 vol % fragmented particles, or the like. In general, the time and temperature involved to promote fragmentation are inversely related, i.e., at a higher temperature, debris dominated fragmentation may involve a shorter period of time.

According to at least one embodiment, the support material is not fragmented during supportation or other treatment prior to polymerization, e.g., the supported catalyst system has a pore size distribution that is essentially maintained upon treatment with the organometallic compound and/or less than 5 vol % of fines is generated by volume of the total support material, e.g., where the support material is resistant to fragmentation, or supportation conditions are selected to inhibit fragmentation.

Maintaining a sufficiently large particle size (average PS or PS mode) of the supported catalyst system material, according to at least one embodiment, facilitates the formation of sufficiently large propylene polymer particles rich with small pores, which can, for example, be readily filled with rubber fill, e.g., in making an TPV or other heterophasic copolymer. On the other hand, an excess of porous polypropylene fines, e.g., 5 vol % or more smaller than 120 μm, generally formed from smaller particles such as the sub-particles of the support material agglomerates or sub-primary particle debris or fines, may result in fouling or plugging of the reactor, lines or equipment during the polymerization of a rubber in the presence of the porous polypropylene or vice versa, and/or in the formation of non-particulated polymer.

In at least one embodiment, the silica support has one or more of

a surface area of from 400 m²/g to 800 m²/g;

an average pore diameter of 90 Å or greater;

an average particle size of 60 μm or greater;

40% or greater of the incremental pore volume comprised of pores having a pore diameter larger than 100 Angstroms or greater; and

sub-particles having an average particle size in the range of 0.01 μm to 5 μm,

as determined by BET nitrogen adsorption as described in Brunauer, Emmett, Teller “Adsorption of Gasses in Multimolecular Layers”, JACS, 60 (1938) 369-319.

In at least one embodiment, the supported catalyst systems comprising a Catalyst I, e.g., on silica, are able to polymerize propylene or ethylene with or without other comonomer in stage 1 to produce polymer resins with a melting point at least 100° C. or higher. A Catalyst II is able to polymerize olefin monomers to produce plastomer or elastomer in stage 2, wherein Catalyst I contributes at least 80 wt % of the stiff matrix phase and Catalyst II contributes less than 20 wt % of the matrix phase as stiff (e.g., in PE based polymerization) or non-stiff (e.g., in PP based polymerization that generate aPP) polymer.

In at least one embodiment, the supported catalysts, e.g., on silica with balanced PS, SA, PV, and PD, such as, for example, PS 70-100 μm, SA 400-800 m²/g, PV 2.0 mL/g or less, and PD 90-120 Å, and sub-particles of from 0.01 μm to 5.0 μm, are able to polymerize propylene to produce iPP resins in stage 1. Furthermore, highly porous structures can house active catalytic species to continue polymerizing additional monomers to form, in stage 2, second phase copolymers in heterophasic copolymers such as TPV with improved physical/chemical properties. TPV resins prepared from the catalysts based on MAO supported on support materials as disclosed herein have been discovered to show improved ethylene-propylene-diene (EPDM) rubber uptake.

In at least one embodiment, the supported activator is optionally treated with another organometallic compound which is also selected as the scavenger, such as a metal alkyl such as an aluminum alkyl, to scavenge any hydroxyl or other reactive species that may be exposed by or otherwise remaining after treatment with the first organometallic compound, e.g., hydroxyl groups on surfaces exposed by fragmentation may be reacted and thereby removed by contact of the fragments with an aluminum alkyl such as triisobutylaluminum (TIBA). Exemplary metal alkyls which may be used according to at least one embodiment to treat the support material have the general formula Rₙ-M, wherein R is C₁-C₄₀ hydrocarbyl such as C₁-C₁₂ alkyl for example, M is a metal (such as a group 13 metal, such as Al), and n is equal to the valence of M (such as 3, 4 or 5), and may include oxophilic species such as diethyl zinc and aluminum alkyls, such as, for example, trimethylaluminum, triethylaluminum, triisobutylaluminum, tri-n-hexylaluminum, tri-n-octylaluminum and the like, including combinations thereof. Then the activator/support material is contacted with a solution of the catalyst precursor compound. In at least one embodiment, the supported activator is generated in situ. In alternate embodiments, the slurry of the support material is first contacted with the catalyst precursor compound for a period of time in the range of from about 0.5 hours to about 24 hours, from about 2 hours to about 16 hours, or from about 4 hours to about 8 hours, and the slurry of the supported catalyst compound(s) is then contacted with an organometallic-activator solution and/or organometallic-scavenger solution.

Preparation of Mixed Catalyst Systems: The above two catalyst types can be combined to form a mixed catalyst system. The two or more metal catalysts can be added together in a desired ratio when combined, contacted with an activator, or contacted with a support material or a supported activator. The metal catalyst compounds may be added to the mixture sequentially or simultaneously. The molar ratio of a Catalyst I to a Catalyst II can vary depending on the balance of processability versus physical characteristics of the desired polymer. For example, the molar ratio (I):(II) can range from 20:1 to 1:1, such as from 1:1 to 20:1, such as from 1:1 to 1:3, such as from 1:1 to 1:2, for example 1:2.

Other procedures for combining the catalysts are possible, such as addition of a first metal catalyst compound to a slurry including a support or a supported activator mixture for a specified reaction time, followed by the addition of the second metal catalyst compound solution, mixed for another specified time, after which the mixture may be recovered for use in a polymerization reactor, such as by spray drying. Lastly, another additive, such as 1-hexene in about 10 vol % can be present in the mixture prior to the addition of the first metal catalyst compound.

The first metal catalyst compound may be supported via contact with a support material for a reaction time. The resulting supported catalyst composition may then be mixed with mineral oil to form a slurry, which may or may not include an activator. The slurry may then be admixed with a second metal catalyst compound prior to introduction of the resulting mixed catalyst system to a polymerization reactor. The second metal catalyst compounds may be admixed at any point prior to introduction to the reactor, such as in a polymerization feed vessel or in-line in a catalyst delivery system.

In general, support, Catalyst I, Catalyst II, and activator can be brought into contact in any order. However, Catalyst I and Catalyst II may display different affinity with an activator, e.g., MAO, to form ion-pairs with different affinity. In the MAO activation case, one of the catalyst derived ion-pairs may display less affinity and the two catalysts can have different activation efficiencies. For example, when the neutral Catalyst I and Catalyst II are charged in a 1:1 mol:mol ratio, the active Catalyst I and Catalyst II may not be in a 1:1 mol:mol ratio; the actual value may differ depending on the MAO to total catalyst ratio, the activation efficiency of each of the catalysts, and affinity of each ion-pair, etc. The catalyst activation efficiency and the derived ion-pair affinity are closely related to both the steric and electronic effects on the catalyst's ligand and metal center (such as Ti, Zr, or Hf). If the one of the catalysts is over charged based on the activation efficiency, neutral non-activated species may exist. And if the neutral catalyst forms tighter ion-pair than the other activated catalyst ion-pair, the neutral catalyst may replace the other catalyst derived ion-pair. This issue can often be altered by reducing the charge of the catalyst with a poorer activation efficiency and bring the catalyst that forms a tighter ion-pair into contact with activator (such as MAO) or supported activator (such as MAO) first before the introduction of the other catalyst to control the Catalyst I and Catalyst II derived active species ratio. For certain polymerization processes, e.g., processes using sequential gas-phase reactor setup, a higher temperature calcination support can be used, e.g., 600-875° C., to reduce the heat of reaction generated through activator (such as MAO) components' reaction with the support surface functional groups to enable a low cost catalyst preparation protocol. For processes that involve a slurry phase polymerization in the 1^{st} stage, activator (such as MAO) is expected to bind on the support surface firmly to avoid activator (such as MAO) leaching in the slurry environment. Therefore a lower temperature calcination temperature, e.g., 200° C., may be useful to generate more anchor points (i.e., functional groups) on the surface to bind activator (such as MAO).

The mixed catalyst system may be formed by combining a first metal catalyst compound (for example a metal catalyst compound useful for producing a first polymer attribute, such as a high molecular weight polymer fraction) with a support and activator, desirably in a first diluent such as an alkane or toluene, to produce a supported, activated catalyst compound. The supported activated catalyst compound, either isolated from the first diluent or not, is then combined in one embodiment with a high viscosity diluent such as mineral or silicon oil, or an alkane diluent comprising from 5 to 99 wt % mineral or silicon oil to form a slurry of the supported metal catalyst compound, followed by, or simultaneous to combining with a second metal catalyst compound (for example, a metal catalyst compound useful for producing a second polymer attribute, such as a low molecular weight polymer fraction or low comonomer content), either in a diluent or as the dry solid compound, to form a supported activated mixed catalyst system (“mixed catalyst system”). The mixed catalyst system thus produced may be a supported and activated first metal catalyst compound in a slurry, the slurry comprising mineral or silicon oil, with a second metal catalyst compound that is not supported and not combined with additional activator, where the second metal catalyst compound may or may not be partially or completely soluble in the slurry. In one embodiment, the diluent consists of mineral oil.

Mineral oil, or “high viscosity diluents,” as used herein refers to petroleum hydrocarbons and mixtures of hydrocarbons that may include aliphatic, aromatic, and/or paraffinic components that are liquids at 23° C. and above, and typically have a molecular weight of at least 300 amu to 500 amu or more, and a viscosity at 40° C. of from 40 to 300 cSt or greater, or from 50 to 200 cSt in a particular embodiment. The term “mineral oil” includes synthetic oils or liquid polymers, polybutenes, refined naphthenic hydrocarbons, and refined paraffins known in the art, such as disclosed in BLUE BOOK 2001, Materials, Compounding Ingredients, Machinery And Services For Rubber, v. 189, pg. 247 (J. H. Lippincott, D. R. Smith, K. Kish & B. Gordon eds. Lippincott & Peto Inc. 2001). Exemplary mineral and silicon oils are those that exclude moieties that are reactive with metallocene catalysts, examples of which include hydroxyl and carboxyl groups.

The diluent may comprise a blend of a mineral, silicon oil, and/or a hydrocarbon selected from the group consisting of C₁ to C₁₀ alkanes, C₆ to C₂₀ aromatic hydrocarbons, C₇ to C₂₁ alkyl-substituted hydrocarbons, and mixtures thereof. When the diluent is a blend comprising mineral oil, the diluent may comprise from 5 to 99 wt % mineral oil. In at least one embodiment, the diluent may consist essentially of mineral oil.

In at least one embodiment, the first metal catalyst compound is combined with an activator and a first diluent to form a catalyst slurry that is then combined with a support material. Until such contact is made, the support particles are typically not previously activated. The first metal catalyst compound can be in any desirable form such as a dry powder, suspension in a diluent, solution in a diluent, liquid, etc. The catalyst slurry and support particles are then mixed thoroughly, in one embodiment at an elevated temperature, so that both the first metal catalyst compound and the activator are deposited on the support particles to form a support slurry.

After the first metal catalyst compound and activator are deposited on the support, a second metal catalyst compound may then be combined with the supported first metal catalyst compound, wherein the second is combined with a diluent comprising mineral or silicon oil by any suitable means either before, simultaneous to, or after contacting the second metal catalyst compound with the supported first metal catalyst compound. In one embodiment, the first metal catalyst compound is isolated from the first diluent to a dry state before combining with the second metal catalyst compound. The second metal catalyst compound might not activated, that is, not combined with any activator, before being combined with the supported first metal catalyst compound. The resulting solids slurry (including both the supported first and second metal catalyst compounds) can then be mixed thoroughly at an elevated temperature.

A wide range of mixing temperatures may be used at various stages of making the mixed catalyst system. For example, in a specific embodiment, when the first metal catalyst compound and at least one activator, such as methylalumoxane, are combined with a first diluent to form a mixture, the mixture can be heated to a first temperature of from 25° C. to 150° C., such as from 50° C. to 125° C., such as from 75° C. to 100° C., such as from 80° C. to 100° C. and stirred for a period of time from 30 seconds to 12 hours, such as from 1 minute to 6 hours, such as from 10 minutes to 4 hours, such as, from 30 minutes to 3 hours.

Next, that mixture is combined with a support material to provide a first support slurry. The support material can be heated, or dehydrated if desired, prior to combining. In one or more embodiments, the first support slurry is mixed at a temperature greater than 50° C., such as greater than 70° C., such as greater than 80° C. such as, greater than 85° C., for a period of time from 30 seconds to 12 hours, such as from 1 minute to 6 hours, such as from 10 minutes to 4 hours, such as from 30 minutes to 3 hours. The support slurry can be mixed for a time sufficient to provide a collection of activated support particles that have the first metal catalyst compound deposited thereto. The first diluent can then be removed from the first support slurry to provide a dried supported first catalyst compound. For example, the first diluent can be removed under vacuum or by nitrogen purge.

Next, the second metal catalyst compound is combined with the activated first metal catalyst compound in the presence of a diluent comprising mineral or silicon oil in one embodiment. The second metal catalyst compound can be added in a molar ratio to the first metal catalyst compound in the range from 20:1 to 1:1, such as from 1:1 to 20:1, such as from 1:1 to 3:1, such as from 2:1 to 1:1, for example 2:1. In at least one embodiment, the molar ratio is approximately 1:1. The resultant slurry (or first support slurry) can be heated to a first temperature from 25° C. to 150° C., such as from 50° C. to 125° C., such as from 75° C. to 100° C., such as from 80° C. to 100° C. and stirred for a period of time from 30 seconds to 12 hours, such as from 1 minute to 6 hours, such as from 10 minutes to 4 hours, such as from 30 minutes to 3 hours.

The first diluent may be an aromatic or alkane hydrocarbon, such as hydrocarbon diluent having a boiling point of less than 200° C. such as toluene, xylene, hexane, etc., and may be removed from the supported first metal catalyst compound under vacuum or by nitrogen purge to provide a supported mixed catalyst system. Even after addition of the oil and/or the second (or other) catalyst compound, it may be desirable to treat the slurry to further remove any remaining solvents such as toluene. This can be accomplished by an N₂ purge or vacuum, for example. Depending upon the level of mineral oil added, the resultant mixed catalyst system may still be a slurry or may be a free flowing powder that comprises an amount of mineral oil. Thus, the mixed catalyst system, while a slurry of solids in mineral oil in one embodiment, may take any physical form such as a free flowing solid. For example, the mixed catalyst system may range from 1 to 99 wt % solids content by weight of the mixed catalyst system (mineral oil, support, all catalyst compounds and activator(s)) in one embodiment. The catalyst compound may be the first or second compound, typically the second compound.

### Activators:

Activators are compounds used to activate any one of the catalyst precursor compounds described above by converting the neutral catalyst precursor compound to a catalytically active catalyst compound cation. Non-limiting activators, for example, include alumoxanes, aluminum alkyls, ionizing activators, which may be neutral or ionic, and conventional-type cocatalysts. Exemplary activators typically include alumoxane compounds, including modified alumoxane compounds, and ionizing anion precursor compounds that abstract a reactive, σ-bound, metal ligand making the metal complex cationic and providing a charge-balancing non-coordinating or weakly coordinating anion.

Alumoxanes are generally oligomeric, partially hydrolyzed aluminum alkyl compounds containing —Al(R¹)—O— sub-units, where R¹ is an alkyl group, and may be produced by the hydrolysis of the respective trialkylaluminum compound. Examples of alumoxane activators include methylalumoxane (MAO), ethylalumoxane, butylalumoxane, isobutylalumoxane, modified MAO (MMAO), halogenated MAO where the MAO may be halogenated before or after MAO supportation, dialkylaluminum cation enhanced MAO, surface bulky group modified MAO, and the like. MMAO may be produced by the hydrolysis of trimethylaluminum and a higher trialkylaluminum such as triisobutylaluminum. Mixtures of different alumoxanes may also be used as the activator(s).

There are a variety of methods for preparing alumoxanes suitable for use in embodiments of the present disclosure, non-limiting examples of which are described in U.S. Pat. Nos. 4,665,208; 4,952,540; 5,041,584; 5,091,352; 5,206,199; 5,204,419; 4,874,734; 4,924,018; 4,908,463; 4,968,827; 5,308,815; 5,329,032; 5,248,801; 5,235,081; 5,157,137; 5,103,031; 5,391,793; 5,391,529; 5,693,838; 5,731,253; 5,731,451; 5,744,656; 5,847,177; 5,854,166; 5,856,256; 5,939,346; EP 0 561 476; EP 0 279 586; EP 0 594-218; EP 0 586 665; WO 1994/010180; WO 1999/015534; halogenated MAO are described in U.S. Pat. Nos. 7,960,488; 7,355,058; 8,354,485; dialkylaluminum cation enhanced MAO are described in US 2013/0345376, U.S. Pat. Nos. 8,575,284, and 9,090,720; and surface bulky group modified supported MAO are described in U.S. Pat. No. 8,895,465; all of which are herein fully incorporated by reference.

Another useful alumoxane is solid polymethylaluminoxane as described in U.S. Pat. Nos. 9,340,630; 8,404,880; and 8,975,209.

When the activator is an alumoxane, at least one embodiment selects the maximum amount of activator at a 5,000-fold molar excess Al/M over the catalyst precursor compound (per metal catalytic site). The minimum activator-to-catalyst-compound is a 1:1 molar ratio. Alternate ranges include from 1:1 to 500:1, alternately from 1:1 to 200:1, alternately from 1:1 to 100:1, or alternately from 1:1 to 50:1, e.g., 1:1 to 10:1 or 10:1 to 50:1.

It is within the scope of the present disclosure to use an ionizing activator, neutral or ionic, such as tri(n-butyl) ammonium tetrakis(pentafluorophenyl) borate, a tris perfluorophenyl boron metalloid precursor or a tris perfluoronaphthyl boron metalloid precursor, polyhalogenated heteroborane anions (WO 1998/043983), boric acid (U.S. Pat. No. 5,942,459), or combination thereof. It is also within the scope of the present disclosure to use neutral or ionic activators or non-coordinating anion activators alone or in combination with alumoxane activators such as in U.S. Pat. Nos. 8,501,655; 7,897,707; 7,928,172; 5,153,157; 5,453,410; EP 0 573 120; WO 1994/007928; and WO 1995/014044; which are herein fully incorporated by reference. Further information regarding useful activators may be found in U.S. Pat. Nos. 8,283,428; 5,153,157; 5,198,401; 5,066,741; 5,206,197; 5,241,025; 5,384,299; 5,502,124; 5,447,895; 7,297,653; 7,799,879; WO 1996/004319; EP 0 570 982; EP 0 520 732; EP 0 495 375; EP 0 500 944; EP 0 277 003; EP 0 277 004; EP 0 277 003; and EP 0 277 004; all of which are herein fully incorporated by reference.

A non-coordinating anion (NCA) is defined to mean an anion either that does not coordinate to the catalyst metal cation or that does coordinate to the metal cation, but only weakly. The term NCA is also defined to include multicomponent NCA-containing activators, such as N,N-dimethylanilinium tetrakis(pentafluorophenyl)borate, that contain an acidic cationic group and the non-coordinating anion. The term NCA is also defined to include neutral Lewis acids, such as tris(pentafluorophenyl)boron, that can react with a catalyst to form an activated species by abstraction of an anionic group. An NCA coordinates weakly enough that a neutral Lewis base, such as an olefinically or acetylenically unsaturated monomer can displace it from the catalyst center. Any metal or metalloid that can form a compatible, weakly coordinating complex may be used or contained in the non-coordinating anion. Suitable metals include, but are not limited to, aluminum, gold, and platinum. Suitable metalloids include, but are not limited to, boron, aluminum, phosphorus, and silicon.

“Compatible” non-coordinating anions can be those which are not degraded to neutrality when the initially formed complex decomposes. Further, the anion might not transfer an anionic substituent or fragment to the cation so as to cause it to form a neutral transition metal compound and a neutral by-product from the anion. Non-coordinating anions can be those that are compatible, stabilize the transition metal cation in the sense of balancing its ionic charge at +1, and yet retain sufficient lability to permit displacement during polymerization.

The catalyst systems of the present disclosure can include at least one non-coordinating anion (NCA) activator. In at least one embodiment, boron containing NCA activators represented by the formula below can be used:

Z_{d}⁺(A^{d-})

where: Z is (L-H) or a reducible Lewis acid; L is a neutral Lewis base; H is hydrogen; (L-H) is a Bronsted acid; A^{d}− is a boron containing non-coordinating anion having the charge d−; d is 1, 2, or 3.

The cation component, Z_{d}⁺ may include Bronsted acids such as protons or protonated Lewis bases or reducible Lewis acids capable of protonating or abstracting a moiety, such as an alkyl or aryl, from the bulky ligand catalyst containing transition metal catalyst precursor, resulting in a cationic transition metal species.

The activating cation Z_{d}⁺ may also be a moiety such as silver, tropylium, carboniums, ferroceniums and mixtures, such as carboniums and ferroceniums. Z_{d}⁺ can be triphenyl carbonium. Reducible Lewis acids can be any triaryl carbonium (where the aryl can be substituted or unsubstituted, such as those represented by the formula: (Ar₃C⁺), where Ar is aryl or aryl substituted with a heteroatom, a C₁ to C₄₀ hydrocarbyl, or a substituted C₁ to C₄₀ hydrocarbyl), such as the reducible Lewis acids in formula (14) above as “Z” include those represented by the formula: (Ph₃C), where Ph is a substituted or unsubstituted phenyl, such as substituted with C₁ to C₄₀ hydrocarbyls or substituted a C₁ to C₄₀ hydrocarbyls, such as C₁ to C₂₀ alkyls or aromatics or substituted C₁ to C₂₀ alkyls or aromatics, such as Z is a triphenylcarbonium.

When Z_{d}⁺ is the activating cation (L-H)_{d}⁺, it can be a Bronsted acid, capable of donating a proton to the transition metal catalytic precursor resulting in a transition metal cation, including ammoniums, oxoniums, phosphoniums, silyliums, and mixtures thereof, such as ammoniums of methylamine, aniline, dimethylamine, diethylamine, N-methylaniline, diphenylamine, trimethylamine, triethylamine, N,N-dimethylaniline, methyldiphenylamine, pyridine, p-bromo N,N-dimethylaniline, p-nitro-N,N-dimethylaniline, phosphoniums from triethylphosphine, triphenylphosphine, and diphenylphosphine, oxomiuns from ethers such as dimethyl ether diethyl ether, tetrahydrofuran and dioxane, sulfoniums from thioethers, such as diethyl thioethers, tetrahydrothiophene, and mixtures thereof.

The anion component A^{d}− includes those having the formula [M^{k+}Qₙ]^{d-} wherein k is 1, 2, or 3; n is 1, 2, 3, 4, 5, or 6 (such as 1, 2, 3, or 4); n−k=d; M is an element selected from group 13 of the Periodic Table of the Elements, such as boron or aluminum, and Q is independently a hydride, bridged or unbridged dialkylamido, halide, alkoxide, aryloxide, hydrocarbyl, substituted hydrocarbyl, halocarbyl, substituted halocarbyl, and halosubstituted-hydrocarbyl radicals, said Q having up to 40 carbon atoms with the proviso that in not more than 1 occurrence is Q a halide. Each Q can be a fluorinated hydrocarbyl group having 1 to 40 carbon atoms, such as each Q is a fluorinated aryl group, and such as each Q is a pentafluoryl aryl group. Examples of suitable A^{d-} also include diboron compounds as disclosed in U.S. Pat. No. 5,447,895, which is fully incorporated herein by reference.

Illustrative, but not limiting, examples of boron compounds which may be used as an activating cocatalyst are the compounds described as (and particularly those specifically listed as) activators in U.S. Pat. No. 8,658,556, which is incorporated by reference herein.

The ionic stoichiometric activator Z_{d}⁺ (A^{d-}) can be one or more of N,N-dimethylanilinium tetra(perfluorophenyl)borate, N,N-dimethylanilinium tetrakis(perfluoronaphthyl)borate, N,N-dimethylanilinium tetrakis(perfluorobiphenyl)borate, N,N-dimethylanilinium tetrakis(3,5-bis(trifluoromethyl)phenyl)borate, triphenylcarbenium tetrakis(perfluoronaphthyl)borate, triphenylcarbenium tetrakis(perfluorobiphenyl)borate, triphenylcarbenium tetrakis(3,5-bis(trifluoromethyl)phenyl)borate, or triphenylcarbenium tetra(perfluorophenyl)borate.

Bulky activators are also useful herein as NCAs. “Bulky activator” as used herein refers to anionic activators represented by the formula:

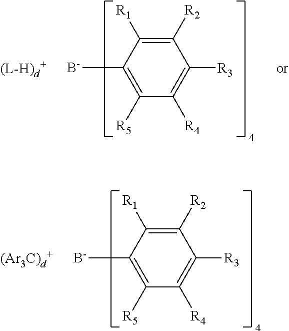

where:

each R₁ is independently a halide, such as a fluoride;

Ar is substituted or unsubstituted aryl group (such as a substituted or unsubstituted phenyl), such as substituted with C₁ to C₄₀ hydrocarbyls, such as C₁ to C₂₀ alkyls or aromatics;

each R₂ is independently a halide, a C₆ to C₂₀ substituted aromatic hydrocarbyl group or a siloxy group of the formula —O—Si—Rₐ, where Rₐ is a C₁ to C₂₀ hydrocarbyl or hydrocarbylsilyl group (such as R₂ is a fluoride or a perfluorinated phenyl group);

each R₃ is a halide, C₆ to C₂₀ substituted aromatic hydrocarbyl group or a siloxy group of the formula —O—Si—Rₐ, where Rₐ is a C₁ to C₂₀ hydrocarbyl or hydrocarbylsilyl group (such as R₃ is a fluoride or a C₆ perfluorinated aromatic hydrocarbyl group); wherein R₂ and R₃ can form one or more saturated or unsaturated, substituted or unsubstituted rings (such as R₂ and R₃ form a perfluorinated phenyl ring); and

L is a neutral Lewis base; (L-H)⁺ is a Bronsted acid; d is 1, 2, or 3;

wherein the anion has a molecular weight of greater than 1020 g/mol; and

wherein at least three of the substituents on the B atom each have a molecular volume of greater than 250 cubic Å, alternately greater than 300 cubic Å, or alternately greater than 500 cubic Å.

For example, (Ar₃C)_{d}⁺ can be (Ph₃C)_{d}⁺, where Ph is a substituted or unsubstituted phenyl, such as substituted with C₁ to C₄₀ hydrocarbyls or substituted C₁ to C₄₀ hydrocarbyls, such as C₁ to C₂₀ alkyls or aromatics or substituted C₁ to C₂₀ alkyls or aromatics.

“Molecular volume” is used herein as an approximation of spatial steric bulk of an activator molecule in solution. Comparison of substituents with differing molecular volumes allows the substituent with the smaller molecular volume to be considered “less bulky” in comparison to the substituent with the larger molecular volume. Conversely, a substituent with a larger molecular volume may be considered “more bulky” than a substituent with a smaller molecular volume.

Molecular volume may be calculated as reported in Girolami, G. S. (1994) “A Simple “Back of the Envelope” Method for Estimating the Densities and Molecular Volumes of Liquids and Solids,” Journal of Chemical Education, v. 71(11), pp. 962-964. Molecular volume (MV), in units of cubic Å, is calculated using the formula: MV=8.3Vₛ, where Vₛ is the scaled volume. Vₛ is the sum of the relative volumes of the constituent atoms, and is calculated from the molecular formula of the substituent using the following table of relative volumes. For fused rings, the Vₛ is decreased by 7.5% per fused ring.

| Element | Relative Volume |
|---|---|
| H | 1 |
| 1^{st} short period, Li to F | 2 |
| 2^{nd} short period, Na to Cl | 4 |
| 1^{st} long period, K to Br | 5 |
| 2^{nd} long period, Rb to I | 7.5 |
| 3^{rd} long period, Cs to Bi | 9 |

For a list of particularly useful Bulky activators please see U.S. Pat. No. 8,658,556, which is incorporated by reference herein.

In another embodiment, one or more of the NCA activators is chosen from the activators described in U.S. Pat. No. 6,211,105.

Exemplary activators include N,N-dimethylanilinium tetrakis(perfluoronaphthyl)borate, N,N-dimethylanilinium tetrakis(perfluorobiphenyl)borate, N,N-dimethylanilinium tetrakis(perfluorophenyl)borate, N,N-dimethylanilinium tetrakis(3,5-bis(trifluoromethyl)phenyl)borate, triphenylcarbenium tetrakis(perfluoronaphthyl)borate, triphenylcarbenium tetrakis(perfluorobiphenyl)borate, triphenylcarbenium tetrakis(3,5-bis(trifluoromethyl)phenyl)borate, triphenylcarbenium tetrakis(perfluorophenyl)borate, [Ph₃C⁺][B(C₆F₅)₄⁻], [Me₃NH⁺][B(C₆F₅)₄⁻], 1-(4-(tris(pentafluorophenyl)borate)-2,3,5,6-tetrafluorophenyl)pyrrolidinium, and tetrakis(pentafluorophenyl)borate, 4-(tris(pentafluorophenyl)borate)-2,3,5,6-tetrafluoropyridine.

In at least one embodiment, the activator comprises a triaryl carbonium (such as triphenylcarbenium tetraphenylborate, triphenylcarbenium tetrakis(pentafluorophenyl)borate, triphenylcarbenium tetrakis-(2,3,4,6-tetrafluorophenyl)borate, triphenylcarbenium tetrakis(perfluoronaphthyl)borate, triphenylcarbenium tetrakis(perfluorobiphenyl)borate, and triphenylcarbenium tetrakis(3,5-bis(trifluoromethyl)phenyl)borate).

In another embodiment, the activator comprises one or more of trialkylammonium tetrakis(pentafluorophenyl)borate, N,N-dialkylanilinium tetrakis(pentafluorophenyl)borate, N,N-dimethyl-(2,4,6-trimethylanilinium) tetrakis(pentafluorophenyl)borate, trialkylammonium tetrakis-(2,3,4,6-tetrafluorophenyl) borate, N,N-dialkylanilinium tetrakis-(2,3,4,6-tetrafluorophenyl)borate, trialkylammonium tetrakis(perfluoronaphthyl)borate, N,N-dialkylanilinium tetrakis(perfluoronaphthyl)borate, trialkylammonium tetrakis(perfluorobiphenyl)borate, N,N-dialkylanilinium tetrakis(perfluorobiphenyl)borate, trialkylammonium tetrakis(3,5-bis(trifluoromethyl)phenyl)borate, N,N-dialkylanilinium tetrakis(3,5-bis(trifluoromethyl)phenyl)borate, N,N-dialkyl-(2,4,6-trimethylanilinium) tetrakis(3,5-bis(trifluoromethyl)phenyl)borate, and di-(i-propyl)ammonium tetrakis(pentafluorophenyl)borate (where alkyl is methyl, ethyl, propyl, n-butyl, sec-butyl, or t-butyl).

In embodiments of the invention, the activator is represented by the Formula (III):

(Z)_{d}⁺(A^{d-}) (III)

wherein Z is (L-H) or a reducible Lewis Acid, L is an neutral Lewis base; H is hydrogen; (L-H)⁺ is a Bronsted acid; A^{d-} is a non-coordinating anion having the charge d−; and d is an integer from 1 to 3 (such as 1, 2 or 3). Optionally, Z is (Ar₃C⁺), where Ar is aryl or aryl substituted with a heteroatom, a C₁ to C₄₀ hydrocarbyl, or a substituted C₁ to C₄₀ hydrocarbyl. The anion component A^{d-} includes those having the formula [M^{k+}Qₙ]^{d-} wherein k is 1, 2, or 3; n is 1, 2, 3, 4, 5, or 6 (preferably 1, 2, 3, or 4); n −k=d; M is an element selected from Group 13 of the Periodic Table of the Elements, preferably boron or aluminum, and Q is independently a hydride, bridged or unbridged dialkylamido, halide, alkoxide, aryloxide, hydrocarbyl, substituted hydrocarbyl, halocarbyl, substituted halocarbyl, and halosubstituted-hydrocarbyl radicals, said Q having up to 40 carbon atoms (optionally with the proviso that in not more than 1 occurrence is Q a halide). Preferably, each Q is a fluorinated hydrocarbyl group having 1 to 40 (such as 1 to 30, such as 1 to 20) carbon atoms, more preferably each Q is a fluorinated aryl group, such as a perfluorinated aryl group and most preferably each Q is a pentafluoryl aryl group or perfluoronaphthalenyl group. Examples of suitable A^{d-} also include diboron compounds as disclosed in U.S. Pat. No. 5,447,895, which is fully incorporated herein by reference.

When Z is the activating cation (L-H), it can be a Bronsted acid, capable of donating a proton to the transition metal catalytic precursor resulting in a transition metal cation, including ammoniums, oxoniums, phosphoniums, sulfoniums, and mixtures thereof, such as ammoniums of methylamine, aniline, dimethylamine, diethylamine, N-methylaniline, N-methyl-4-nonadecyl-N-octadecylaniline, N-methyl-4-octadecyl-N-octadecylaniline, diphenylamine, trimethylamine, triethylamine, N,N-dimethylaniline, methyldiphenylamine, pyridine, p-bromo N,N-dimethylaniline, p-nitro-N,N-dimethylaniline, dioctadecylmethylamine, phosphoniums from triethylphosphine, triphenylphosphine, and diphenylphosphine, oxoniums from ethers such as dimethyl ether, diethyl ether, tetrahydrofuran and dioxane, sulfoniums from thioethers, such as diethyl thioethers, tetrahydrothiophene, and mixtures thereof.

In particularly useful embodiments of the invention, the activator is soluble in non-aromatic-hydrocarbon solvents, such as aliphatic solvents.

In one or more embodiments, a 20 wt % mixture of the activator compound in n-hexane, isohexane, cyclohexane, methylcyclohexane, or a combination thereof, forms a clear homogeneous solution at 25° C., preferably a 30 wt % mixture of the activator compound in n-hexane, isohexane, cyclohexane, methylcyclohexane, or a combination thereof, forms a clear homogeneous solution at 25° C.

In embodiments of the invention, the activators described herein have a solubility of more than 10 mM (or more than 20 mM, or more than 50 mM) at 25° C. (stirred 2 hours) in methylcyclohexane.

In embodiments of the invention, the activators described herein have a solubility of more than 1 mM (or more than 10 mM, or more than 20 mM) at 25° C. (stirred 2 hours) in isohexane.

In embodiments of the invention, the activators described herein have a solubility of more than 10 mM (or more than 20 mM, or more than 50 mM) at 25° C. (stirred 2 hours) in methylcyclohexane and a solubility of more than 1 mM (or more than 10 mM, or more than 20 mM) at 25° C. (stirred 2 hours) in isohexane.

In a preferred embodiment, the activator is a non-aromatic-hydrocarbon soluble activator compound.

Non-aromatic-hydrocarbon soluble activator compounds useful herein include those represented by the Formula (V):

[R^{1′}R^{2′}R^{3′}EH]_{d+}[Mt^{k+}Qₙ]^{d-} (V)

wherein:

E is nitrogen or phosphorous;

d is 1, 2 or 3; k is 1, 2, or 3; n is 1, 2, 3, 4, 5, or 6; n −k=d (preferably d is 1, 2 or 3; k is 3; n is 4, 5, or 6);

R^{1′}, R^{2′}, and R^{3′} are independently a C₁ to C₅₀ hydrocarbyl group optionally substituted with one or more alkoxy groups, silyl groups, a halogen atoms, or halogen containing groups,

wherein R^{1′}, R^{2′}, and R^{3′} together comprise 15 or more carbon atoms;

Mt is an element selected from group 13 of the Periodic Table of the Elements, such as B or Al; and

each Q is independently a hydride, bridged or unbridged dialkylamido, halide, alkoxide, aryloxide, hydrocarbyl, substituted hydrocarbyl, halocarbyl, substituted halocarbyl, or halosubstituted-hydrocarbyl radical.

Non-aromatic-hydrocarbon soluble activator compounds useful herein include those represented by the Formula (VI):

[R^{1′}R^{2′}R^{3′}EH]⁺[BR^{4′}R^{5′}R^{6′}R^{7′}] (VI)

wherein: E is nitrogen or phosphorous; R^{1′} is a methyl group; R^{2′} and R^{3′} are independently is C₄-C₅₀ hydrocarbyl group optionally substituted with one or more alkoxy groups, silyl groups, a halogen atoms, or halogen containing groups wherein R^{2′} and R^{3′} together comprise 14 or more carbon atoms; B is boron; and R^{4′}, R^{5′}, R^{6′}, and R^{7′} are independently hydride, bridged or unbridged dialkylamido, halide, alkoxide, aryloxide, hydrocarbyl, substituted hydrocarbyl, halocarbyl, substituted halocarbyl, or halosubstituted-hydrocarbyl radical.

Activator compounds that are particularly useful in this invention include one or more of:
N,N-di(hydrogenated tallow)methylammonium [tetrakis(perfluorophenyl) borate],
N-methyl-4-nonadecyl-N-octadecylanilinium [tetrakis(perfluorophenyl)borate],
N-methyl-4-hexadecyl-N-octadecylanilinium [tetrakis(perfluorophenyl)borate],
N-methyl-4-tetradecyl-N-octadecylanilinium [tetrakis(perfluorophenyl)borate],
N-methyl-4-dodecyl-N-octadecylanilinium [tetrakis(perfluorophenyl)borate],
N-methyl-4-decyl-N-octadecylanilinium [tetrakis(perfluorophenyl)borate],
N-methyl-4-octyl-N-octadecylanilinium [tetrakis(perfluorophenyl)borate],
N-methyl-4-hexyl-N-octadecylanilinium [tetrakis(perfluorophenyl)borate],
N-methyl-4-butyl-N-octadecylanilinium [tetrakis(perfluorophenyl)borate],
N-methyl-4-octadecyl-N-decylanilinium [tetrakis(perfluorophenyl)borate],
N-methyl-4-nonadecyl-N-dodecylanilinium [tetrakis(perfluorophenyl)borate],
N-methyl-4-nonadecyl-N-tetradecylanilinium [tetrakis(perfluorophenyl)borate],
N-methyl-4-nonadecyl-N-hexadecylanilinium [tetrakis(perfluorophenyl)borate],
N-ethyl-4-nonadecyl-N-octadecylanilinium [tetrakis(perfluorophenyl)borate],
N-methyl-N,N-dioctadecylammonium [tetrakis(perfluorophenyl)borate],
N-methyl-N,N-dihexadecylammonium [tetrakis(perfluorophenyl)borate],
N-methyl-N,N-ditetradecylammonium [tetrakis(perfluorophenyl)borate],
N-methyl-N,N-didodecylammonium [tetrakis(perfluorophenyl)borate],
N-methyl-N,N-didecylammonium [tetrakis(perfluorophenyl)borate],
N-methyl-N,N-dioctylammonium [tetrakis(perfluorophenyl)borate],
N-ethyl-N,N-dioctadecylammonium [tetrakis(perfluorophenyl)borate],
N,N-di(octadecyl)tolylammonium [tetrakis(perfluorophenyl)borate],
N,N-di(hexadecyl)tolylammonium [tetrakis(perfluorophenyl)borate],
N,N-di(tetradecyl)tolylammonium [tetrakis(perfluorophenyl)borate],
N,N-di(dodecyl)tolylammonium [tetrakis(perfluorophenyl)borate],
N-octadecyl-N-hexadecyl-tolylammonium [tetrakis(perfluorophenyl)borate],
N-octadecyl-N-hexadecyl-tolylammonium [tetrakis(perfluorophenyl)borate],
N-octadecyl-N-tetradecyl-tolylammonium [tetrakis(perfluorophenyl)borate],
N-octadecyl-N-dodecyl-tolylammonium [tetrakis(perfluorophenyl)borate],
N-octadecyl-N-decyl-tolylammonium [tetrakis(perfluorophenyl)borate],
N-hexadecyl-N-tetradecyl-tolylammonium [tetrakis(perfluorophenyl)borate],
N-hexadecyl-N-dodecyl-tolylammonium [tetrakis(perfluorophenyl)borate],
N-hexadecyl-N-decyl-tolylammonium [tetrakis(perfluorophenyl)borate],
N-tetradecyl-N-dodecyl-tolylammonium [tetrakis(perfluorophenyl)borate],
N-tetradecyl-N-decyl-tolylammonium [tetrakis(perfluorophenyl)borate],
N-dodecyl-N-decyl-tolylammonium [tetrakis(perfluorophenyl)borate],
N-methyl-N-octadecylanilinium [tetrakis(perfluorophenyl)borate],
N-methyl-N-hexadecylanilinium [tetrakis(perfluorophenyl)borate],
N-methyl-N-tetradecylanilinium [tetrakis(perfluorophenyl)borate],
N-methyl-N-dodecylanilinium [tetrakis(perfluorophenyl)borate],
N-methyl-N-decylanilinium [tetrakis(perfluorophenyl)borate], and
N-methyl-N-octylanilinium [tetrakis(perfluorophenyl)borate].

Additional useful activators and the synthesis of non-aromatic-hydrocarbon soluble activators, are described in U.S. Ser. No. 16/394,166 filed Apr. 25, 2019, U.S. Ser. No. 16/394,186, filed Apr. 25, 2019, and U.S. Ser. No. 16/394,197, filed Apr. 25, 2019, which are incorporated by reference herein.

The typical activator-to-catalyst ratio, e.g., all NCA activators-to-catalyst ratio is about a 1:1 molar ratio. Alternate ranges include from 0.1:1 to 100:1, alternately from 0.5:1 to 200:1, alternately from 1:1 to 500:1, alternately from 1:1 to 1000:1. A particularly useful range is from 0.5:1 to 10:1, such as 1:1 to 5:1.

It is also within the scope of the present disclosure that the catalyst compounds can be combined with combinations of alumoxanes and NCA's (see for example, U.S. Pat. Nos. 5,153,157; 5,453,410; EP 0573120; WO 1994/007928; and WO 1995/014044 which discuss the use of an alumoxane in combination with an ionizing activator).

Optional Scavengers or Co-Activators: In addition to the activator compounds, scavengers or co-activators may be used. Suitable co-activators may be selected from the group consisting of trialkylaluminum, dialkylmagnesium, alkylmagnesium halide, and dialkylzinc. Aluminum alkyl or organoaluminum compounds which may be utilized as scavengers or co-activators include, for example, trimethylaluminum, triethylaluminum, triisobutylaluminum, tri-n-hexylaluminum, tri-n-octylaluminum, and the like. Other oxophilic species, such as diethyl zinc may be used. As mentioned above, the organometallic compound used to treat the calcined support material may be a scavenger or co-activator, or may be the same as or different from the scavenger or co-activator. In an embodiment, the co-activator is selected from the group consisting of: trimethylaluminum, triethylaluminum, triisobutylaluminum, tri-n-octylaluminum, trihexylaluminum, and diethylzinc (alternately the group consisting of trimethylaluminum, triethylaluminum, triisobutylaluminum, trihexylaluminum, tri-n-octylaluminum, dimethylmagnesium, diethylmagnesium, dipropylmagnesium, diisopropylmagnesium, dibutyl magnesium, diisobutylmagnesium, dihexylmagnesium, dioctylmagnesium, methylmagnesium chloride, ethylmagnesium chloride, propylmagnesium chloride, isopropylmagnesium chloride, butyl magnesium chloride, isobutylmagnesium chloride, hexylmagnesium chloride, octylmagnesium chloride, methylmagnesium fluoride, ethylmagnesium fluoride, propylmagnesium fluoride, isopropylmagnesium fluoride, butyl magnesium fluoride, isobutylmagnesium fluoride, hexylmagnesium fluoride, octylmagnesium fluoride, dimethylzinc, diethylzic, dipropylzinc, and dibutylzinc).

Chain Transfer Agents: The present disclosure further relates to methods to polymerize olefins using the above complexes in the presence of a chain transfer agent (“CTA”). The CTA can be any suitable chain transfer agent such as those disclosed in WO 2007/130306. The CTA can be selected from periodic group 2, 12 or 13 alkyl or aryl compounds; such as zinc, magnesium or aluminum alkyls or aryls; such as where the alkyl is a C₁ to C₃₀ alkyl, alternately a C₂ to C₂₀ alkyl, alternately a C₃ to C₁₂ alkyl, typically selected independently from methyl, ethyl, propyl, butyl, isobutyl, tertbutyl, pentyl, hexyl, cyclohexyl, phenyl, octyl, nonyl, decyl, undecyl, and dodecyl; e.g., dialkyl zinc compounds, where the alkyl is selected independently from methyl, ethyl, propyl, butyl, isobutyl, tertbutyl, pentyl, hexyl, cyclohexyl, and phenyl, such as di-ethylzinc; or e.g., trialkyl aluminum compounds, where the alkyl is selected independently from methyl, ethyl, propyl, butyl, isobutyl, tertbutyl, pentyl, hexyl, cyclohexyl, and phenyl; or e.g., diethyl aluminum chloride, diisobutylaluminum hydride, diethylaluminum hydride, di-n-octylaluminum hydride, dibutylmagnesium, diethylmagnesium, dihexylmagnesium, and triethylboron.

CTAs can be present in a polymerization reactor at from 10, or 20, or 50, or 100, equivalents to 600, or 700, or 800, or 1,000 equivalents relative to the catalyst component. Alternately the CTA is preset at a catalyst complex-to-CTA molar ratio of from about 1:3000 to 10:1; alternatively 1:2000 to 10:1; alternatively 1:1000 to 10:1; alternatively, 1:500 to 1:1; alternatively 1:300 to 1:1; alternatively 1:200 to 1:1; alternatively 1:100 to 1:1; alternatively 1:50 to 1:1; or/and alternatively 1:10 to 1:1.

Monomers: Monomers useful for stage 1 are C₂ to C₄₀ olefins, preferably either propylene or ethylene, with an optional small amount of comonomers (C₂-C₁₀ olefin, preferably alpha olefin) such that the melting point of the resulting materials is at least 100° C. Monomers useful for stage 2 polymerizations of the present disclosure include substituted or unsubstituted C₂ to C₄₀ alpha olefins, such as C₂ to C₂₀ alpha olefins, such as C₂ to C₁₂ alpha olefins, such as ethylene, propylene, butene, pentene, hexene, heptene, octene, nonene, decene, undecene, dodecene and isomers thereof. In at least one embodiment, the monomer comprises propylene and optional co-monomer(s) comprising one or more of ethylene or C₄ to C₄₀ olefins, such as C₄ to C₂₀ olefins, or such as C₆ to C₁₂ olefins. The C₄ to C₄₀ olefin monomers may be linear, branched, or cyclic. The C₄ to C₄₀ cyclic olefins may be strained or unstrained, monocyclic or polycyclic, and may optionally include heteroatoms and/or one or more functional groups. In at least one embodiment, the monomer is propylene and no co-monomer is present.

Exemplary C₂ to C₄₀ olefin monomers and optional co-monomers include ethylene, propylene, butene, pentene, hexene, heptene, octene, nonene, decene, undecene, dodecene, norbornene, cyclopentene, cycloheptene, cyclooctene, cyclododecene, 7-oxanorbornene, substituted derivatives thereof, and isomers thereof, such as hexene, heptene, octene, nonene, decene, dodecene, cyclooctene, 1-hydroxy-4-cyclooctene, 1-acetoxy-4-cyclooctene, 5-methylcyclopentene, cyclopentene, norbornene, and their respective homologs and derivatives.

In at least one embodiment, one or more dienes are present in a stage 2 polymerization providing for a copolymer (such as an EPDM) having a diene content of up to 10 weight %, such as from 0.00001 to 1.0 weight %, such as from 0.002 to 0.5 weight %, such as from 0.003 to 0.2 weight %, based upon the total weight of the polymer produced in the second stage. In at least one embodiment, 500 ppm or less of diene is added to the stage 2 polymerization, such as 400 ppm or less, such as 300 ppm or less. In other embodiments, at least 50 ppm of diene is added to the stage 2 polymerization, or 100 ppm or more, or 150 ppm or more.

In embodiments of the invention, the TPV has a diene content of up to 10 weight 00 such as from 0.00001 to 1.0 weight %, such as from 0.002 to 0.5 weight %, based upon the total weight of the polymer produced after all polymerization stages.

Exemplary diolefin monomers for stage 2 polymerizations of the present disclosure include any suitable hydrocarbon structure, such as C₄ to C₃₀, having at least two unsaturated bonds, wherein at least two of the unsaturated bonds are suitable for incorporation into a polymer by either a stereospecific or a non-stereospecific catalyst(s). Diolefin monomers can be selected from alpha, omega-diene monomers (e.g., di-vinyl monomers). Diolefin monomers can be linear di-vinyl monomers, such as those containing from 4 to 30 carbon atoms. Examples of exemplary dienes include butadiene, 1,3-pentadiene, 1,4-pentadiene, 1,3-hexadiene, 1,4-hexadiene, 1,5-hexadiene, 1,3-heptadiene and its diene isomers, octadiene isomers, nonadiene isomers, decadiene isomers, undecadiene isomers, dodecadiene isomers, tridecadiene isomers, tetradecadiene isomers, pentadecadiene isomers, hexadecadiene isomers, heptadecadiene isomers, octadecadiene isomers, nonadecadiene isomers, icosadiene isomers, heneicosadiene isomers, docosadiene isomers, tricosadiene isomers, tetracosadiene isomers, pentacosadiene isomers, hexacosadiene isomers, heptacosadiene isomers, octacosadiene isomers, nonacosadiene isomers, triacontadiene isomers, such as 1,6-heptadiene, 1,7-octadiene, 1,6-octadiene, 7-Methyl-1,6-octadiene, 1,8-nonadiene, 1,9-decadiene, 1,10-undecadiene, 1,11-dodecadiene, 1,12-tridecadiene, 1,13-tetradecadiene, and low molecular weight polybutadienes (Mw less than 1000 g/mol). Exemplary cyclic dienes include cyclopentadiene, vinylnorbornene, norbornadiene, ethylidene norbornene, divinylbenzene, dicyclopentadiene or higher ring containing diolefins with or without substituents at various ring positions. In at least one embodiment, a diolefin monomer is selected from norbornadiene, dicyclopentadiene, cyclooctadiene, 7-oxanorbornadiene, substituted derivatives thereof, and isomers thereof, such as 1,5-cyclooctadiene. For gas phase polymerization, a low boiling point diolefin compound is desired, the diolefin of choice should therefore be less than 8 carbons, e.g., C₅ to Cₛ dienes such as 1,4-pentadiene, 1,4-hexadiene, 1,5-hexadiene, 2-methyl-1,4-pentadiene, 3-methyl-1,4-pentadiene, 1,4-, 1,5-, and 1,6-heptadiene, 1,4-, 1,5-, 1,6-, and 1,7-octadiene, and their diene isomers. Suitable diolefin monomers are non-conjugated dienes; such as suitable diolefin monomers are non-conjugated dienes with one of the vinyl group having more substituents than the other that is a terminal double bond linked to only one carbon, e.g., H₂C═CH—C moiety.

Stage 2 polymerizations or copolymerizations are carried out using olefins such as ethylene, propylene, 1-butene, 1-hexene, 4-methyl-1-pentene, and 1-octene, vinylcyclohexane, norbornene and norbornadiene. In particular, propylene and ethylene are polymerized in stage 2. Preferably, in stage 2, propylene and ethylene are polymerized with a diene. In at least one embodiment, the monomers comprise 0 wt % diene monomer in the stage 1 polymerization.

In a stage 2 polymerization, the co-monomer(s) can be present in the final propylene polymer composition at less than 70 mol %, such as from 10 mol % to 65 mol %, such as from 20 mol % to 60 mol %, such as from 45 mol % to 55 mol %, such as from 10 mol % to 20 mol %, such as from 7 mol % to 15 mol %, with the balance of the copolymer being made up of the main monomer (e.g., propylene), based on mol %.

In at least one embodiment, the polymer produced in stage 1 is iPP, such as isotactic polypropylene (typically isotactic homopolymer), and aPP, such as atactic polypropylene (typically atactic homopolymer), and the polymer produced in stage 2 is an ethylene-propylene-diene monomer terpolymer (EPDM). In at least one embodiment, the polymer produced in stage 2 includes propylene and from 0.5 mol % to 50 mol % ethylene (such as ethylene from 0.5 mol % to 45 mol %, such as from 1 mol % to 30 mol %, such as from 3 mol % to 25 mol %, such as from 5 mol % to 20 mol %, such as from 7 mol % to 15 mol %), and from 0.1 mol % to 20 mol % diene (such as from 0.2 mol % to 10 mol %, such as from 0.5 mol % to 5 mol %, such as from 0.5 mol % to 3 mol %, such as from 1 mol % to 2 mol %) with the balance of the copolymer being made up of propylene.

Sequential Polymerization: The propylene polymer compositions according to embodiments of the present disclosure may be prepared using polymerization processes such as a two-stage process in two reactors or a three-stage process in three reactors, although it is also possible to produce these compositions in a single reactor using batch mode with staged addition of monomers. In embodiments, each stage may be independently carried out in either the gas, solution or liquid slurry phase. For example, the first stage (stage 1) may be conducted in the slurry phase and the second stage (stage 2) in the gas phase or vice versa and the optional third stage (stage 3) in gas or slurry phase. Alternatively, each phase may be the same in the various stages. The propylene polymer compositions of the present disclosure can be produced in multiple reactors, such as two or three, operated in series, where iPP and aPP are polymerized first in a slurry phase. EPDM (the polymeric material produced in the presence of iPP and aPP from stage 1) is polymerized in a second reactor such as a gas phase reactor.

As used herein “stage” is defined as that portion of a polymerization process during which one component of the in-reactor composition, e.g., iPP and aPP in stage 1 or EPDM in stage 2, is produced. One or multiple reactors may be used during each stage. The same or different polymerization process may be used in each stage.

The stages of the processes of present disclosure can be carried out in any suitable manner, such as in solution, in suspension or in the gas phase, continuously or batch wise, or any combination thereof, in one or more steps. Homogeneous polymerization processes are useful. For purposes herein, a homogeneous polymerization process is preferably to be a process where at least 90 wt % of the product is soluble in the reaction media. A bulk homogeneous process is also useful, wherein for purposes herein a bulk process is defined to be a process where monomer concentration in all feeds to the reactor is 70 volume % or more. Alternately, in embodiments, no solvent or diluent may be present or added in the reaction medium, except for the small amounts used as the carrier for the catalyst system or other additives, or amounts typically found with the monomer; e.g., propane in propylene as is known in the art. The term “gas phase polymerization” refers to the state of the monomers during polymerization, where the “gas phase” refers to the vapor state of the monomers. In another embodiment, a slurry process is used in one or more stages. As used herein the term “slurry polymerization process” means a polymerization process where a supported catalyst is used and monomers are polymerized on the supported catalyst particles, and at least 95 wt % of polymer products derived from the supported catalyst are in granular form as solid particles (not dissolved in the diluent).

In at least one embodiment, stage 1 produces iPP and aPP, and stage 2 produces copolymer, such as EPDM. It has been discovered that a catalyst of Formula (II) present in the mixed catalyst system during a stage 1 polymerization promotes the formation of aPP, and catalyst of Formula (I) present in the mixed catalyst system during a stage 1 polymerization promotes the formation of iPP. Diene present in a stage 2 polymerization can act as a poison for catalyst of Formula (I) present in the mixed catalyst system, promoting selective EPDM formation in the stage 2 polymerization.

In at least one embodiment, a polymerization process (e.g., stage 1 and or stage 2) of the present disclosure is carried out as a suspension (slurry) or bulk polymerization, where an inert solvent or diluent is not used, i.e., the polymerization is solventless. Solventless polymerizations reduce or eliminate solvent removal (e.g., solvent stripping process) from the polymer product (e.g., a propylene polymer composition) after polymerization. Alternatively, an inert solvent or diluent may be used, for example, the polymerization may be carried out in suitable diluents/solvents. Suitable diluents/solvents for polymerization include non-coordinating, inert liquids. Examples include straight and branched-chain hydrocarbons, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof, such as can be found commercially (ISOPAR™); perhalogenated hydrocarbons, such as perfluorinated C₄₋₁₀ alkanes, chlorobenzene, and aromatic and alkylsubstituted aromatic compounds, such as benzene, toluene, mesitylene, and xylene. Suitable diluents/solvents also include liquid olefins which may act as monomers or co-monomers including ethylene, propylene, 1-butene, 1-hexene, 1-pentene, 3-methyl-1-pentene, 4-methyl-1-pentene, 1-octene, 1-decene, and mixtures thereof. In at least one embodiment, aliphatic hydrocarbon solvents are used as the solvent, such as isobutane, butane, pentane, isopentane, hexanes, isohexane, heptane, octane, dodecane, and mixtures thereof, cyclic and alicyclic hydrocarbons, such as cyclohexane, cycloheptane, methylcyclohexane, methylcycloheptane, and mixtures thereof. In another embodiment, the diluent/solvent is not aromatic, such as aromatics are present in the diluent/solvent at less than 1 wt %, such as less than 0.5 wt %, such as less than 0 wt % based upon the weight of the diluents/solvents. It is also possible to use mineral spirit or a hydrogenated diesel oil fraction as a solvent. Toluene may also be used. The polymerization can be carried out in the liquid monomer(s). If inert solvents are used, the monomer(s) is (are) typically metered in gas or liquid form.

In at least one embodiment, the feed concentration of the monomers and co-monomers for the polymerization is 60 vol % solvent or less, or 40 vol % or less, or 20 vol % or less, based on the total volume of the feedstream. In at least one embodiment, the polymerization is run in a bulk process.

In at least one embodiment, a polymerization can be run at any temperature and/or pressure suitable to obtain the desired polymers. Typical temperatures and/or pressures in any stage include a temperature greater than 30° C., or greater than 50° C., or greater than 65° C., or greater than 70° C., or greater than 75° C., alternately less than 300° C., or less than 200° C., or less than 150° C., or less than 140° C.; and/or at a pressure in the range of from 100 kPa to 20 MPa, about 0.35 MPa to about 10 MPa, or from about 0.45 MPa to about 6 MPa, or from about 0.5 MPa to about 5 MPa.

In embodiments, polymerization in any stage may include a reaction run time of up to 300 minutes, or in the range of from 5 minutes to 250 minutes, or from 10 minutes to 120 minutes. In at least one embodiment, in a continuous process the polymerization time for one or more stages is from 1 minute to 600 minutes, or 5 minutes to 300 minutes, or from about 10 minutes to 120 minutes.

Hydrogen and/or other chani transfer agents (CTA) may be added to one, two, or more reactors or reaction zones. In embodiments, hydrogen and/or CTA are added to control Mw and melt flow rate (MFR) of the polymer produced. In embodiments, the overall pressure in the polymerization in one or more stages is at least about 0.5 bar, or at least about 2 bar, or at least about 5 bar. In embodiments, pressures higher than about 100 bar, e.g., higher than about 80 bar and, in particular, higher than about 64 bar may not be utilized. In at least one embodiment, hydrogen is present in the polymerization reaction zone at a partial pressure of from 0.001 psig to 100 psig (0.007 kPa to 690 kPa), or from 0.001 psig to 50 psig (0.007 kPa to 345 kPa), or from 0.01 psig to 25 psig (0.07 kPa to 172 kPa), or 0.1 psig to 10 psig (0.7 kPa to 70 kPa). In at least one embodiment, hydrogen, and/or CTA, may be added to the first reactor, a second, or third, or subsequent reactor, or any combination thereof. Likewise, in a two stage process hydrogen may be added to the first stage and or the second stage. In at least one embodiment, hydrogen is added in a higher concentration to the second stage as compared to the first stage. In an alternate embodiment, hydrogen is added in a higher concentration to the first stage as compared to the second stage. For further information on stage hydrogen addition in impact copolymer production please see US 2015/0119537, incorporated herein by reference.

Polymerization processes of the present disclosure can be carried out in each of the stages in a batch, semi-batch, or continuous mode. If two or more reactors (or reaction zones) are used, they can be combined so as to form a continuous process. In at least one embodiment, polymerizations can be run at any temperature and or pressure suitable to obtain the desired polymers. In at least one embodiment, the process to produce a propylene polymer composition is continuous.

In at least one embodiment, in stage 1, propylene and from about 0 wt % to 15 wt % C₂ and/or C₄ to C₂₀ alpha olefins (alternately 0.5 wt % to 10 wt %, alternately 1 wt % to 5 wt %), based upon the weight of the monomer/co-monomer feeds (and optional H₂), are contacted with a mixed catalyst system of the present disclosure under polymerization conditions. In stage 1, the monomers can comprise propylene and optional co-monomers comprising one or more of ethylene and/or C₄ to C₂₀ olefins, such as C₄ to C₁₆ olefins, or such as C₆ to C₁₂ olefins. The C₄ to C₂₀ olefin monomers may be linear, branched, or cyclic. The C₄ to C₂₀ cyclic olefins may be strained or unstrained, monocyclic or polycyclic, and may optionally include heteroatoms and/or one or more functional groups. In at least one embodiment, the monomer in stage 1 is propylene and no co-monomer is present to form a polypropylene composition comprising iPP and aPP. Typically, the weight % ratio of iPP:aPP is about 80 wt %:20 wt % or higher (e.g., 90 wt %: 10 wt %) to limit impact on stiffness. The Catalyst I and II ratio can be adjusted and pairs of catalyst where Catalyst I has a higher activity than Catalyst II can be chosen to modify such a ratio.

In at least one embodiment, in stage 2, propylene and from about 0 wt % to 15 wt % C₂ and/or C₄ to C₂₀ alpha olefins (alternately 0.5 to 10 wt %, alternately 1 to 5 wt %), based upon the weight of the monomer/co-monomer feeds, are contacted with a mixed catalyst system of the present disclosure under polymerization conditions to form an EPDM. In the second stage, the monomers can comprise propylene and optional co-monomers comprising one or more of ethylene and/or C₄ to C₂₀ olefins, such as C₄ to C₁₆ olefins, or such as C₆ to C₁₂ olefins. The C₄ to C₂₀ olefin monomers may be linear, branched, or cyclic. The C₄ to C₂₀ cyclic olefins may be strained or unstrained, monocyclic or polycyclic, and may optionally include heteroatoms and/or one or more functional groups. In at least one embodiment, a polymer produced in stage 2 is an EPDM. In at least one embodiment, the polymer produced in stage 2 comprises propylene and from 0.5 mol % to 50 mol % ethylene (such as ethylene from 0.5 mol % to 45 mol %, such as from 1 to 30 mol %, such as from 3 to 25 mol %, such as from 5 mol % to 20 mol %, such as from 7 mol % to 15 mol %), and from 0.1 mol % to 20 mol % diene (such as from 0.2 mol % to 10 mol %, such as from 0.5 mol % to 5 mol %, such as from 0.5 mol % to 3 mol %, such as from 1 mol % to 2 mol %) with the balance of the copolymer being made up of propylene. During stage 2, the EPDM formed is intimately mixed with the iPP and aPP of stage 1, which forms the propylene polymer composition.

In at least one embodiment, during stage 1 or stage 2, a polymerization is performed in the presence of a catalyst system of the present disclosure and hydrogen and or CTA, under polymerization conditions to form iPP and aPP intimately mixed with EPDM which forms the propylene polymer composition.

The catalyst systems used in the stages may be the same or different and can be the same. In at least one embodiment, the catalyst system used in stage 1 is transferred with the polymerizate (e.g., iPP and aPP) to stage 2, where it is contacted with additional monomer to form EPDM, and thus the final propylene polymer composition. In other embodiments, catalyst is provided to one, two, or all three reaction zones.

In at least one embodiment, stage 1 produces an isotactic homopolypropylene and an atactic homopolypropylene, and stage 2 produces a terpolymer of ethylene-propylene-diene, such as ethylene-propylene-7-methyl-1,6-octadiene.

In at least one embodiment, little or no scavenger is used in a polymerization in any stage to produce the polymer, i.e., scavenger (such as trialkyl aluminum) is present at a molar ratio of scavenger metal to transition metal of 0:1, alternately less than 100:1, or less than 50:1, or less than 15:1, or less than 10:1, or less than 1:1, or less than 0.1:1.

Other additives may also be used in the polymerization in any stage, as desired, such as one or more scavengers, promoters, modifiers, hydrogen, CTAs other than or in addition to hydrogen (such as diethyl zinc), reducing agents, oxidizing agents, aluminum alkyls, or silanes, or the like.

In at least one embodiment, the productivity of the catalyst system in a single stage or in all stages combined is at least 50 g(polymer)/g(cat)/hour, such as 500 or more g(polymer)/g(cat)/hour, such as 800 or more g(polymer)/g(cat)/hour, such as 5,000 or more g(polymer)/g(cat)/hour, such as 50,000 or more g(polymer)/g(cat)/hour. For example, in one embodiment, the productivity during stage 1 of a catalyst of Formula (I) is 9-fold higher than a catalyst of Formula (II) during stage 1.

In at least one embodiment, the activity of the catalyst system in a single stage or in all stages combined is at least 50 kg P/mol cat, such as 500 or more kg P/mol cat, such as 5,000 or more kg P/mol cat, such as 50,000 or more kg P/mol cat. According to at least one embodiment, the catalyst system in a single stage or in all stages combined provides a catalyst activity of at least 800, or at least 1,000, or at least 1,500, or at least 2,000 g propylene polymer produced per g of the catalyst precursor compound per hour.

In at least one embodiment, the conversion of olefin monomer is at least 10%, based upon polymer yield and the weight of the monomer entering the reaction zone, or 20% or more, or 30% or more, or 50% or more, or 80% or more. A “reaction zone”, also referred to as a “polymerization zone”, is a vessel or portion thereof or combination of vessels, where the polymerization process takes place, for example, a batch reactor. When multiple reactors are used in either series or parallel configuration, each reactor is considered as a separate polymerization zone. For a multi-stage polymerization in both a batch reactor and a continuous reactor, each polymerization stage is considered as a separate polymerization zone. In at least one embodiment, the polymerization occurs in two, three, four, or more reaction zones. In another embodiment, the conversion of olefin monomer is at least 10%, based upon polymer yield and the weight of the monomer entering all reaction zones, or 20% or more, or 30% or more, or 50% or more, or 80% or more.

Propylene Polymer Compositions: The polymer products herein may comprise polypropylene, such as, iPP, aPP, and EPDM.

Heterophasic Compositions: In at least one embodiment, a propylene polymer composition is a heterophasic propylene polymer composition. In the following embodiments, component A refers to the composition produced after stage 1 discussed in the preceding polymer product embodiments and includes iPP and aPP. In at least one embodiment, component B is an ethylene copolymer or an EP rubber (e.g., EPDM). In at least one embodiment, the matrix phase is comprised primarily of component A, while component B primarily comprises the dispersed phase or is co-continuous. It has been discovered that catalyst systems and polymerization processes of the present disclosure can provide a high amount of rubber fill (e.g., heterophasic composition having 60 wt % EPDM) in a continuous iPP matrix phase also having aPP dispersed therein.

In at least one embodiment, component A is a continuous phase and the component B (e.g., fill rubber such as EPDM) is a dispersed or co-continuous phase.

An “in-situ thermoplastic vulcanizate (TPV)” or “in-situ TPV” is a type of TPV which is a reactor blend of the (A) and (B) components, meaning (A) and (B) were made in separate reactors (or reactions zones) physically connected in series, with the effect that an intimately mixed final product is obtained in the product exiting the final reactor (or reaction zone). Typically, the components are produced in a sequential polymerization process (stage 1 followed by stage 2), wherein (A) is produced in a first reactor is transferred to a second reactor where (B) is produced in a second reactor and (B) is incorporated into the (A) matrix. There may also be a component (C) as another phase different from the phase (A) and phase (B), e.g., a high crystalline phase (A), a semi-crystalline phase (B) and a non-crystalline (C), if the third reactor is used to do a stage 3 polymerization. In at least one embodiment, the polymer composition produced herein is an in-situ TPV, e.g., iPP-EPDM-ICP or iPP-EPDM1-EPDM2.

An “ex-situ thermoplastic vulcanizate (TPV)” or “ex-situ TPV” is a type of TPV which is a physical blend of (A) and (B), meaning (A) and/or (B) were synthesized independently and then subsequently blended typically using a melt-mixing process, such as an extruder. An ex-situ TPV is distinguished by the fact that (A) and (B) are collected in solid form after exiting their respective polymerization processes, and then combined; whereas for an in-situ TPV, (A) and (B) are combined within a common polymerization process (e.g., serial or parallel reactors) and only the blend is collected in solid form. Preferably the instant TPV's are in-situ TPV's.

Compositions (which can include heterophasic compositions): Although PE can be used as the stiff matrix phase construction and EP (C₂C₃), EB (C₂C₄), EH (C₂C₆), or EO (C₂C₈) with a diene can be used to construct the fill phase, here only iPP-EPDM heterophasic copolymer is used to describe the compositions. It should be understood that the stiff PE based polymer with melting point at least 100° C. can be used to form the matrix phase and the very low density (e.g., <0.85) PE with diene derived vinyl end groups can also be used as a fill phase to form the TPV-like compositions.

In at least one embodiment, the propylene polymer made in stage 1 is a mixture of iPP and aPP, one or both of which can be homopolypropylene. In at least one embodiment, the propylene polymer made in stage 2 is propylene copolymer, such as a copolymer of propylene, ethylene, and a diene. In an embodiment, the propylene polymer made in stage 1 is propylene-ethylene-diene terpolymer, where the diene is 7-methyl-1,6-octadiene.

According to at least one embodiment, the propylene polymer matrix (formed in stage 1) has a porosity of 15% or more, e.g., from 20%, or 25%, or 30%, or 35%, or 40%; up to 85%, 80%, 75%, 70%, 60%, or 50%, based on the total volume of the propylene polymer matrix, determined by mercury infiltration porosimetry.

In at least one embodiment, the propylene polymer matrix has a median PD less than 165 μm, e.g., from 6 μm to 160 μm, as determined by mercury intrusion porosimetry. In additional or alternate embodiments, the propylene polymer matrix has a median PD greater than 0.1 μm, greater than 1 μm, or greater than 2 μm, or greater than 5 μm, or greater than 6 μm, or greater than 8 μm, or greater than 10 μm, or greater than 12 μm, or greater than 15 μm, or greater than 20 μm; up to less than 50 μm, or less than 60 μm, or less than 70 μm, or less than 80 μm, or less than 90 μm, or less than 100 μm, or less than 120 μm, or less than 125 μm, or less than 140 μm, or less than 150 μm, or less than 160 μm, or less than 165 μm.

In at least one embodiment, the iPP formed in stage 1 has more than 5, or more than 10, or more than 15 regio defects per 10,000 propylene units, determined by ¹³C NMR.

In at least one embodiment, the propylene polymer composition (iPP+aPP+EPDM) has a multimodal MWD (Mw/Mn). According to at least one embodiment, the propylene polymer composition has a multimodal particle size distribution. According to at least one embodiment, the propylene polymer composition has a multimodal pore size distribution.

In at least one embodiment, the propylene polymer matrix formed in stage 1 comprises a terpolymer, such as an EPDM, (formed in stage 2) at least partially filling the pores in the matrix. For example, the EPDM can be a rubber fill material at least partially filling the pores, such as, for example, an ethylene-propylene-diene terpolymer, e.g., a copolymer of ethylene, from about 3 wt % to 75 wt % of one or more C₃ to C₂₀ alpha olefins (such as propylene), and from about 0.1 wt % to 25 wt % diene, by weight of the terpolymer. The propylene sequences can be isotactic, syndiotactic, or atactic, such as atactic.

In at least one embodiment, the propylene polymer composition is heterophasic, for example, comprising a second polymer, e.g., fill rubber (such as an EPDM formed in stage 2) disposed in the pores in an amount of at least 20 wt %, or at least 30 wt %, or at least 40 wt %, or at least 50 wt %, or at least 60 wt %, or at least 70 wt %, or at least 80 wt % or more, based on a total weight of the propylene polymer composition.

In additional or alternate embodiments, the second polymer is disposed essentially entirely within the pores, i.e., an exterior surface of the polymer particle is essentially free of the second polymer so that the polymer particles remain free flowing and do not agglomerate and plug processing equipment such as reactors, lines, fttings, and/or valves used in their production. Propylene polymer compositions of the present disclosure are free flowing, at least in part, because of the aPP content. In at least one embodiment, a propylene composition comprises atactic polypropylene (aPP) in an amount of from 0.1 wt % to 90 wt %, such as from 1 wt % to 50 wt %, such as from 5 wt % to 50 wt %, such as from 5 wt % to 25 wt %, such as from 5 wt % to 10 wt %, such as from 7 wt % to 10 wt %, based on the total weight of the propylene polymer composition. In at least one embodiment, a ratio of iPP:aPP (by weight) is from 20:1 to 1:1, such as from 20:1 to 4:1, such as from 20:1 to 10:1, such as from 15:1 to 6:1, such as from 10:1 to 4:1, such as about 4:1.

According to at least one embodiment, the propylene polymer composition is in a particulated form, such as, wherein at least 95% by weight has a particle size of 200 μm or greater, such as 500 μm or greater, such as 10 mm or greater, such as 5 mm or greater, such as 1 mm or greater. In at least one embodiment, the propylene polymer composition is in a particulated form, such as, wherein at least 80% by weight has a particle size of 500 μm or greater, such as 600 μm or greater, such as 700 μm or greater.

In at least one embodiment, a propylene polymer composition has an additive content of less than 1 wt %, such as less than 0.5 wt %, such as less than 0.1 wt %, such as 0 wt % based on the total weight of the propylene polymer compositions. In comparison, a propylene polymer composition having iPP and terpolymer (e.g., an EPDM) formed by physical blending (such as melt blending) would necessitate an additive (such as calcium stearate) in order to promote flowable material. Propylene polymer compositions of the present disclosure, however, can be formed by a two-stage process and do not necessitate calcium stearate additive and can have suitable flowability in order to reduce or prevent fouling in a curing extruder. As used herein, a polymer composition is “flowable” or “free flowing” when particles of the polymer composition can be poured in 120 seconds or less through a funnel having a 29 mm bottom opening, as determined by ASTM 1895-method B. Preferably, a free flowing polymer composition herein can pass the mechanical sieving set to give a Gaussian or Gaussian like particle size distribution at ambient temperature, as described in the experimental section.

According to at least one embodiment, the matrix of the propylene polymer is comprised of a plurality of polymer subglobules defining interstitial spaces forming the pores in polymer globules. In additional or alternate embodiments, the matrix further comprises dispersed microparticles of a catalyst system comprising a Catalyst I precursor compound, a Catalyst II precursor compound of Formula (II), an activator, and a support. In additional or alternate embodiments, the support comprises (1) silica agglomerates having an average PS of from 30 μm to 200 μm and comprising a plurality of primary particles having a relatively smaller average PS from 1 nm to 50 μm, wherein the silica agglomerates have a surface area of 400 m²/g or more, a pore volume of from 0.5 mL/g to 2 mL/g, and a mean or average pore diameter of from 1 nm to 20 nm as determined by BET nitrogen adsorption; or (2) a plurality of free primary particles spaced apart from each other in the polymer subglobules, wherein the primary particles comprise one or more of the primary particles disagglomerated from the silica agglomerates; or (3) a combination thereof.

According to at least one embodiment, the matrix of the propylene polymer is comprised of a plurality of polymer subglobules defining interstitial spaces forming the pores in polymer globules. In additional or alternate embodiments, the matrix further comprises dispersed microparticles of a catalyst system comprising a catalyst precursor compound of Formula (I), a catalyst precursor compound of Formula (II), an activator, and a support. In additional or alternate embodiments, the support comprises (1) silica agglomerates having an average PS of from 30 μm to 200 μm and comprising a plurality of primary particles having a relatively smaller average PS from 1 nm to 50 μm, wherein the silica agglomerates have a surface area of 400 m²/g or more, a pore volume of from 0.5 mL/g to 2 mL/g, and a mean or average pore diameter of from 1 nm to 20 nm as determined by BET nitrogen adsorption; or (2) a plurality of free primary particles spaced apart from each other in the polymer subglobules, wherein the primary particles comprise one or more of the primary particles disagglomerated from the silica agglomerates; or (3) a combination thereof.

In at least one embodiment, the propylene polymer compositions produced herein may have a multimodal MWD of polymer species as determined by GPC as described below. By multimodal MWD is meant that the GPC trace has more than one peak or inflection point, typically two or more peaks or inflection points. An inflection point is that point where the second derivative of the curve changes in sign (e.g., from negative to positive or vice versa. In at least one embodiment, the propylene polymer compositions produced herein may have a bimodal MWD of polymer species as determined by GPC as described below. In at least one embodiment, the propylene polymer compositions produced herein may have a unimodal MWD of polymer species as determined by GPC as described below.

Propylene polymer compositions produced herein may have a multimodal pore size distribution (PSD) as determined by laser diffraction. By multimodal PSD is meant that the PSD curve with respect to volume has more than one peak or inflection point. The propylene polymer compositions produced herein may have a bimodal PSD as determined by laser diffraction. In another embodiment, the propylene polymer compositions produced herein may have a unimodal PSD as determined by laser diffraction.

Propylene polymer compositions of the present disclosure can have a 1% secant flexural modulus from 1,000 MPa, about 1,100 MPa, about 1,200 MPa, about 1,250 MPa, about 1,300 MPa, about 1,400 MPa, or about 1,500 MPa to about 1,800 MPa, about 2,100 MPa, about 2,600 MPa, or about 3,000 MPa, as measured according to ASTM D 790 (A, 1.0 mm/min), such as from about 1,100 MPa to about 2,200 MPa, about 1,200 MPa to about 2,000 MPa, about 1,400 MPa to about 2,000 MPa, or about 1,500 MPa or more. 1% Secant flexural modulus is determined by using an ISO 37-Type 3 bar, with a crosshead speed of 1.0 mm/min and a support span of 30.0 mm via an Instron machine according to ASTM D 790 (A, 1.0 mm/min).

Propylene polymer compositions of the present disclosure can have a 1% secant flexural modulus from about 1,000 MPa to about 3,000 MPa, about 1,500 MPa to about 3,000 MPa, about 1,800 MPa to about 2,500 MPa, or about 1,800 MPa to about 2,000 MPa.

Propylene polymer compositions of the present disclosure can have a melt flow rate (MFR, ASTM 1238, 230° C., 2.16 kg) from about 0.1 dg/min, about 0.2 dg/min, about 0.5 dg/min, about 1 dg/min, about 15 dg/min, about 30 dg/min, or about 45 dg/min to about 75 dg/min, about 100 dg/min, about 200 dg/min, or about 300 dg/min. For example, the polymer compositions can have an MFR of about 0.5 dg/min to about 300 dg/min, about 1 dg/min to about 300 dg/min, about 5 dg/min to about 150 dg/min, about 10 dg/min to about 100 dg/min, or about 20 dg/min to about 60 dg/min.

Propylene polymer compositions of the present disclosure can have an MFR (ASTM 1238, 230° C., 2.16 kg) of from about 1 dg/min to about 300 dg/min, about 5 dg/min to about 150 dg/min, about 10 dg/min to about 100 dg/min, or about 20 dg/min to about 60 dg/min, such as from about 50 to about 200 dg/min, such as from about 55 to about 150 dg/min, such as from about 60 to about 100 dg/min.

Propylene polymer compositions of the present disclosure can have an Mw (as measured by GPC as described below) from 50,000 g/mol to 1,500,000 g/mol, alternately from 200,000 g/mol to 1,000,000 g/mol, alternately from 300,000 g/mol to 950,000 g/mol, alternately from 400,000 g/mol to 900,000 g/mol, alternately from 500,000 g/mol to 850,000 g/mol, or alternately from 500,000 g/mol to 800,000 g/mol.

Terpolymers (e.g., EPDM) formed in stage 2 of the present disclosure can have an Mw (as measured by GPC as described below) from 50,000 g/mol to 1,000,000 g/mol, alternately from 80,000 g/mol to 500,000 g/mol, alternately from 100,000 g/mol to 400,000 g/mol, alternately from 200,000 g/mol to 400,000 g/mol, alternately from 200,000 g/mol to 400,000 g/mol, or alternately from 250,000 g/mol to 350,000 g/mol.

In at least one embodiment, a propylene polymer composition can have an Mw/Mn (as measured by GPC as described below) of from 1 to 20, or 1.5 to 15, or 2 to 10, or 3 to 5, or 4 to 5.

In at least one embodiment, the propylene polymer compositions produced herein can have a total propylene content of from 1 mol % to 99 mol %, such as 10 mol % to 80 mol %, such as 50 mol % to 90 mol %, such as 50 mol % to 80 mol %, such as 50 mol % to 75 mol %, based on the propylene polymer composition.

In at least one embodiment, the propylene polymer compositions produced herein can have a total alpha-olefin co-monomer (e.g., ethylene) content from about 1 mol % to about 99 mol %, about 2 mol % to about 50 mol %, about 5 mol % to about 40 mol %, or about 10 mol % to about 40 mol %, based on the propylene polymer composition.

In at least one embodiment, the propylene polymer compositions produced herein have a total diene content from about 0.1 mol % to about 20 mol %, about 0.2 mol % to about 10 mol %, about 0.5 mol % to about 5 mol %, or about 0.8 mol % to about 2 mol %, based on the propylene polymer composition.

In at least one embodiment, the propylene polymer compositions produced herein have a melting point (Tₘ, DSC peak second melt) from at least 100° C. to about 200° C., about 120° C. to about 170° C., about 140° C. to about 165° C., or about 145° C. to about 155° C.

In at least one embodiment, a propylene polymer composition produced herein has a crystallization point (Tc, DSC) of 115° C. or more, such as from at least 100° C. to about 150° C., about 105° C. to about 130° C., about 105° C. to about 125° C., or about 105° C. to about 115° C.

In at least one embodiment, a propylene polymer composition produced herein has a CDBI of 50% or more (such as 60% or more, alternately 70% or more, alternately 80% or more, alternately 90% or more, alternately 95% or more).

In at least one embodiment, a propylene polymer composition produced herein has a unimodal MWD (Mw/Mn) distribution of polymer species, as determined by GPC-4D.

In at least one embodiment, a propylene polymer composition produced herein has a melting heat of fusion (HOFm) of from 20 j/g to 80 j/g, such as 25 j/g to 70 j/g, such as 30 j/g to 60 j/g, such as 50 j/g to 60 j/g.

In at least one embodiment, a propylene polymer composition of the present disclosure has a heat of fusion (Hf) of 30 j/g or less, such as 10 j/g or less, such as 5 j/g or less, such as 1 j/g or less.

¹³C-NMR Spectroscopy on Polyolefins: Polypropylene microstructure is determined by ¹³C-NMR spectroscopy, including the concentration of isotactic and syndiotactic diads ([m] and [r]), triads ([mm] and [rr]), and pentads ([mmmm] and [rrrr]). The designation “in” or “r” describes the stereochemistry of pairs of contiguous propylene groups, “m” referring to meso and “r” to racemic. Samples are dissolved in d2-1,1,2,2-tetrachloroethane at 120° C., and spectra are acquired with a 10-mm broadband probe recorded at 120° C. using a 400 MHz or 700 MHz NMR spectrometer (such as Varian Inova 700 or Unity Plus 400, in event of conflict the 700 shall be used). Polymer resonance peaks are referenced to mmmm=21.83 ppm. Calculations involved in the characterization of polymers by NMR are described by F. A. Bovey in Polymer Conformation and Configuration (Academic Press, New York 1969) and J. Randall in Polymer Sequence Determination, ¹³C NMR Method (Academic Press, New York, 1977).

Regio Defect Concentrations by ¹³C NMR: ¹³Carbon NMR spectroscopy is used to measure stereo and regio defect concentrations in the polypropylene. ¹³Carbon NMR spectra are acquired with a 10-mm broadband probe on a Varian Inova 700 or UnityPlus 400 spectrometer (in event of conflict the 700 shall be used). The samples were prepared in 1,1,2,2-tetrachloroethane-d2 (TCE). Sample preparation (polymer dissolution) was performed at 120° C. In order to optimize chemical shift resolution, the samples were prepared without chromium acetylacetonate relaxation agent. Signal-to-noise was enhanced by acquiring the spectra with nuclear Overhauser enhancement for 10 seconds before the acquisition pulse, and 3.2 second acquisition period, for an aggregate pulse repetition delay of 14 seconds. Free induction decays of 3400-4400 coadded transients were acquired at a temperature of 120° C. After Fourier transformation (256 K points and 0.3 Hz exponential line broadening), the spectrum is referenced by setting the dominant mmmm meso methyl resonance to 21.83 ppm.

Chemical shift assignments for the stereo defects (given as stereo pentads) can be found in the literature [L. Resconi, L. Cavallo, A. Fait, and F. Piemontesi, Chem. Rev. 2000, 100, pp. 1253-1345]. The stereo pentads (e.g., mmmm, mmmr, mrrm, etc.) can be summed appropriately to give a stereo triad distribution (mm, mr, and rr), and the mole percentage of stereo diads (m and r). Three types of regio defects were quantified: 2,1-erythro, 2,1-threo, and 3,1-isomerization. The structures and peak assignments for these are also given in Chem. Rev. 2000, 100, pp. 1253-1345. The concentrations for all defects are quoted in terms of defects per 10,000 monomer units.

The regio defects each give rise to multiple peaks in the carbon NMR spectrum, and these are all integrated and averaged (to the extent that they are resolved from other peaks in the spectrum), to improve the measurement accuracy. The chemical shift offsets of the resolvable resonances used in the analysis are tabulated below. The precise peak positions may shift as a function of NMR solvent choice.

| Regio defect | Chemical shift range (ppm) |
|---|---|
| 2,1-erythro | 42.3, 38.6, 36.0, 35.9, 31.5, 30.6, 17.6, 17.2 |
| 2,1-threo | 43.4, 38.9, 35.6, 34.7, 32.5, 31.2, 15.4, 15.0 |
| 3,1 insertion | 37.6, 30.9, 27.7 |

The average integral for each defect is divided by the integral for one of the main propylene signals (CH₃, CH, CH₂), and multiplied by 10,000 to determine the defect concentration per 10,000 monomer units.

Ethylene content in ethylene copolymers is determined by ASTM D 5017-96, except that the minimum signal-to-noise should be 10,000:1. Propylene content in propylene copolymers is determined by following the approach of Method 1 in Di Martino and Kelchermans, J. Appl. Polym. Sci., 56, p. 1781, (1995), and using peak assignments from Zhang, Polymer, 45, p. 2651 (2004) for higher olefin co-monomers.

Composition Distribution Breadth index (CDBI) is a measure of the composition distribution of monomer within the polymer chains. It is measured as described in WO 1993/003093, specifically columns 7 and 8 as well as in Wild et al, J. Poly. Sci., Poly. Phys. Ed., Vol. 20, p. 441, (1982) and U.S. Pat. No. 5,008,204, including that fractions having Mw below 15,000 g/mol are ignored when determining CDBI.

Unless otherwise indicated, Tg is determined by DSC as described below.

### EXPERIMENTAL

All reactions were carried out under a purified nitrogen atmosphere using standard glovebox, high vacuum or Schlenk techniques, in a CELSTIR reactor unless otherwise noted.

Methylalumoxane (MAO), 30% toluene solution, was obtained from Albemarle Corporation (Baton Rouge, La.) and used as received. Tri-iso-butylaluminum (TIBAL) and tri-n-octylaluminom (TNOAL) were obtained from Sigma Aldrich and used as received. PD14024 and PD13054 silica were obtained from PQ Corporation. D15060A, D100-100A, and D70-120A silica were obtained from AGC Chemicals Americas, Inc. All solvents, obtained from Sigma Aldrich, were anhydrous grade, and were further treated with activated 3A molecular sieves by storing the solvent in a container with 5-10 wt % molecular sieves at least for overnight before use. All deuterated solvents were obtained from Cambridge Isotopes (Cambridge, Mass.) and dried over 3A molecular sieves before use. All ¹H NMR data were collected on a Bruker AVANCE III 400 MHz spectrometer running Topspin™ 3.0 software at room temperature (RT) using tetrachloroethane-d₂ as a solvent (chemical shift of 5.98 ppm was used as a reference) for all materials.

rac-dimethylsilandiyl(4-(3′,5′-di-tert-butyl-4′-methoxy-phenyl)-2-methylindenyl)(4-o-biphenyl-2-hexyl-indenyl)ZrCl₂ can be synthesized according to the method described in the Experimental section of US 2018/0162964 for MCN1.

Dimethylsilandiyl(tetramethylcyclopendienyl) (cyclododecylamido)titanium dimethyl can be prepared as described in U.S. Pat. No. 6,265,338.

Differential Scanning Calorimetry (DSC): Peak crystallization temperature (Tc), peak melting temperature (Tm), heat of fusion (Hf), percent crystallinity, and glass transition temperature (Tg) are measured via differential scanning calorimetry (DSC) using a DSCQ200 unit. The sample is first equilibrated at 25° C. and subsequently heated to 220° C. using a heating rate of 10° C./min (first heat). The sample is held at 220° C. for 3 min. The sample is subsequently cooled down to −100° C. with a constant cooling rate of 10° C./min (first cool). The sample is equilibrated at −100° C. before being heated to 220° C. at a constant heating rate of 10° C./min (second heat). The exothermic peak of crystallization (first cool) is analyzed using the TA Universal Analysis software and the corresponding to 10° C./min cooling rate is determined. The endothermic peak of melting (second heat) is also analyzed using the TA Universal Analysis software and Tₘ corresponding to 10° C./min heating rate is determined. Areas under the DSC curve are used to determine H_{f}, upon melting (HOFm) or He, upon crystallization, and Tg. Materials having no detectable melting point (Tm) and or crystallization point (Tc) are considered amorphous. The heat of fusion (H_{f}) is used to calculate the degree of crystallinity (also called the percent crystallinity). The percent crystallinity (X %) is calculated using the formula: [area under the curve (in J/g)/H° (in J/g)]*100, where H° is the ideal heat of fusion for a perfect crystal of the homopolymer of the major monomer component. These values for H° are to be obtained from the Polymer Handbook, Fourth Edition, published by John Wiley and Sons, New York 1999, except that a value of 290 J/g is used for H° (polyethylene), a value of 140 J/g is used for H° (polybutene), and a value of 207 J/g is used for H° (polypropylene).

Silicas useful herein are described in the Table 1 below.

TABLE 1

| | PS | SA | PV | PD |
|---|---|---|---|---|
| Support | um | m²/g | mL/g | nm (Å) |
| AGC D150-60A | 150 | 733 | 1.17 | 6.4 (64) |
| PQ PD13054 | 130 | 671 | 1.11 | 6.6 (66) |
| AGC D100-100A | 100 | 543 | 1.51 | 11 (110) |
| PQ PD-14024 | 85 | 611 | 1.40 | 9.2 (92) |
| AGC D70-120A | 70 | 450 | 1.64 | 12 (120) |
| AGC D70-120A | 70 | 450 | 1.64 | 12 (120) |

PS—average particle size (from manufacturer);
SA—BET surface area (from manufacturer);
PV—pore volume (from manufacturer);
PD—pore diameter (from manufacturer).

### Experiment I—Catalyst Preparation

Silica calcination: Silica PD-14024 400 g was loaded into the tube furnace (Model VST 12/600) and calcined at 200° C. for 6 hours under Nitrogen atmosphere. A container capable of connecting to the calcination device with N₂ protection, was used to collect the calcined silica from the tube furnace.

Activator MAO supportation: In a 4 liter jacket reactor (Ace Glass Inc.) were charged 340 g of calcined PD-14024 silica and 2,380 g of toluene. The reactor was cooled to −10° C. MAO 864 g (13 mmol Al/g silica) was added slowly through an addition funnel while stirring the slurry at 350 rpm. After the completion of the addition, the reaction mixture was stirred at room temperature for 45 minutes and then heated to 100° C. for 3 hours. The agitator was stopped to allow the solid in the slurry to settle. An H¹-NMR spectrum was taken for the supernatant in THF-d8. The NMR result did not show detectable MAO in the supernatant. The reaction mixture as is was carried on to the next step of metallocene catalyst supportation. Estimated yield of supported MAO (sMAO) based on starting material charges was 608 g (340 g silica+864 g×31% MAO).

Dual Catalyst Supportation: The dual catalyst system can be prepared with different methods, for example, mixing the pre-formed silica supported MAO (sMAO) with one of the two catalysts (of Formula (I) or Formula (II)) and then the other catalyst (of Formula (I) or Formula (II)), or simultaneously mixing the two catalysts (a catalyst of Formula (I) and a catalyst of Formula (II)) with the pre-formed sMAO; or mixing the solution of MAO with one of the two catalysts and then adding the other and allow for sufficient reaction time to obtain sufficient activation before contacting a silica support, or simultaneously mixing the solution MAO with the two catalysts before contacting a silica support. It should be understood that the catalyst activation process involving multiple catalyst precursor compounds is an equilibrium reaction and the ratio of the activated catalysts can be different under different MAO to total catalyst ratio. Generally, the higher the MAO:catalyst ratio, the more activated catalyst species are present in the equilibrium reaction. The dual catalyst system of the experimental section herein used higher MAO loading on silica, e.g., ˜20% Al wt % compared to a typical amount of 12-16 Al wt %, to limit the addition sequence effect of catalyst 1 and catalyst 2 during activation. The procedure below first formed a single catalyst composition (catalyst 1, the iPP catalyst) for two purposes: 1) possible iPP only applications; and 2) the isolation of the iPP catalyst contribution in the 2^{nd} stage EPDM polymerization. The procedure below then formed the dual catalyst system by the addition of catalyst 2 (EPDM catalyst) to the supported catalyst 1, therefore the catalyst 1 to catalyst 2 ratio can be manipulated by the addition of a variable amount of catalyst 2 to the fixed catalyst 1 for the dual catalyst system studies.

1. Catalyst 1 supportation: TIBAL based on 0.34 mmol TIBAL/g sMAO was added to the sMAO slurry in toluene and stirred for 15 min. 10.12 g of rac-dimethylsilandiyl(4-(3′,5′-di-tert-butyl-4′-methoxy-phenyl)-2-methylindenyl)(4-o-biphenyl-2-hexyl-indenyl)ZrCl₂ (0.16 wt % Zr/g sMAO) was added into slurry and stirred for 2 hours. The solvent was removed by filtering through the frit at the bottom of the 4 liter jacketed reactor, and the solid was dried under vacuum for overnight. 622.71 g of peach colored supported catalyst was obtained. This single catalyst system is called S-Cat.
2. Catalyst 2 supportation: In a 20 ml vial were charged 2 g of the supported Catalyst 1 made above, 10 g of toluene, and 0.029 g of dimethylsilandiyl(tetramethylcyclopendienyl) (cyclododecylamido)titanium dimethyl (based on 0.16 wt % Ti; Mw: 437.65) and the vial was shaken for 1 hour. After 1 hour, the slurry was filtered through a frit, washed with 2×10 gm toluene and 10 gm pentane, and then dried under vacuum for 3 hours and obtained 1.98 g of solid. Zr: 0.1186% (Inductively Couple Plasma); Ti: 0.1158% (Inductively Couple Plasma), indicating a Zr:Ti ratio of about 1:2 mol:mol. This dual catalyst system is called D-Cat. This procedure was used multiple times for making the dual catalyst system for polymerization tests.

Mineral oil catalyst slurry preparation: 5 wt % supported catalyst mineral oil slurry was used for the polymerization. For example, in a 200 ml round bottom flask took 2.085 gm supported catalyst and 38.26 g dried mineral oil. The bottle was shaken on a shaker to obtain a homogeneous suspension.

### Experiment II—Polymerization

Equipment: 2 Liter Zipper Autoclave was used. The Autoclave has heating and cooling controls and was connected through a manifold to a batch propylene charging line with a volume control device showing the volume in mL, a continuing ethylene feed line with a pressure control device showing the pressure in PSI, a batch hydrogen charging container of 150 mL with a pressure control device showing pressure in PSI, and a nitrogen line. Before each polymerization test, the reactor was heated to 100° C. for 1 hr under N₂ purge. The ethylene is fed into the reactor continually as a gas through a pressure regulator. The propylene was fed into the reactor by batch charge with the volume controllable through a volume measurement device equipped with a side glass showing the volume in mL. Both ethylene and propylene monomers are purified using standard polymerization grade purification columns. The diene used was 7-methyl-1,6-octadiene from Sigma Aldrich. The diene was purified by stirring and storing with Na/K alloy before use.

Polymerization Example 1 (Comparative Example, CP1): This example shows that the single catalyst system containing an iPP catalyst used in the 2 stage iPP-EPDM polymerization does not produce any significant amount of EPDM due to the diene poisoning. Only iPP from the 1^{st} stage iPP polymerization is obtained.

Prior to the run, the 2 Liter zipper autoclave reactor was washed with 500 ml of xylenes to remove any remaining diene that would reduce activity in the upcoming reactor run. The reactor was heated at 90° C. for one hour prior to the run with a Nitrogen purge, and then cooled to room temperature.

In the glove box, 2.0 g of catalyst slurry of S-Cat (the single-catalyst catalyst system) and 1 ml hexane were loaded into a catalyst charging tube. In the 5 mL syringe with a long needle was loaded 1 ml of 5.0 vol % TNOAL hexane solution and the needle tip was capped with a rubber septum. Also, 1.5 g of purified diene was charged into a diene charging tube. Both the catalyst charging tube and the diene charging tube are equipped with an adaptor on each of the two ends that allow the charging tubes to be placed in between either the pressured ethylene or the pressured propylene source and therefore the pressured ethylene or propylene can push the contents in the tubes into the reactor.

One end of the catalyst charging tube was attached to the catalyst charging port, and the other end of the catalyst charging tube was attached to the propylene source. The TNOAL solution in the syringe was added first to the reactor through the scavenger charging port under a low pressure nitrogen protection flow, followed by the addition of 250 ml propylene. Agitator was turned on at 500 rpm for 5 minutes. The reactor controlling software was started and the catalyst was then added in the charging tube at ambient temperature with 100 ml propylene. Pre-polymerization at ambient temperature was performed for 5 minutes, and the reactor pressure was about 190 PSI.

iPP Stage

The reactor temperature was increased to 70° C. and maintained for 10 minutes under agitation of 500 rpm with the average reactor pressure showing about 418 PSI.

EPDM Stage

Prior to the diene and ethylene introduction, the agitator frequency was reduced to 250 rpm. The propylene in the reactor was slowly vented to 350 PSI. This very slow venting allowed for very little temperature drop, e.g., >65° C. The ethylene line was connected to one end of the diene charging tube similar to the catalyst charging tube having an adaptor and a valve on each of the two ends to allow the diene to be pushed into the reactor through the pressured ethylene. The other end of the diene charging tube was connected to the reactor charging port. The ethylene pressure was adjusted to 500 PSI therefore to give an ethylene partial pressure of 150 PSI on top of the 350 PSI propylene pressure already in the reactor. The agitation was increased to 500 rpm and the two valves of the diene charging tube were simultaneously opened to allow the pressured ethylene to push the diene into the reactor with a continuing ethylene feed with the 500 PSI ethylene pressure. The reactor was maintained at 70° C. at 500 rpm for 20 minutes. The polymerization reaction was stopped by reducing the temperature to ambient and venting the reactor to ambient pressure, the polymer was collected and dried under N₂ flow overnight in the hood. Yield 46 g (Sample CP1).

Polymerization Example 2 (P2): This is a one stage polymerization of propylene using the dual catalyst system to illustrate the aPP contribution from Catalyst 2 (the EPDM catalyst) during a stage 1 polymerization. The choices of iPP catalyst (Catalyst 1) and EPDM catalyst (Catalyst 2) and the amount of each catalyst present in the catalyst system can control the iPP-aPP ratio in the propylene polymerization of stage 1. The use of D-Cat (vide supra) with a ratio of iPP catalyst:EPDM catalyst about 1:2 mol:mol allowed an iPP dominant iPP-aPP mixture composition, e.g., ˜90 wt % iPP, under the conditions below.

In the glove box, 2.0 g catalyst slurry of D-Cat and 1 ml hexane were loaded into a catalyst charging tube. In the 5 mL syringe with a long needle was loaded 1 ml of 5.0 vol % TNOAL hexane solution and the needle tip was capped with a rubber septum. One end of the catalyst charging tube was connected to the reactor catalyst charging port and the other end to the propylene source.

The TNOAL solution was added first to the reactor under low pressure nitrogen protection flow, followed by 250 ml propylene. The agitator was turned on at 500 rpm for 5 min. The reactor controlling software was started and then supported catalyst was added in the charging tube at ambient temperature with 100 ml propylene. Pre-polymerization was performed at ambient temperature for 5 minutes. Then the reactor temperature was increased to 70° C. and run for 10 minutes with the average reactor pressure showing about 364 PSI. The polymerization reaction was stopped by reducing the temperature to ambient and venting the reactor to ambient pressure. The polymer was collected and dried under N₂ flow overnight in the hood. Yield 48 g (Sample P2).

Polymerization Example 3 (P3): This is one of the four iPP-EPDM heterophasic copolymer examples from a two-stage polymerization process using the dual catalyst system D-Cat. Prior to the run, the 2 Liter zipper autoclave reactor was washed with 500 ml of xylenes to remove any remaining diene that might reduce catalyst activity in a reactor run. The reactor was heated at 90° C. for one hour prior to the run with a Nitrogen purge and then cooled to room temperature.

The reactor, procedure, chemicals, and chemical charging devices are the same as those described in Polymerization Example 1, except the use of the dual catalyst system D-Cat to replace the single catalyst system S-Cat. In the glove box, 2.2 g catalyst slurry of D-Cat and 1 ml hexane were loaded into the catalyst charging tube. In the 5 mL syringe with a long needle was loaded 1 ml of 5.0 vol % TNOAL, and the needle tip was capped with a rubber septum. Also, 1.51 g of NaK alloy purified diene was charged in a diene charging tube.

Attached one end of the catalyst charging tube to the catalyst charge port and the other end to the propylene source. The TNOAL solution in the syringe was added first to the reactor through the scavenger charging port under a low pressure nitrogen protection flow, followed by the addition of 100 ml propylene. The agitator was turned on at 500 rpm for 5 minutes. Started run on reactor controlling software and then the catalyst was added in the charging tube at ambient temperature with 250 ml propylene. Pre-polymerization was performed at ambient temperature for 5 min with the reactor pressure showing about 190 PSI.

iPP Stage

The temperature was increased to 70° C. and maintained for 10 minutes under agitation of 500 rpm with the average reactor pressure showing about 400 PSI.

EPDM Stage

Prior to the diene and ethylene introduction, the agitator frequency was reduced to 250 rpm. The propylene in the reactor was slowly vented to 350 PSI. This very slow venting allowed for very little temperature drop, e.g., >65° C. One end of the diene charging tube was connected to the ethylene line and the other end was connected to the reactor. The ethylene pressure was adjusted to 500 PSI therefore to give an ethylene partial pressure of 150 PSI in addition to the 350 PSI propylene pressure already in the reactor. The agitation was increased to 500 rpm and the two valves of the diene charging tube were simultaneously opened to allow both ethylene and diene to feed into the reactor and the reactor was maintained at 70° C. at 500 rpm for 30 minutes. The polymerization reaction was stopped by reducing the temperature to ambient and venting the reactor to ambient pressure. The polymer was collected, mixed well with 0.5 g Irganox in 10 mL toluene, and then dried under N₂ flow overnight in the hood. Yield 171 g (Sample P3).

Polymerization Example 4 (P4): This is one of the four iPP-EPDM heterophasic copolymer examples from a two-stage polymerization using the dual catalyst system D-Cat. Prior to the run, the 2 Liter zipper autoclave reactor was washed with 500 ml of xylenes to remove any remaining diene that might reduce activity in the upcoming reactor run. The reactor was heated at 90° C. for one hour prior to the run with a Nitrogen purge and then cooled to room temperature.

The reactor, procedure, chemicals, and chemical charging devices are the same those described in Polymerization Example 3, except the reaction conditions are changed to obtain different rubber content and a different ethylene content in the rubber phase. In the glove box, 2.2 g catalyst slurry of D-Cat and 1 ml hexane were loaded into the catalyst charging tube. In the 5 mL syringe with a long needle was loaded 1 ml of 5.0 vol % TNOAL and the needle tip was capped with a rubber septum. Also, 1.50 g of NaK alloy purified diene was charged in a diene charging tube.

One end of the catalyst charging tube was attached to the catalyst charge port and the other end of the catalyst charging tube was attached to the propylene source. The TNOAL solution in the syringe was added first to the reactor through the scavenger charge port under a nitrogen protection flow, followed by the addition of 100 ml propylene. The agitator was turned on at 500 rpm for 5 minutes. The reactor controlling software was started and then the supported catalyst system was added in the charge tube at ambient temperature with 250 ml propylene. Pre-polymerization at ambient temperature was performed for 5 minutes with the reactor pressure showing about 170 PSI.

iPP Stage

The temperature is increased to 70° C. and maintained for 10 minutes under agitation of 500 rpm with the average reactor pressure showing about 407 PSI.

EPDM Stage

Prior to the diene and ethylene introduction to the reactor, the agitator frequency was reduced to 250 rpm. The propylene in the reactor was slowly vented to 350 PSI. This very slow venting allowed for very little temperature drop, e.g., >65° C. The ethylene line was connected to the diene charger to allow the high pressure ethylene to push the diene into the reactor. The ethylene pressure was adjusted to 510 PSI to give an ethylene partial pressure of 160 PSI in addition to the 350 PSI propylene pressure already in the reactor. The agitation was increased to 500 rpm and the diene charge valves were simultaneously opened to allow both ethylene and diene to feed into the reactor, and the reactor was maintained at 70° C. at 500 rpm for 30 minutes. The polymerization reaction was stopped by reducing the temperature to ambient and venting the reactor to ambient pressure. The polymer was collected, mixed well with 0.5 g Irganox, and then dried under N₂ flow overnight in the hood. Yield 128 g (Sample P4).

Polymerization Example 5 (P5): This is one of the four iPP-EPDM heterophasic copolymer examples from a two-stage polymerization using the dual catalyst system D-Cat. Prior to the run, the 2 Liter zipper autoclave reactor was washed with 500 ml of xylenes to remove any remaining diene that might reduce activity in the upcoming reactor run. The reactor was heated at 90° C. for one hour prior to the run with a Nitrogen purge and then cooled to room temperature. The reactor, procedure, chemicals, and chemical charging devices are the same as those described in Polymerization Example 3, except the reaction conditions are changed to obtain a different rubber content and a different ethylene content in the rubber phase.

In the glove box, 2.0 g catalyst slurry of D-Cat and 1 ml hexane were loaded into the catalyst charging tube. In the 5 mL syringe with a long needle was loaded 1 ml of 5.0 vol % TNOAL, and the needle tip was capped with a rubber septum. Also, 1.50 g of NaK alloy purified diene was charged in a diene charging tube.

The catalyst charging tube was attached to the catalyst charge port and the propylene source. The TNOAL solution in the syringe was added first to the reactor through the scavenger charging port under a low pressure nitrogen protection flow, followed by the addition of 100 ml propylene. The agitator was turned on at 500 rpm for 5 minutes. The reactor controlling software was started and then catalyst was added to the charging tube at ambient temperature with 250 ml propylene. Pre-polymerization was performed at ambient temperature for 5 minutes with the reactor pressure showing about 184 PSI.

iPP Stage

The reactor temperature was increased to 70° C. and maintained for 10 minutes under agitation of 500 rpm with the average reactor pressure showing about 350 PSI (a small leak was found and fixed before EPDM polymerization stage).

EPDM Stage

Prior to the diene and ethylene introduction, the agitator frequency was reduced to 250 rpm. Because the propylene in the reactor was already 350 PSI due to a small leak that was fixed right away, no venting procedure was applied. The ethylene line was connected to one end of the diene charging tube and the other end of the diene charging tube was connected to the reactor. The ethylene pressure was adjusted to 500 PSI therefore to give an ethylene partial pressure of 150 PSI on top of the 350 PSI propylene pressure already in the reactor. The agitation was increased to 500 rpm and the two valves of the diene charging tube were simultaneously opened to provide both ethylene and diene to feed into the reactor, and the reactor was maintained at 70° C. at 500 rpm for 20 minutes. The polymerization reaction was stopped by reducing the temperature to ambient and venting the reactor to ambient pressure. The polymer was collected, mixed well with 0.5 g Irganox, and then dried under N₂ flow overnight in the hood. Yield 108 g (Sample P5).

Polymerization Example 6 (P6): This is one of the four iPP-EPDM heterophasic copolymer examples from a two-stage polymerization using the dual catalyst system D-Cat. Prior to the run, the 2 Liter zipper autoclave reactor was washed with 500 ml of xylenes to remove any remaining diene that might reduce activity in the upcoming reactor run. The reactor was heated at 90° C. for one hour prior to the run with a Nitrogen purge, and then cooled to room temperature.

The reactor, procedure, chemicals, and chemical charging devices are the same to those described in Polymerization Example 3, except the reaction conditions were changed to obtain a different rubber content and a different ethylene content in the rubber phase. In the glove box, 2.0 g catalyst slurry of D-Cat and 1 ml hexane were loaded into the catalyst charging tube. In the 5 mL syringe with a long needle was loaded 1 ml of 5.0 vol % TNOAL solution and the needle tip was capped with a rubber septum. Also, 1.50 g of NaK alloy purified diene was charged in a diene charging tube.

The catalyst charging tube was attached to the catalyst charging port and the propylene source. The TNOAL solution in the syringe was added first to the reactor through the scavenger charging port under a low pressure nitrogen protection flow, followed by the addition of 100 ml propylene. The agitator was turned on at 500 rpm for 5 minutes. The reactor controlling software was turned on and then the catalyst system was added in the charge tube at ambient temperature with 250 ml propylene. Pre-polymerization was performed at ambient temperature for 5 minutes with the reactor pressure showing about 190 PSI.

iPP Stage

The temperature is increased to 70° C. and maintained for 10 minutes under agitation of 500 rpm with the average reactor pressure showing about 419 PSI.

EPDM Stage

Prior to the diene and ethylene introduction, the agitator frequency was reduced to 250 rpm. The propylene in the reactor was slowly vented to 350 PSI. This very slow venting allowed for very little temperature drop, e.g., >65° C. The ethylene line was then connected to one end of the diene charger and the other end of the diene charging tube was connected to the reactor. The ethylene pressure was adjusted to 500 PSI to give an ethylene partial pressure of 150 PSI in addition to the 350 PSI propylene pressure already in the reactor. The agitation was increased to 500 rpm and the two valves of the diene charging tube were simultaneously opened to allow both ethylene and diene to feed into the reactor, and the reactor was maintained at 70° C. at 500 rpm for 20 minutes. The polymerization reaction was stopped by reducing the temperature to ambient and venting the reactor to ambient pressure. The polymer was collected, mixed well with 0.5 g Irganox, and then dried under N₂ flow overnight in the hood. Yield 108 g (Sample P6).

The four iPP-EPDM polymerization results are summarized in Table 2.

TABLE 2
Sequential Polymerization Summary

| | | iPP Stage | | | EPDM Stage | | | | Pro- |
|---|---|---|---|---|---|---|---|---|---|
| Sam- | | C3 | Reactor | | C3:C2 | | | | ductivity |
| ple | Cat | charge | P | Time | P | Diene | Time | Yield | (gPolym/ |
| ID | (mg) | (mL) | (PSI) | (min) | (PSI) | (mmol) | (min) | (g) | gCat/hr) |
| P3 | 100 | 350 | 400 | 10 | 350:160 | 12.1 | 30 | 171 | 2335 |
| P4 | 100 | 350 | 407 | 10 | 350:150 | 12.1 | 30 | 128 | 1920 |
| P5 | 100 | 350 | 400 | 10 | 350:160 | 12.1 | 20 | 108 | 2160 |
| | | | (350*) | | | | | | |
| P6 | 100 | 350 | 419 | 10 | 350:150 | 12.1 | 20 | 108 | 2160 |

*Reactor small leak caused pressure drop and was corrected before PDM polymerization

### Experiment III—Polymer Characterization

### A. Heterophasic Copolymer Component Quantification by HPLC-SEC

Mass composition of constituent polymers was determined by High Performance Liquid Chromatography-Size Exclusion Chromatography (HPLC-SEC) equipped with an IR5 detector (Polymer Char, S. A., Valencia, Spain). Details of the analysis method and features of the instrument used are as follows.

One high temperature Hypercarb column for HPLC (100.0×4.6 mm, 5 μm particle size) and one high temperature Agilent PL Rapid H column for SEC (100.0×10.0 mm, 10 μm particle size) were used. The various transfer lines, columns, and detector were contained in an oven maintained at 160° C. The nominal flow rate of HPLC is 0.025 mL/min running with a programmed gradient of 1-decanol and 1,2,4,-trichlorobenzene (TCB) mixtures, and the nominal flow rate of SEC was 5 mL/min in TCB. The TCB purchased from Aldrich reagent grade was filtered through membrane (Millipore, polytetrafluoroethylene, 0.1 μm) before use. The 1-decanol was used as received from Alpha Aesar. The 1-decanol polymer solutions were prepared by placing dry polymer and 10 wt % of Irganox 1078 in glass vials, then the Polymer Char auto-sampler transferred a desired amount of 1-decanol, and the mixture was heated at 160° C. with continuous shaking for about 1.5 hours. All quantities were measured gravimetrically. All samples were prepared at a concentration approximately 0.3 to 2.0 mg/mL, with lower concentrations being used for higher molecular weight samples.

The auto-sampler transferred 100 μL of the prepared sample solution into the instrument. The HPLC has a varying gradient composition of a mobile phase of 1-decanol and TCB, beginning with 100 vol. % of 1-decanol under nominal flow rate of 0.025 mL/min. After injection of sample solution, the mobile phase of HPLC was programmatically adjusted with varying linear gradient changes from 0 vol % TCB/min to 100 vol % TCB/min over a period of time. The HPLC gradient profiles used for this analysis (over 300 minute analysis time) is 0% of TCB (0 min), 30% of TCB (150 min), 30% of TCB (170 min), 50% of TCB (190 min), 100% TCB (200 min) and 100% of TCB (300 min). A sampling loop collects HPLC eluents and transfers into SEC every 2 minutes. The SEC has TCB as a mobile phase with the nominal flow rate of 5 mL/min. The IR5 (Polymer Char) infrared detector was used to obtain a concentration and chemical composition of polymer in the eluting flow.

The analysis of HPLC-SEC was performed with using in-house developed MATLAB (Version R2015b) based algorithm (HPC×SEC version 1.8). The chemical composition (CH3/1000C) was calculated from a linear calibration curve of the IR5 detector which was performed with a series of known composition of polymers. The mass compositional percentage was calculated from the ratio of the integrated area of the HPLC chromatography over whole integrated area of HPLC chromatography.

Under the conditions above, the HPLC-SEC normalized intensity vs. eluent volume (mL) plots for polymer samples from Experiment II are as follows:

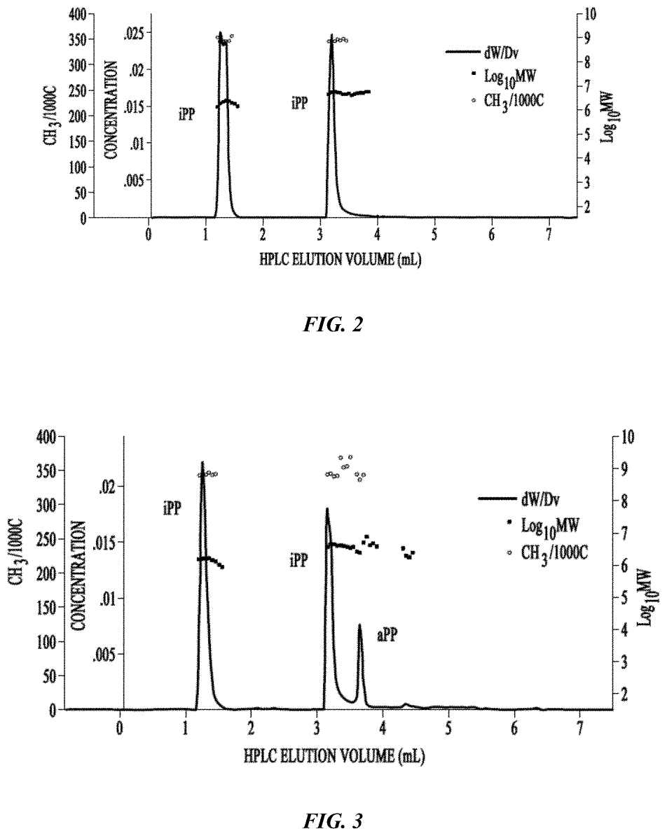

1. Comparative Polymerization Example 1—Sample CP1, which is an iPP homopolymer (shown in FIG. 2).
FIG. 2 is an HPLC projection illustrating the polymer composition obtained from a single catalyst system containing only the iPP catalyst (rac-dimethylsilandiyl(4-(3′,5′-di-tert-butyl-4′-methoxy-phenyl)-2-methylindenyl)(4-o-biphenyl-2-hexyl-indenyl)zirconium dichloride) in a 2-stage polymerization attempted to obtain an iPP matrix in the stage 1 polymerization and an EPDM fill phase in the stage 2 polymerization. However, FIG. 2 illustrate that only iPP is obtained and there is no detectable EPDM present. The iPP shows as two separated components at about 1.5 and 3.3 mL EV (see FIG. 2), which are common for homo-iPP polymers from both the conventional Ziegler-Natta catalysts and the metallocene catalysts using this HPLC-SEC method. Without being bound by theory, the cause of the separation is not fully understood, but the 1st component is likely related to lower molecular weight and higher isotacticity. A lack of EPDM detected indicates a diene poisoning to the iPP catalyst since this catalyst was found to be highly active for ethylene-propylene copolymerization without diene (e.g., stage 1 polymerization). As mentioned previously, it is common that many metallocenes cannot be practically used for diene copolymerization due to the diene poisoning, a problem which can be resolved by use of dual catalyst systems of the present disclosure according to at least one embodiment.
2. Polymerization Example 2—Sample P2 (which is a polyethylene polymer composition comprising iPP-aPP) (shown in FIG. 3).

FIG. 3 is an HPLC projection illustrating the polymer composition obtained from the dual catalyst system in a stage 1 propylene polymerization. FIG. 3 illustrates the aPP contribution from catalyst 2 (EPDM catalyst). The amount of aPP is about 10 wt %. Even with the ratio of 1:2 for catalyst 1 (iPP catalyst) to catalyst 2 (EPDM catalyst), catalyst 1 still dominates the iPP polymerization (e.g., the activity of catalyst 1 under stage 1 polymerization conditions is much higher than the activity of catalyst 2 under stage 1 polymerization conditions).

3. iPP-EPDM Copolymerization Examples 3-6, Samples P3-P6.

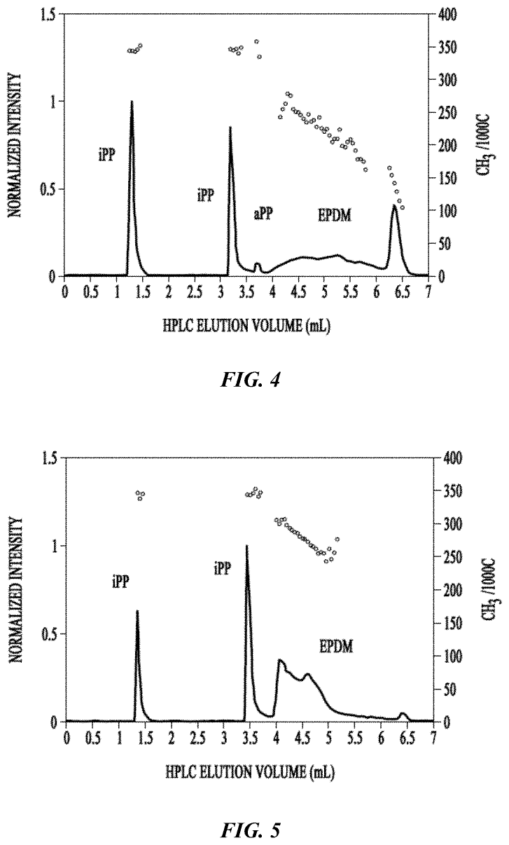

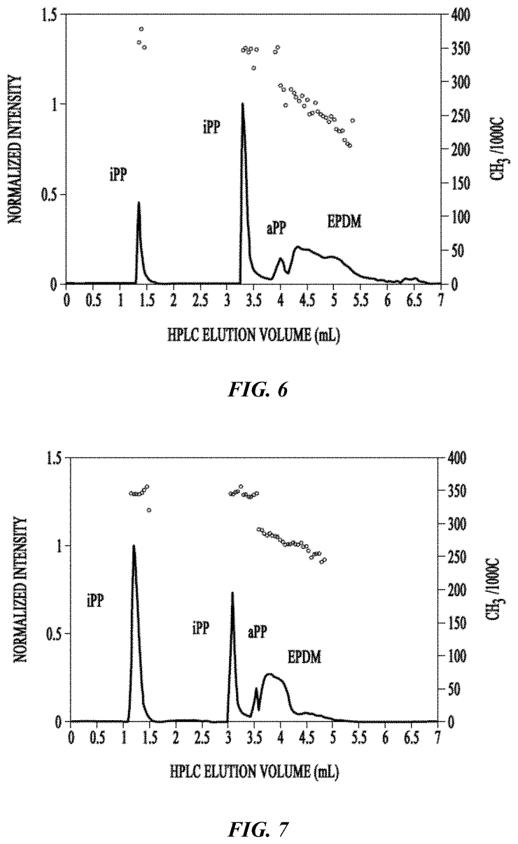

FIG. 4 is an HPLC projection illustrating the polymer composition: iPP-EPDM HeteroPhasic Copolymer (P3). FIG. 5 is an HPLC projection illustrating the polymer composition: iPP-EPDM Heterophasic Copolymer (P4). FIG. 6 is an HPLC projection illustrating the polymer composition: iPP-EPDM heterophasic Copolymer (P5). FIG. 7 is an HPLC projection illustrating the polymer composition: iPP-EPDM heterophasic Copolymer (P6). The HPLC-SEC results for these samples are summarized in Table 3.

TABLE 3
HPLC Results for Samples P1-P6

| | Begin of | End of | Propylene in | |
|---|---|---|---|---|
| | elution | elution | Component* | Component |
| Sample ID | (mL) | (mL) | (wt %) | (wt %) |
| CP1 | 1.1 | 1.7 | 100 (iPP) | 54.8 |
| | 3.0 | 5.0 | 100 (iPP) | 42.0 |
| P2 | 1.1 | 1.7 | 100 (iPP) | 36.9 |
| | 3.1 | 3.6 | 100 (iPP) | 45.6 |
| | 3.6 | 3.8 | 100 (aPP) | 10.8 |
| P3 | 1.2 | 1.7 | 100 (iPP) | 21.3 |
| | 3.1 | 3.7 | 100 (iPP) | 19.1 |
| | 3.7 | 3.9 | 100 (aPP) | 2.2 |
| | 3.9 | 6.9 | 72.6-31.2 (EPDM) | 57.4 |
| P4 | 1.3 | 1.8 | 100 (iPP) | 11.3 |
| | 3.4 | 3.9 | 100 (iPP) | 24.1 |
| | 3.9 | 6.6 | 91.5-72.9 (EPDM) | 64.6 |
| P5 | 1.3 | 1.8 | 100 (iPP) | 9.9 |
| | 3.2 | 3.9 | 100 (iPP) | 31.3 |
| | 3.9 | 6.9 | 87.6-72.6 (EPDM) | 58.5 |
| P6 | 1.0 | 1.7 | 100 (iPP) | 35.9 |
| | 2.9 | 3.5 | 100 (iPP) | 19.8 |
| | 3.5 | 5.4 | 87.3-73.5 (EPDM) | 44.3 |

Calculated based on CH₃/1000 C (the dot distribution in FIG. 2 to FIG. 7), e.g., if the CH₃ concentration is 333 CH₃/1000 C, then the total propylene (CH₃—CH═CH₂) C is 333 × 3 = 999, which is a 100 wt % homo-polypropylene.

Sample P3 in Table 3 shows the EPDM phase about 57.4% with propylene distribution from 72.6 to 31.2 wt %. The aPP from the catalyst 2 (EPDM catalyst) is about 2.2 wt %. Due to the batch propylene charge and continuing ethylene charge in the single reactor setup, the EPDM phase shows a decreasing propylene content in the normalized intensity vs. elution volume plots, indicating that at the beginning of the EPDM copolymerization stage, the EPDM generated has a higher propylene content, but at the end, the propylene content is lower. A narrower methyl distribution (i.e., the propylene distribution) or a close to fixed ratio of propylene to ethylene can be obtained once both propylene and ethylene are co-fed in a controlled ratio, e.g., in a commercial scale reactor.

B. iPP-EPDM Heterophasic Copolymer Crystallinity Determination by DSC
Differential Scanning Calorimetry was performed as described above. The results of DSC for P3, P4, P5, and P6 polymer samples are collected in Table 4.

TABLE 4
Crystallization Temperature, Melting Temperature, and Heat of Fusion

| Sample | 1^{st} Tc | 1^{st} HOFc | 1^{st} Tm | 1^{st} HOFm | 2^{nd} Tm | 2^{nd} HOFm |
|---|---|---|---|---|---|---|
| ID | (° C.) | (j/g) | (° C.) | (j/g) | (° C.) | (j/g) |
| P3 | 109.7 | 27.5 | 150.1 | 27.3 | 150.4 | 30.5 |
| P4 | 103.4 | 20.9 | 148.0 | 18.3 | 148.1 | 30.4 |
| P5 | 109.7 | 32.4 | 150.1 | 32.6 | 150.5 | 37.2 |
| P6 | 110.7 | 50.4 | 151.2 | 52.2 | 151.1 | 55.4 |

Tc = crystallization temperature;
HOFc = crystallization heat of fusion;
Tm = melting temperature;
HOFm = melting heat of fusion;
NR = not recorded

C. Molecular Weight and Ethylene and Diene Contents of the iPP-EPDM Copolymers

GPC-4D was used to obtain molecular weight and ethylene content information; H¹ NMR was used to determine diene contents in the iPP-EPDM copolymers; and C¹³ NMR was used to obtain C₂ contents and compared to GPC-4D results.

Gel Permeantion Chromotography with 4 detectors (GPC-4D) Analysis for Molecular Weight Determination: GPC-4D was the instrumentation used to determine the molecular weight of the polymer samples. Using GPC-4D, the distribution and the moments of molecular weight (Mw, Mn, Mw/Mn, etc.) and the comonomer content (C₂, C₃, C₆, etc.), are determined with a high temperature Gel Permeation Chromatography (PolymerChar GPC-IR) equipped with a multiple-channel band filter based Infrared detector ensemble IR5, in which a broad-band channel is used to measure the polymer concentration while two narrow-band channels are used for characterizing composition. Three Agilent PLgel 10 μm Mixed-B LS columns are used to provide polymer separation. Aldrich reagent grade 1,2,4-trichlorobenzene (TCB) with 300 ppm antioxidant butylated hydroxytoluene (BHT) is used as the mobile phase. The TCB mixture is filtered through a 0.1 μm Teflon filter and degassed with an online degasser before entering the GPC instrument. The nominal flow rate is 1.0 mL/min and the nominal injection volume is 200 μL. The whole system including transfer lines, columns, detectors are contained in an oven maintained at 145° C. Given amount of polymer sample is weighed and sealed in a standard vial with 80 μL flow marker (Heptane) added to it. After loading the vial in the auto-sampler, polymer is automatically dissolved in the instrument with 8 mL added TCB solvent. The polymer is dissolved at 160° C. with continuous shaking for about 1 hour for most PE samples or 2 hour for PP samples. The TCB densities used in concentration calculation are 1.463 g/ml at room temperature and 1.284 g/ml at 145° C. The sample solution concentration is from 0.2 to 2.0 mg/ml, with lower concentrations being used for higher molecular weight samples.

The concentration, c, at each point in the chromatogram is calculated from the baseline-subtracted IR5 broadband signal, I, using the following equation:

c=αI

where α is the mass constant determined with PE or PP standards. The mass recovery is calculated from the ratio of the integrated area of the concentration chromatography over elution volume and the injection mass which is equal to the pre-determined concentration multiplied by injection loop volume.

The molecular weight is determined by combining universal calibration relationship with the column calibration which is performed with a series of monodispersed polystyrene (PS) standards. The MW is calculated at each elution volume with the following equation:

$$log {M}_{X} = \frac{log ( {K}_{P S} / {K}_{X} )}{{a}_{X} + 1} + \frac{{a}_{P S} + 1}{{a}_{X} + 1} log {M}_{P S}$$

where the variables with subscript “PS” stand for polystyrene while those with subscript “x” are for the test samples. In this method, α_{PS}=0.67 and K_{PS}=0.000175, and a and K for other materials are as calculated and published in literature (Sun, T. et al. Macromolecules 2001, 34, 6812), except that for purposes of this invention and claims thereto, α=0.700 and K=0.0003931 for ethylene, propylene, diene momoner copolymers, α=0.705 and K=0.0002288 for propylene polymers, and α=0.695 and K=0.000579 for ethylene polymers.

The comonomer composition is determined by the ratio of the IR detector intensity corresponding to CH₂ and CH₃ channel calibrated with a series of PE and PP homo/copolymer standards whose nominal values are predetermined by NMR or FTIR. GPC-1D, GPC-4D, and H¹ NMR results are illustrated in Table 5.

TABLE 5
GPC and NMR Results for iPP-EPDM
Copolymer MW and C2/Diene Contents

| | | GPC-4D | | | C¹³ | |
|---|---|---|---|---|---|---|
| | GPC-1D | EPDM | | | NMR | H¹ |
| Method | Total | (wt %) | EPDM | C₂ in | C₂ in | NMR |
| Sample | Mw | GPC/ | Mw | EPDM | EPDM | diene/ |
| ID | (k)/PDI | HPLC* | (k)/PDI | (wt %) | (wt %) | 1000 C. |
| P3 | 329.7/4.87 | 61.6/57.4 | 103.6/3.60 | 47.7 | 47 | 1.45 |
| P4 | 579.0/4.41 | 42.7/64.6 | 296.3/5.83 | 28.3 | 27 | 0.91 |
| P5 | 631.5/4.69 | 52.6/58.5 | 291.9/3.92 | 32.3 | 33 | 1.45 |
| P6 | 800.0/4.46 | NR/44.3 | NR | NR | NR | 1.39 |

*HPLC results added for comparison;
NR = not recorded

### Example IV—Granule “Stickiness” Quantification

If the reactor made granules are considered “sticky” (e.g., not flowable), they agglomerate and distort the Gaussian particle size distribution curve of the parent iPP granules to show larger particles and, in particular, a lack of small particles. A mechanical sieve shaker with a set of different mesh size sieve pans is used to obtain particle size distribution curve to determine the stickiness. If a Gaussian or Gaussian like distribution curve is obtained at room temperature (20-25° C.), the granules are defined as non-sticky. The sieve shakers used were Meinzer II Sieve Shaker, CSC Scientific, Model #Meinz 110 (115V, 60 Hz). 8″ Test Sieves, brass sieve pans were used. The sieves were made in compliance with ASTM E11 and ISO 3310 specifications (in event of conflict ASTM E11 controls). A set of 9 sieve pans was used for obtaining the particle size distribution curve with mesh size of 90 μm, 125 μm, 355 μm, 710 μm, 1.0 mm, 1.4 mm, 1.7 mm and 2.3 mm.

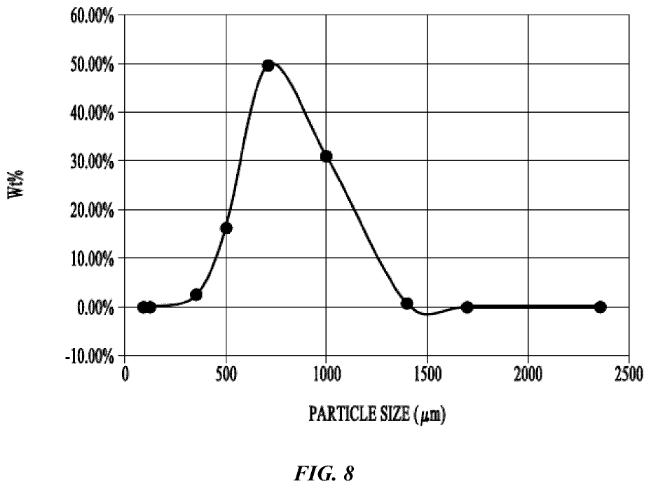

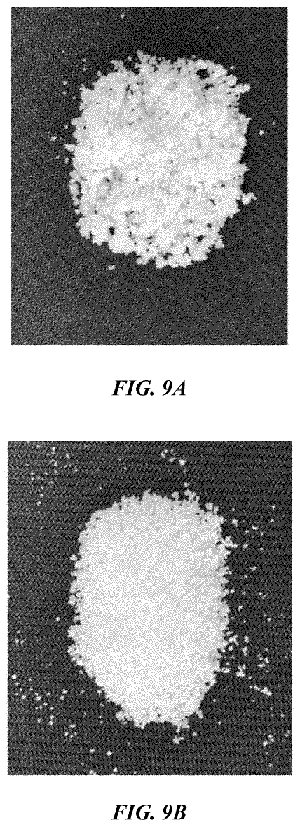

Sample P6, representing one of the iPP-EPDM samples, was sieved through the screen set to obtain the particle size data (shown in Table 6). FIG. 8 is a graph illustrating particle size distribution of polymer sample P6. FIGS. 9a and 9b are images of polymer samples P3 and P6, respectively.

TABLE 6
Granule Particle Size Distribution of Sample P6

| mesh | | | |
|---|---|---|---|
| size(μm) | gm | Wt % | Accumulation |
| 90 | 0 | 0.00% | 0.00% |
| 125 | 0 | 0.00% | 0.00% |
| 355 | 1.42 | 2.54% | 2.54% |
| 500 | 9.08 | 16.25% | 18.79% |
| 710 | 27.68 | 49.53% | 68.32% |
| 1000 | 17.3 | 30.96% | 99.28% |
| 1400 | 0.4 | 0.72% | 100.00% |
| 1700 | 0 | 0.00% | 100.00% |
| 2360 | 0 | 0.00% | 100.00% |
| Total | 55.88 | | |

### Example V—iPP-EPDM Copolymer Properties after Vulcanization

### 1. Cure

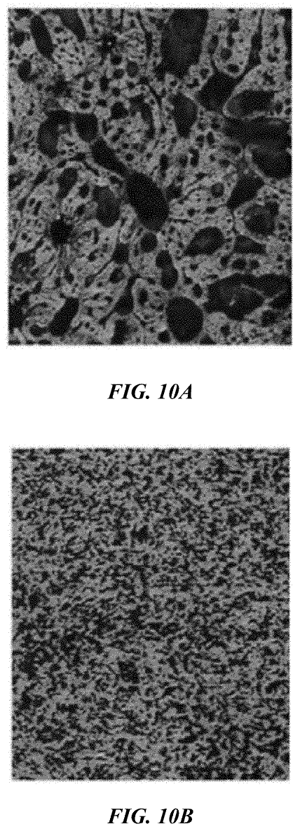

Polymer sample P6 was cured with RIO/SnCl₂ cure package in Brabender in a small scale. RIO is phenolic (SP1045) resin curative in a paraffinic oil and SnCl₂ is the catalyst for cure. 50 phr oil was added to lower the vulcanized compound viscosity. FIGS. 10a and 10b are AFM images of polymer sample P6 before and after curing, respectively. Tapping phase images were acquired on cryo-faced samples (cryo-facing using a cryo-microtome (Leica) at −120° C.) with an Icon AFM (Bruker) operating in tapping mode.

### 2. Elongation

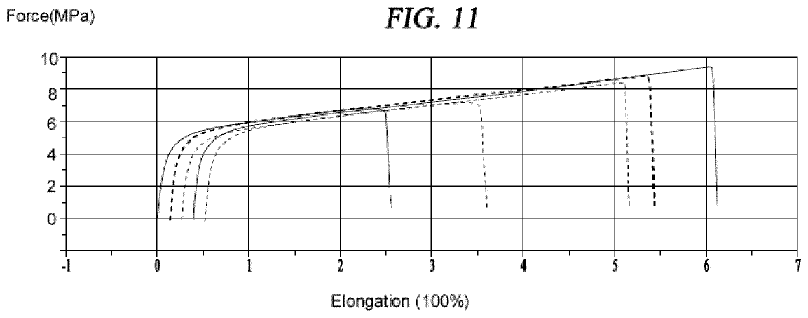

FIG. 11 is a graph illustrating tensile elongation of polymer sample P6 after curing (mean tensile 8.2 Mpa, mean elongation 418%). (Vertical axis is Force; horizontal axis is displacement). These data illustrate that a TPV derived from propylene polymer compositions of the present disclosure can have improved elongation, as compared to a typical lower than 400% elongation found in conventional TPVs made by extrusion blending and dynamic vulcanization of iPP and EPDM blends.

### 3. Hysteresis

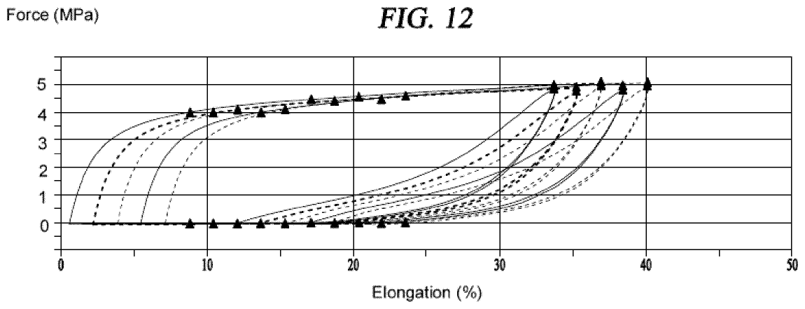

FIG. 12 is a graph illustrating hysteresis of polymer sample P6 after curing. Sample P6 illustrates excellent and consistent recovery. (Vertical axis is Force; horizontal axis is displacement). After compression molding of all TPV samples into plaques, their mechanical properties were measured using an instrument manufactured by Instron and following ASTM standards. The tensile test is based on ISO37 (2005) using 30 mm grip and operating at 508 mm/min extensional rate whereas hysteresis is running 2 cycles with 200% extension at 200 mm/min extensional rate.

Overall, the present disclosure provides dual catalyst systems, propylene polymer compositions, and multistage polymerization methods. Catalyst systems and processes of the present disclosure can provide polypropylene materials that can be heterophasic with a high fill loading of a second polymer component in a first polymer component, polypropylene materials that can be formed without post-reactor blending, polypropylene materials that are flowable (e.g., do not foul a reactor), and polypropylene materials having a low additive content. Processes of the present disclosure can be solventless, can use diene(s) in a second stage polymerization, and do not require post-reactor physical blending or additives for suitable processability.

All documents described herein are incorporated by reference herein for purposes of all jurisdictions where such practice is allowed, including any priority documents, related application and/or testing procedures to the extent they are not inconsistent with this text. As is apparent from the foregoing general description and the specific embodiments, while at least one embodiment has been illustrated and described, various modifications can be made without departing from the spirit and scope of the present disclosure. Accordingly, it is not intended that the scope be limited thereby. Likewise, the term “comprising” is considered synonymous with the term “including.” Likewise whenever a composition, an element or a group of elements is preceded with the transitional phrase “comprising”, it is understood that we also contemplate the same composition or group of elements with transitional phrases “consisting essentially of”, “consisting of”, “selected from the group of consisting of”, or “is” preceding the recitation of the composition, element, or elements and vice versa.

1. A catalyst system comprising a support having a surface area of 400 m²/g or more, a first catalyst compound capable of producing olefin polymer having a Tm of 100° C. or more in a first polymerization reaction and a second catalyst compound capable of producing elastomer or plastomer in a second polymerization reaction and optionally an amorphous polymer in the first polymerization reaction, provided that the first and second catalyst compounds may be the same catalyst compound when the catalyst compound is capable of producing olefin polymer having a Tm of 100° C. or more in the first polymerization reaction and is capable of producing a vulcanizable elastomer or plastomer in the second polymerization reaction.

2. The catalyst system of claim 1, wherein the first catalyst is a bridging C₂, a bridging C₁ or a bridging Cₛ metallocene or post-metallocene, and the second catalyst is a constrained geometry catalyst, a bridging C₁, or a bridging Cₛ metallocene or post metallocene.

3. The catalyst system of claim 1, wherein the first catalsyt compound is represented by Formula (I): 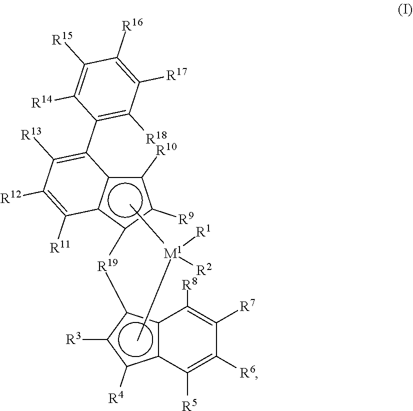
wherein M¹ is selected from the group consisting of titanium, zirconium, hafnium, vanadium, niobium, tantalum, chromium, molybdenum and tungsten;
R¹ and R² are independently hydrogen, halogen, hydroxyl, hydrocarbyl, or substituted hydrocarbyl;
each of R³ and R⁹ is independently linear alkyl;
each of R³, R⁴, R⁶, R⁷, R⁸, R¹⁰, R¹¹, R¹², and R¹³ is independently hydrogen, halogen, C₁-C₄₀ hydrocarbyl or C₁-C₄₀ substituted hydrocarbyl, —NR′₂, —SR′, —OR, —OSiR′₃, —PR′₂, wherein each R′ is hydrogen, halogen, C₁-C₁₀ alkyl, or C₆-C₁₀ aryl;
R⁵ is hydrogen, halogen, C₁-C₄₀ hydrocarbyl or C₁-C₄₀ substituted hydrocarbyl, —NR′₂, —R′, —OR, —OSiR′₃, —PR′₂, wherein each R′ is hydrogen, halogen, C₁-C₁₀ alkyl, or C₅-C₁₀ aryl, or two or more adjacent radicals R⁵ to R⁸ together form one or more saturated or unsaturated rings;
R¹⁹ is —B(R²⁰)—, —Al(R²⁰)—, —O—, —S—, —SO—, —SO₂—, —N(R²⁰)—, —CO—, —P(R²⁰)—, or —P(O)(R²⁰)—, an amidoborane radical or one of the following: 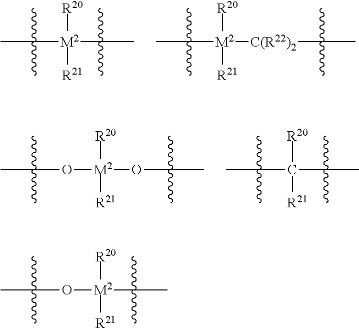
wherein each of R²⁰, R²¹, R²² is independently hydrogen, halogen, C₁-C₂₀ alkyl, C₁-C₂₀ fluoroalkyl or sila-alkyl, C₆-C₃₀ aryl, C₆-C₃₀ fluoroaryl, C₁-C₂₀ alkoxy, C₂-C₂₀ alkenyl, C₇-C₄₀ arylalkyl, C₈-C₄₀ arylalkenyl, C₇-C₄₀ alkylaryl, or one R²⁰ and one R²¹, together with the atoms in R¹⁹ connecting them, form one or more rings; M² is one or more carbons, silicon, germanium or tin;
R¹⁴ is substituted or unsubstituted C₆-C₁₀ aryl;
R¹⁸ is hydrogen, halogen, substituted or unsubstituted C₃-C₂₀ alkyl, substituted or unsubstituted C₆-C₄₀ aryl, C₂-C₁₀ alkenyl, —NR′₂, —SR′, —OR, —OSiR′₃ or —PR′₂, wherein each R′ is hydrogen, halogen, C₁-C₁₀ alkyl, or C₆-C₁₀ aryl;
R¹⁵ and R¹⁷ are independently hydrogen, C₂-C₂₀ alkyl which may be substituted, C₆-C₄₀ aryl which may be substituted, or C₂-C₁₀ alkenyl; and
R¹⁶ is selected from hydrogen, halogen, C₁-C₁₀ alkyl which may be substituted, C₆-C₂₀ aryl which may be substituted, C₂-C₁₀ alkenyl which may be substituted, or two or more adjacent radicals R¹⁵ to R¹⁸ together form one or more rings, and -TR′ₙ, wherein T is a group 14-17 heteroatom having an atomic weight of 13 to 79 and R′ is one of hydrogen, halogen, C₁-C₁₀ alkyl, or C₆-C₁₀ aryl and n is 0, 1, 2, or 3.

4. The catalyst system of claim 1, wherein the second catalyst compound is represented by Formula (II):
T_{y}CpₘMGₙX_{q} (II)
wherein:
Cp is independently a substituted or unsubstituted cyclopentadienyl ligand or substituted or unsubstituted ligand isolobal to cyclopentadienyl;
M is a group 4 transition metal;
G is a heteroatom group represented by the formula JR*_{Z} wherein J is N, P, O or S, and R* is a linear, branched, or cyclic C₁-C₂₀ hydrocarbyl, and z is 1 or 2;
T is a bridging group;
y is 0 or 1;
X is a leaving group;
m=1;
n=1, 2 or 3;
q=0, 1, 2 or 3; and
the sum of m+n+q is equal to the oxidation state of the transition metal.

5. The catalyst system of claim 4, wherein J is N, and R* is methyl, ethyl, propyl, butyl, pentyl, hexyl, heptyl, octyl, nonyl, cyclooctyl, cyclododecyl, decyl, undecyl, dodecyl, adamantyl or an isomer thereof, and where Cp is tetramethylcyclopentadienyl, indenyl, fluorenyl, tetrahydro-as-indacenyl or tetrahydro-s-indacenyl.

6-7. (canceled)

8. The catalyst system of claim 3, wherein R³ is methyl, ethyl, or propyl; and R⁹ is butyl, pentyl, hexyl, heptyl, octyl, nonyl, or decyl; M is Ti, and each X is, independently, is Br, Cl, I, F, methyl, ethyl, propyl, butyl, pentyl, hexyl, cyclopentyl, cyclohexyl, benzyl, phenyl, methylphenyl, or tert-butylphenyl, wherein each X is C₁ to C₅ alkyl, wherein R¹⁴ is phenyl, and wherein R¹⁵ and R¹⁷ are hydrogen.

9. (canceled)

10. The catalyst system of claim 3, wherein R⁵ is:

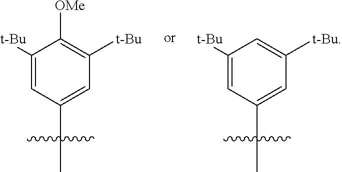 [SMILES: *c1cc(C(C)(C)C)c(OC)c(C(C)(C)C)c1 ; "or" ; *c1cc(C(C)(C)C)cc(C(C)(C)C)c1]

11. (canceled)

12. The catalyst system of claim 1, wherein the second catalyst is one or more of: 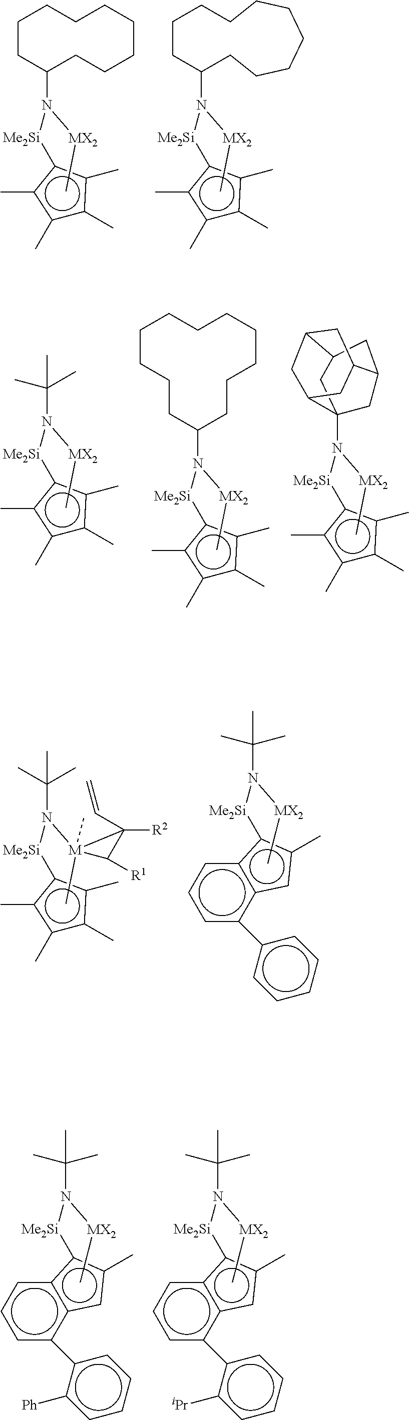 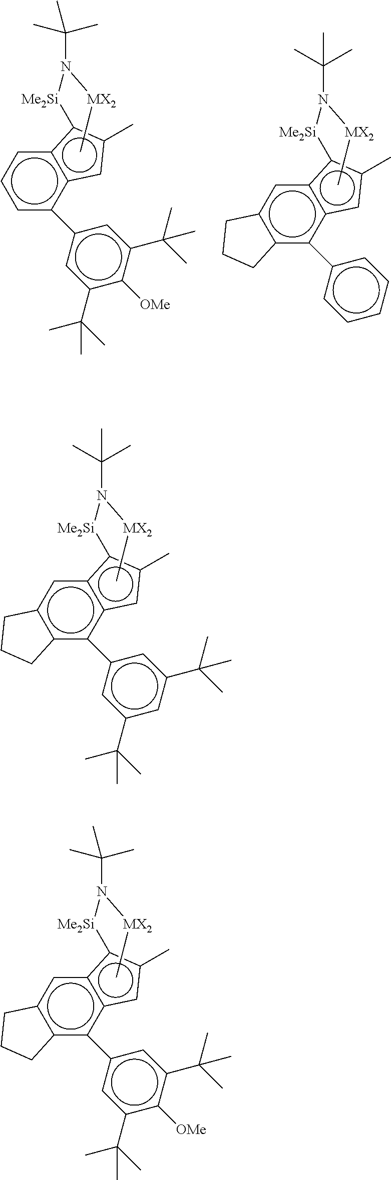 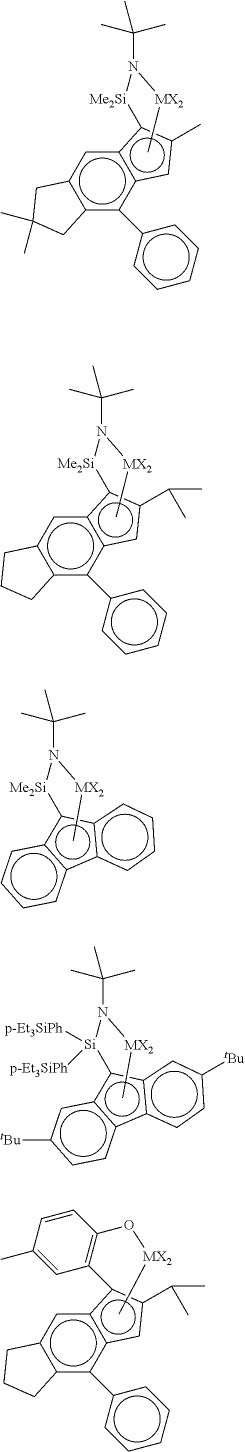 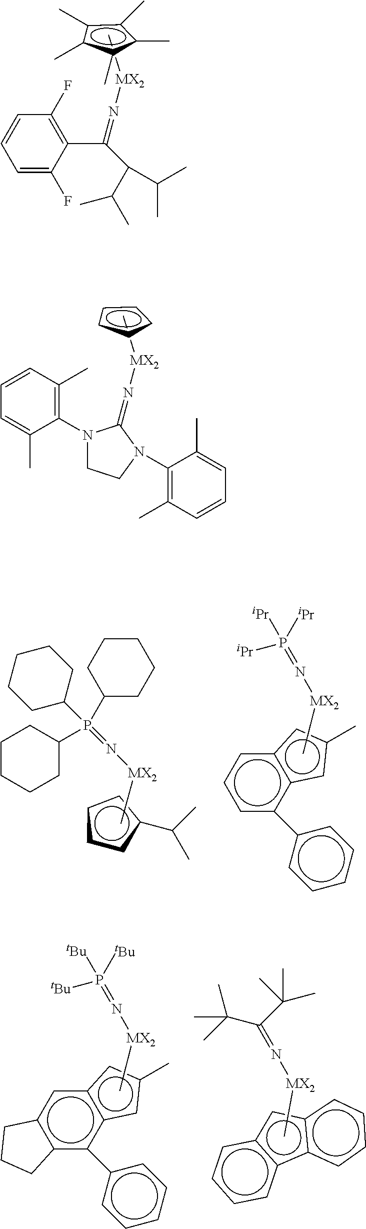 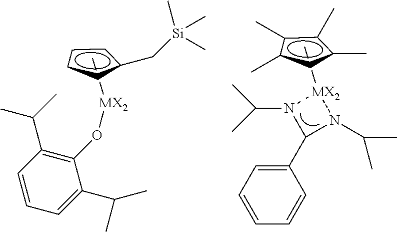
where R¹ or R² is H or Me; M is Ti, Hf or Zr; and each X is independently halogen or C₁ to C₂₀ hydrocarbyl.

13. The catalyst system of claim 1, wherein the second catalyst is:
dimethylsilandiyl(2,3,4,5-tetramethylcyclopentadienyl)(cyclododecyamido)Ti(CH₃)₂,
or dimethylsilandiyl(2,3,4,5-tetramethylcyclopentadienyl)(cyclododecyamido)TiCl₂.

14. The catalyst system of claim 1, wherein the first catalyst is selected from:
dimethylsilandiyl(4-(3′,5′-di-tert-butyl-4′-methoxy-phenyl)-2-methylindenyl)(4-o-biphenyl-2-hexyl-indenyl)ZrCl₂;
dimethylsilandiyl(2-ethyl-4-(3′,5′-di-tert-butyl-4′-methoxyphenyl)indenyl)(2-n-hexyl-4-(o-biphenyl)indenyl)ZrCl₂;
dimethylsilandiyl(2-propyl-4-(3′,5′-di-tert-butyl-4′-methoxyphenyl)indenyl)(2-n-hexyl-4-(o-biphenyl)indenyl)ZrCl₂;
dimethylsilandiyl(2-butyl-4-(3′,5′-di-tert-butyl-4′-methoxyphenyl)indenyl)(2-n-hexyl-4-(o-biphenyl)indenyl)ZrCl₂;
dimethylsilandiyl(2-methyl-4-(3′,5′-bistrifluoromethyl-4′-methoxyphenyl)indenyl)(2-n-hexyl-4-(o-biphenyl)indenyl)ZrCl₂;
dimethylsilandiyl(2-methyl-4-(3′,5′-bistrifluoromethyl-4′-methoxyphenyl)indenyl)(2-n-hexyl-4-(o-biphenyl)indenyl)Zr(CH₃)₂;
dimethylsilandiyl(2-ethyl-4-(3′,5′-bistrifluoromethyl-4′-methoxyphenyl)indenyl)(2-n-hexyl-4-(o-biphenyl)indenyl)ZrCl₂;
dimethylsilandiyl(2-propyl-4-(3′,5′-bistrifluoromethyl-4′-methoxyphenyl)indenyl)(2-n-hexyl-4-(o-biphenyl)indenyl)ZrCl₂;
dimethylsilandiyl(2-butyl-4-(3′,5′-bistrifluoromethyl-4′-methoxyphenyl)indenyl)(2-n-hexyl-4-(o-biphenyl)indenyl)ZrCl₂;
dimethylsilandiyl(2-methyl-4-(3′,5′-di-iso-propyl-4′-methoxyphenyl)indenyl)(2-n-hexyl-4-(o-biphenyl)indenyl)ZrCl₂;
dimethylsilandiyl(2-ethyl-4-(3′,5′-di-iso-propyl-4′-methoxyphenyl)indenyl)(2-n-hexyl-4-(o-biphenyl)indenyl)ZrCl₂;
dimethylsilandiyl(2-propyl-4-(3′,5′-di-iso-propyl-4′-methoxyphenyl)indenyl)(2-n-hexyl-4-(o-biphenyl)indenyl)ZrCl₂;
dimethylsilandiyl(2-butyl-4-(3′,5′-di-iso-propyl-4′-methoxyphenyl)indenyl)(2-n-hexyl-4-(o-biphenyl)indenyl)ZrCl₂;
dimethylsilandiyl(2-methyl-4-(3′,5′-di-phenyl-4′-methoxyphenyl)indenyl)(2-n-hexyl-4-(o-biphenyl)indenyl)ZrCl₂;
dimethylsilandiyl(2-ethyl-4-(3′,5′-di-phenyl-4′-methoxyphenyl)indenyl)(2-n-hexyl-4-(o-biphenyl)indenyl)ZrCl₂;
dimethylsilandiyl(2-propyl-4-(3′,5′-di-phenyl-4′-methoxyphenyl)indenyl)(2-n-hexyl-4-(o-biphenyl)indenyl)ZrCl₂;
dimethylsilandiyl(2-butyl-4-(3′,5′-di-phenyl-4′-methoxyphenyl)indenyl)(2-n-hexyl-4-(o-biphenyl)indenyl)ZrCl₂;
dimethylamidoborane(2-methyl-4-(3′,5′-di-tert-butyl-4′-methoxyphenyl)indenyl)(2-n-hexyl-4-[o-biphenyl] indenyl)ZrCl₂;
dimethylamidoborane(2-ethyl-4-(3′,5′-di-tert-butyl-4′-methoxyphenyl)indenyl)(2-n-hexyl-4-(o-biphenyl)indenyl)ZrCl₂;
dimethylamidoborane(2-propyl-4-(3′,5′-di-tert-butyl-4′-methoxyphenyl)indenyl)(2-n-hexyl-4-(o-biphenyl)indenyl)ZrCl₂;
dimethylamidoborane(2-butyl-4-(3′,5′-di-tert-butyl-4′-methoxyphenyl)indenyl)(2-n-hexyl-4-(o-biphenyl)indenyl)ZrCl₂;
dimethylamidoborane(2-methyl-4-(3′,5′-bistrifluoromethyl-4′-methoxyphenyl)indenyl)(2-n-hexyl-4-(o-biphenyl)indenyl)ZrCl₂;
dimethylamidoborane(2-ethyl-4-(3′,5′-bistrifluoromethyl-4′-methoxyphenyl)indenyl)(2-n-hexyl-4-(o-biphenyl)indenyl)ZrCl₂;
dimethylamidoborane(2-propyl-4-(3′,5′-bistrifluoromethyl-4′-methoxyphenyl)indenyl)(2-n-hexyl-4-(o-biphenyl)indenyl)ZrCl₂;
dimethylamidoborane(2-butyl-4-(3′,5′-bistrifluoromethyl-4′-methoxyphenyl)indenyl)(2-n-hexyl-4-(o-biphenyl)indenyl)ZrCl₂;
dimethylamidoborane(2-methyl-4-(3′,5′-di-iso-propyl-4′-methoxyphenyl)indenyl)(2-n-hexyl-4-(o-biphenyl)indenyl)ZrCl₂;
dimethylamidoborane(2-ethyl-4-(3′,5′-di-iso-propyl-4′-methoxyphenyl)indenyl)(2-n-hexyl-4-(o-biphenyl)indenyl)ZrCl₂;
dimethylamidoborane(2-propyl-4-(3′,5′-di-iso-propyl-4′-methoxyphenyl)indenyl)(2-n-hexyl-4-(o-biphenyl)indenyl)ZrCl₂;
dimethylamidoborane(2-tert-butyl-4-(3′,5′-di-iso-propyl-4′-methoxyphenyl)indenyl)(2-n-hexyl-4-(o-biphenyl)indenyl)ZrCl₂;
dimethylamidoborane(2-methyl-4-(3′,5′-di-phenyl-4′-methoxyphenyl)indenyl)(2-n-hexyl-4-(o-biphenyl)indenyl)ZrCl₂;
dimethylamidoborane(2-ethyl-4-(3′,5′-di-phenyl-4′-methoxyphenyl)indenyl)(2-n-hexyl-4-(o-biphenyl)indenyl)ZrCl₂;
dimethylamidoborane(2-propyl-4-(3′,5′-diphenyl-4′-methoxyphenyl)indenyl)(2-n-hexyl-4-(o-biphenyl)indenyl)ZrCl₂;
dimethylamidoborane(2-butyl-4-(3′,5′-diphenyl-4′-methoxyphenyl)indenyl)(2-n-hexyl-4-(o-biphenyl)indenyl)ZrCl₂;
di-iso-propylamidoborane(2-methyl-4-(3′,5′-di-tert-butyl-4′-methoxyphenyl) indenyl)(2-n-hexyl-4-(o-biphenyl)indenyl)ZrCl₂;
di-iso-propylamidoborane(2-ethyl-4-(3′,5′-di-tert-butyl-4′-methoxyphenyl)indenyl)(2-n-hexyl-4-(o-biphenyl)indenyl)ZrCl₂;
di-iso-propylamidoborane(2-propyl-4-(3′,5′-di-tert-butyl-4′-methoxyphenyl)indenyl)(2-n-hexyl-4-(o-biphenyl)indenyl)ZrCl₂;
di-iso-propylamidoborane(2-butyl-4-(3′,5′-di-tert-butyl-4′-methoxyphenyl)indenyl)(2-n-hexyl-4-(o-biphenyl)indenyl)ZrCl₂;
di-iso-propylamidoborane(2-methyl-4-(3′,5′-bistrifluoromethyl-4′-methoxyphenyl)indenyl)(2-n-hexyl-4-(o-biphenyl)indenyl)ZrCl₂;
di-iso-propylamidoborane(2-ethyl-4-(3′,5′-bistrifluoromethyl-4′-methoxyphenyl)indenyl)(2-n-hexyl-4-(o-biphenyl)indenyl)ZrCl₂;
di-iso-propylamidoborane(2-propyl-4-(3′,5′-bistrifluoromethyl-4′-methoxyphenyl)indenyl)(2-n-hexyl-4-(o-biphenyl)indenyl)ZrCl₂;
di-iso-propylamidoborane(2-butyl-4-(3′,5′-bistrifluoromethyl-4′-methoxyphenyl)indenyl)(2-n-hexyl-4-(o-biphenyl)indenyl)ZrCl₂;
di-iso-propylamidoborane(2-methyl-4-(3′,5′-di-iso-propyl-4′-methoxyphenyl)indenyl)(2-n-hexyl-4-(o-biphenyl)indenyl)ZrCl₂;
di-iso-propylamidoborane(2-ethyl-4-(3′,5′-di-iso-propyl-4′-methoxyphenyl)indenyl)(2-n-hexyl-4-(o-biphenyl)indenyl)ZrCl₂;
di-iso-propylamidoborane(2-propyl-4-(3′,5′-di-iso-propyl-4′-methoxyphenyl)indenyl)(2-n-hexyl-4-(o-biphenyl)indenyl)ZrCl₂;
di-iso-propylamidoborane(2-tert-butyl-4-(3′,5′-di-iso-propyl-4′-methoxyphenyl)indenyl)(2-n-hexyl-4-(o-biphenyl)indenyl)ZrCl₂;
di-iso-propylamidoborane(2-methyl-4-(3′,5′-diphenyl-4′-methoxyphenyl)indenyl)(2-n-hexyl-4-[o-biphenyl] indenyl)ZrCl₂;
di-iso-propylamidoborane(2-ethyl-4-(3′,5′-di-phenyl-4′-methoxyphenyl)indenyl)(2-n-hexyl-4-(o-biphenyl)indenyl)ZrCl₂;
di-iso-propylamidoborane(2-propyl-4-(3′,5′-diphenyl-4′-methoxyphenyl)indenyl)(2-n-hexyl-4-(o-biphenyl)indenyl)ZrCl₂;
di-iso-propylamidoborane(2-butyl-4-(3′,5′-diphenyl-4′-methoxyphenyl)indenyl)(2-n-hexyl-4-(o-biphenyl)indenyl)ZrCl₂;
bis(trimethylsilyl)amidoborane(2-methyl-4-(3′,5′-di-tert-butyl-4′-methoxyphenyl)indenyl)(2-n-hexyl-4-(o-biphenyl)indenyl)ZrCl₂;
bis(trimethylsilyl)amidoborane(2-ethyl-4-(3′,5′-di-tert-butyl-4′-methoxyphenyl)indenyl)(2-n-hexyl-4-(o-biphenyl)indenyl)ZrCl₂;
bis(trimethylsilyl)amidoborane(2-propyl-4-(3′,5′-di-tert-butyl-4′-methoxyphenyl)indenyl)(2-n-hexyl-4-(o-biphenyl)indenyl)ZrCl₂;
bis(trimethylsilyl)amidoborane(2-butyl-4-(3′,5′-di-tert-butyl-4′-methoxyphenyl)indenyl)(2-n-hexyl-4-(o-biphenyl)indenyl)ZrCl₂;
bis(trimethylsilyl)amidoborane(2-methyl-4-(3′,5′-bistrifluoromethyl-4′-methoxyphenyl) indenyl)(2-n-hexyl-4-(o-biphenyl)indenyl)ZrCl₂;
bis(trimethylsilyl)amidoborane(2-ethyl-4-(3′,5′-bis trifluoromethyl-4′-methoxyphenyl)indenyl)(2-n-hexyl-4-(o-biphenyl)indenyl)ZrCl₂;
bis(trimethylsilyl)amidoborane(2-propyl-4-(3′,5′-bis trifluoromethyl-4′-methoxyphenyl) indenyl)(2-n-hexyl-4-(o-biphenyl)indenyl)ZrCl₂;
bis(trimethylsilyl)amidoboran (2-butyl-4-(3′,5′-bis-trifluorometllyl-4′-methoxyphenyl)indenyl)(2-n-hexyl-4-(o-biphenyl)indenyl)ZrCl₂;
bis(trimethylsilyl)amidoborane(2-methyl-4-(3′,5′-di-iso-propyl-4′-methoxyphenyl)indenyl)(2-n-hexyl-4-(o-biphenyl)indenyl)ZrCl₂;
bis(trimethylsilyl)amidoborane(2-ethyl-4-(3′,5′-di-iso-propyl-4′-methoxyphenyl)indenyl)(2-n-hexyl-4-(o-biphenyl)indenyl)ZrCl₂;
bis(trimethylsilyl)amidoborane(2-propyl-4-(3′,5′-di-iso-propyl-4′-methoxyphenyl)indenyl)(2-n-hexyl-4-(o-biphenyl)indenyl)ZrCl₂;
bis(trimethylsilyl)amidoborane(2-butyl-4-(3′,5′-di-iso-propyl-4′-methoxyphenyl)indenyl)(2-n-hexyl-4-(o-biphenyl)indenyl)ZrCl₂;
bis(trimethylsilyl)amidoborane(2-methyl-4-(3′,5′-diphenyl-4′-methoxyphenyl)indenyl)(2-n-hexyl-4-(o-biphenyl)indenyl)ZrCl₂;
bis(trimethylsilyl)amidoborane(2-ethyl-4-(3′,5′-diphenyl-4′-methoxyphenyl)indenyl)(2-n-hexyl-4-(o-biphenyl)indenyl)ZrCl₂;
bis(trimethylsilyl)amidoborane(2-propyl-4-(3′,5′-diphenyl-4′-methoxyphenyl)indenyl)(2-n-hexyl-4-(o-biphenyl)indenyl)ZrCl₂; and
bis(trimethylsilyl)amidoborane(2-butyl-4-(3′,5′-diphenyl-4′-methoxyphenyl)indenyl)(2-n-hexyl-4-(o-biphenyl)indenyl)ZrCl₂.

15. The catalyst system of claim 1, wherein the first catalyst is dimethylsilandiyl(4-(3′,5′-di-tert-butyl-4′-methoxy-phenyl)-2-methyl-indenyl)(4-o-biphenyl-2-hexyl-indenyl)ZrCl₂.

16. The catalyst system of claim 1, wherein a molar ratio of the fist catalyst to the second catalyst is from 10:1 to 1:4.

17. The catalyst system of claim 1, wherein the support material comprises (as determined by BET nitrogen adsorption) one or more of:
a surface area of from 400 m²/g to 800 m²/g;
an average pore diameter of 90 Angstroms or greater;
an average particle size of 60 μm or greater;
40% or greater of the incremental pore volume comprising pores having a pore diameter larger than 100 Angstroms or greater; and
sub-particles having an average particle size in the range of 0.01 μm to 5 μm.

18. A propylene polymer composition comprising:
isotactic polypropylene;
0.1 to 10 wt % of atactic polypropylene, based on the weight of the composition; and
ethylene-propylene-diene terpolymer.

19. The propylene polymer composition of claim 18, further comprising:
a matrix phase comprising the isotactic polypropylene and the atactic polypropylene; and
a fill phase comprising the ethylene-propylene-diene terpolymer,
wherein the composition comprises 60 wt % or greater of the ethylene-propylene-diene terpolymer, based on the weight of the composition, and wherein the composition comprises from 5 wt % to 10 wt % of the atactic polypropylene; and
wherein the composition comprises an additive content of 5 wt % or less, and wherein the composition is configured to be poured within 120 seconds or less through a funnel having a 29 mm bottom opening, as determined by ASTM 1895-method B.

20-23. (canceled)

24. The catalyst system of claim 1, wherein the second catalyst compound is represented by the formula: 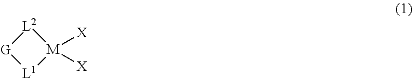
wherein:
M is zirconium;
L¹ is a unsubstituted fluorenyl, heterocyclopentalenyl, or heterofluorenyl, or a substituted fluorenyl, heterocyclopentapentalenyl, or heterofluorenyl ligand with one or more symmetric or pseudo symmetric substituents, each substituent group being, independently, a radical group which is a hydrocarbyl, substituted hydrocarbyl, halocarbyl, substituted halocarbyl, silylcarbyl or germylcarbyl, and optionally two or more adjacent substituents may join to form a substituted or unsubstituted, saturated, partially unsaturated or aromatic, cyclic or polycyclic substituent;
L² is a cyclopentadienyl ring or a substituted cyclopentadienyl ring with one or more symmetric or pseudo symmetric substituents in the 2 and 5 positions of the ring, each substituent group being, independently, a radical group which is a hydrocarbyl, substituted hydrocarbyl, halocarbyl, substituted halocarbyl, silylcarbyl or germylcarbyl;
G is a bridging group;
X are independently, hydride radicals, hydrocarbyl radicals, substituted hydrocarbyl radicals, halocarbyl radicals, substituted halocarbyl radicals, silylcarbyl radicals, substituted silylcarbyl radicals, germylcarbyl radicals, or substituted germylcarbyl radicals; or both X are joined and bound to the metal atom to form a metallacycle ring containing from about 3 to about 20 carbon atoms; or both together can be an olefin, diolefin or aryne ligand; both X may, independently, be a halogen, alkoxide, aryloxide, amide, phosphide or other univalent anionic ligand or both X can also be joined to form a anionic chelating ligand.

25. The catalyst system of claim 24, wherein L¹ is fluorenyl or substituted fluorenyl; L² is cyclopentadienyl; G is be methylene, dimethylmethylene, diphenylmethylene, dimethylsilylene, diphenylsilylene, di(4-triethylsilylphenyl)silylene, ethylene, or di(para-triethylsilylphenyl)methylene, diphenylmethylene, diphenylsilylene, dimethylsilylene, ethylene; X is hydrocarbyl or halogen.

26. The catalyst system of claim 1, wherein the second catalyst comprises one or more of: diphenylmethylene(cyclopentadienyl)(9-fluorenyl)zirconium dichloride, methylene-(cyclopentadienyl)(9-fluorenyl)zirconium dichloride, dimethylmethylene(cyclopentadienyl) (9-fluorenyl)zirconium dichloride, dimethylsilylene(cyclopentadienyl)(9-fluorenyl)zirconium dichloride, diphenylsilylene(cyclopentadienyl)(9-fluorenyl)zirconium dichloride, ethylene-(cyclopentadienyl)(9-fluorenyl)zirconium dichloride, diphenylmethylene(cyclopentadienyl) (9-fluorenyl)zirconium dimethyl, methylene(cyclopentadienyl)(9-fluorenyl)zirconium di-methyl, dimethylmethylene(cyclopentadienyl)(9-fluorenyl)zirconium dimethyl, dimethyl-silylene(cyclopentadienyl)(9-fluorenyl)zirconium dimethyl, diphenylsilylene-(cyclopentadienyl)(9-fluorenyl)zirconium dimethyl, ethylene(cyclopentadienyl)(9-fluorenyl)zirconium dimethyl, and di(para-triethylsilylphenyl)methylene(2,7-di-tert-butyl fluorenyl)(cyclopentadienyl) zirconium dimethyl, diphenylmethylene(cyclopentadienyl)(9-fluorenyl)zirconium dimethyl, diphenyl-methylene(cyclopentadienyl)(9-fluorenyl)zirconium dimethyl, and di(para-triethylsilylphenyl)methylene(2,7-di-tert-butyl fluorenyl)(cyclopentadienyl) zirconium dimethyl.

27. The catalyst system of claim 1, wherein the second catalyst comprises one or more of catalyst compounds represented by the formula: 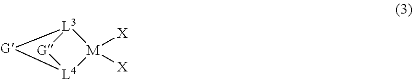
wherein:
M is zirconium;
L³ is a cyclopentadienyl ring optionally substituted in the 4 position of the ring, the substituent group being chosen from a radical group which is a hydrocarbyl, substituted hydrocarbyl, halocarbyl, substituted halocarbyl, silylcarbyl or germylcarbyl;
L⁴ is a substituted cyclopentadienyl ring with symmetric or pseudo symmetric substituents in the 3 and 5 positions of the ring, each substituent group being, independently, a radical group which is a hydrocarbyl, substituted hydrocarbyl, halocarbyl, substituted halocarbyl, silylcarbyl or germylcarbyl;
G′ and G″ are bridging groups; and
X are independently, hydride radicals, hydrocarbyl radicals, substituted hydrocarbyl radicals, halocarbyl radicals, substituted halocarbyl radicals, silylcarbyl radicals, substituted silylcarbyl radicals, germylcarbyl radicals, or substituted germylcarbyl radicals; or both X are joined and bound to the metal atom to form a metallacycle ring containing from about 3 to about 20 carbon atoms; or both together can be an olefin, diolefin or aryne ligand; both X may, independently, be a halogen, alkoxide, aryloxide, amide, phosphide or other univalent anionic ligand or both X can also be joined to form a anionic chelating ligand.

28. The catalyst system of claim 2, wherein the first catalyst compound is a bridging C₁ compound selected from the group consisting of: 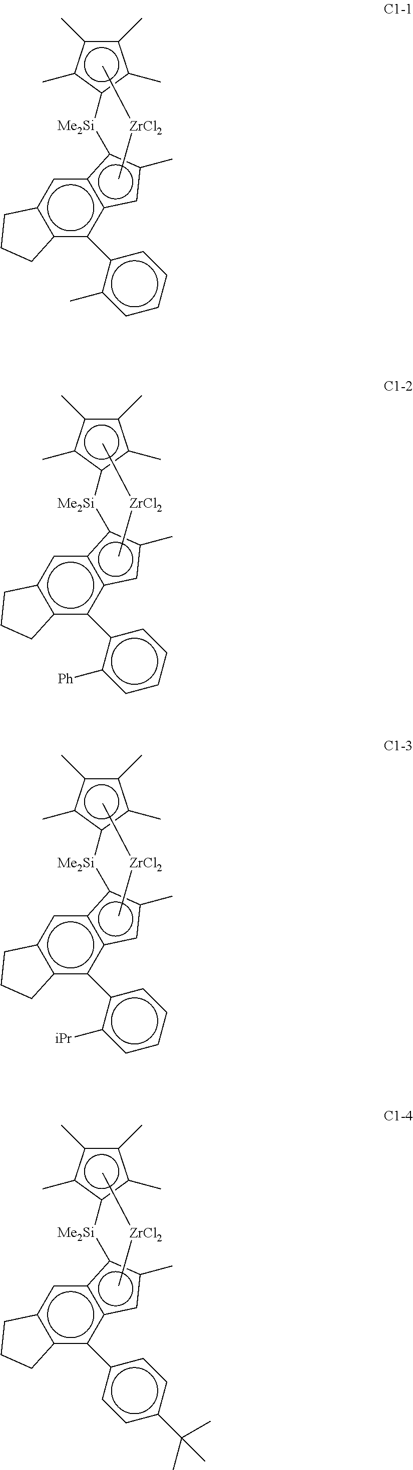 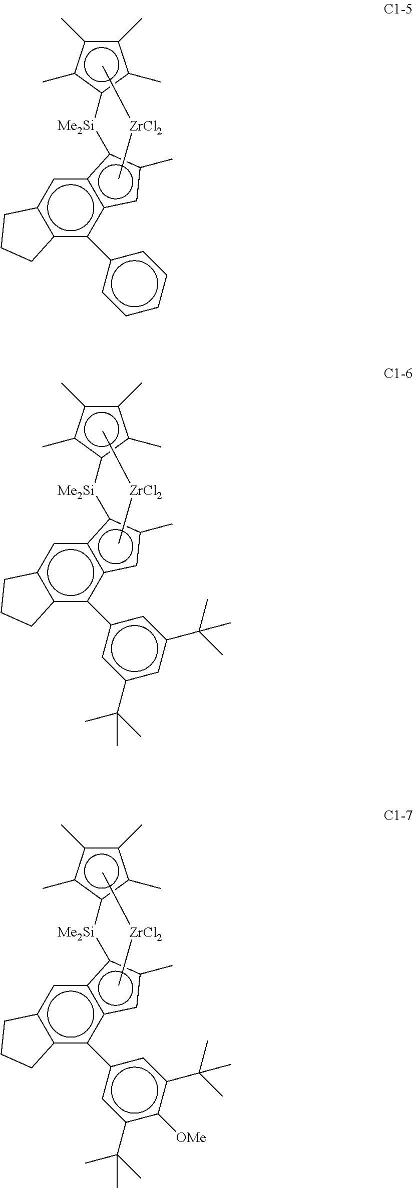 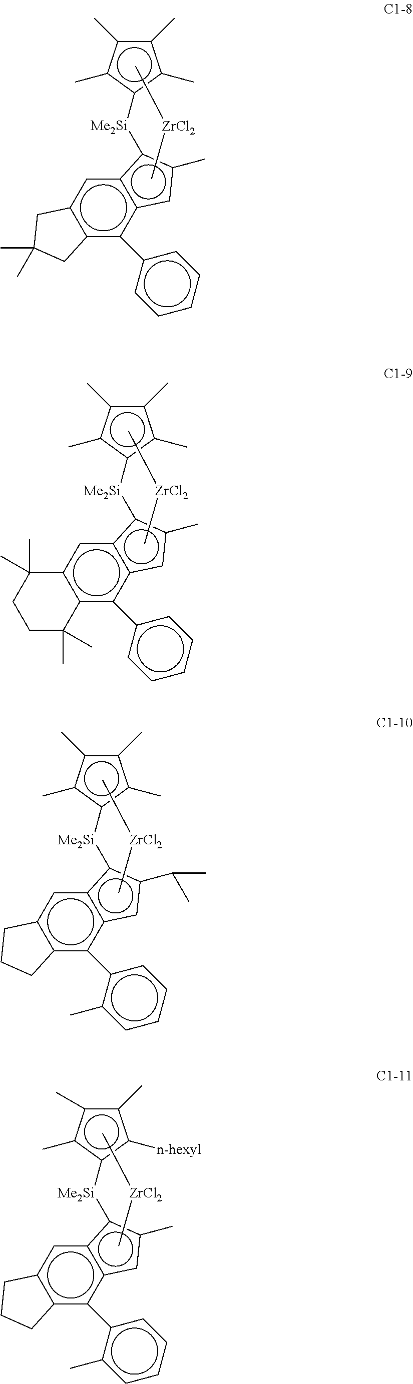 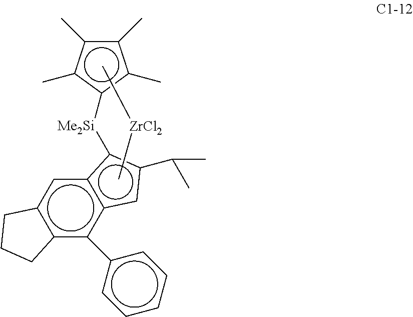 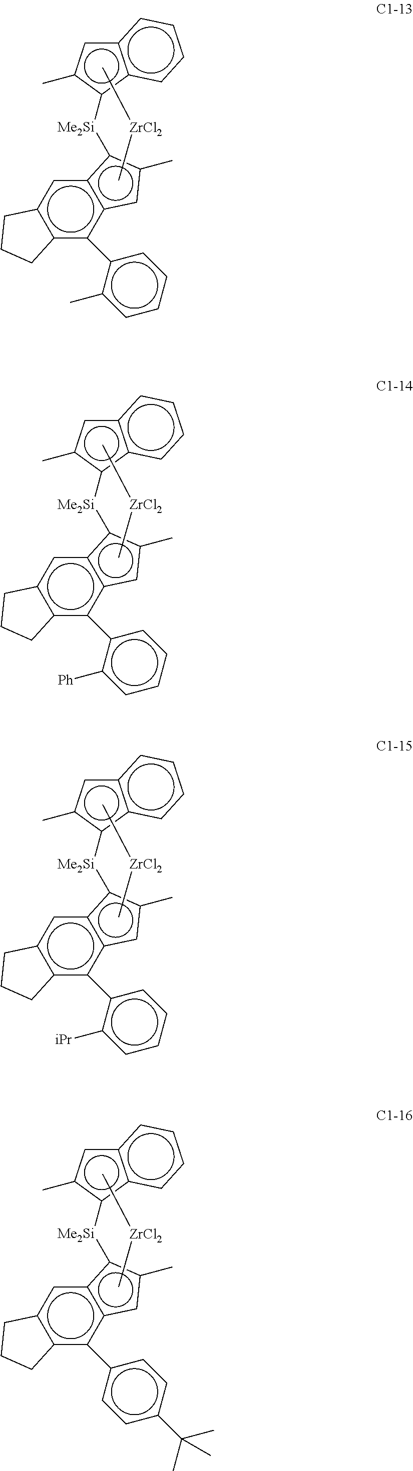 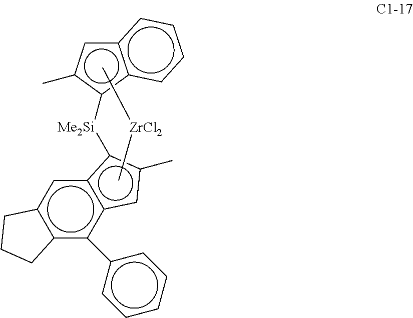 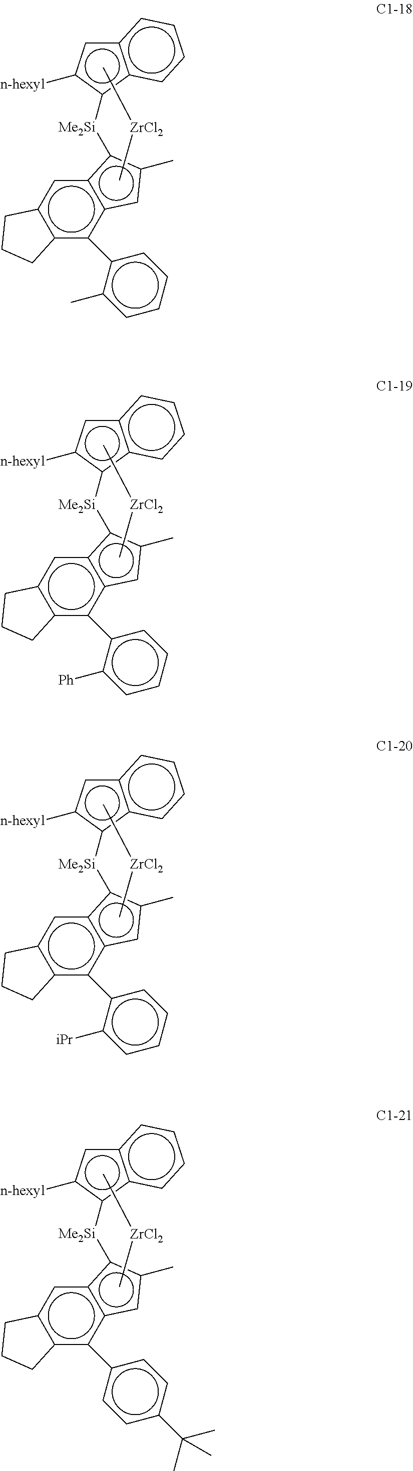 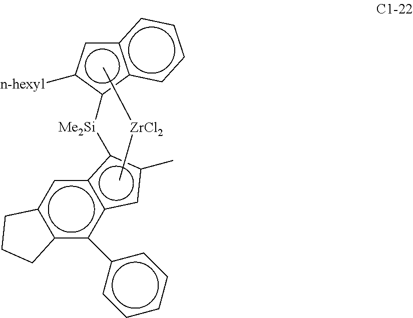 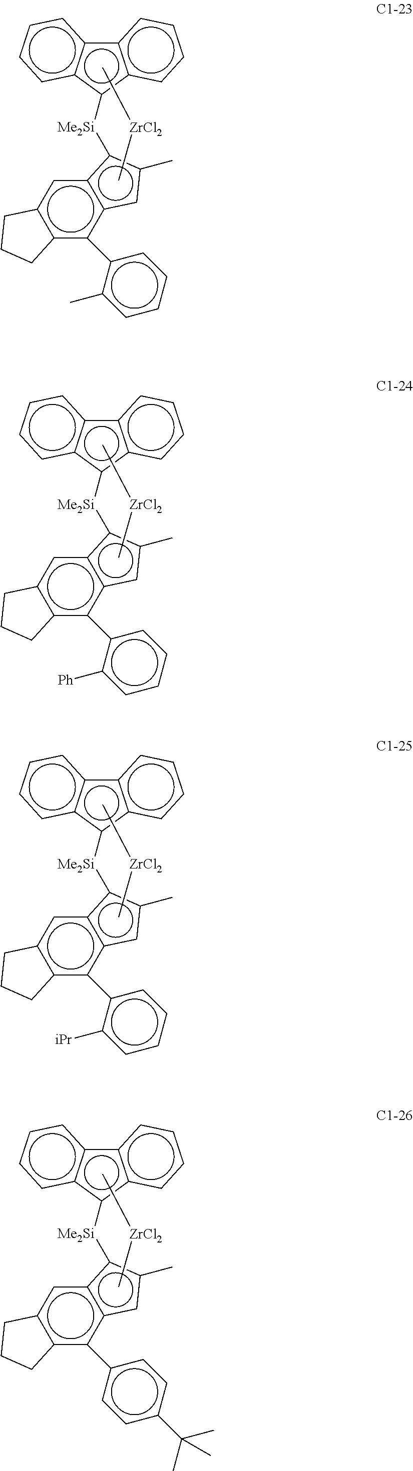 [chemical structure]
